(19) United States
(12) Patent Application Publication
(10) Pub. No.: US 2007/0083730 A1
(43) Pub. Date: Apr. 12, 2007

(54) Data processing device and method

(76) Inventors: Martin Vorbach, Lingenfeld (DE); Markus Weinhardt, Munich (DE); Juergen Becker, Jockgrim (DE)

Correspondence Address: KENYON & KENYON LLP, ONE BROADWAY, NEW YORK, NY, 10004, US

(21) Appl. No.: 10/561,135

(22) PCT Filed: Jun. 17, 2004
(86) PCT No.: PCT/EP04/06547

§ 371 Date: Apr. 25, 2006

(30) Foreign Application Priority Data
Jun. 17, 2003 (EP) 03013694.9
Jul. 2, 2003 (EP) 03015015.5

(51) Int. Cl. G06F 15/00

(52) U.S. Cl. 712/10

(57) ABSTRACT

The present invention relates to a method of coupling at least one (conventional) unit processing data in a sequential manner, e.g. a CPU, von-Neumann-Processor and/or microcontroller, the (conventional) unit for data processing comprising an instruction pipeline, and an array for processing data comprising a plurality of data processing cells, e.g. a preferably coarse grain and/or preferably runtime reconfigurable data processor, FPGA, DFP, DSP, XPP or chaemeleon-technology-like data processing fabric, wherein the array is coupled to the instruction pipeline.

### 2 HARDWARE

2.1 Design Parameter Changes

Since the XPP core shall be integrated as a functional unit into a standard RISC core, some system parameters have to be reconsidered:

2.1.1 Pipelining, Concurrency and Synchronicity

RISC instructions of totally different type (Ld/St, ALU, Mul/Div/MAC, FPALU, FPMul . . . ) are executed in separate specialized functional units to increase the fraction of silicon that is busy on average. Such functional unit separation has led to superscalar RISC designs, that exploit higher levels of parallelism.

Each functional unit of a RISC core is highly pipelined to improve throughput. Pipelining overlaps the execution of several instructions by splitting them into unrelated phases, which are executed in different stages of the pipeline. Thus different stages of consecutive instructions can be executed in parallel with each stage taking much less time to execute. This allows higher core frequencies.

Since the pipelines of all functional units are approximately subdivided into sub-operations of the same size (execution time), these functional units/pipelines execute in a highly synchronous manner with complex floating point pipelines being the exception.

Since the XPP core uses dataflow computation, it is pipelined by design. However, a single configuration usually implements a loop of the application, so the configuration remains active for many cycles, unlike the instructions in every other functional unit, which typically execute for one or two cycles at most. Therefore it is still worthwhile to consider the separation of several phases (e.g.: Ld/Ex/Store) of an XPP configuration (=XPP instruction) into several functional units to improve concurrency via pipelining on this coarser scale. This also improves throughput and response time in conjunction with multi tasking operations and implementations of simultaneous multithreading (SMT).

The multi cycle execution time also forbids a strongly synchronous execution scheme and rather leads to an asynchronous scheme, like for e.g. floating point square root units. This in turn necessitates the existence of explicit synchronization instructions.

2.1.2 Core Frequency and the Memory Hierarchy

As a functional unit, the XPP's operating frequency will either be half of the core frequency or equal to the core frequency of the RISC. Almost every RISC core currently on the market exceeds its memory bus frequency with its core frequency by a larger factor. Therefore caches are employed, forming what is commonly called the memory hierarchy: Each layer of cache is larger but slower than its predecessors.

This memory hierarchy does not help to speed up computations which shuffle large amounts of data with little or no data reuse. These computations are called “bounded by memory bandwidth”. However other types of computations with more data locality (another name for data reuse) gain performance as long as they fit into one of the upper layers of the memory hierarchy. This is the class of applications that gain the highest speedups when a memory hierarchy is introduced.

Classical vectorization can be used to transform memory-bounded algorithms, with a data set too big to fit into the upper layers of the memory hierarchy. Rewriting the code to reuse smaller data sets sooner exposes memory reuse on a smaller scale. As the new data set size is chosen to fit into the caches of the memory hierarchy, the algorithm is not memory bounded any more, yielding significant speed-ups.

2.1.3 Software: Multitasking Operating Systems

As the XPP is introduced into a RISC core, the changed environment—higher frequency and the memory hierarchy—not only necessitate reconsideration of hardware design parameters, but also a reevaluation of the software environment.

Memory Hierarchy

The introduction of a memory hierarchy enhances the set of applications that can be implemented efficiently. So far the XPP has mostly been used for algorithms that read their data sets in a linear manner, applying some calculations in a pipelined fashion and writing the data back to memory. As long as all of the computation fits into the XPP array, these algorithms are memory bounded. Typical applications are filtering and audio signal processing in general.

But there is another set of algorithms, that have even higher computational complexity and higher memory bandwidth requirements. Examples are picture and video processing, where a second and third dimension of data coherence opens up. This coherence is e.g. exploited by picture and video compression algorithms, that scan pictures in both dimensions to find similarities, even searching consecutive pictures of a video stream for an analogies. Naturally these algorithms have a much higher algorithmic complexity as well as higher memory requirements. Yet they are data local, either by design or they can be transformed to be, thus efficiently exploiting the memory hierarchy and the higher clock frequencies of processors with memory hierarchies.

Multi Tasking

The introduction into a standard RISC core makes it necessary to understand and support the needs of a multitasking operating system, as standard RISC processors are usually operated in multitasking environments. With multitasking, the operating system switches the executed application on a regular basis, thus simulating concurrent execution of several applications (tasks). To switch tasks, the operating system has to save the state (i.e. the contents of all registers) of the running task and then reload the state of another task. Hence it is necessary to determine what the state of the processor is, and to keep it as small as possible to allow efficient context switches.

Modern microprocessors gain their performance from multiple specialized and deeply pipelined functional units and high memory hierarchies, enabling high core frequencies. But high memory hierarchies mean that there is a high penalty for cache misses due to the difference between core and memory frequency. Many core cycles pass until the values are finally available from memory. Deep pipelines incur pipeline stalls due to data dependences as well as branch penalties for mispredicted conditional branches. Specialized functional units like floating point units idle for integer-only programs. For these reasons, average functional unit utilization is much too low.

The newest development with RISC processors, Simultaneous MultiThreading (SMT), adds hardware support for a finer granularity (instruction/functional unit level) switching of tasks, exposing more than one independent instruction stream to be executed. Thus, whenever one instruction stream stalls or doesn't utilize all functional units, the other one can jump in. This improves functional unit utilization for today's processors.

With SMT, the task (process) switching is done in hardware, so the processor state has to be duplicated in hardware. So again it is most efficient to keep the state as small as possible. For the combination of the PACT XPP and a standard RISC processor, SMT is very beneficial, since the XPP configurations execute longer than the average RISC instruction. Thus another task can utilize the other functional units, while a configuration is running. On the other side, not every task will utilize the XPP, so while one such non-XPP task is running, another one will be able to use the XPP core.

2.2 Communication Between the RISC Core and the XPP Core.

The following sections introduce several possible hardware implementations for accessing memory.

2.2.1 Streaming

Since streaming can only, support (number_of_IO_ports*width_of_IO_port) bits per cycle, it is only well suited for small XPP arrays with heavily pipelined configurations that feature few inputs and outputs. As the pipelines take a long time to fill and empty while the running time of a configuration is limited (as described under “context switches”), this type of communication does not scale well to bigger XPP arrays and XPP frequencies near the RISC core frequency.
Streaming from the RISC core
In this setup, the RISC supplies the XPP array with the streaming data. Since the RISC core has to execute several instructions to compute addresses and load an item from memory, this setup is only suited, if the XPP core is reading data with a frequency much lower than the RISC core frequency.
Streaming via DMA
In this mode the RISC core only initializes a DMA channel which then supplies the data items to the streaming port of the XPP core.
   2.2.2 Shared Memory (Main Memory)

In this configuration the XPP array configuration uses a number of PAEs to generate an address that is used to access main memory through the IO ports. As the number of IO ports is very limited this approach suffers from the same limitations as the previous one, although for larger XPP arrays the impact of using PAEs for address generation is diminishing. However this approach is still useful for loading values from very sparse vectors.

2.2.3 Shared Memory (IRAM)

This data access mechanism uses the IRAM elements to store data for local computations. The IRAMs can either be viewed as vector registers or as local copies of main memory.

There are several ways to fill the IRAMs with data.
1. The IRAMs are loaded in advance by a separate configuration using streaming.
   This method can be implemented with the current XPP architecture. The IRAMs act as vector registers. As explicated above, this will limit the performance of the XPP array, especially as the IRAMs will always be part of the externally visible state and hence must be saved and restored on context switches.
2. The IRAMs can be loaded in advance by separate load-instructions.
   This is similar to the first method. Load-instructions which load the data into the IRAMs are implemented in hardware. The load-instructions can be viewed as hard coded load-configuration. Therefore configuration reloads are reduced. Additionally, the special load instructions may use a wider interface to the memory hierarchy.
   Therefore a more efficient method than streaming can be used.
3. The IRAMs can be loaded by a “burst preload from memory” instruction of the cache controller. No configuration or load-instruction is needed on the XPP. The IRAM load is implemented in the cache controller and triggered by the RISC processor. But the IRAMs still act as vector registers and are therefore included in the externally visible state.
4. The best mode however is a combination of the previous solutions with the extension of a cache:
   A preload instruction maps a specific memory area defined by starting address and size to an IRAM. This triggers a (delayed, low priority) burst load from the memory hierarchy (cache). After all IRAMs are mapped, the next configuration can be activated. The activation incurs a wait until all burst loads are completed. However, if the preload instructions are issued long enough in advance and no interrupt or task switch destroys cache locality, the wait will not consume any time.
   To specify a memory block as output-only IRAM, a “preload clean” instruction is used, which avoids loading data from memory. The “preload clean” instruction just defines the IRAM for write-back.
   A synchronization instruction is needed to make sure that the content of a specific memory area, which is cached in IRAM, is written back to the memory hierarchy. This can be done globally (full write-back), or selectively by specifying the memory area, which will be accessed.
      2.3 State of the XPP Core

As described in the previous section, the size of the state is crucial for the efficiency of context switches. However, although the size of the state is fixed for the XPP core, it depends on the declaration of the various state elements, whether they have to be saved or not.

The state of the XPP core can be classified as

1 Read: only (instruction data)
configuration data, consisting of PAE configuration and routing configuration data

2 Read-Write
the contents of the data registers and latches of the PAEs, which are driven onto the busses
the contents of the IRAM elements
   2.3.1 Limiting Memory Traffic

There are several possibilities to limit the amount of memory traffic during context switches.

Do not Save Read-Only Data

This avoids storing configuration data, since configuration data is read only. The current configuration is simply overwritten by the new one.

Save Less Data

If a configuration is defined to be uninterruptible (non pre-emptive), all of the local state on the busses and in the PAEs can be declared as scratch. This means that every configuration gets its input data from the IRAMs and writes its output data to the IRAMs. So after the configuration has finished all information in the PAEs and on the buses is redundant or invalid and does not have to be saved.

Save Modified Data Only

To reduce the amount of R/W data, which has to be saved, we need to keep track of the modification state of the different entities. This incurs a silicon area penalty for the additional “dirty” bits.

Use Caching to Reduce the Memory Traffic

The configuration manager handles manual preloading of configurations. Preloading will help in parallelizing the memory transfers with other computations during the task switch. This cache can also reduce the memory traffic for frequent context switches, provided that a Least Recently Used (LRU) replacement strategy is implemented in addition to the preload mechanism.

The IRAMs can be defined to be local cache copies of main memory as proposed as fourth method in section 2.2.3. Then each IRAM is associated with a starting address and modification state information. The IRAM memory cells are replicated. An IRAM PAE contains an IRAM block with multiple. IRAM instances. Only the starting addresses of the IRAMs have to be saved and restored as context. The starting addresses for the IRAMs of the current configuration select the IRAM instances with identical addresses to be used.

If no address tag of an IRAM instance matches the address of the newly loaded context, the corresponding memory area is loaded to an empty IRAM instance.

If no empty IRAM instance is available, a clean (unmodified) instance is declared empty (and hence must be reloaded later on).

If no clean IRAM instance is available, a modified (dirty) instance is cleaned by writing its data back to main memory. This adds a certain delay for the write-back.

This delay can be avoided, if a separate state machine (cache controller) tries to clean inactive IRAM instances by using unused memory cycles to write-back the IRAM instances' contents.

2.4 Context Switches

Usually a processor is viewed as executing a single stream of instructions. But today's multi tasking operating systems support hundreds of tasks being executed on a single processor. This is, achieved by switching contexts, where all, or at least the most relevant parts of the processor state, which belong to the current task—the task's context—is exchanged with the state of another task, that will be executed next.

There are three types of context switches: switching of virtual processors with simultaneous multithreading (SMT, also known as HyperThreading), execution of an Interrupt Service Routine (ISR) and a Task Switch.

2.4.1 SMT Virtual Processor Switch

This type of context switch is executed without software interaction, totally in hardware. Instructions of several instruction streams are merged into a single instruction stream to increase instruction level parallelism and improve functional unit utilization. Hence the processor state cannot be stored to and reloaded from memory between instructions from different instruction streams: Imagine the worst case of alternating instructions from two streams and the hundreds to thousand of cycles needed to write the processor state to memory and read in another state.

Hence hardware designers have to replicate the internal state for every virtual processor. Every instruction is executed within the context (on the state) of the virtual processor, whose program counter was used to fetch the instruction. By replicating the state, only the multiplexers, which have to be inserted to select one of the different states, have to be switched.

Thus the size of the state also increases the silicon area needed to implement SMT, so the size of the state is crucial for many design decisions.

2.4.2 Interrupt Service Routine

This type of context switch is handled partially by hardware and partially by software. All of the state modified by the ISR has to be saved on entry and must be restored on exit.

The part of the state, which is destroyed by the jump to the ISR, is saved by hardware (e.g. the program counter). It is the ISR's responsibility to save and restore the state of all other resources, that are actually used within the ISR.

The more state information to be saved, the slower the interrupt response time will be and the greater, the performance impact will be if external events trigger interrupts at a high rate.

The execution model of the instructions will also affect the tradeoff between short interrupt latencies and maximum throughput: Throughput is maximized if the instructions in the pipeline are finished, and the instructions of the ISR are chained. This adversely affects the interrupt latency. If, however, the instructions are abandoned (preempted) in favor of a short interrupt latency, they must be fetched again later, which affects throughput. The third possibility would be to save the internal state of the instructions within the pipeline, but this requires too much hardware effort. Usually this is not done.

2.4.3 Task Switch

This type of context switch is executed totally in software. All of a task's context (state) has to be saved to memory, and the context of the new task has to be reloaded. Since tasks are usually allowed to use all of the processor's resources to achieve top performance, all of the processor state has to be saved and restored. If the amount of state is, excessive, the rate of context switches must be decreased by less frequent rescheduling, or a severe throughput degradation will result, as most of the time will be spent in saving and restoring task contexts. This in turn increases the response time for the tasks.

2.5 A Load Store Architecture

We propose an XPP integration as an asynchronously pipelined functional unit for the RISC. We further propose an explicitly preloaded cache for the IRAMs, on top of the memory hierarchy existing within the RISC (as proposed as fourth method in section 2.2.3). Additionally a de-centralized explicitly preloaded configuration cache within the PAE array is employed to support preloading of configurations and fast switching between configurations.

Since the IRAM content is an explicitly preloaded memory area, a virtually unlimited number of such IRAMs can be used. They are identified by their memory address and their size. The IRAM content is explicitly preloaded by the application. Caching will increase performance by reusing data from the memory hierarchy. The cached operation also eliminates the need for explicit store instructions; they are handled implicitly by cache write-back operations but can also be forced for synchronization.

The pipeline stages of the XPP functional unit are Load, Execute and Write-back (Store). The store is executed delayed as a cache write-back. The pipeline stages execute in an asynchronous fashion, thus hiding the variable delays from the cache preloads and the PAE array.

The XPP functional unit is decoupled of the RISC by a FIFO, which is fed with the XPP instructions. At the head of this FIFO, the XPP PAE consumes and executes the configurations and the preloaded IRAMs. Synchronization of the XPP and the RISC is done explicitly by a synchronization instruction.

Instructions

In the following we define the instruction formats needed for the proposed architecture. We use a C style prototype definition to specify data types. All instructions, except the XppSync instruction execute asynchronously. The XppSync instruction can be used to force synchronization.

XppPreloadConfig (void *ConfigurationStartAddress)

The configuration is added to the preload FIFO to be loaded into the configuration cache within the PAE array.

Note that speculative preloads are possible, since successive preload commands overwrite the previous.

The parameter is a pointer register of the RISC pointer register file. The size is implicitly contained in the configuration.

XppPreload (int IRAM, void *StartAddress, int Size)

XppPreloadClean (int IRAM, void *StartAddress, int Size)

This instruction specifies the contents of the IRAM for the next configuration execution. In fact, the memory area is added to the preload FIFO to be loaded into the specified IRAM.

The first parameter is the IRAM number. This is an immediate (constant) value.

The second parameter is a pointer to the starting address. This parameter is provided in a pointer register of the RISC pointer register file.

The third parameter is the size in units of 32 bit words. This is an integer value. It resides in a general-purpose register of the RISC's integer register file.

The first variant actually preloads the data from memory.

The second variant is for write-only accesses. It skips the loading operation. Thus no cache misses can occur for this IRAM. Only the address and size are defined. They are obviously needed for the write-back operation of the IRAM cache.

Note that speculative preloads are possible, since successive preload commands to the same IRAM overwrite each other (if no configuration is executed in between). Thus only the last preload command is actually effective, when the configuration is executed.

XppExecute ( )

This instruction executes the last preloaded configuration with the last preloaded IRAM contents. Actually a configuration start command is issued to the FIFO. Then the FIFO is advanced; this means that further preload commands will specify the next configuration or parameters for the next configuration. Whenever a configuration finishes, the next one is consumed from the head of the FIFO, if its start command has already been issued.

XppSync (void *StartAddress int Size)

This instruction forces write-back operations for all IRAMs that overlap the given memory area.

The first parameter is a pointer to the starting address. This parameter is provided in a pointer register of the RISC pointer register file.

The second parameter is the size. This is an integer value. It resides in a general-purpose register of the RISC's integer register file.

If overlapping IRAMs are still in use by a configuration or preloaded to be used, this operation will block. Giving an address of NULL (zero) and a size of MAX_INT (bigger than the actual memory), this instruction can also be used to wait until all issued configurations finish.

Giving a size of zero can be used as a simple wait for the end of the configuration.

XppSave (void *StartAddress)

This instruction saves the task context of the XPP to the given memory area.

The parameter is a pointer to the starting address. This parameter is provided in a pointer register of the RISC pointer register file.

The size depends on the actual implementation of the XPP. However, only the task scheduler of the operating system will use this instruction. So this is a usual limitation.

XppRestore (void *StartAddress)

This instruction restores the task context of the XPP from the given memory area.

The parameter is a pointer to the starting address. This parameter is provided in a pointer register of the RISC pointer register file.

The size depends on the actual implementation of the XPP. However, only the task scheduler of the operating system will use this instruction. So this is a usual limitation.

2.5.1 A Basic Implementation

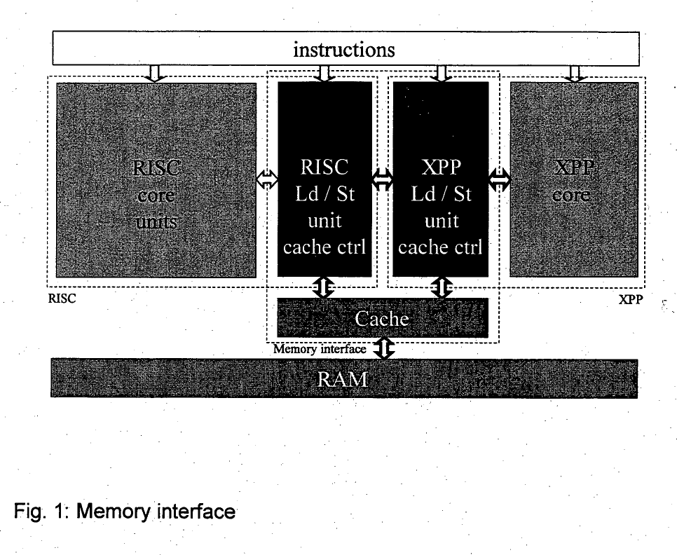

The XPP core shares the memory hierarchy with the RISC core using a special cache controller (see FIG. 1)

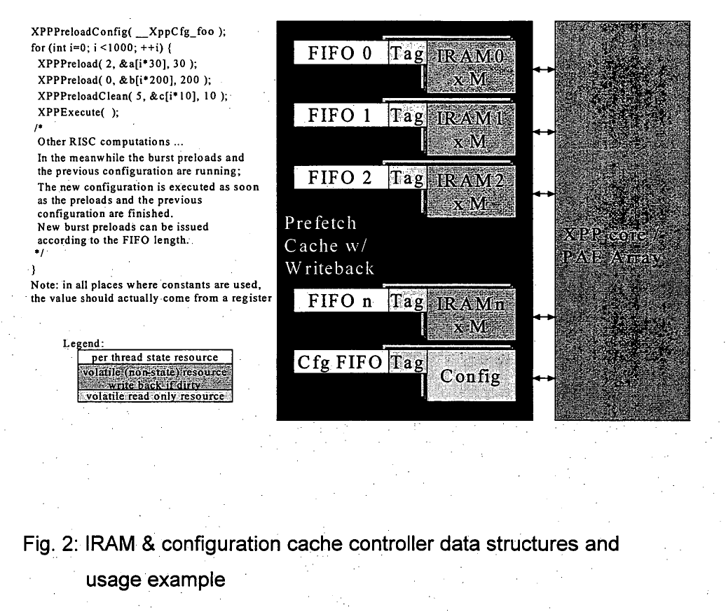

The preload-FIFOs in FIG. 2 contain the addresses and sizes for already issued IRAM preloads, exposing them to the XPP cache controller. The FIFOs have to be duplicated for every virtual processor in an SMT environment. Tag is the typical tag for a cache line containing starting address, size and state (empty/clean/dirty/in-use). The additional in-use state signals usage by the current configuration. The cache controller cannot manipulate these IRAM instances.

The execute configuration command advances all preload FIFOs, copying the old state to the newly created entry. This way the following preloads replace the previously used IRAMs and configurations. If no preload is issued for an IRAM before the configuration is executed, the preload of the previous configuration is retained. Therefore it is not necessary to repeat identical preloads for an IRAM in consecutive configurations.

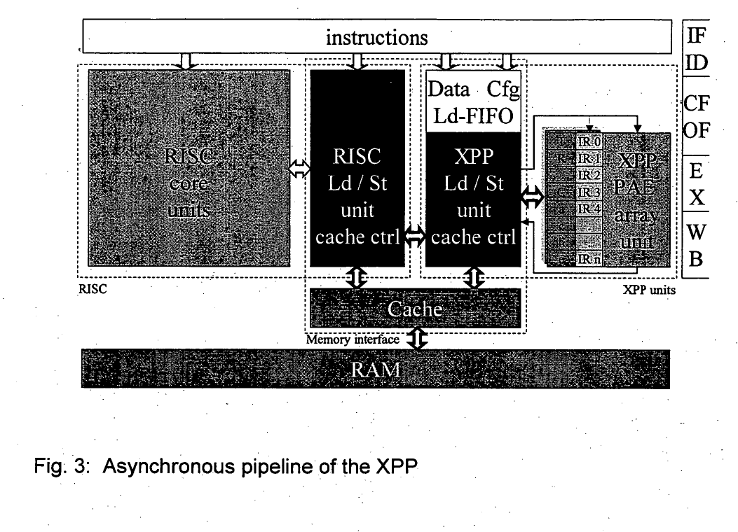

Each configuration's execute command has to be delayed (stalled) until all necessary preloads are finished, either explicitly by the use of a synchronization command or implicitly by the cache controller. Hence the cache controller (XPP Ld/St unit) has to handle the synchronization and execute commands as well, actually starting the configuration as soon as all data is ready. After the termination of the configuration, dirty IRAMs are written back to memory as soon as possible, if their content is not reused in the same IRAM. Therefore the XPP PAE array and the XPP cache controller can be seen as a single unit since they do not have different instruction streams: rather, the cache controller can be seen as the configuration fetch (CF), operand fetch (OF) (IRAM preload) and write-back (WB) stage of the XPP pipeline, also triggering the execute stage (EX) (PAE array). (see FIG. 3)

Due to the long latencies, and their non-predictability (cache misses, variable length configurations), the stages can be overlapped several configurations wide using the configuration and data preload FIFO (=pipeline) for loose coupling. So if a configuration is executing and the data for the next has already been preloaded, the data for the next but one configuration is preloaded. These preloads can be speculative; the amount of speculation is the compiler's trade-off. The reasonable length of the preload FIFO can be several configurations; it is limited by diminishing returns, algorithm properties, the compiler's ability to schedule preloads early and by silicon usage due to the IRAM duplication factor, which has to be at least as big as the FIFO length. Due to this loosely coupled operation, the interlocking—to avoid data hazards between IRAMs—cannot be done optimally by software (scheduling), but has to be enforced by hardware (hardware interlocking). Hence the XPP cache controller and the XPP PAE array can be seen as separate but not totally independent functional units.

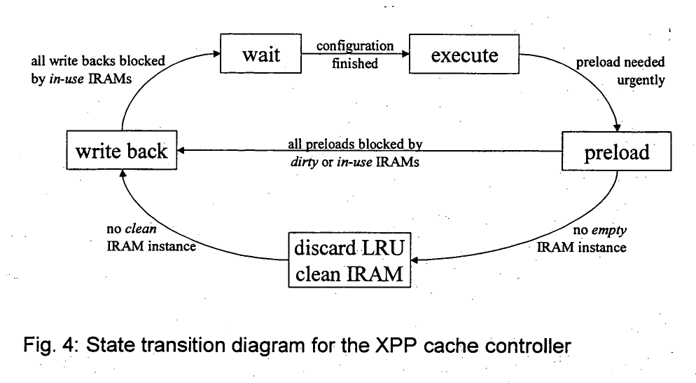

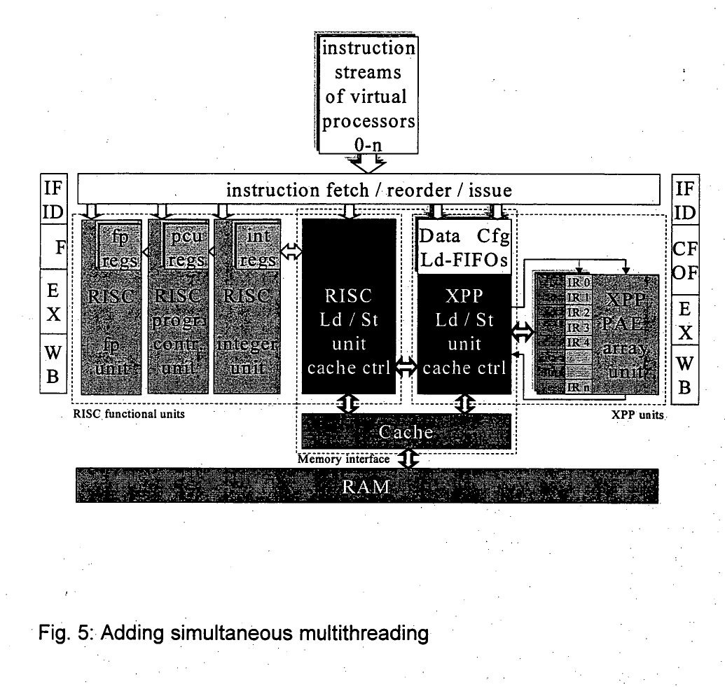

The XPP cache controller has several tasks. These are depicted as states in the diagram shown in FIG. 4. State transitions take place along the edges between states, whenever the condition for the edge is true. As soon as the condition is not true any more, the reverse state transition takes place. The activities for the states are as follows:

At the lowest priority, the XPP cache controller has to fulfill already issued preload commands, while writing back dirty IRAMs as soon as possible.

As soon as a configuration finishes, the next configuration can be started. This is a more urgent task than write-backs or future preloads. To be able to do that, all associated yet unsatisfied preloads have to be finished first. Thus they are preloaded with the high priority inherited from the execute state.

A preload in turn can be blocked by an overlapping in-use or dirty IRAM instance in a different block or by the lack of empty IRAM instances in the target. IRAM block. The former can be resolved by waiting for the configuration to finish and/or by a write-back. To resolve the latter, the least recently used clean IRAM can be discarded, thus becoming empty. If no empty or clean IRAM instance exists, a dirty one has to be written back to the memory hierarchy. It cannot occur that no empty, clean or dirty IRAM instances exist, since only one instance can be in-use and there should be more than one instance in an IRAM block—otherwise no caching effect is achieved.

In an SMT environment the load FIFOs have to be replicated for every virtual processor. The pipelines of the functional units are fed from the shared fetch/reorder/issue stage. All functional units execute in parallel. Different units can execute instructions of different virtual processors.

So we get the following design parameters with their smallest initial value:

IRAM length: 128 words
The longer the IRAM length, the longer the running time of the configuration and the less influence the pipeline startup has.

FIFO length: 1
This parameter helps to hide cache misses during preloading: The longer the FIFO length, the less disruptive is a series of cache misses for a single configuration.

IRAM duplication factor: (pipeline stages+caching factor)*virtual processors: 3
Pipeline stages is the number of pipeline stages. LD/EX/WB plus one for every FIFO stage above one: 3
Caching factor is the number of IRAM duplicates available for caching: 0
Virtual processors is the number of virtual processors with SMT: 1

The size of the state of a virtual processor is mainly dependent on the FIFO length. It is:
FIFO length*#IRAM ports*(32 bit (Address)+32 bit (Size))

This has to be replicated for every virtual processor.

The total size of memory used for the IRAMs is:
#IRAM ports*IRAM duplication factor*IRAM length*32 bit

A first implementation will probably keep close to the above-stated minimum parameters, using a FIFO length of one, an IRAM duplication factor of four, an IRAM length of 128 and no simultaneous multithreading.

2.5.2 Implementation Improvements

Write Pointer

To further decrease the penalty for unloaded IRAMs, a simple write pointer may be used per IRAM, which keeps track of the last address already in the IRAM. Thus no stall is required, unless an access beyond this write pointer is encountered. This is especially useful, if all IRAMs have to be reloaded after a task switch: The delay to the configuration start can be much shorter, especially, if the preload engine of the cache controller chooses the blocking IRAM next whenever several IRAMs need further loading.

Longer FIFOs

The frequency at the bottom of the memory hierarchy (main memory) cannot be raised to the same extent as the frequency of the CPU core. To increase the concurrency between the RISC core and the PACT XPP core, the prefetch FIFOs in the above drawing can be extended. Thus the IRAM contents for several configurations can be preloaded, like the configurations themselves. A simple convention makes clear which IRAM preloads belong to which configuration: the configuration execute switches to the next configuration context. This can be accomplished by advancing the FIFO write pointer with every configuration execute, while leaving it unchanged after every preload. Unassigned IRAM FIFO entries keep their contents from the previous configuration, so every succeeding configuration will use the preceding configuration's IRAMx if no different IRAMx was preloaded.

If none of the memory areas to be copied to IRAMs is in any cache, extending the FIFOs does not help, as the memory is the bottleneck. So the cache size should be adjusted together with the FIFO length.

A drawback of extending the FIFO length is the increased likelihood that the IRAM content written by an earlier configuration is reused by a later one in another IRAM. A cache coherence protocol can clear the situation. Note however that the situation can be resolved more easily: If an overlap between any new IRAM area and a currently dirty IRAM contents of another IRAM bank is detected, the new IRAM is simply not loaded until the write-back of the changed IRAM has finished. Thus the execution of the new configuration is delayed until the correct data is available.

For a short (single entry) FIFO, an overlap is extremely unlikely, since the compiler will usually leave the output IRAM contents of the previous configuration in place for the next configuration to skip the preload. The compiler does so using a coalescing algorithm for the IRAMs/vector registers. The coalescing algorithm is the same as used for register coalescing in register allocation.

Read Only IRAMs

Whenever the memory, that is used by the executing configuration, is the source of a preload command for another IRAM, an XPP pipeline stall occurs: The preload can only be started, when the configuration has finished, and—if the content was modified—the memory content has been written to the cache. To decrease the number of pipeline stalls, it is beneficial to add an additional read-only IRAM state. If the IRAM is read only, the content cannot be changed, and the preload of the data to the other IRAM can proceed without delay. This requires an extension to the preload instructions: The XppPreload and the XppPreloadClean instruction formats can be combined to a single instruction format, that has two additional bits, stating whether the IRAM will be read and/or written. To support debugging, violations should be checked at the IRAM ports, raising an exception when needed.

2.5.3 Support for Data Distribution and Data Reorganization

The IRAMs are block-oriented structures, which can be read in any order by the PAE array. However, the address generation adds complexity, reducing the number of PAEs available for the actual computation. So it is best, if the IRAMs are accessed in linear order. The memory hierarchy is block oriented as well, further encouraging linear access patterns in the code to avoid cache misses.

As the IRAM read ports limit the bandwidth between each IRAM and the PAE array to one word read per cycle, it can be beneficial to distribute the data over several IRAMs to remove this bottleneck. The top of the memory hierarchy is the source of the data, so the amount of cache misses never increases when the access pattern is changed, as long as the data locality is not destroyed.

Many algorithms access memory in linear order by definition to utilize block reading and simple address calculations. In most other cases and in the cases where loop tiling is needed to increase the data bandwidth between the IRAMs and the PAE array, the code can be transformed in a way that data is accessed in optimal order. In many of the remaining cases, the compiler can modify the access pattern by data layout rearrangements (e.g. array merging), so that finally the data is accessed in the desired pattern. If none of these optimizations can be used because of dependences, or because the data layout is fixed, there are still two possibilities to improve performance:

Data Duplication

Data is duplicated in several IRAMs. This circumvents the IRAM read port bottleneck, allowing several data items to be read from the input every cycle.

Several options are possible with a common drawback: data duplication can only be applied to input data: output IRAMs obviously cannot have overlapping address ranges.
Using several IRAM preload commands specifying just different target IRAMs:
This way cache misses occur only for the first preload. All other preloads will take place without cache misses—only the time to transfer the data from the top of the memory hierarchy to the IRAMs is needed for every additional load. This is only beneficial, if the cache misses plus the additional transfer times do not exceed the execution time for the configuration.
Using an IRAM preload instruction to load multiple IRAMs concurrently:
As identical data is needed in several IRAMs, they can be loaded concurrently by writing the same values to all of them. This amounts to finding a clean IRAM instance for every target IRAM, connecting them all to the bus and writing the data to the bus. The problem with this instruction is that it requires a bigger immediate field for the destination (16 bits instead of 4 for the XPP 64). Accordingly this instruction format grows at a higher rate, when the number of IRAMs is increased for bigger XPP arrays.
The interface of this instruction looks like:
XppPreloadMultiple (int IRAMS, void *StartAddress, int Size)
This instruction behaves as the XppPreload/XppPreloadClean instructions with the exception of the first parameter:
The first parameter is IRAMS. This is an immediate (constant) value. The value is a bitmap—for every bit in the bitmap, the IRAM with that number is a target for the load operation.
There is no “clean” version, since data duplication is applicable for read data only.
   Data Reordering

Data reordering changes the access pattern to the data only. It does not change the amount of memory that is read. Thus the number of cache misses stays the same.
Adding additional functionality to the hardware:
   Adding a vector stride to the preload instruction.
   A stride (displacement between two elements in memory) is used in vector load operations to load e.g.: a column of a matrix into a vector register.
   This is a non-sequential but still linear access pattern. It can be implemented in hardware by giving a stride to the preload instruction and adding the stride to the IRAM identification state. One problem with this instruction is that the number of possible cache misses per IRAM load rises: In the worst case it can be one cache miss per loaded value, if the stride is equal to the cache line size and all data is not in the cache.
   But as already stated: the total number of misses stays the same—just the distribution changes. Still this is an undesirable effect.
   The other problem is the complexity of the implementation and a possibly limited throughput, as the data paths between the layers of the memory hierarchy are optimized for block transfers. Transferring non-contiguous words will not use wide busses in an optimal fashion.
   The interface of the instruction looks like:
   XppPreloadStride (int IRAM, void *StartAddress, int Size, int Stride)
   XppPreloadCleanStride (int IRAM, void *StartAddress, int Size, int Stride)
   This instruction behaves as the XppPreload/XppPreloadClean instructions with the addition of another parameter:
   The fourth parameter is the vector stride. This is an immediate (constant) value. It tells the cache controller, to load only every n^{th} value to the specified IRAM.
Reordering the data at run time, introducing temporary copies.
   On the RISC:
   The RISC can copy data at a maximum rate of one word per cycle for simple address computations and at a somewhat lower rate for more complex ones.
   With a memory hierarchy, the sources will be read from memory (or cache, if they were used recently) once and written to the temporary copy, which will then reside in the cache, too. This increases the pressure in the memory hierarchy by the amount of memory used for the temporaries. Since temporaries are allocated on the stack memory, which is re-used frequently, the chances are good that the dirty memory area is re-defined before it is written back to memory. Hence the write-back operation to memory is of no concern.
   Via an XPP configuration:
   The PAE array can read and write one value from every IRAM per cycle. Thus if half of the IRAMs are used as inputs and half of the IRAMs are used as outputs, up to eight (or more, depending on the number of IRAMs) values can be reordered per cycle, using the PAE array for address generation. As the inputs and outputs reside in IRAMs, it does not matter, if the reordering is done before or after the configuration that uses the data—the IRAMs can be reused immediately.
      IRAM Chaining

If the PAEs do not allow further unrolling, but there are still IRAMs left unused, it is possible to load additional blocks of data into these IRAMs and chain two IRAMs by means of an address selector. This does not increase throughput as much as unrolling would do, but it still helps to hide long pipeline startup delays whenever unrolling is not possible.

2.6 Software/Hardware Interface

According to the design parameter changes and the corresponding changes to the hardware, the hardware/software interface has changed. In the following the most prominent changes and their handling will be discussed:

2.6.1. Explicit Cache

The proposed cache is not a usual cache, which would be—not considering performance issues—invisible to the programmer/compiler, as its operation is transparent. The proposed cache is an explicit cache. Its state has to be maintained by software.

Cache Consistency and Pipelining of Preload/Configuration/Write-Back

The software is responsible for cache consistency. It is possible to have several IRAMs caching the same, or overlapping memory areas. As long as only one of the IRAMs is written, this is perfectly ok: Only this IRAM will be dirty and will be written back to memory. If however more than one of the IRAMs is written, it is not defined, which data will be written to memory. This is a software bug (non deterministic behavior).

As the execution of the configuration is overlapped with the preloads and write-backs of the IRAMs, it is possible to create preload/configuration sequences, that contain data hazards. As the cache controller and the XPP array can be seen as separate functional units, which are effectively pipelined, these data hazards are equivalent to pipeline hazards of a normal instruction pipeline. As with any ordinary pipeline, there are two possibilities to resolve this:
Hardware interlocking:
Interlocking is done by the cache controller: If the cache controller detects, that the tag of a dirty or in-use item in IRAMx overlaps a memory area used for another IRAM preload, it has to stall that preload, effectively serializing the execution of the current configuration and the preload.
Software interlocking:
If the cache controller does not enforce interlocking, the code generator has to insert explicit synchronize instructions to take care of potential interlocks. Inter-procedural and inter-modular alias- and data-dependence analyses can determine if this is the case, while scheduling algorithms help to alleviate the impact of the necessary synchronization instructions.

In either case, as well as in the case of pipeline stalls due to cache misses, SMT can use the computation power, that would be wasted otherwise.

Code Generation for the Explicit Cache

Apart from the explicit synchronization instructions issued with software interlocking, the following instructions have to be issued by the compiler.
Configuration preload instructions, preceding the IRAM preload instructions, that will be used by that configuration. These should be scheduled as early as possible by the instruction scheduler.
IRAM preload instructions, which should also be scheduled as early as possible by the instruction scheduler.
Configuration execute instructions, following the IRAM preload instructions for that configuration. These instructions should be scheduled between the estimated minimum and the estimated maximum of the cumulative latency of their preload instructions.
IRAM synchronization instructions, which should be scheduled as late as possible by the instruction scheduler. These instructions must be inserted before any potential access of the RISC to the data areas that are duplicated and potentially modified in the IRAMs. Typically these instructions will follow a long chain of computations on the XPP, so they will not significantly decrease performance.
   Asynchronicity to Other Functional Units

An XppSync must be issued by the compiler, if an instruction of another functional unit (mainly the Ld/St unit) can access a memory area, that is potentially dirty or in-use in an IRAM. This forces a synchronization of the instruction streams and the cache contents, avoiding data hazards. A thorough inter-procedural and inter-modular array alias analysis limits the frequency of these synchronization instructions to an acceptable level.

2.7 Another Implementation

For the previous design, the IRAMs are existent in silicon, duplicated several times to keep the pipeline busy. This amounts to a large silicon area, that is not fully busy all the time, especially, when the PAE array is not used, but as well whenever the configuration does not use all of the IRAMs present in the array. The duplication also makes it difficult to extend the lengths of the IRAMs, as the total size of the already large IRAM area scales linearly.

For a more silicon efficient implementation, we should integrate the IRAMs into the first level cache, making this cache bigger. This means, that we have to extend the first level cache controller to feed all IRAM ports of the PAE array. This way the XPP and the RISC will share the first level cache in a more efficient manner. Whenever the XPP is executing, it will steal as much cache space as it needs from the RISC. Whenever the RISC alone is running it will have plenty of additional cache space to improve performance.

The PAE array has the ability to read one word and write one word to each IRAM port every cycle. This can be limited to either a read or a write access per cycle, without limiting programmability: If data has to be written to the same area in the same cycle, another IRAM port can be used. This increases the number of used IRAM ports, but only under rare circumstances.

This leaves sixteen data accesses per PAE cycle in the worst case. Due to the worst case of all sixteen memory areas for the sixteen IRAM ports mapping to the same associative bank, the minimum associativity for the cache is 16-way set associativity. This avoids cache replacement for this rare, but possible worst-case example.

Two factors help to support sixteen accesses per PAE array cycle:
The clock frequency of the PAE array generally has to be lower than for the RISC by a factor of two to four. The reasons lie in the configurable routing channels with switch matrices which cannot support as high a frequency as solid point-to-point aluminium or copper traces.
This means that two to four IRAM port accesses can be handled serially by a single cache port, as long as all reads are serviced before all writes, if there is a potential overlap. This can be accomplished by assuming a potential overlap and enforcing a priority ordering of all accesses, giving the read accesses higher priority.
A factor of two, four or eight is possible by accessing the cache as two, four or eight banks of lower associativity cache.
For a cycle divisor of four, four banks of four-way associativity will be optimal. During four successive cycles, each bank of four-way associativity can serve four different accesses. Up to four-way data duplication can be handled by using adjacent IRAM ports that are connected to the same bus (bank). For further data duplication, the data has to be duplicated explicitly, using an XppPreloadMultiple cache controller instruction. The maximum data duplication for sixteen read accesses to the same memory area is, supported by an actual data duplication factor of four: one copy in each bank. This does not affect the cache RAM efficiency as adversely as an actual data duplication of 16 for the design proposed in section 2.5.

The cache controller is running at the same speed as the RISC. The XPP is running at a lower (e.g. quarter) speed. This way the worst case of sixteen read requests from the PAE array need to be serviced in four cycles of the cache controller, with an additional four read requests from the RISC. So one bus at full speed can be used to service four IRAM read ports. Using four-way associativity, four accesses per cycle can be serviced, even in the case that all four accesses go to addresses that map to the same associative block.

The RISC still has a 16-way set associative view of the cache, accessing all four four-way set associative banks in parallel. Due to data duplication it is possible, that several banks return a hit. This has to be taken care of with a priority encoder, enabling only one bank onto the data bus.

The RISC is blocked from the banks that service IRAM port accesses. Wait states are inserted accordingly. The impact of wait states is reduced, if the RISC shares the second cache access port of a two-port cache with the RAM interface, using the cycles between the RAM transfers for its accesses.

Another problem is that one IRAM read could potentially address the same memory location as a write from another IRAM; the value read depends on the order of the operations, so the order must be fixed: all writes have to take place after all reads, but before the reads of the next cycle. This can be relaxed, if the reads and writes actually do not overlap. However a simple priority scheme for the bus accesses enforces the correct ordering of the accesses.

The problem of read-write consistency is more severe with data duplication, when only one copy of the data is actually modified. Therefore modifications are forbidden with data duplication.

2.7.1 Programming Model Changes

Data Interference

With this design without dedicated IRAMs, it is not possible any more to load input data to the IRAMs and write the output data to a different IRAM, which is mapped to the same address, thus operating on the original, unaltered input data during the whole configuration.

As there are no dedicated IRAMs any more, writes directly modify the cache contents, which will be read by succeeding reads. This changes the programming model significantly. Additional and more in-depth compiler analyses are necessary accordingly.

2.7.2 Hiding Implementation Details

The actual number of bits in the destination field of the XppPreloadMultiple instruction is implementation dependent. It depends on the number cache banks and their associativity, which are determined by the clock frequency divisor of the XPP PAE array relative to the cache frequency. However, the assembler can hide this by translating IRAM ports to cache banks, thus reducing the number of bits from the number of IRAM ports to the number of banks. For the user it is sufficient to know, that each cache bank services an adjacent set of IRAM ports starting at a power of two. Thus it is best to use data duplication for adjacent ports, starting with the highest power of two bigger than the number of read ports to the duplicated area.

### 3 PROGRAM OPTIMIZATIONS

3.1 Code Analysis

In this section we describe the analyses that can be performed on programs. These analyses are then used by different optimizations. They describe the relationships between data and memory locations in the program. More details can be found in several books [2,3,5].

3.1.1 Dataflow Analysis

Dataflow analysis examines the flow of scalar values through a program, to provide information about how the program manipulates its data. This information can be represented by dataflow equations operating on sets. A dataflow equation for object i, that can be an instruction or a basic block, is formulated as
Ex[i]=Gen[i]Y(In[i]−Kill[i])

It means that data available at the end of the execution of object i, Ex[i], are either produced by i, Gen[i] or were alive at the beginning of i, In[i], but were not deleted during the execution of j, Kill[i].

These equations can be used to solve several problems like:
the problem of reaching definitions,
the Def-Use and Use-Def chains, describing for a definition all uses that can be reached from it, and for a use all definitions that can reach it, respectively.
the available expressions at a point in the program,
the live variables at a point in the program,
   whose solutions are then used by several compilation phases, analysis, or optimizations.

As an example let us take the problem of computing the Def-Use chains of the variables of a program. This information can be used for instance by the data dependence analysis for scalar variables or by the register allocation. A Def-Use chain is associated to each definition of a variable and is the set of all visible uses from this definition. The dataflow equations presented above are applied to the basic blocks to detect the variables that are passed from one block to another along the control-flow graph. In the figure below, two definitions for variable x are produced: S1 in B1 and S4 in B3. Hence the variable that can be found at the exit of B1 is Ex(B1)={x(S1)}, and at the exit of B4 is Ex(B4)={x(S4)}. Moreover we have Ex(B2)=Ex(B1) as no variable is defined in B2. Using these sets, we find that the uses of x in S2 and S3 depend on the definition of x in B1, that the use of x in S5 depend on the definitions of x in B1 and B3. The Def-Use chains associated with the definitions are then D(S1)={S2,S3,S5} and D(S4)={S5}.

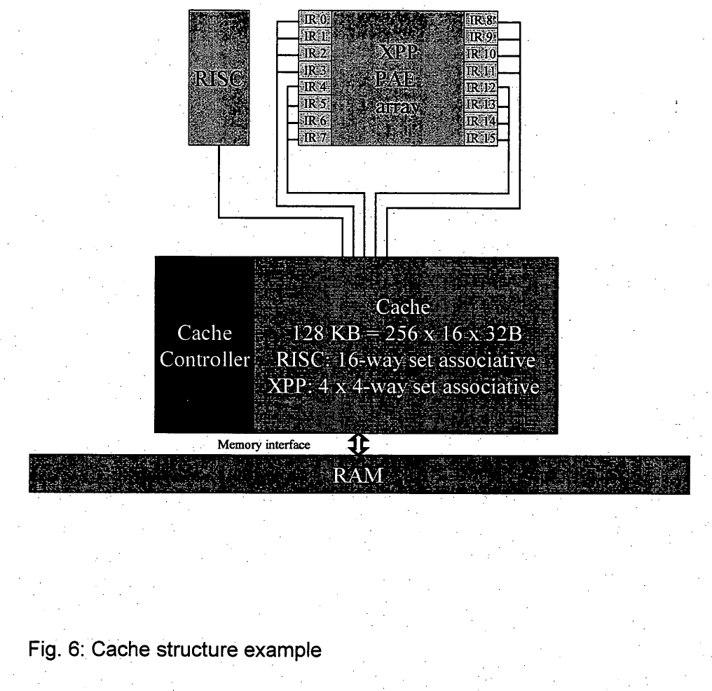

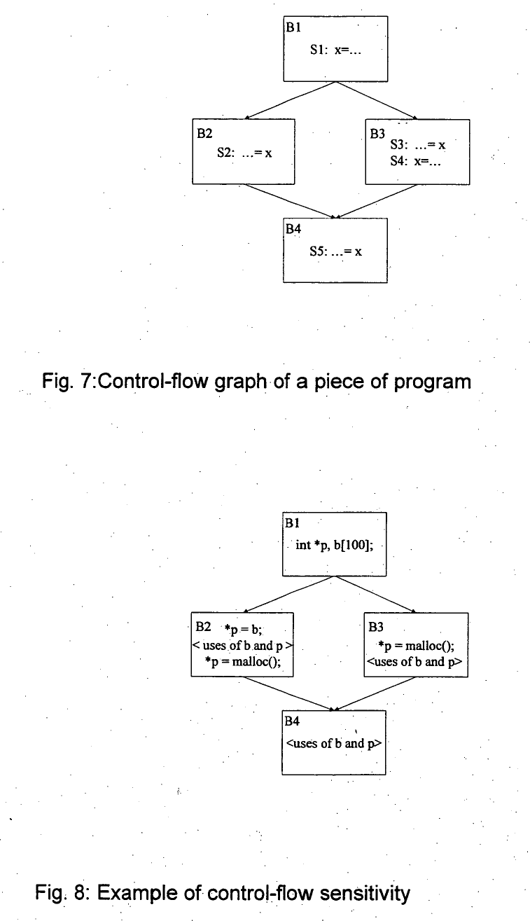

The Control-flow graph of a piece of program is shown in FIG. 7.

3.1.2 Data Dependence Analysis

A data dependence graph represents the dependences existing between operations writing or reading the same data. This graph is used for optimizations like scheduling, or certain loop optimizations to test their semantic validity. The nodes of the graph represent the instructions, and the edges represent the data dependences. These dependences can be of three types: true (or flow) dependence when a variable is written before being read, anti-dependence when a variable is read before being written, and output dependence when a variable is written twice. Here is a more formal definition [3].

Definition

Let S and S′ be 2 statements, then S′ depends on S, noted SδS′ iff:

(1) S is executed before S′

(2) ∃vεVAR:vεDEF(S)I USE(S′) [symbol] vεUSE(S)I DEF(S′) [symbol] vεDEF(S)I DEF(S′)

(3) There is no, statement T such that S is executed before T and T is executed before S′, and vεDEF(T)

Where VAR is the set of the variables of the program, DEF(S) is the set of the variables defined by instruction S, and USE(S) is the set of variables used by instruction S.

Moreover if the statements are in a loop, a dependence can be loop-independent or loop-carried. This notion introduces the definition of the distance of a dependence. When a dependence is loop-independent it means that it occurs between two instances of different statements in the same iteration, and then its distance is equal to zero. On the contrary when a dependence occurs between two instances in two different iterations the dependence is loop-carried, and the distance is equal to the difference between the iteration numbers of the two instances.

The notion of direction of dependence generalizes the notion of distance, and is generally used when the distance of a dependence is not constant, or cannot be computed with precision. The direction of a dependence is given by <, if the dependence between S and S′ occurs when the instance of S is in an iteration before the iteration of the instance of S′, =if the two instances are in the same iteration, and > if the instance of S is an iteration after the iteration of the instance of S′.

In the case of a loop nest we have then distance and direction vector, with one element for each level of the loop nest. The examples below illustrate all these definitions. The data dependence graph is used by a lot of optimizations, and is also useful to determine if their application is valid. For instance a loop can be vectorized if its data dependence graph does not contain any cycle.

Example of a true dependence with distance 0 on array a:

for(i=0; i<N; i=i+1) {
S: a[i] = b[i] + 1;
S1: c[i] = a[i] + 2;
}

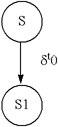

Example of an anti-dependence with distance 0 on array b:

for(i=0; i<N; i=i+1) {

S: a[i] = b[i] + 1;
S1 b[i] = c[i] + 2;

}

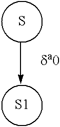

Example of an output dependence with distance 0 on array a:

for(i=0; i<N; i=i+1) {
S: a[i] = b[i] + 1;
S1: a[i] = c[i] + 2;
}

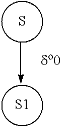

Example of a dependence with direction vector (=,=) between S1 and S2 and a dependence with direction vector (=,=,<) between S2 and S2:

for(j=0;j<=N;j++)

for(i=0;i<=N;i++)

{

S1: c[i][j] = 0;

for(k=0;k<=N;k++)

S2: c[i][j] = c[i][j] + a[i][k]*b[k][j];

}

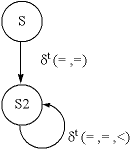

Example of an anti-dependence with distance vector (0,2).

for(i=0;i<=N;i++)

for(j=0;j<=N;j++)

S: a[i][j] = a[i][j+2] + b[i];

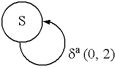

3.1.3 Interprocedural Alias Analysis

The aim of alias analysis is to determine if a memory location is accessible by several objects, like variables or arrays, in a program. It has a strong impact on data dependence analysis and on the application of code optimizations. Aliases can occur:
with statically allocated data, like unions in C where all fields refer to the same memory area, or
with dynamically allocated data, which are the usual targets of the analysis, or
with pointers referencing static data, like in C.

In the following example, we have a typical case of aliasing where p aliases b.

Example for typical aliasing:

int b[100],*p;
for(p=b;p < &b[100];p++)
*p=0;

Alias analysis can be more or less precise depending on whether or not it takes the control-flow into account. When it does, it is called flow-sensitive, and when it does not, it is called flow-insensitive. Flow-sensitive alias analysis is able to detect in which blocks along a path two objects are aliased. As it is more precise, it is more complicated and more expensive to compute. Usually flow-insensitive alias information is sufficient. This aspect is illustrated in FIG. 8 where a flow-insensitive analysis would find that p alias b, but where a flow-sensitive analysis would be able to find that p alias b only in block B2.

Furthermore aliases are classified into must-aliases and may-aliases. For instance, if we consider flow-insensitive may-alias information, then x alias y, iff x and y may, possibly at different times, refer to the same memory location. And if we consider flow-insensitive must-alias information, x alias y, iff x and y must, throughout the execution of a procedure, refer to the same storage location. In the case of FIG. 8, if we consider flow-insensitive may-alias information, p alias b holds, whereas if we consider flow-insensitive must-alias information, p alias b does not hold. The kind of information to use depends on the problem to solve. For instance, if we want to remove redundant expressions or statements, must-aliases have to be used, whereas if we want to build a data dependence graph may-aliases are necessary.

Practically, as exact alias information is hard to compute, the analysis is rather used to be sure that two objects are not aliased. Finally this analysis must be interprocedural to be able to detect aliases caused by non-local variables and parameter passing. The latter case is depicted in the example below where i and j are aliased through the function call where k is passed twice as parameter.

Example for aliasing by parameter passing:

void foo(int *i,int* j)
{
*i = *j+1;
}
...
foo(&k,&k);

3.1.4 Interprocedural Value Range Analysis

This analysis can find the range of values taken by variables. It can help to apply optimizations like dead code elimination, loop unrolling and others. For this purpose it can use information on the types of variables and then consider operations applied on these variables during the execution of the program. Thus it can determine for instance if tests in conditional instructions are likely to be met or not, or determine the iteration range of loop nests.

This analysis has to be interprocedural as for instance loop bounds can be passed as parameters of a function, like in the following example. We know by analyzing the code that in the loop executed with array a, N is at least equal to 11, and that in the loop executed with array b, N is at most equal to 10.

```
void foo(int *c,int N)
{
    int i;
  for (i=0;i<N;i++)
        c[i] = g(i,2);
}
...
if (N > 10)
      foo(a,N);
else
      foo(b,N);
```

The programmer can support value range analysis by stating value constraints which cannot be retrieved from the language semantics. This can be done by pragmas or by a compiler known assert function.

3.1.5 Alignment Analysis

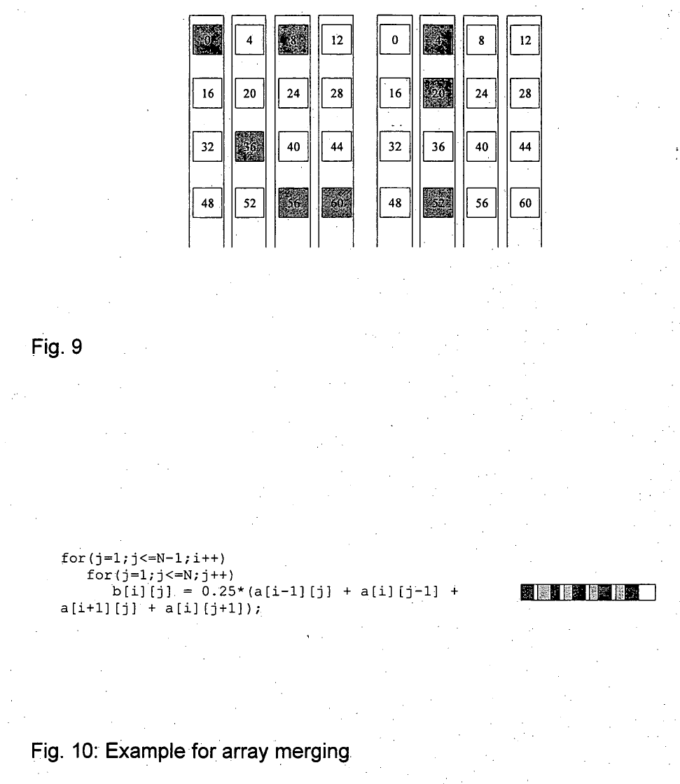

Alignment analysis deals with data layout for distributed memory architectures. As stated by Saman Amarasinghe: “Although data memory is logically a linear array of cells, its realization in hardware can be viewed as a multi-dimensional array. Given a dimension in this array, alignment analysis will identify memory locations that always resolve to a single value in that dimension. For example, if the dimension of interest is memory banks, alignment analysis will identify if a memory reference always accesses the same bank”. This is the case in the right half of FIG. 9, that can be found in [10], where all accesses, depicted in grey, occur to the same memory bank, whereas in the left half the accesses are not aligned. He adds then that: “Alignment information is useful in a variety of compiler-controlled memory optimizations leading to improvements in programmability, performance, and energy consumption.”

Alignment analysis, for instance, is able to find a good distribution scheme of the data and is furthermore useful for automatic data distribution tools. An automatic alignment analysis tool can be able to automatically generate alignment proposals for the arrays accessed in a procedure and thus simplifies the data distribution problem. This can be extended with an interprocedural analysis taking into account dynamic realignment.

Alignment analysis can also be used to apply loop alignment that transforms the code directly rather than the data layout in itself, as shown later. Another solution can be used for the PACT XPP, relying on the fact that it can handle aligned code very efficiently. It consists in adding a conditional instruction testing if the accesses in the loop body are aligned followed by the necessary number of peeled iterations of the loop body, then the aligned loop body, and then some compensation code. Only the aligned code is executed by the PACT XPP, the rest is executed by the host processor. If the alignment analysis is more precise (inter-procedural or inter-modular) less conditional code has to be inserted.

3.2 Code Optimizations

Most of the optimizations and transformations presented here can be found in detail in [4], and also in [2,3,5].

3.2.1 General Transformations

We present in this section a few general optimizations that can be applied to straightforward code, and to loop bodies. These are not the only ones that appear in a compiler, but they are mentioned in the sequel of this document.

Constant Propagation

This optimization propagates the values of constants into the expressions using them throughout the program. This way a lot of computations can be done statically by the compiler, leaving less work to be done during the execution. This part of the optimization is also known as constant folding.

Example of constant propagation:

| | |
|---|---|
| N = 256; | for(i=0; i<= 256; i++) |
| c = 3; | a[i] = b[i] + 3; |
| for(i=0;i <= N;i++) | |
| a[i] = b[i] + c; | |

Copy Propagation

This optimization simplifies the code by removing redundant copies of the same variable in the code. These copies can be produced by the programmer or by other optimizations. This optimization reduces the register pressure and the number of register-to-register move instructions.

Example of copy propagation:

| | |
|---|---|
| t = i*4; | t = i*4; |
| r = t; | for(i=0;i <= N;i++) |
| for(i=0;i <= N;i++) | a[t] = b[t] + a[i]; |
| a[r] = b[r] + a[i]; | |

Dead Code Elimination

This optimization removes pieces of code that will never be executed. Code is never executed if it is in the branch of a conditional statement whose condition is always evaluated to true or false, or if it is a loop body, whose number of iterations is always equal to zero. The latter implies that this optimization relies also on value range analysis.

Code updating variables, that are never used, are also useless and can be removed as well. If a variable is never used, then the code for updating it and its declaration can also be eliminated.

Example of dead code elimination:

| | |
|---|---|
| for(i=0;i <= N;i++) { | for(i=0;i <= N;i++) { |
| if (i > N) | for(j=0;j<10;j++) |
| for(j=0;j<10;j++) | a[j+1] = a[j] + b[j]; |
| a[j] = b[j] + a[i]; | } |
| else | |
| for(j=0;j<10;j++) | |
| a[j+1] = a[j] + b[j]; | |
| } | |

Forward Substitution

This optimization is a generalization of copy propagation. The use of a variable is replaced by its defining expression. It can be used for simplifying the data dependence analysis and the application of other transformations by making the use of loop variables visible.

Example of forward substitution:

| | |
|---|---|
| c = N + 1; | for(i=0; i<= N; i++) |
| for(i=0;i <= N;i++) | a[N+1] = b[N+1] + a[i]; |
| a[c] = b[c] + a[i]; | |

Idiom Recognition

This transformation recognizes pieces of code and can replace them by calls to compiler known functions, or less expensive code sequences, like code for absolute value computation.

Example of idiom recognition:

| | |
|---|---|
| for(i=0; i<N; i++){ | for(i=0; i<N; i++){ |
| c = a[i] − b[i]; | c = a[i] − b[i]; |
| if (c<0) | c = abs(c); |
| c = −c; | d[i] = c; |
| d[i] = c; | } |
| } | |

3.2.2 Loop Transformations
Loop Normalization

This transformation ensures that the iteration space of a loop has a lower bound equal to 0 or 1 (depending on the input language), and an increment of 1. The array subscript expressions and the bounds of the loops are modified accordingly. It can be used before loop fusion to find opportunities, and ease inter-loop dependence analysis, and it also enables the use of dependence tests requiring normalized loops.

Example of loop normalization:

| | |
|---|---|
| for(i=2; i<N; i=i+2) | for(i=0; i<(N−2)/2; i++) |
| a[i] = b[i]; | a[2*i+2] = b[2*i+2]; |

Loop Reversal

This transformation changes the direction in which the iteration space of a loop is scanned. It is frequently used in conjunction with loop normalization and other transformations, like loop interchange, because it changes the dependence vectors.

Example of loop reversal:

| | |
|---|---|
| for(i=N; i>=0; i−−) | for(i=0; i<=N; i++) |
| a[i] = b[i]; | a[i] = b[i]; |

Strength Reduction

This transformation replaces expressions in the loop body by equivalent but less expensive ones. It can be used on induction variables, other than the loop variable, to be able to eliminate them.

Example of Strength Reduction:

| | |
|---|---|
| for(i=0; i<N; i++) | t = c; |
| a[i] = b[i] + c*i; | for(i=0; i<N; i++){ |
| | a[i] = b[i] + t; |
| | t = t + c; |
| | } |

Induction Variable Elimination

This transformation can use strength reduction to remove induction variables from a loop, hence reducing the number of computations and easing the analysis of the loop. This also removes dependence cycles due to the update of the variable, enabling vectorization.

Example of Induction Variable Elimination:

| | |
|---|---|
| for(i=0; i<=N; i++) { | for(i=0; i<=N; i++){ |
| k = k + 3; | a[i] = b[i] + a[k+(i+1)*3]; |
| a[i] = b[i] + a[k]; | } |
| } | k = k +(N+1)*3; |

Loop-Invariant Code Motion

This transformation moves computations outside a loop if their result is the same in all iterations. This allows to reduce the number of computations in the loop body. This optimization can also be conducted in the reverse direction in order to get perfectly nested loops, that are easier to handle by other optimizations.

Example of loop-invariant code motion:

| | |
|---|---|
| for(i=0; i<N; i++) | if (N >= 0) |
| a[i] = b[i] + x*y; | c = x*y; |
| | for(i=0; i<N; i++) |
| | a[i] = b[i] + c; |

Loop Unswitching

This transformation moves a conditional instruction out of a loop body if its condition is loop-invariant. The branches of the new condition contain the original loop with the appropriate statements from the original condition. Loop unswitching allows parallelization of the loop by removing control-flow code from the loop body.

Example of loop unswitching:

| | |
|---|---|
| for(i=0; i<N; i++) { | if (x > 2) |
| a[i] = b[i] + 3; | for(i=0; i<N; i++){ |
| if (x > 2) | a[i] = b[i] + 3; |
| b[i] = c [i] + 2; | b[i] = c[i] + 2; |
| else | } |
| b[i] = c[i] − 2; | else |
| } | for(i=0; i<N; i++){ |
| | a[i] = b[i] + 3; |
| | b[i] = c[i] − 2; |
| | } |

If-Conversion

This transformation is applied to loop bodies with conditional instructions. It changes control dependences into data dependences and enables a subsequent vectorization. It can be used in conjunction with loop unswitching to handle loop bodies with several basic blocks. The conditions, where array expressions could appear, are replaced by boolean terms called guards. Processors with predicated execution support can directly execute such code, and configurable hardware can use the result of guards to direct dataflow through different branches by means of multiplexers and demultiplexers.

Example of if-conversion:

| | |
|---|---|
| for(i = 0;i < N; i++) { | for(i = 0;i < N;i++) { |
| a[i] = a[i] + b[i]; | a[i] = a[i] + b[i]; |
| if (a[i] != 0) | c2 = (a[i] != 0); |
| if (a[i] > c[i]) | if (c2) c4 = (a[i] > c[i]); |
| a[i] = a[i] − 2; | if (c2 && c4) a[i] = a[i] − 2; |
| else | if (c2 && !c4) a[i] = a[i] + 1; |
| a[i] = a[i] + 1; | d[i] = a[i] * 2; |
| d[i] = a[i] * 2; | } |
| } | |

Strip-Mining

This transformation enables to adjust the granularity of an operation. It is commonly used to choose the number of independent computations in the inner loop nest. When the iteration count is not known at compile time, it can be used to generate a fixed iteration count inner loop satisfying the resource constraints. It can be used in conjunction with other transformations like loop distribution or loop interchange. It is also called loop sectioning. Cycle shrinking, also called stripping, is a specialization of strip-mining.

Example of strip-mining:

| | |
|---|---|
| for(i=0; i<N; I++) | up = (N/16)*16; |
| a[i] = b[i] + c; | for(i=0; i<up; i = i + 16) |
| | for(j=i;j <= 16;j++) |
| | a[j] = b[j] + c; |
| | for(j=i+1;j<N;j++) |
| | a[i] = b[i] + c; |

Loop Tiling

This transformation modifies the iteration space of a loop nest by introducing loop levels to divide the iteration space in tiles. It is a multi-dimensional generalization of strip-mining. It is generally used to improve memory reuse, but can also improve processor, register, translation-lookaside buffer (TLB), or page locality. It is also called loop blocking.

The size of the tiles of the iteration space is chosen such that the data needed in each tile fits into the cache memory, thus reducing the cache misses. In the case of coarse-grain computers, the size of the tiles can also be chosen such that the number of parallel operations of the loop body matches the number of processors of the computer.

Example of loop tiling:

| | |
|---|---|
| for(i=0; i<N; i++) | for(ii=0; ii<N; ii = ii+16) |
| for(j=0; j<N; j++) | for(jj=0; jj<N; jj = jj+16) |
| a[i][j] = b[j][i]; | for(i=ii; i< min(ii+15,N); i++) |
| | for(j=jj; j< min(jj+15,N); j++) |
| | a[i][j] = b[j][i]; |

Loop Interchange

This transformation interchanges loop levels of a nest in order to change data dependences. It can:
enable vectorization by interchanging an independent loop with a dependent loop, or
improve vectorization by pushing the independent loop with the largest range further inside, or
deduce the stride, or
increase the number of loop-invariant expressions in the inner-loop, or
improve parallel performance by moving an independent loop outside of a loop nest to increase the granularity of each iteration and reduce the number of barrier synchronizations.

Example of loop interchange:

| | |
|---|---|
| for(i=0; i<N; i++) | for(j=0; j<N; j++) |
| for(j=0;j<N; j++) | for(i=0; i<N; i++) |
| a[i] = a[i] + b[i][j]; | a[i] = a[i] + b[i][j]; |

Loop-Coalescing/Collapsing

This transformation combines a loop nest into a single loop. It can improve the scheduling of the loop, and also reduces the loop overhead. Collapsing is a simpler version of coalescing in which the number of dimensions of arrays is reduced as well. Collapsing reduces the overhead of nested loops and multi-dimensional arrays. Collapsing can be applied to loop nests that iterate over memory with a constant stride, otherwise loop coalescing is a better approach. It can be used to make vectorizing profitable by increasing the iteration range of the innermost loop.

Example of loop coalescing:

| | |
|---|---|
| for(i=0; i<N; i++) | for(k=0; k<N*M; k++){ |
| for(j=0;j<M; j++) | i = ((k−1)/m)*m + 1; |
| a[i][j] = a[i][j] + c; | j = ((T−1)%m) + 1; |
| | a[i][j] = a[i][j] + c; |
| | } |

Loop Fusion

This transformation, also called loop jamming or loop merging, merges 2 successive loops. It reduces loop overhead, increases instruction-level parallelism, improves register, cache, or page locality, and improves the load balance of parallel loops. Alignment can be taken into account by introducing conditional instructions to take care of dependences.

Example of loop fusion:

| | |
|---|---|
| for(i=0; i<N; i++) | for(i=0; i<N; i++) { |
| a[i] = b[i] + c; | a[i] = b[i] + c; |
| for(i=0; i<N; i++) | d[i] = e[i] + c; |
| d[i] = e[i] + c; | } |

Loop Distribution

This transformation, also called loop fission, allows splitting a loop in several pieces in case the loop body is too big, or because of dependences. The iteration space of the new loops is the same as the iteration space of the original loop. Loop spreading is a more sophisticated distribution.

Example of loop distribution:

| | |
|---|---|
| for(i=0; i<N; i++) { | for(i=0; i<N; i++) |
| a[i] = b[i] + c; | a[i] = b[i] + c; |
| d[i] = e[i] + c; | for(i=0;i<N; i++) |
| } | d[i] = e[i] +c; |

Loop Unrolling/Unroll-and-Jam

This transformation replicates the original loop body in order to get a larger one. A loop can be unrolled partially or completely. It is used to get more opportunity for parallelization by making the loop body bigger, it also improves register, or cache usage and reduces loop overhead. Unrolling the outer loop followed by merging the induced inner loops is referred to as unroll-and-jam.

Example of loop unrolling:

| | |
|---|---|
| for(i=0; i<N; i++) | for(i=0; i<N; i = i+2{ |
| a[i] = b[i] + c | a[i] = b[i] + c; |
| | a[i+1] = b[i+1] + c; |
| | } |
| | if ((N−1)%2) == 1) |
| | a[N−1] = b[N−1] + c; |

Loop Alignment

This optimization transforms the code to achieve aligned array accesses in the loop body. The application of loop alignment transforms loop-carried dependences into loop-independent dependences, which allows extracting more parallelism from a loop. It uses a combination of other transformations, like loop peeling or introduces conditional statements. Loop alignment can be used in conjunction with loop fusion to align the array accesses in both loop nests. In the example below, all accesses to array a become aligned.

Example of loop alignment:

| | |
|---|---|
| for(i=2;i <= N;i++) { | for(i=1; i<=N; i++) { |
| a[i] = b[i] + c[i]; | If (i>1) a[i] = b[i] + c[i]; |
| d[i] = a[i−1] * 2; | if (i<N) d[i+1] = a[i] * 2; |
| e[i] = a[i−1] + d[i+1]; | if (i<N) e[i+1] = a[i] + d[i+2]; |
| } | } |

Loop Skewing

This transformation is used to enable parallelization of a loop nest. It is useful in combination with loop interchange. It is performed by adding the outer loop index multiplied by a skew factor, f, to the bounds of the inner loop variable, and then subtracting the same quantity from every use of the inner loop variable inside the loop.

Example of loop skewing:

| | |
|---|---|
| for(i=1; i <= N; i++) | for(i=1; i <= N; i++) |
| for(j=1;j <= N; j++) | for(j=i+1;j <= i+N; j++) |
| a[i] = a[i+j] + c; | a[i] = a[j] + c; |

Loop Peeling

This transformation removes a small number of starting or closing iterations of a loop to avoid dependences in the loop body. These removed iterations are executed separately. It can be used for matching the iteration control of adjacent loops to enable loop fusion.

Example of loop peeling:

| | |
|---|---|
| for(i=0; i<=N; i++) | a[0][N] = a[0][N] + a[N][N]; |
| a[i][N] = a[0][N] + a[N][N]; | for(i=1;i<=N−1; i++) |
| | a[i][N] = a[0][N] + a[N][N]; |
| | a[N][N] = a[0][N] + a[N][N]; |

Loop Splitting

This transformation cuts the iteration space in pieces by creating other loop nests. It is also called Index Set Splitting, and is generally used because of dependences that prevent parallelization. The iteration space of the new loops is a subset of the original one. It can be seen as a generalization of loop peeling.

Example of loop splitting:

| | |
|---|---|
| for(i=0; i<=N; i++) | for(i=0;i<(N+1)/2; i++) |
| a[i] = a[N−i+1] + c; | a[i] = a[N−i+1] + c; |
| | for(i= (N+1)/2;i <= N;i++) |
| | a[i] = a[N−I+1] + c; |

Node Splitting

This transformation splits a statement in pieces. It is used to break dependence cycles in the dependence graph due to the too high granularity of the nodes, thus enabling vectorization of the statements.

Example of node splitting:

| | |
|---|---|
| for(i=0;i < N;i++) { | for(i = 0,i < N;i++) { |
| b[i] = a[i] + c[i] * d[i] ; | t1[i] = c[i] * d[i]; |
| a[i+1] = b[i] * (d[i] − c[i]); | t2[i] = d[i] − c[i]; |
| } | b[i] = a[i] + t1[i]; |
| | a[i+1] = b[i] * t2[i]; |
| | } |

Scalar Expansion

This transformation replaces a scalar in a loop by an array to eliminate dependences in the loop body and enables parallelization of the loop nest. If the scalar is used after the loop, compensation code must be added.

Example of scalar expansion:

| | |
|---|---|
| for(i=0; i<N; i++){ | for(i=0;i<N; i++){ |
| c = b[i]; | tmp[i] = b[i]; |
| a[i] = a[i] + c; | a[i] = a[i] + tmp[i]; |
| } | } |
| | c = tmp[N−1]; |

Array Contraction/Array Shrinking

This transformation is the reverse transformation of scalar expansion. It may be needed if scalar expansion generates too many memory requirements.

Example of array contraction:

| | |
|---|---|
| for(i=0; i<N;i++) | for(i=0; i<N;i++) |
| for(j=0; j<N;j++) { | for (j=0; j<N;j++) { |
| t[i][j] = a[i][j] * 3; | t[j] = a[i][j] * 3; |
| b[i][j] = t[i][j] + c[j]; | b[i][j] = t[j] + c[j]; |
| } | } |

Scalar Replacement

This transformation replaces an invariant array reference in a loop by a scalar. This array element is loaded in a scalar before the inner loop and stored again after the inner loop, if it is modified. It can be used in conjunction with loop interchange.

Example of scalar replacement:

| | |
|---|---|
| for(i=0; i<N; i++) | for(i=0;i<N; i++){ |
| for(j=0; j<N;j++) | tmp = a[i]; |
| a[i] = a[i] + b[i][j]; | for(j=0; j<N;j++) |
| | tmp = tmp + b[i][j]; |
| | a[i] = tmp; |
| | } |

Reduction Recognition

This transformation allows handling reductions in loops. A reduction is an operation that computes a scalar value from arrays. It can be a dot product, the sum or minimum of a vector for instance. The goal is then to perform as many operations in parallel as possible. One way is to accumulate a vector register of partial results and then reduce it to a scalar with a sequential loop. Maximum parallelism is achieved by reducing the vector register with a tree: pairs of elements are summed, then pairs of these results are summed, etc.

Example of reduction recognition:

| | |
|---|---|
| for(i=0; i<N;i++) | for(i=0; i<N; i=i+64) |
| s = s + a[i]; | tmp[0:63] = tmp[0:63] + a[i:i+63]; |
| | for(i=0; i<64;i++) |
| | s = s + tmp[i]; |

Loop Pushing/Loop Embedding

This transformation replaces a call in a loop body by the loop in the called function. It is an inter-procedural optimization. It allows the parallelization of the loop nest and eliminates the overhead caused by the procedure call. Loop distribution can be used in conjunction with loop pushing.

Example of loop pushing:

| | |
|---|---|
| for(i=0; i<N; i++) | f2(x) |
| f(x,i); | void f2(int* a) { |
| void f(int* a,int j) { | for(i=0; i<N; i++) |
| a[j] = a[j] + c; | a[i] = a[i] + c; |
| } | } |

Procedure Inlining

This transformation replaces a call to a procedure by the code of the procedure itself. It is an inter-procedural optimization. It allows a loop nest to be parallelized, removes overhead caused by the procedure call, and can improve locality.

Example of procedure inlining:

| | |
|---|---|
| for(i=0; i<N; i++) | for(i=0; i<N; i++) |
| f(a,i); | a[i] = a[i] + c; |
| void f(int* x, int j){ | |
| x[j] = x[j] + c; | |
| } | |

Statement Reordering

This transformation schedules instructions of the loop body to modify the data dependence graph and hence enables vectorization.

Example of statement reordering:

| | |
|---|---|
| for(i=0;i < N;i++) { | for(i=0; i<N; i++) { |
| a[i] = b[i] * 2; | c[i] = a[i−1] − 4; |
| c[i] = a[i−1] − 4; | a[i] = b[i] * 2; |
| } | } |

Software Pipelining

This transformation parallelizes a loop body by scheduling instructions of different instances of the loop body. It is a powerful optimization to improve instruction-level parallelism. It can be used in conjunction with loop unrolling. In the example below, the preload commands can be issued one after another, each taking only one cycle. This time is just enough to request the memory areas. It is not enough to actually load them. This takes many cycles, depending on the cache level that actually has the data. Execution of a configuration behaves similarly. The configuration is issued in a single cycle, waiting until all data are present. Then the configuration executes for many cycles. Software pipelining overlaps the execution of a configuration with the preloads for the next configuration. This way, the XPP array can be kept busy in parallel to the Load/Store unit.

Example of software pipelining:

Issue Cycle Command

| | |
|---|---|
| | XppPreloadConfig(CFG1); |
| | for (i=0; i<100; ++i) { |
| 1: | XppPreload(2,a+10*i,10); |
| 2: | XppPreload(5,b+20*i,20); |
| 3: | |
| 4: | // delay |
| 5: | |
| 6: | XppExecute( ); |
| | } |

Issue Cycle Command

| | |
|---|---|
| Prologue | XppPreloadConfig(CFG1); |
| | XppPreload(2,a,10); |
| | XppPreload(5,b,20); |
| | // delay |
| | for (i=1; i<100; ++i) { |

| | | |
|---|---|---|
| Kernel | 1: | XppExecute( ); |
| | 2: | XppPreload(2,a+10*i,10); |
| | 3: | XppPreload(5,b+20*i,20); |
| | 4: | } |
| | | XppExecute( ); |

| | |
|---|---|
| Epilog | // delay |

Vector Statement Generation

This transformation replaces instructions by vector instructions that can perform an operation on several data in parallel. This occurs at the end of the vectorization process, and is only of interest if the target processor is a vector processor.

Example of vector statement generation:

| | |
|---|---|
| for(i=0; i<=N; i++) | a[0:N] = b[0:N]; |
| a[i] = b[i]; | |

3.2.3 Data-Layout Optimizations

In the following we describe optimizations that modify the data layout in memory in order to extract more parallelism or prevent memory problems like cache misses.

Scalar Privatization

This optimization is used in multi-processor systems to increase the amount of parallelism and avoid unnecessary communications between the processing elements. If a scalar is only used like a temporary variable in a loop body, then each processing element can receive a copy of it and achieve its computations with this private copy.

Example for scalar privatization:

```
for(i=0;i <= N;i++) {
  c = b[i];
  a[i] = a[i] + c;
}
```

Array Privatization

This optimization is the same as scalar privatization except that it works on arrays rather than on scalars.

Array Merging

This optimization transforms the data layout of arrays by merging the data of several arrays following the way they are accessed in a loop nest. This way, memory cache misses can be avoided. The layout of the arrays can be different for each loop nest. In FIG. 10 the example of a cross-filter is shown, where the accesses to array a are interleaved with accesses to array b. The picture next to it represents the data layout of both arrays where blocks of a (green) are merged with blocks of b (yellow). Unused memory space is white. Thus cache misses are avoided as data blocks containing arrays a and b are loaded into the cache when getting data from memory. Details may be found in [11].

3.2.4 Example of Application of the Optimizations

A lot of optimizations can be performed on loops before and also after generation of vector statements. Finding a sequence of optimizations producing an optimal solution for all loop nests of a program is still an area of research. Therefore we propose a way to use the optimizations that follows a reasonable heuristic to produce vectorizable loop nests. To vectorize the code, we can use the Allen-Kennedy algorithm that uses statement reordering and loop distribution before vector statements are generated. It can be enhanced with loop interchange, scalar expansion, index set splitting, node splitting, loop peeling. All these transformations are based on the data dependence graph. A statement can be vectorized if it is not part of a dependence cycle, hence optimizations are performed to break cycles or, if not completely possible, to create loop nests without dependence cycles. The example presented below is intended as an illustration for the use of the optimizations presented before.

The whole process is divided in four majors steps. First the procedures are restructured by analyzing the procedure calls inside the loop bodies and trying to remove them. Then some high-level dataflow optimizations are applied to the loop bodies to modify their control-flow and simplify the code. The third step prepares the loop nests for vectorization by building perfect loop nests and ensures that inner loop levels are vectorizable. Then target specific optimizations are applied which optimize the data locality. Note that other optimizations and code transformations may be applied between these different steps.

The first step comprises procedure inlining and loop pushing to remove the procedure calls of the loop bodies. The second step consists of loop-invariant code motion, loop unswitching, strength reduction and idiom recognition. The third step can be divided in several subsets of optimizations. We first apply loop reversal, loop normalization and if-conversion to obtain normalized loop nests. This allows building the data dependence graph. If dependences prevent the loop nest to be vectorized adequate transformations are applied. If, for instance, dependences occur only on certain iterations, loop peeling or loop splitting can remove these dependences. Node splitting, loop skewing, scalar expansion or statement reordering can be applied in other cases. Loop interchange moves inwards the loop levels without dependence cycles. The objective is to obtain perfectly nested loops with the loop levels carrying dependence cycles as much outwards as possible. We subsequently apply loop fusion, reduction recognition, scalar replacement/array contraction and loop distribution to further improve the vectorization. Finally vector statement generation is performed (using the Allen-Kennedy algorithm, for instance). The last step consists of optimizations like loop tiling, strip-mining, loop unrolling and software pipelining which take the target processor into account.

The number of optimizations in the third step is large, but not all of them are applied to each loop nest. Following the goal of the vectorization and the data dependence graph only some of them are applied. Heuristics are used to guide the application of the optimizations, that can be applied several times if needed. Let us illustrate this with an example.

```
void f(int** a, int** b, int *c,int i, int j) {
    a[i][j] = a[i][j−1] − b[i+1][j−1];
}
void g(int* a,int* c,int i) {
      a[i] = c[i] + 2;
}
for(i=0; i<N;i++) {
  for(j=1; j<9;j=j++)
      if (k>0)
        f(a,b,i,j);
      else
        g(d,c,j);
    }
  d[i] = d[i+1] + 2;
}
for(i=0; i<N;i++)
    a[i][i] = b[i] + 3;
```

The first step finds that inlining the two procedure calls is possible, then loop unswitching is applied to remove, the conditional instruction of the loop body. The second step starts with applying loop normalization and analyses the data dependence graph. A cycle can be broken by applying loop interchange as it is only carried by the second level. The two levels are exchanged, so that the inner level is vectorizable. Before that or also after, we apply loop distribution. Loop fusion is applied when the loop level with induction variable i is pulled out of the conditional instruction by a traditional redundant code elimination optimization. Finally vector code is generated for the resulting loops.

So in more details, after procedure inlining, we obtain:

```
for(i=0; i<N;i++) {
  for(j=1; j<9;j=j++)
    if (k>0)
      a[i][j] = a[i][j−1] − b[i+1][j−1];
    else
      d[j] = c[j] + 2;
    }
  d[i] = d[i+1] + 2;
}
for(i=0; i<N;i++)
    a[i][i] = b[i] + 3;
```

After loop unswitching, we obtain:

```
if (k > 0)
  for(i=0; i<N;i++) {
    for(j=1; j<9;j=j++)
      a[i][j] = a[i][j−1] − b[i+1][j−1];
    d[i] = d[i+1] + 2;
    }
else
  for(i=0; i<N;i++) {
    for(j=1; j<9;j=j++)
      d[j] = c[j] + 2;
    d[i] = d[i+1] + 2;
}
for(i=0; i<N;i++)
    a[i][i] = b[i] + 3;
```

After loop normalization, we obtain:

```
if (k > 0)
  for(i=0; i<N;i++) {
    for(j=0; j<8;j=j++)
      a[i][j+1] = a[i][j] − b[i+1][j];
    d[i] = d[i+1] + 2;
    }
else
  for(i=0; i<N;i++) {
    for(j=0; j<8;j=j++)
      d[j] = c[j+1] + 2;
    d[i] = d[i+1] + 2;
}
for(i=0; i<N;i++)
    a[i][i] = b[i] + 3;
```

After loop distribution and loop fusion, we obtain:

```
if (k > 0)
  for(i=0; i<N;i++)
      for(j=0; j<8;j=j++)
        a[i][j+1] = a[i][j] − b[i+1][j];
else
  for(i=0; i<N;i++)
      for(j=0; j<8;j=j++)
          d[j] = c[j+1] + 2;
for(i=0; i<N;i++) {
    d[i] = d[i+1] + 2;
    a[i][i] = b[i] + 3;
}
```

After loop interchange, we obtain:

```
if (k > 0)
    for(j=0; j<8;j=j++)
          for(i=0; i<N;i++)
            a[i][j+1] = a[i][j] − b[i+1][j];
else
  for(i=0; i<N;i++)
        for(j=0; j<8;j=j++)
              d[j] = c[j+1] + 2;
for(i=0; i<N;i++) {
      d[i] = d[i+1] + 2;
      a[i][i] = b[i] + 3;
}
```

After vector code generation, we obtain

```
if (k > 0)
  for(j=0; j<8;j=j++)
      a[0:N−1][j+1] = a[0:N−1][j] − b[0:N][j];
else
  for(i=0; i<N;i++)
    d[0:8] = c[1:9] + 2;
d[0:N−1] = d[1:N] + 2;
a[0:N−1][0:N−1] = b[0:N] + 3;
```

### 4 COMPILER SPECIFICATION FOR THE PACT XPP

4.1 Introduction

A cached RISC-XPP architecture exploits its full potential on code that is characterized by high data locality and high computational effort. A compiler for this architecture has to consider these design constraints. The compiler's primary objective is to concentrate computational expensive calculations to innermost loops and to make up as much data locality as possible for them.

The compiler contains usual analysis and optimizations. As interprocedural analysis, like alias analysis, are especially useful, a global optimization driver is necessary to ensure the propagation of global information to all optimizations The following sections concentrate on the way the PACT XPP influences the compiler.

4.2 Compiler Structure

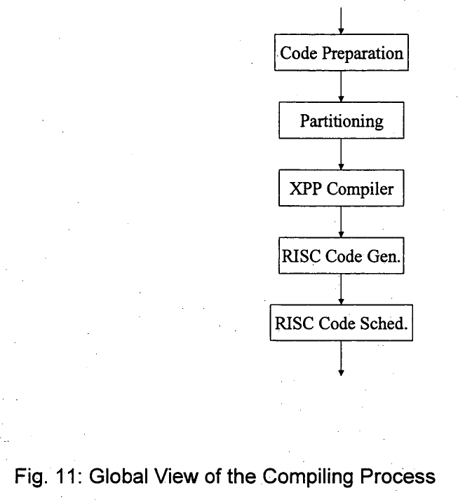

FIG. 11 shows the main steps the compiler must follow to produce code for a system containing a RISC processor and a PACT XPP. The next sections focus on the XPP compiler itself, but first the other steps are briefly described.

4.2.1 Code Preparation

This step takes the whole program as input and can be considered as a usual compiler front-end. It will prepare the code by applying code analysis and optimizations to enable the compiler to extract as many loop nests as possible to be executed by the PACT XPP. Important optimizations are idiom recognition, copy propagation, dead code elimination, and all usual analysis like dataflow and alias analysis.

Handling of Pointer and Array Accesses

Pointer and array accesses are represented identically in the intermediate code representation which is built during the parsing of the source program. Hence pointer accesses are considered like array accesses in the data dependence analysis as well as in the optimizations used to transform the loop bodies. Interprocedural alias analysis, for instance, leads in the code shown below to the decision that the two pointers p and q never reference the same memory area, and that the loop body may be successfully handled by the XPP rather than by the host processor.

Example of pointer disambiguation:

```
int foo(int *p, int *q, int N)
{
  for(i = 0;i < N;i++)
    {
      p[i] = q[i] * q [i+1];
    }
return p[N−1];
}
main( )
int a [100],b[100];
int N;
...
foo(a,b,N);
```

4.2.2 Partitioning

Partitioning decides which part of the program is executed by the host processor and which part is executed by the XPP.

A loop nest is executed by the host in three cases:
if the loop nest is not well-formed,
if the number of operations to execute is not worth it to be executed on the PACT XPP, or
if it is impossible to get a mapping of the loop nest on the PACT XPP.

A loop nest is said to be well-formed if the loop bounds are computable and the step of all loops is constant, the loop induction variables are known, and if there is only one entry and one exit to the loop nest.

If the loop bounds are constant but unknown at compile, time it is possible to speculatively generate XPP code which assumes adequate iteration counts (loop tiling). But small loop iteration counts at run time can drive generated XPP code towards inefficiency. One possible solution is the introduction of a conditional instruction testing whether the loop bounds are large enough for profitable XPP code. Two versions of the loop nest are produced. One for execution on the host processor, and the other for execution on the XPP. This concept also eases the application of loop transformations needing minimal iteration counts.

4.2.3 RISC Code Generation and Scheduling

After the XPP compiler has produced NML code for the loops chosen by the partitioning phase, the main compiling process must handle the code that will be executed by the host processor where instructions to manage the configurations have been inserted. This is the objective of the last two steps:
RISC Code Generation and
RISC Code Scheduling.

The first one produces code for the host processor and the second one further optimizes further by looking for a better scheduling using software pipelining for instance.

4.3 XPP Compiler for Loops

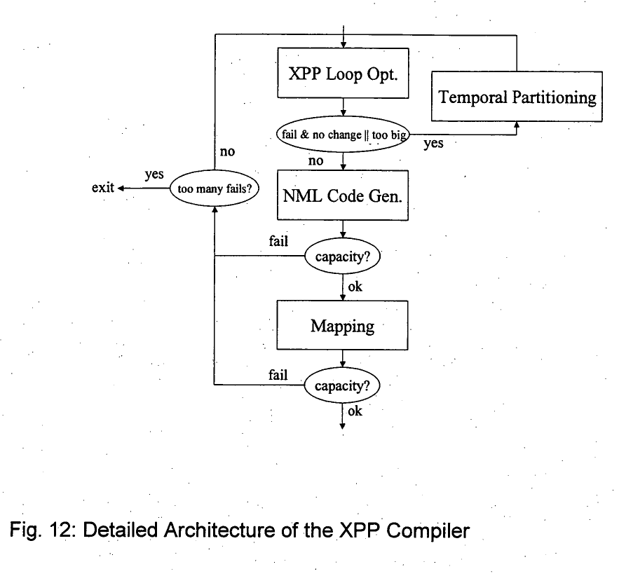

FIG. 12 describes the internal processing of the XPP Compiler. It is a complex cooperation between program transformations, included in the XPP Loop Optimizations, a temporal partitioning phase, NML code generation and the mapping of the configuration on the PACT XPP.

First target specific loop optimizations are applied to produce innermost loop bodies that can be executed on the array of processors. If case of success, the NML code generation phase is called, otherwise temporal partitioning is applied to obtain several configurations for one loop. After NML code generation and the mapping phase, it is possible that a configuration will not fit into the PAE array. In this case the loop optimizations are applied again with respect to the reasons of failure of the NML code generation or of the mapping. If this new application of loop optimizations does not change the code, temporal partitioning is applied. Furthermore we keep track of the number of attempts for the NML Code Generation and the mapping. If too many attempts are made, and we still do not obtain a solution, we break the process, and the loop nest will be executed by the host processor.

4.3.1 Temporal Partitioning

Temporal partitioning splits the code generated for the XPP in several configurations if the number of operations, i.e. the size of the configuration exceeds the number of operations executable in a single configuration. This transformation is called loop dissevering [6]. These configurations are integrated in a loop of configurations whose number of execution corresponds to the iteration range of the original loop.

4.3.2 Generation of NML Code

This step takes as input an intermediate form of the code produced by the XPP Loop Optimizations step, together with a dataflow graph built upon it. NML code is then produced by using tree- or DAG-pattern matching techniques [12,13]. After this step, specific NML optimizations are applied. For instance, partial redundancy elimination and boolean simplification dedicated to optimizing the generated event networks are invoked.

4.3.3 Mapping Step

This step takes care of mapping the NML modules on the XPP by placing the operations on the ALUs, FREGs, and BREGs, and routing the data through the buses.

4.4 XPP Loop Optimizations Driver

The objective of the loop optimizations used for the XPP is to extract as much parallelism as possible from the loop nests in order to execute them on the XPP by exploiting the ALU-PAEs as effectively as possible and to avoid memory bottlenecks by means of IRAM usage. The following sections explain how they are organized and how to take into account the architecture for applying the optimizations.

4.4.1 Organization of the System

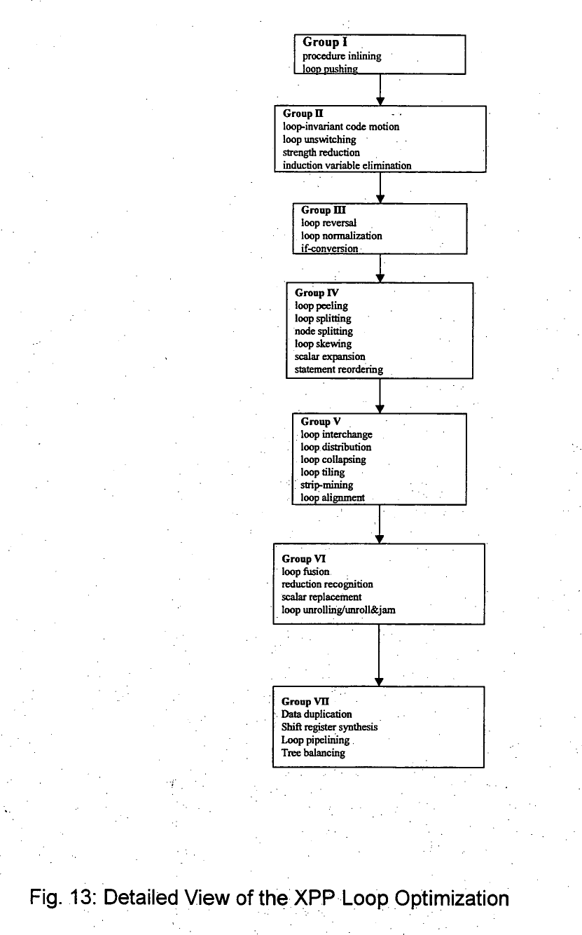

FIG. 13 presents the organization of the loop optimizations. The transformations are divided in six groups. Other standard optimizations and analyses are applied in-between. Each group is called several times. Loops over several groups may also occur. The number of iterations for each driver loop is constant or determined at compile time by the optimizations itself (e.g. repeat until a certain code quality is reached). In the first iteration of the loop, it can be checked if loop nests are usable for the XPP, it is mainly directed to check the loop bounds etc. For instance if the loop nest is well-formed and the data dependence graph does not prevent optimization, but the loop bounds are unknown, then in the first iteration loop tiling is applied to get an innermost loop that is easier to handle and can be better optimized, and in the second iteration, loop normalization, if-conversion, loop interchange and other optimizations are applied to effectively optimize the loop nest for the XPP.

Group I ensures that no procedure calls occur in the loop nest. Group II prepares the loop bodies by removing loop-invariant instructions and conditional instruction to ease the analysis. Group III generates loop nests suitable for the data dependence analysis. Group IV contains optimizations to transform the loop nests to obtain data dependence graphs that are suitable for vectorization. Group V contains optimizations ensuring that innermost loops can be executed on the XPP. Group VI contains optimizations that further extract parallelism from the loop bodies. Group VII contains target specific optimizations.

In each group the application of the optimizations depends on the result of the analysis and the characteristics of the loop nest. Hence, for instance, the application of a transformation out of Group IV depends on the data dependence graph computed before.

4.4.2 Loop Preparation

The optimizations of Groups I, II and III of the XPP compiler generate loop bodies without procedure calls, conditional instructions and induction variables other than loop control variables. Thus loop nests, where the innermost loops are suitable for execution on the XPP, are obtained. The iteration ranges are normalized to ease data dependence analysis and the application of other code transformations.

4.4.3 Transformation of the Data Dependence Graph

The optimizations of Group IV are performed to obtain innermost loops suitable for vectorization with respect to the data dependence graph. Nevertheless a difference with usual vectorization is that a dependence cycle, that would normally prevent any vectorization of the code, does not prevent the optimization of a loop nest for the PACT XPP. If a cycle is due to an anti-dependence, then it could be that it won't prevent optimization of the code as stated in [7]. Furthermore dependence cycles will not prevent vectorization for the PACT XPP when it consists only of a loop-carried true dependence on the same expression. If cycles with distance k occur in the data dependence graph, then this is handled by holding k values in registers. This optimization is of the same class as cycle shrinking.

Nevertheless limitations due to the dependence graph exist. Loop nests cannot be handled if some dependence distances are not constant, or unknown. If only a few dependences prevent the optimization of the whole loop nest, this could be overcome, by using the traditional vectorization algorithm that sorts topologically the strongly connected components of the data dependence graph (statement reordering), and then applies loop distribution. This way, loop nests which can be handled by the XPP are obtained.

4.4.4 Influence of the Architectural Parameters

Some hardware specific parameters influence the application of the loop transformations. The compiler estimates the number of operations and memory accesses which are consumed within a loop body. These parameters influence loop unrolling, strip-mining, loop tiling and also loop interchange (iteration range).

The table below lists the parameters that influence the application of the optimizations. For each of them two values are given: a starting value computed from the loop, and a restriction value which is the value the parameter should reach or should not exceed after the application of the optimizations. Vector length depicts the number of elements (i.e. 32-bit data) of an array accessed in the loop body. Reused data set size represents the amount of data that must fit in the cache. I/O IRAMs, ALU, FREG, BREG stand for the number of IRAMs, ALUs, FREGs, and BREGs respectively that constitute the XPP. The dataflow graph width represents the number of operations that can be executed in parallel in the same pipeline stage. The dataflow graph height represents the length of the pipeline. Configuration cycles amounts to the length of the pipeline, and to the number of cycles dedicated to the control. The application of each optimization may
decrease a parameter's value (−),
increase a parameter's value (+),
not influence a parameter (id), or
adapt a parameter's value to fit into the goal size (make fit).

Furthermore, some resources must be kept for control in the configuration; this means that the optimizations should not make the needs exceed more than 70-80% of each resource.

| Parameter | Goal | Starting Value |
|---|---|---|
| Vector length | IRAM size (128 | Loop count |
| | words) | |
| Reused data set size | Approx. cache | Algorithm analysis/loop sizes |
| | size | |
| I/O IRAMs | XPP size (16) | Algorithm inputs + outputs |
| ALU | XPP size (<64) | ALU opcode estimate |
| BREG | XPP size (<80) | BREG opcode estimate |
| FREG | XPP size (<80) | FREG opcode estimate |
| Dataflow graph width | High | Algorithm dataflow graph |
| Dataflow graph height | Small | Algorithm dataflow graph |
| Configuration cycles | ≦command line | Algorithm analysis |
| | parameter | |

Here are some additional notations used in the following descriptions. Let n be the total number of processing elements available, r, the width of the dataflow graph, in, the maximum number of input values in a cycle and out, the maximum number of output values possible in a cycle. On the XPP, n is the number of ALUs, FREGs and BREGs available for a configuration, r is the number of ALUs, FREGs and BREGs that can be started in parallel in the same pipeline stage and, in and out amount to the number of available IRAMs. As IRAMs have 1 input port and 1 output port, the number of IRAMs yields directly the number of input and output data.

The number of operations of a loop body is computed by adding all logic and arithmetic operations occurring in the instructions. The number of input values is the number of operands of the instructions regardless of address operations. The number of output values is the number of output operands of the instructions regardless of address operations. To determine the number of parallel operations, input and output values as well as the dataflow graph must be considered. The effects of each transformation on the architectural parameters are now presented in detail.

Loop Interchange

Loop interchange is applied when the innermost loop has a very small iteration range. In that case, loop interchange allows having an innermost loop with a more profitable iteration range. It is also influenced by the layout of the data in memory. It is profitable to data locality to interchange two loops to get a more practical way to access arrays in the cache and therefore prevent cache misses. It is of course also influenced by data dependences as explained earlier.

| Parameter | Effect |
|---|---|
| Vector length | + |
| Reused data set size | make fit |
| I/O IRAMs | id |
| ALU | id |
| BREG | id |
| FREG | id |
| Dataflow graph width | id |
| Dataflow graph height | id |
| Configuration cycles | − |

Loop Distribution

Loop distribution is applied if a loop body is too big to fit on the XPP. Its main effect is to reduce the processing elements needed by the configuration. Reducing the need for IRAMs is a side effect of this optimization.

| Parameter | Effect |
|---|---|
| Vector length | id |
| Reused data set size | id |
| I/O IRAMs | make fit |
| ALU | make fit |
| BREG | make fit |
| FREG | make fit |
| Dataflow graph width | − |
| Dataflow graph height | − |
| Configuration cycles | − |

Loop Collapsing

Loop collapsing is used to make the loop body use more memory resources. As several dimensions are merged, the iteration range is increased and the memory needed is increased as well.

| Parameter | Effect |
|---|---|
| Vector length | + |
| Reused data set size | + |
| I/O IRAMs | + |
| ALU | id |
| BREG | id |
| FREG | id |
| Dataflow graph width | + |
| Dataflow graph height | + |
| Configuration cycles | + |

Loop Tiling

Loop tiling, as multi-dimensional strip-mining, is influenced by all parameters, it, is especially useful when the iteration space is by far too big to fit in the IRAM, or to guarantee maximum execution time when the iteration space is unbounded (see Section 4.4.7). Loop tiling makes the loop body fit with the resources of the XPP, namely the IRAM and cache line sizes. The size of the tiles for strip-mining and loop filing can be computed by
tile size=resources available for the loop body/resources necessary for the loop body

The resources available for the loop body are the whole resources of the XPP for the current configuration. One tile size may be computed for the data and another one for the processing elements. The final tile size is the minimum of these two computations. If, for instance, the amount of data accessed is larger than the capacity of the cache, loop tiling can be applied which is shown be the following example.

Example of loop tiling for the PACT XPP:

| | |
|---|---|
| for(i=0;i <= 1048576;i++) | for(i=0; i<= 1048576; I+= CACHE_SIZE) |
| <loop body> | for(j=0; j< CACHE_SIZE; |
| | j+=IRAM_SIZE) |
| | for(k=0; k<IRAM_SIZE;k++) |
| | <tiled loop body> |

| Parameter | Effect |
|---|---|
| Vector length | make fit |
| Reused data set size | make fit |
| I/O IRAMs | id |
| ALU | id |
| BREG | id |
| FREG | id |
| Dataflow graph width | + |
| Dataflow graph height | + |
| Configuration cycles | + |

Strip-Mining

Strip-mining is used to match the amount of memory accesses of the innermost loop with the IRAM capacity. Usually the necessary number of processing elements does not build the bottleneck, as the XPP provides 64, ALU-PAEs which is sufficient to execute most single loop bodies. However, the number of operations can be also taken into account the same way as the data.

| Parameter | Effect |
|---|---|
| Vector length | make fit |
| Reused data set size | id |
| I/O IRAMs | − |
| ALU | id |
| BREG | id |
| FREG | id |
| Dataflow graph width | + |
| Dataflow graph height | id |
| Configuration cycles | id |

Loop Fusion

Loop fusion is applied when a loop body does not use enough resources. In this case several loop bodies are merged to obtain a configuration using a larger part of the available resources.

| Parameter | Effect |
|---|---|
| Vector length | id |
| Reused data set size | id |
| I/O IRAMs | + |
| ALU | + |
| BREG | + |
| FREG | + |
| Dataflow graph width | id |
| Dataflow graph height | + |
| Configuration cycles | + |

Scalar Replacement

The amount of memory needed by the loop body should always fit into the IRAMs. Due to this optimization, some input or output array data is replaced by scalars, that are either stored in FREGs or kept on buses.

| Parameter | Effect |
|---|---|
| Vector length | id |
| Reused data set size | id |
| I/O IRAMs | − |
| ALU | id |
| BREG | id/+ |
| FREG | id/+ |
| Dataflow graph width | id/− |
| Dataflow graph height | id/− |
| Configuration cycles | id |

Loop Unrolling/Loop Collapsing/Loop Fusion

Loop unrolling, loop collapsing and loop fusion are influenced by the number of operations within the body of the loop nest and the number of data inputs and outputs of these operations, as they modify the size of the loop body. The number of operations should always be smaller than n, and the number of input and output data should always be smaller than in and out. Note that although the number of configuration cycles increases, the throughput increases as well resulting in a better performance.

| Parameter | Effect |
|---|---|
| Vector length | id |
| Reused data set size | id |
| I/O IRAMs | + |
| ALU | + |
| BREG | + |
| FREG | + |
| Dataflow graph width | id |
| Dataflow graph height | + |
| Configuration cycles | + |

Loop Distribution

Like the optimizations above, loop distribution is influenced by the number of operations of the body of the loop nest and the number of data inputs and outputs of these operations. The number of operations should always be smaller than n, and the number of input and output data should always be smaller than in and out. The following table describes the effect for each of the loops resulting from the loop distribution.

| Parameter | Effect |
|---|---|
| Vector length | id |
| Reused data set size | id |
| I/O IRAMs | − |
| ALU | − |
| BREG | − |
| FREG | − |
| Dataflow graph width | id |
| Dataflow graph height | − |
| Configuration cycles | − |

Unroll-and-Jam

Unroll-and-Jam consists of unrolling an outer loop and then merging the inner loops. It must compute the unrolling degree u with respect to the number of input memory accesses m and output memory accesses p in the inner loop. The following inequality must hold: u*m≦in [symbol] u*p≦out. Moreover the number of operations of the new inner loop must also fit on the PACT XPP. The unrolling degree u is computed using the following formula: u=min(u_{PAE},u_{RAM}), where u_{PAE} and u_{RAM} are computed by the same formula: u┌resources available/Σresources needed┐. Once more although the number of configuration cycles increases, the throughput increases as well resulting in better performance.

| Parameter | Effect |
|---|---|
| Vector length | id |
| Reused data set size | + |
| I/O IRAMs | + |
| ALU | + |
| BREG | + |
| FREG | + |
| Dataflow graph width | id |
| Dataflow graph height | + |
| Configuration cycles | + |

4.4.5 Target Specific Optimizations

At this step other optimizations, specific to the XPP, may be applied. These optimizations deal mostly with memory problems and dataflow considerations. This is the case for shift register synthesis, input data duplication (similar to scalar or array privatization), and loop pipelining.

Shift Register Synthesis

This optimization deals with array accesses occurring during the execution of a loop body. When several values of an array are alive for different iterations, it is convenient to store them in registers rather than accessing memory each time they are needed. As the same value must be stored in different registers depending on the number of iterations it is alive, a value shares several registers and flows from a register to another at each iteration. It is similar to a vector register allocated to an array access with the same value for each element. This optimization is performed directly on the dataflow graph by inserting nodes representing registers when a value must be stored in a register. In the PACT XPP, it amounts to store it in a data register. A detailed explanation can be found in [1].

Shift register synthesis is mainly suitable for small to medium amounts of iterations where values are alive. Since the pipeline length increases with each iteration for which the value has to be buffered, the following method is better suited for medium to large distances between accesses in one input array.

Nevertheless this method works very well for image processing algorithms which mostly alter a pixel by analyzing itself and its surrounding neighbors. Some resources are needed to produce guards on input or output values to ensure the semantics of the produced code, as all registers must be filled to allow the code to produce correct values.

| Parameter | Effect |
|---|---|
| Vector length | + |
| Reused data set size | id |
| I/O IRAMs | id |
| ALU | + |
| BREG | id/+ |
| FREG | + |
| Dataflow graph width | − |
| Dataflow graph height | + |
| Configuration cycles | + |

Input Data Duplication

This optimization is orthogonal to shift register synthesis. If different elements of the same array are needed concurrently, instead of storing the values in registers, the same values are copied into different IRAMs. The advantage against shift register synthesis is the shorter pipeline length, and therefore the increased parallelism, and the unrestricted applicability. On the other hand, the cache-IRAM bottleneck can affect the performance of this solution, depending on the amounts of data to be moved. Nevertheless we assume that cache-IRAM transfers are negligible to transfers in the rest of the memory hierarchy.

| Parameter | Effect |
|---|---|
| Vector length | id |
| Reused data set size | id |
| I/O IRAMs | + |
| ALU | id |
| BREG | id |
| FREG | id |
| Dataflow graph width | + |
| Dataflow graph height | − |
| Configuration cycles | id |

FIFO Pipelining

This optimization is used to store an array in the memory of the PACT XPP, when the size of the array is smaller than the total amount of memory of the PACT XPP, but larger than the size of an IRAM. It can be used for input or output data. Several IRAMs in FIFO mode are linked to each other, and the input/output port of the last one is used by the computing network. A condition to use this method is that the access pattern of the elements of the array must allow using the FIFO mode. It avoids to apply loop tiling/strip-mining to make an array fit on the PACT XPP.

| Parameter | Effect |
|---|---|
| Vector length | id |
| Reused data set size | id |
| I/O IRAMs | + |
| ALU | id |
| BREG | id |
| FREG | id |
| Dataflow graph width | id |
| Dataflow graph height | − |
| Configuration cycles | + |

Loop Pipelining

This optimization synchronizes operations by inserting delays in the dataflow graph. These delays are registers. For the PACT XPP, it amounts to store values in data registers to delay the operation using them. This is the same as pipeline balancing performed by xmap.

| Parameter | Effect |
|---|---|
| Vector length | id |
| Reused data set size | id |
| I/O IRAMs | id |
| ALU | id |
| BREG | + |
| FREG | + |
| Dataflow graph width | + |
| Dataflow graph height | −/id |
| Configuration cycles | − |

Tree Balancing

This optimization consists in balancing the tree representing the loop body. It reduces the depth of the pipeline, thus reducing the execution time of an iteration, and increases parallelism.

| Parameter | Effect |
|---|---|
| Vector length | id |
| Reused data set size | id |
| I/O IRAMs | id |
| ALU | id |
| BREG | id |
| FREG | id |
| Dataflow graph width | id |
| Dataflow graph height | − |
| Configuration cycles | − |

4.4.6 Memory Optimizations
Optimization of Memory Accesses

A particular concern for the PACT XPP are memory accesses. These need to be reduced in order to get enough parallelism to exploit. The loop bodies are freed of unnecessary memory accesses when shift register synthesis and scalar replacement are applied. Scalar replacement has the same effect as redundant load/store elimination. Array accesses are taken out of the loop body and handled by the host processor. It should be noted that redundant load/store elimination takes care not only of array accesses but also of accesses to global variables and records. On the other hand, shift register synthesis removes some accesses completely from the code.

Access Patterns and Loading of the Data into the IRAMs

A major issue is also how to load data in the IRAMs efficiently in terms of resources consumed and in terms of execution time. Non linear access patterns consume a lot of resources to compute the addresses, moreover their loading into the IRAMs can then be delayed by cache misses and these costly computations. Furthermore it is profitable for the execution time when the accesses are linear between the IRAMs and the ALU-PAEs.

As already stated in section 2.2.5, methods exist to prevent these problems. They can be applied at different levels:
on the data layout,
the source code, or
on the data transfer.

By modifying the data layout, the access patterns are simplified, thus saving resources and computation time. This is achieved by array merging, for instance.

The source code itself can be modified to simplify the access patterns. This is the case for matrix multiplication, presented in the case studies, where a matrix is transposed to obtain an access line-by-line and not row-by-row, or in the example presented at the end of the section. On the other hand, loop tiling allows filling the IRAMs by modifying the iteration range of the innermost loop.

Furthermore the access patterns can be modified by reordering the data. This can happen in two ways, as already described in section 2.2.5:
either by loading the data in the IRAMs in a specific order,
or by reordering dynamically the data.

The first data reordering strategy supposes a constant stride between two accesses, if this is not the case, then the second approach is chosen. More resources are needed, as the flow of data is reordered by computations done the PACT XPP to feed the ALU-PAEs, but the data are accessed linearly inside the IRAMs.

Finally if none of these methods is applicable, and the access patterns are too costly to be synthesized on the XPP array, the index expressions are computed in advance and loaded into an IRAM that is used as an index for accessing the array values stored in another IRAM. For instance, with, the following loop the values {0,0,0,1,1,1, . . . ,7,7,8} are loaded in an IRAM, and will feed the address input of the IRAM containing array b.

for(i=0;i <= 24;i++)
a[i] = b[i/3];

In this example, where only one expression causes problem, another solution is to apply loop tiling to prune it. The resulting loop is shown below. The expression i/3 evaluates to 0, as it is always smaller than 3. This is found by the value range analysis. The access pattern can then be synthesized on the XPP array to access the array values in the IRAMs.

| | |
|---|---|
| for(j=0;j <= 7;j++) | for(j=0;j <= 7;j++) |
| for(i=0;i < 3;i++) | for(i=0; i < 3; i++) { |
| a[i+3*j] = b[i/3+j]; | a[i+3*j] = b[j]; |
| } | } |

4.4.7 Limiting the Execution Time of a Configuration

The execution time of a configuration must be controlled. This is ensured in the compiler by strip-mining and loop tiling that also take care that the input data does not exceed the IRAMs capacity. This way the iteration range of the loop that is executed on the XPP is limited, and therefore its execution time. Moreover partitioning ensures that loops, whose execution count can be computed at run time, are going to be executed on the XPP. This condition is trivial for-loops, but for while-loops, where the execution count cannot be determined statically, a transformation like the one sketched below is applied. As a result, the inner for-loop can be handled by the XPP.

Transformation of while-loops:

| | |
|---|---|
| while (ok) { | while (ok) |
| <loop body> | for(i=0; i<100 && ok; i++) { |
| } | <loop body> |
| | } |

### 5 CASE STUDIES

5.1 Introduction

The following chapter contains six case studies from fields where a RISC-XPP combination fits best. As typical DSP examples a finite impulse response (FIR) filter and a viterbi decoder are investigated. Image processing algorithms are represented by an edge detector function, the inverse discrete cosine transformation from an MPEG codec and a wave let transformation. Furthermore a matrix multiplication and the quantization functions of the MPEG codec are investigated.

All algorithms are transformed with various optimizations presented in the preceding chapters. The result of the transformations is presented in C code, which is sometimes shortened for better understanding. In a last step the code is split in C code, which runs on the RISC host, and C code which runs on the XPP array. Furthermore the XPP configuration is presented as a dataflow graph which should generally give a better understanding, since some features of the XPP array cannot be presented in C adequately.

5.2 Conventions

5.2.1 Configuration and IRAM Names

Configurations are named by a prefix _XppCfg_ and a name. They are defined as C functions without parameters and without a return value.

The communication with the rest of the system is done over the IRAMs exclusively. They are identified by a number between 0 and 15. In the C representation of configurations they are differently declared depending on how they are used:
As a pointer of type (unsigned) char*, short*, or int*, respectively. When this representation is used, the IRAM is used in FIFO mode. Although this notation is not totally correct, it describes the access mode best. IRAMs in this mode are read and written sequentially starting with address 0. No address generators are needed. The access is illustrated by using the post increment notation *iram<N>++. When the declaration is of a smaller data type than integer, this silently implies that converters to 32 bits are produced by the compiler.
As arrays of type (unsigned) char[512], short[256], or int[128], respectively. The access notation in C is then iram<N>[offset expression]. In contrast to FIFO access dedicated address generators must be synthesized. As mentioned above, the usage of data types smaller than integer implies automatically generated data type converters.

All code parts outside a _XppCfg_-prefixed function are meant to run on the RISC host. The RISC code contains, besides normal C statements, calls to the compiler known functions which are presented in the hardware chapter.

5.2.2 Endianess

We assume big endian data layout. This means that the string representation of the word “PACT XPP” loaded to an IRAM causes the following IRAM content.

| Address | Content |
|---|---|
| 0x00 | 0x50414354 (‘P’<<24\|‘A’ <<16\|‘C’ << 8\|‘T’) |
| 0x01 | 0x20585050 (‘ ’<<24\|‘X’ <<16\|‘P’ << 8\|‘P’) |

Similarly, loading an array of 4 16-bit (short) values with the values 0x1234, 0x5678, 0x9abc and 0xdef0 respectively, causes the following content.

| Address | Content |
|---|---|
| 0x00 | 0x12345678 |
| 0x01 | 0x9abcdef0 |

There is no special reason for this choice, little endian order would be possible, too. Of course the predefined modules in the next section must then be adapted to the changed data layout.

5.2.3, Predefined Modules

For better readability of the examples some redefined modules are used. In the following subsections they are shortly described and their dataflow graphs are given.

Up Counters

The counters are used on one hand to drive the IRAM reads and writes and, on the other hand, to generate event sequences for the conversion modules presented next. The different implementations are described in [12] in detail.

Conversion Modules

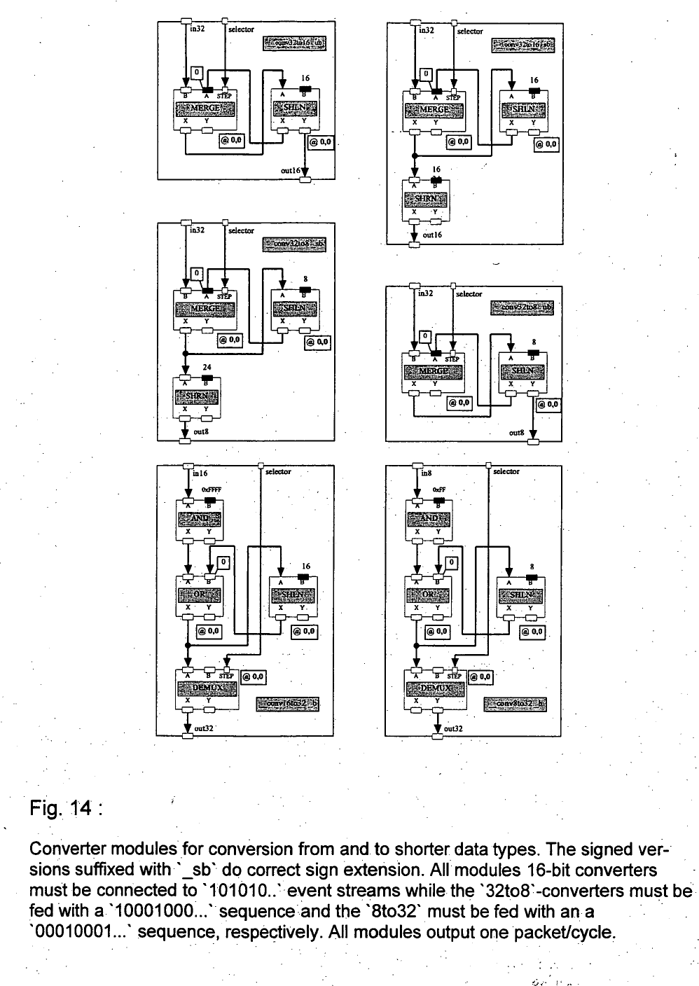

Predefined conversion modules are used throughout the case studies. The compiler handles them as compiler known functions. The compiler either generates conversion modules which produce a sequential stream of converted values, or it generates modules which simply split packets into parallel streams which then can be processed concurrently. FIG. 14 shows the implementations of the converters which convert to one stream. They output one 8/16-bit value per cycle. The input connectors expect data packets with packed values of the shorter data type. Furthermore the selector inputs need special event sequences for correct operations.

The second type of converters, which can only be used if dependences allow it, simply split a data packet in 2 or 4 streams with boolean operations, and do a sign extension if necessary. Since the implementations are straightforward, the dataflow graphs are omitted.

5.3 Performance Evaluation Procedure

5.3.1 Target Hardware Platform

The case studies are based on the basic design presented in chapter 2.5. The following parameters were used for the evaluation design:

| Unit | Frequency | |
|---|---|---|
| RISC core | 400 MHz | |
| XPP Cache Controller | 400 MHz | 1 preload FIFO stage |
| XPP PAE Array | 200 MHz | 8 × 8 ALU PAE's, 16 IRAM ports, 4 I/O Ports |

| Storage | Frequency | Size | |
|---|---|---|---|
| ICache | 400 MHz | 64 KB | fully associative |
| | | | cache line 32 Bytes |
| DCache | 400 MHz | 128 KB | fully associative |
| | | | cache line 32 Bytes |
| | | | write-back/write allocation |
| IRAMs | 400 MHz | 32 KB | 16 ports × 4 shadows × 128 ints × 32 bits |

| | | | Max | |
|---|---|---|---|---|
| Bus | Frequency | Bus width | Throughput | |
| ICache - PAE | 400 MHz | 32 bit | 1600 MB/s | |
| DCache - IRAMs | 400 MHz | 128 bit | 6400 MB/s | |
| SDRAM | 100 MHz | 32 bit | 400 MB/s | Read Burst: 7-1-1-1-1-1-1-1 |
| | | | | Write Burst: 1-1-1-1-1-1-1-1 |

As a simplification, we do not consider alignment, assuming a cache miss every thirty-two bytes, when reading succeeding memory cells. We may do this, because we potentially omit only a single cache miss, that potentially occurs, if the array spans one more cache line due to misalignment.

Execution times, in 400 MHz cycles:

| | | t(data size [bits]) |
|---|---|---|
| | Resource | [400 MHz cycles] |
| ICache Hit: | ICache -> | ceil(data size/32) |
| | PAE Array | |
| DCache Hit | DCache -> IRAM or | ceil(data size/128) |
| | IRAM -> DCache | |
| Cache Read Miss | RAM -> Cache | roundUp(data size, 256)/ |
| | | (8 * 32/((7 + 7 * 1) * 4) = |
| | | ceil(data size * 56/256) |
| Cache Write-Back | Cache -> RAM | roundUp(data size, 256)/ |
| | | (8 * 32/((8 * 1) * 4) = ceil |
| | | (data size * 32/256) |
| Cache Write Miss | IRAM -> RAM: | Cache Read Miss + |
| | Cache Read Miss + | Transfer(Write) = ceil |
| | Write Transfer | (data size * 56/256) + |
| | (IRAM -> Cache) | ceil(data size/128) |
| Execution | PAE Array | Configuration execution |
| | | cycles * 2 |

Whenever there are no pipeline stalls, the different units and busses can work in parallel. Thus the total execution time is defined by the following formula, where RAM transfer cycles summarizes the cycles of the cache read misses and the cache write-back cycles:
max(Sum(Execution cycles),
Sum(RAM transfer cycles),
max(Sum(ICache transfer cycles),
Sum(DCache transfer cycles))) [cycles @ 400 MHz]

If there are pipeline stalls, the outer maximum is replaced by a sum, reflecting the fact, that the units have to wait for each other to finish.

Only the amount of data that actually has to be transferred, is considered. Data that is already in a cache or in the IRAMs, is not accounted for.

For the startup case, the caches are assumed to be empty. Only the read data is considered, as the write-backs of the first iteration will take place in the next iteration. Due to the dependences, the above formula changes to a sum over all configurations of the following—per configuration—term:
ICache read miss+
max(ICache transfer cycles,Data cache read miss₁+
Sum_{i=2 . . . n-1}(max(Data cache read missᵢ,DCache transferᵢ₋₁))+
DCache transferₙ)+
Execution cycles [cycles @ 400 MHz]

This double sum converges to the previous formula for any non-trivial number of IRAM preloads. Also the RAM cycles dominate the transfer cycles by an order of magnitude. Therefore this more complicated computation method is only used for the trivial cases.

For the average case only data, that are read for the first time, are accounted for. The average case is defined as the iteration after an infinite number of iterations: all data that can be reused from the previous iteration are in the cache. All data that are used for the first time must be fetched from RAM and all data that are defined, but are not redefined by the next iteration have to be written back to the cache and the RAM.

The use of the XppPreloadClean instruction is a special case: no write allocation takes place, except at the start and the end of the array, if it is not aligned to a cache line boundary. These burst transfers are neglected. Also no read transfer from the cache to the IRAM takes place.

5.3.2 Evaluation Procedure

As mentioned above, all examples are transformed with various transformations and intermediate results are presented in C code on a regular basis. Wherever possible it is tried to present valid C code. Nevertheless in some examples it is necessary to use features which are not expressible in the source language. These then appear in comments within the source code.

After the partition step, configurations are hand written in NML to simulate the compiler code generation step. Placement and routing is done automatically by the mapping tool XMAP. For convenience the NML feature to define modules is used. In some cases, the objects in the critical path are placed relatively to each other, as this has proven to improve the execution performance drastically.

Each example lists the estimated data transfer performance in a table as the one below. The estimation assumes a cache controller which works with the RISC frequency which is twice the frequency of the XPP array, and four times the frequency of the 32-bit main memory bus. The Cache-IRAM transfers are executed with full cache controller speed over an 128-bit bus. All values are scaled to the cache controller frequency. The table below shows a typical data transfer estimation.

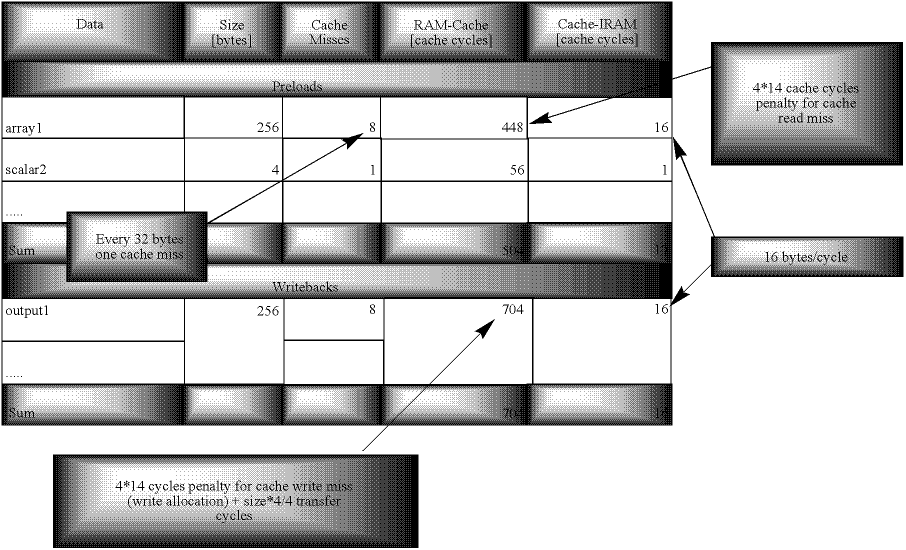

A cache read miss causes a 14 cycles penalty for the burst transfer on the main memory bus which calculates to 4*14=56 cache cycles to load a 32 byte cache line from main memory. If a write miss occurs, the cache controller write allocation must first load the affected cache line before it can be altered and written back. By using XppPreloadClean, write misses can be avoided. Then only the cache-RAM transfer with a 32-bit word every 4 cache cycles must be accounted for. For this reason, some examples show a smaller number of write-back cache misses than expected.

The XPP execute cycles are calculated by taking the double cycle difference (scaling to cache frequency) between the end of the configuration execution and the start of the configuration execution. The NML sources are implemented so that configuration loading and configuration execution do not overlap. This is done by means of a start object which is configured last and creates an event to start execution. The cycle measurements for the XPP only include the code which is executed in the configurations, i.e. in the loops of the evaluated function. The remaining control code, i.e. if statements, is not included. It is possible to neglect this remaining code on the RISC processor, since this code is executed in parallel to the XPP and is significantly shorter.

On the reference system, this code is executed in sequence to the code of the configurations, so it cannot be neglected. Moreover, splitting the code for the reference system into many small units prevents many optimizations for that system, making the measurements unrealistic. Thus the complete loop is timed on the reference system for those cases studies that suffer most from these effects.

The performance data of the reference system were measured by using a production compiler for a 32 bit fixed point DSP with a maximum instruction issue of four, an average instruction issue of approximately two and a one cycle memory access to on-chip high speed RAM. This allows to simply add the data cache miss cycles to the measured execution time to obtain realistic execution times for a memory hierarchy and off-chip RAM. Since the DSP cannot handle 8-bit data types reasonably, the sources were adapted to work with short, int and long types only to get representative results.

The results are summarized in another table. An example is shown below. All values are converted to the highest frequency (cache/RISC cycles). For each configuration the data access cycles and the instruction access cycles are listed for RAM and cache accesses. Then the execution cycles are given for both the XPP and the reference system. Finally the speedup is presented as reference execution cycles/XPP execution cycles. Using the formulas of section 5.3.1, execution cycles and speedup are given for all three different possibilities, where the data can be located initially: in-IRAM (column core—for the XPP only, for the RISC, the in-cache column is used instead), in-cache or in-RAM.

In the example performance evaluation table below the first three rows list the performance data of each configuration separately, and the last row lists the performance data of all configurations of the function. The data transfer cycles for the separate configurations, Data Access, represent all preloads and write-backs which would be necessary for executing the configuration alone. The data transfer cycles for executing all configurations is less than the sum of the cycles for the separate configurations, because data can remain in the IRAMs or in the cache between two configurations and do not need to be loaded again.

Usually the configurations are executed in a loop. Therefore the first table describes the first iteration of the example loop, All configurations are not in the cache, as are the required input data. No outputs

| | Data Access | | Configuration | | XPP Execute | | | Ref. System | | Speedup | | |
|---|---|---|---|---|---|---|---|---|---|---|---|---|
| configurations | RAM | DCache | RAM | ICache | Core | Cache | RAM | Cache | RAM | Core | Cache | RAM |
| configuration1 | 828 | 36 | 9688 | 1377 | 366 | 1377 | 10516 | 3624 | 4452 | 9.9 | 2.6 | 0.4 |
| configuration2 | 536 | 17 | 3024 | 429 | 56 | 429 | 3560 | 256 | 792 | 4.6 | 0.6 | 0.2 |
| configuration3 | 427 | 16 | 1736 | 245 | 76 | 245 | 2163 | 192 | 619 | 2.5 | 0.8 | 0.3 |
| all cfgs | 1218 | 37 | 14392 | 2051 | 498 | 2051 | 15610 | 4072 | 5290 | 8.2 | 2.0 | 0.3 |

have been computed so far, so no write-backs take place.

In the second table, the average case is described: All configurations are cached in the XPP array, as are the input data arrays that can be reused from the previous iteration. Therefore the table is missing all instruction transfer cycles.

| | Data Access | | Configuration | | XPP Execute | | | Ref. System | | Speedup | | |
|---|---|---|---|---|---|---|---|---|---|---|---|---|
| configurations | RAM | DCache | RAM | ICache | Core | Cache | RAM | Cache | RAM | Core | Cache | RAM |
| configuration1 | 1352 | 52 | | | 366 | 366 | 1352 | 3624 | 4976 | 9.9 | 9.9 | 3.7 |
| configuration2 | 536 | 17 | | | 56 | 56 | 536 | 256 | 792 | 4.6 | 4.6 | 1.5 |
| configuration3 | 760 | 32 | | | 76 | 76 | 760 | 192 | 952 | 2.5 | 2.5 | 1.3 |
| all cfgs | 1440 | 53 | | | 498 | 498 | 1440 | 4072 | 5512 | 8.2 | 8.2 | 3.8 |

This is repeated for all loops in the example. For some examples, no outer loop exists. In this case, the sub-optimal linear case is described as well as the case that the given function is called within a typical loop.

5.4 3×3 Edge Detector

5.4.1 Original Code

| #define VERLEN 16 | |
|---|---|
| #define HORLEN 16 | |
| main( ) { | |
| int v, h, inp; | |
| int p1[VERLEN][HORLEN]; | |
| int p2[VERLEN][HORLEN]; | |
| int htmp, vtmp, sum; | |
| for(v=0; v<VERLEN; v++) | // loop nest 1 |
| for(h=0; h<HORLEN; h++) { | |
| scanf(“%d”, &p1[v][h]); // read input pixels to p1 | |
| p2[v][h] = 0; // initialize p2 | |
| } | |
| for(v=0; v<=VERLEN−3; v++) { | // loop nest 2 |

| for(h=0; h<=HORLEN−3; h++) { | |
|---|---|
| htmp = | (p1[v+2][h] − p1[v][h]) + |
| | (p1[v+2][h+2] − p1[v][h+2]) + |
| | 2 * (p1[v+2][h+1] − p1[v][h+1]); |
| if (htmp < 0) | |
| htmp = − htmp; | |
| vtmp = | (p1[v][h+2] − p1[v][h]) + |
| | (p1[v+2][h+2] − p1[v+2][h]) + |
| | 2 * (p1[v+1][h+2] − p1[v+1][h]); |

| if (vtmp < 0) | |
|---|---|
| vtmp = − vtmp; | |
| sum = htmp + vtmp; | |
| if (sum > 255) | |
| sum = 255; | |
| p2[v+1][h+1] = sum; | |
| } | |
| } | |
| for(v=0; v<VERLEN; v++) | // loop nest 3 |

```
    for(h=0; h<HORLEN; h++)
      printf(“%d\n”, p2[v][h]); // print output pixels from p2
}
```

5.4.2 Preliminary Transformations

Due to the calls to the library functions scanf and printf in loop nest one and loop nest three, respectively, only loop nest two is handled in the further sections.

Interprocedural Optimizations

The first step normally invokes interprocedural transformations like function inlining and loop pushing. Since no procedure calls are within the loop body, these transformations are not applied to this example.

Basic Transformations

The following transformations are done:
Idiom recognition finds the abs( ) and min( ) patterns and reduces them to compiler known functions.
Tree balancing reduces the tree depth by swapping the operands of the additions.
The array accesses are mapped to IRAM accesses.
Since this example uses different values of one IRAM within an iteration, either shift register synthesis or data duplication must be used. To show the difference between these two transformations, both are outlined here.

The resulting code after this step is shown below. First with shift register synthesis:

```
for(v=0; v<=VERLEN−3; v++) {
  int iram0[128]; // p1[v]
  int iram1[128]; // p1[v+1]
  int iram2[128]; // p1[v+2]
  int iram3[128]; // p2[v+1][1]
  for(h=0; h<=HORLEN−1; h++) {
    // fill shift registers
    if (i>1) { tmp00 = tmp01; tmp10 = tmp11; tmp20 = tmp21; }
    if (i>0) { tmp01 = tmp02; ; tmp21 = tmp22; }
    tmp02 = iram0[h]; tmp12 = iram1[h]; tmp22 = iram2[h];
    if (h>2) {
```

| | |
|---|---|
| htmp = 2 * | (tmp21 − tmp01) + |
| | (tmp20 − tmp00) + |
| | (tmp22 − tmp02); |

htmp = abs(htmp);

| | |
|---|---|
| vtmp = 2 * | (tmp12 − tmp10) + |
| | (tmp02 − tmp00) + |
| | (tmp22 − tmp20); |

```
          ;
      vtmp = abs(vtmp);
      sum = min(255, htmp + vtmp);
      iram3[h−1] = sum;
    }
  }
}
```

And with data duplication:

for(v=0; v<=VERLEN−3; v++) {

| | |
|---|---|
| int iram0[128], iram1[128], | iram2[128]; // p1[v] |
| int iram3[128], | iram4[128]; // p1[v+1] |
| int iram5[128], iram6[128], | iram7[128]; // p1[v+2] |

```
  int iram8[128]; // p2[v+1][1]
  for(h=0; h<=HORLEN−3; h++) {
```

| | |
|---|---|
| tmp00 = iram0[h]; tmp10 = iram3[h]; | tmp20 = iram5[h]; |
| tmp01 = iram1[h+1]; | tmp21 = iram6[h+1]; |
| tmp02 = iram2[h+2]; tmp12 = iram4[h+2]; | tmp22 = iram7[h+2]; |

| | |
|---|---|
| htmp = 2 * | (tmp21 − tmp01) + |
| | (tmp20 − tmp00) + |
| | (tmp22 − tmp02); |

htmp = abs(htmp);

| | |
|---|---|
| vtmp = 2 * | (tmp12 − tmp10) + |
| | (tmp02 − tmp00) + |
| | (tmp22 − tmp20); |

```
        ;
    vtmp = abs(vtmp);
    sum = min(255, htmp + vtmp);
    iram3[h−1] = sum;
  }
}
```

The following table shows the estimated utilization and performance values.

| | | Value (data |
|---|---|---|
| Parameter | Value (shift register synthesis) | duplication) |
| Vector length | 16 | 16 |
| Reused data set size | 32 | 32 |
| I/O IRAMs | 3 I + 1 O = 4 | 8 I + 1 O = 9 |
| ALU | 8 (calc) + 3 * 2 (compare for | 8 (calc) |
| | shift register synthesis) = 14 | |
| BREG | 10 (BREG_SUB/ | 10 (BREG_SUB/ |
| | BREG_ADD) | BREG_ADD) |
| FREG | 3 * 2 = 6 (shift register | few |
| | synthesis) | |
| Dataflow graph width | 12 | 12 |
| Dataflow graph height | 3 (shift registers) + 8 | 8 (calculation) |
| | (calculation) | |
| Configuration cycles | 11 + 16 = 27 | 8 + 16 = 24 |

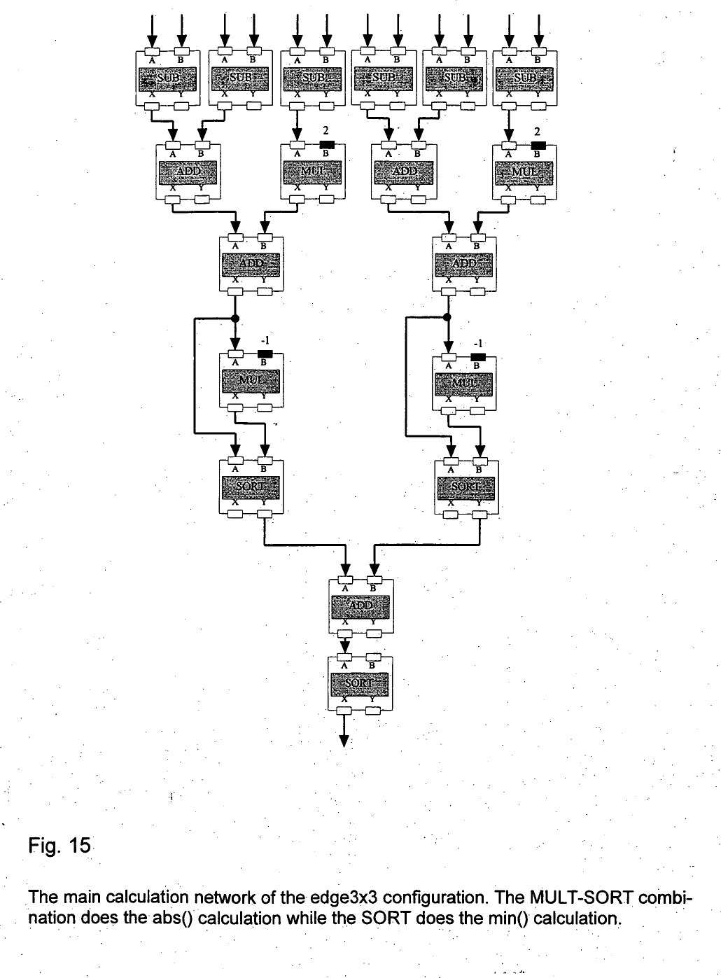

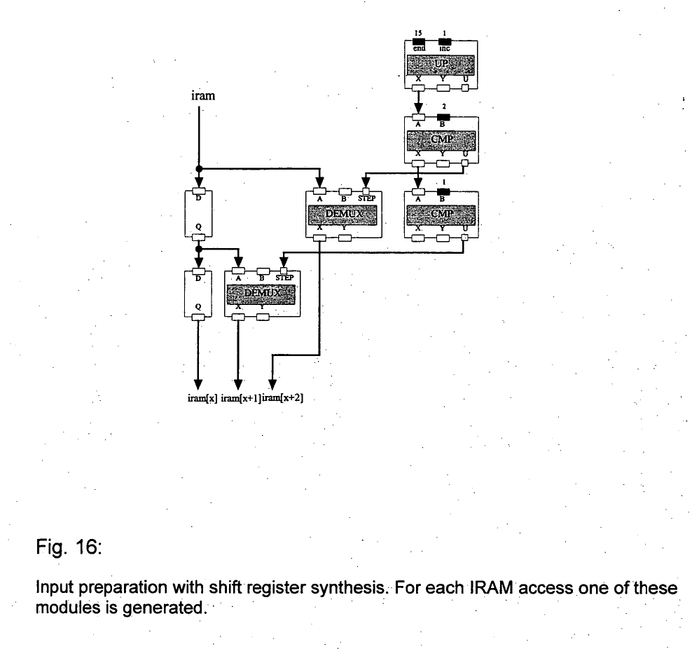

The inner loop calculation dataflow graph is shown in FIG. 15. The inputs are either connected over the shift register network shown in FIG. 16, or directly to an own IRAM.

5.4.3 Enhancing Parallelism

The table above shows a utilization of about one fourth of the ALUs. Until now we neglected that the SUB and ADD operations can be done by BREGs as well. Therefore we try to maximize utilization.

Unroll-and-Jam

Unroll-and-jam is the transformation of choice, because of its nature to bring iterations together. As the reused data size increases, the IRAM usage does not increase proportionally to the unrolling factor.

The parameters which determine the unrolling factor are the overall loop count of 14, the IRAM utilization of 4 and 9, respectively and the PAE counts. The first parameter allows an unrolling degree for unroll-and-jam equal to 2 and 7, while the IRAMs restrict it to 7 and 2 respectively. The PAE usage would allow an unrolling degree equal to 4 (ALU ADD/SUB replaced by BREG ADD/SUB). Therefore the minimum of all factors must be taken, which is 2. The estimated values are shown in the next table

| | Value | Value |
|---|---|---|
| Parameter | (shift register synthesis) | (data duplication) |
| Vector length | 2 * 16 | 2 * 16 |
| Reused data set size | 48 | 48 |
| I/O IRAMs | 4 I + 2 O = 6 | 12 I + 2 O = 14 |
| ALU | 2 * 8 + 4 * 2 = 24 | 2 * 8 = 16 |
| BREG | 20 | 20 |
| FREG | 4 * 2 = 8 | few |
| Dataflow graph width | 12 | 12 |
| Dataflow graph height | 3 (shift registers) + 8 | 8 (calculation) |
| | (calculation) | |
| Configuration cycles | 11 + 16 = 27 (two | 8 + 16 = 24 (two |
| | outputs/configuration) | outputs/configuration) |

5.4.4 Final Code
Shift Register Synthesis

The RISC code for shift register synthesis after unroll-and-jam reads then:

```
XppPreloadCanfig(_XppCfg_edge3x3);
for(v=0; v<=VERLEN−3; v+=2) {
    XppPreload(0, &p1[v], 16);
    XppPreload(1, &p1[v+1], 16);
    XppPreload(2, &p1[v+2], 16);
    XppPreload(3, &p1[v+3], 16);
    XppPreloadClean(4, @p1[v+1][1], 14]);
    XppPreloadClean(5, @p1[v+2][1], 14]);
    XppExecute( );
}
```

The configuration reads as follows:

| void _XppCfg_edge3x3 { | |
|---|---|
| // IRAMs | |
| int iram0[128]; // p1[v] | |
| int iram1[128]; // p1[v+1] | |
| int iram2[128]; // p1[v+2] | |
| int iram3[128]; // p1[v+3] | |
| int iram4[128]; // p2[v+1][1] | |
| int iram5[128]; // p2[v+2][1] | |
| for(h=0; h<=HORLEN−1; h++) { | |
| // fill shift registers | |
| if (i>1) { | tmp00 = tmp01; tmp10 = tmp11; tmp20 = tmp21; |
| | tmp30 = tmp31; } |
| if (i>0) { | tmp01 = tmp02; tmp11 = tmp12; tmp21 = tmp22; |
| | tmp31 = tmp32; } |

```
    tmp02 = iram0[h]; tmp12 = iram1[h]; tmp22 = iram2[h];
    tmp32 = iram3[h];
    if (h>2) {
      htmp = 2 * (tmp21 − tmp01) +
                (tmp20 − tmp00) +
                (tmp22 − tmp02);
      htmp0 = abs(htmp0);
      vtmp0 = 2 * (tmp12 − tmp10) +
                (tmp02 − tmp00) +
                (tmp22 − tmp20);
          ;
      vtmp0 = abs(vtmp0);
      sum0 = min(255, htmp0 + vtmp0);
      iram4[h−1] = sum0;
      htmp1 = 2 * (tmp31 − tmp11) +
                (tmp30 − tmp10) +
                (tmp32 − tmp12);
      htmp1 = abs(htmp1);
      vtmp1 = 2 * (tmp22 − tmp20) +
                (tmp12 − tmp10) +
                (tmp32 − tmp30);
          ;
      vtmp1 = abs(vtmp1);
      sum1 = min(255, htmp1 + vtmp1);
      iram5 [h−1] = sum1;
    }
  }
}
```

Data Duplication

Data duplication needs more preloads.

```
XppPreloadConfig(_XppCfg_edge3x3);
for(v=0; v<=VERLEN−3; v+=2) {
    XppPreload(0, &p1[v], 16);
    XppPreload(1, &p1[v], 16);
    XppPreload(2, &p1[v], 16);
    XppPreload(3, &p1[v+1], 16);
    XppPreload(4, &p1[v+1], 16);
    XppPreload(5, &p1[v+1], 16);
    XppPreload(6, &p1[v+2], 16);
    XppPreload(7, &p1[v+2], 16);
    XppPreload(8, &p1[v+2], 16);
    XppPreload(9, &p1[v+3], 16);
    XppPreload(10, &p1[v+3], 16);
    XppPreload(11, &p1[v+3], 16);
    XppPreloadClean(12, @p1[v+1][1], 14]);
    XppPreloadClean(13, @p1[v+2][1], 14]);
    XppExecute( );
}
```

On the other hand the configuration is less complex.

```
void _XppCfg_edge3x3 {
  // IRAMs
  int iram0[128], iram1[128],  iram2[128];  // p1[v]
  int iram3[128], iram4[128]  iram5[128];  // p1[v+1]
  int iram6[128], iram7[128],  iram8[128];  // p1[v+2]
  int iram9[128], iram10[128], iram11[128]; // p1[v+3]
  int iram12[128]; // p2[v+1][1]
  int iram13[128]; // p2[v+2][1]
  for(h=0; h<=HORLEN−3; h++) {
    tmp00 = iram0[h]; tmp10 = iram3[h];
    tmp20 = iram6[h]; tmp30 = iram9[h];
    tmp01 = iram1[h+1]; tmp11 = iram4[h+1];
    tmp21 = iram7[h+1]; tmp31 = iram10[h+1];
    tmp02 = iram2[h+2]; tmp12 = iram5[h+2];
    tmp22 = iram8[h+2]; tmp32 = iram11[h+2];
    htmp0 = 2 * (tmp21 − tmp01) +
                (tmp20 − tmp00) +
                (tmp22 − tmp02);
    htmp0 = abs(htmp0);
    vtmp0 = 2 * (tmp12 − tmp10) +
                (tmp02 − tmp00) +
                (tmp22 − tmp20);
        ;
    vtmp0 = abs(vtmp0);
    sum0 = min(255, htmp0 + vtmp0);
    iram12[h] = sum0;
    htmp1 = 2 * (tmp31 − tmp11) +
                (tmp30 − tmp10) +
                (tmp32 − tmp12);
    htmp1 = abs(htmp1);
    vtmp1 = 2 * (tmp22 − tmp20) +
                (tmp12 − tmp10) +
                (tmp32 − tmp30);
        ;
    vtmp1 = abs(vtmp1);
    sum1 = min(255, htmp1 + vtmp1);
    iram13[h] = sum1;
  }
}
```

5.4.5 Performance Evaluation

The next two tables list the estimated performance of data transfers. The values consider the data reuse, which means that after the startup, which preloads 4 picture rows, each iteration only advances two picture rows. Therefore two rows are reused and stay in the cache.

| | | | | |
|---|---|---|---|---|
| | | | | Cache to |
| | | | | IRAM |
| | Size | Cache | RAM to Cache | [cache |
| Data | [bytes] | Misses | [cache cycles] | cycles] |

Startup preloads

| | | | | |
|---|---|---|---|---|
| p1[v] | 64 | 2 | 112 | 4 |
| p1[v + 1] | 64 | 2 | 112 | 4 |
| p1[v + 2] | 64 | 2 | 112 | 4 |
| p1[v + 3] | 64 | 2 | 112 | 4 |
| Sum | | | 448 | 16 |

Steady State Preloads

| | | | | |
|---|---|---|---|---|
| p1[v] (reuse p[v + 2]) | 64 | | 0 | 4 |
| p1[v + 1] (reuse p[v + | 64 | | 0 | 4 |
| 3]) | | | | |
| p1[v + 2] | 64 | 2 | 112 | 4 |
| p1[v + 3] | 64 | 2 | 112 | 4 |
| Sum | | | 224 | 16 |

Steady State Writebacks

| | | | | |
|---|---|---|---|---|
| p2[v + 1] | 56 | 2 | 176 | 4 |
| p2[v + 2] | 56 | 2 | 176 | 4 |
| Sum | | | 352 | 8 |

For data duplication the following transfer statistics are estimated. The table accounts for the tripled data transfers between cache and IRAMs.

| | | | | |
|---|---|---|---|---|
| | | | | Cache |
| | | | | to IRAM |
| | Size | Cache | RAM to Cache | [cache |
| Data | [bytes] | Misses | [cache cycles] | cycles] |

Startup preloads

| | | | | |
|---|---|---|---|---|
| p1[v] (3 times) | 64 | 2 | 112 | 12 |
| p1[v + 1] (3 times) | 64 | 2 | 112 | 12 |
| p1[v + 2] (3 times) | 64 | 2 | 112 | 12 |
| p1[v + 3] (3 times) | 64 | 2 | 112 | 12 |
| Sum | | | 448 | 48 |

Steady State Preloads

| | | | | |
|---|---|---|---|---|
| p1[v] (reuse p[v + 2], | 64 | | 0 | 12 |
| 3 times) | | | | |
| p1[v + 1] (reuse p[v + | 64 | | 0 | 12 |
| 3], 3 times) | | | | |
| p1[v + 2] (3 times) | 64 | 2 | 112 | 12 |
| p1[v + 3] (3 times) | 64 | 2 | 112 | 12 |
| Sum | | | 224 | 48 |

Steady State Writebacks

| | | | | |
|---|---|---|---|---|
| p2[v + 1] | 56 | 2 | 64 | 4 |
| p2[v + 2] | 56 | 2 | 64 | 4 |
| Sum | | | 128 | 8 |

Both configurations, representing the loop, are hand coded in NML and mapped and simulated with the XDS tools.

The simulation yields—scaled to the cache frequency—124 and 144 cycles, respectively. This is remarkable in so far, that we expected the variant with data duplication would produce better results. It seems that the duplicated IRAMs cause a worse routing.

The performance comparison of the two configurations with the reference system yields the results in the following table. The first two rows of a section list the startup state and the steady state of the v-loop. Since the v-loop ha a trip count of 7, the columns sum calculate to startup state+7*steady state. All values assume worst-case performance, i.e. that configuration preload cannot be hidden and that no data is in the cache.

| | Data Access | | Configuration | | XPP Execute | | | Ref. System | | Speedup | | |
|---|---|---|---|---|---|---|---|---|---|---|---|---|
| configurations | RAM | DCache | RAM | ICache | Core | Cache | RAM | Cache | RAM | Core | Cache | RAM |

shift register synthesis

| | | | | | | | | | | | | |
|---|---|---|---|---|---|---|---|---|---|---|---|---|
| edge3 × 3 startup | 448 | 16 | 2296 | 1290 | 0 | 1290 | 2744 | | | | | |
| edge3 × 3 steady | 352 | 24 | 0 | 0 | 124 | 124 | 352 | | | | | |
| sum | 2912 | | | | 868 | 2158 | 5208 | 5628 | 8540 | 6.5 | 2.6 | 1.6 |

data duplication

| | | | | | | | | | | | | |
|---|---|---|---|---|---|---|---|---|---|---|---|---|
| edge3 × 3 startup | 448 | 48 | 1848 | 1049 | 0 | 1049 | 2296 | | | | | |
| edge3 × 3 steady | 352 | 56 | 0 | 0 | 144 | 144 | 352 | | | | | |
| sum | 2912 | | | | 1008 | 2057 | 4760 | 5628 | 8540 | 5.6 | 2.7 | 1.8 |

The results show the dominance of the configuration preload. Although the core performance of the case using data duplication is worse than the case using shift register synthesis, this is neglectable for the values including the memory hierarchy. The next table assumes that configuration preload can be issued early enough, so it can be hidden and must not be taken into account.

| | Data Access | | Configuration | | XPP Execute | | | Ref. System | | Speedup | | |
|---|---|---|---|---|---|---|---|---|---|---|---|---|
| configurations | RAM | DCache | RAM | ICache | Core | Cache | RAM | Cache | RAM | Core | Cache | RAM |

shift register synthesis

| | | | | | | | | | | | |
|---|---|---|---|---|---|---|---|---|---|---|---|
| edge3 × 3 startup | 448 | 16 | 0 | 0 | 16 | 448 | | | | | |
| edge3 × 3 steady | 352 | 24 | 0 | 124 | 124 | 352 | | | | | |
| sum | 2912 | | | 868 | 884 | 2912 | 5628 | 8540 | 6.5 | 6.4 | 2.9 |

data duplication

| | | | | | | | | | | | |
|---|---|---|---|---|---|---|---|---|---|---|---|
| edge3 × 3 startup | 448 | 48 | 0 | 0 | 48 | 448 | | | | | |
| edge3 × 3 steady | 352 | 56 | 0 | 144 | 144 | 352 | | | | | |
| sum | 2912 | | | 1008 | 1056 | 2912 | 5628 | 8540 | 5.6 | 5.3 | 2.9 |

The results again show the impact of the configuration preload for configurations that calculate small or medium amounts of data. When it can be hidden, performance is almost doubled in this example.

The comparison to the reference system shows less improvement compared to other examples. The reason is the short vector length. Nevertheless pictures of size 16×26 are not very common, thus we expect better improvements in the next section, which embeds the algorithm in a parameterized function.

The final utilization is shown in the next table. As the estimations did not account for counters and other controlling networks, the values for BREGs and FREGs differ significantly.

| | Value (shift | |
|---|---|---|
| Parameter | register synthesis) | Value (data duplication) |
| Vector length | 2 * 16 | 2 * 16 |
| Reused data set size | 48 | 48 |
| I/O IRAMs [sum-pct] | 6-38% | 14-88% |
| ALU[sum-pct] | 33-52% | 19-30% |
| BREG [def/route/sum-pct] | 34/14/58-73% | 36/20/56-70% |
| FREG [def/route/sum-pct] | 25/27/52-65% | 9/38/47-59% |

5.4.6 Parameterized Function
Source Code

The benchmark source code is not very likely to be written in that form in real world applications. Normally it would be encapsulated in a function with parameters for input and output arrays along with the sizes of the picture to work on.

Therefore the source code would look similar to:

```
void edge3x3(int *p1, int *p2, int HORLEN, int VERLEN)
{
  for(v=0; v<=VERLEN−3; v++) {
    for(h=0; h<=HORLEN−3; h++) {
```

| htmp = | (**(p1 + (v+2) * HORLEN + h) − **(p1 + v * HORLEN + h)) + |
|---|---|
| | (**(p1 + (v+2) * HORLEN + h+2) − **(p1 + v * HORLEN + h+2))+ |
| 2 * | (**(p1 + (v+2) * HORLEN + h+1) − **(p1 + v * HORLEN + h+1)); |

```
      if (htmp < 0)
        htmp = − htmp;
```

| | |
|---|---|
| vtmp = | (**(p1 + v * HORLEN + h+2) − **(p1 + v * HORLEN + h)) + |
| | (**(p1 + (v+2) * HORLEN + h+2) − **(p1 + (v+2) * HORLEN + h))+ |
| 2 * | (**(p1 + (v+1) * HORLEN + h+2) − **(p1 + (v+1) * HORLEN + h)); |

```
      if (vtmp < 0)
        vtmp = − vtmp;
      sum = htmp + vtmp;
      if (sum > 255)
        sum = 255;
      **(p2 + (v+1) * HORLEN + h+1) = sum;
    }
  }
}
```

5.4.7 Transformations

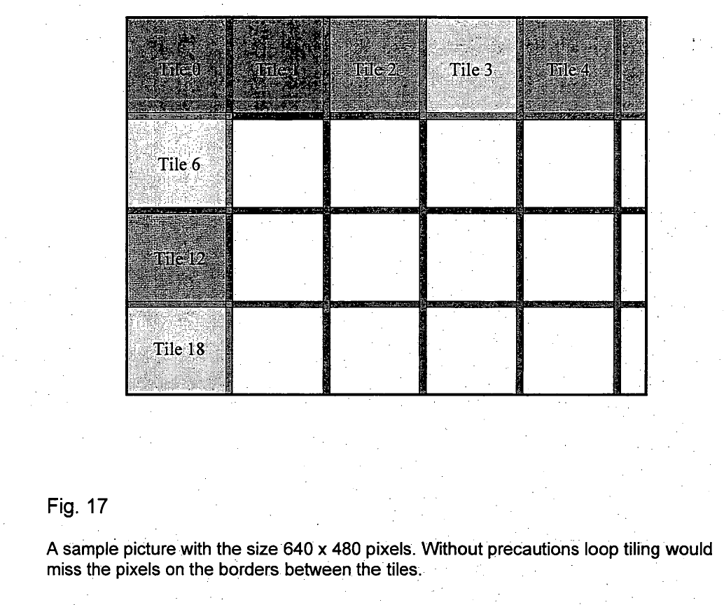

In addition to the transformations presented in section 5.4.2, this requires some additional features from the compiler.
Loop tiling assures that the IRAM size is not exceeded, and that the cache content is reused. In this example the algorithm must assure that the tiles overlap. FIG. 17 shows, that although the tile size must be 128, the loops that advance the tile must have step sizes of 125, otherwise the grey border edges would not be handled. The final tile size is computed by the RISC and passed to the array.
As the unroll-and-jam algorithm needs iteration counts which are a multiple of 2, a guarded peeled off first iteration is inserted, which calculates the values either on the RISC or in an own configuration.

The loop nest reads then as follows. We show only the variant with shift register synthesis, with the loop body omitted for better reading. As stated above, the tile size is 128 (IRAM size), but the tile advancing loops increase by 125, overlapping the tiles correctly. The loop body equals the one in 5.4.4 (Shift Register Synthesis).

```
for (v=0: v <= VERLEN−3; v+= 125)
  for(h=0; h <= HORLEN−3; h+= 125)
    for (vv=v; vv< min(v+ 127, VERLEN−2); v+=2)
      for(hh=h; hh< min(h+ 127, HORLEN−2); hh++) {
      .............
    }
```

5.4.8 Final Code

In addition to the simple variant, the final tile size of the innermost loop has to be passed to the array. Therefore the RISC code reads as follows, where the body of the guarded first iteration for odd tile sizes is omitted for simplicity.

```
XppPreloadConfig(_XppCfg_edge3x3);
for (v=0: v <= VERLEN−3; v+= 125)
  for(h=0; h <= HORLEN−3; h+= 125) {
    v_tilesize = min(128, VERLEN − v);
    if (v_tilesize & 1 != 0) {
      // calculate line on RISC
        v++; tilesize &= 1;
    }
    for (vv=v; vc< v + v_tilesize; v+=2) {
      tilesize = min(128, HORLEN−h);
        XppPreload(0, &p1[vv][h], tilesize);
        XppPreload(1, &p1[vv+1][h], tilesize);
        XppPreload(2, &p1[vv+2][h], tilesize);
        XppPreload(3, &p1[vv+3][h], tilesize);
        XppPreloadClean(4, @p1[vv+1][h+1], tilesize − 2]);
        XppPreloadClean(5, @p1[vv+2][h+1], tilesize − 2]);
        XppPreload(6, &tilesize, 1);
        XppExecute( );
}
```

The configuration reads then.

```
void _XppCfg_edge3x3 {
  // IRAMs
  int iram0[128]; // p1[vv]
  int iram1[128]; // p1[vv+1]
  int iram2[128]; // p1[vv+2]
  int iram3[128]; // p1[vv+3]
  int iram4[128]; // p2[vv+1][h+1]
  int iram5[128]; // p2[vv+2][h+1]
  int iram6[128]; // tilesize
  for(h=0; h<=iram6[0]; h++) {
    // fill shift registers
    if (i>1) { tmp00 = tmp01; tmp10 = tmp11; tmp20 = tmp21;
          tmp30 = tmp31; }
    if (i>0) { tmp01 = tmp02; tmp11 = tmp12; tmp21 = tmp22;
          tmp31 = tmp32; }
    tmp02 = iram0[h]; tmp12 = iram1[h]; tmp22 = iram2[h];
    tmp32 = iram3[h];
    if (h>2) {
      htmp0 = 2 * (tmp21 − tmp01) +
            (tmp20 − tmp00) +
            (tmp22 − tmp02);
      htmp0 = abs(htmp0);
      vtmp0 = 2 * (tmp12 − tmp10) +
            (tmp02 − tmp00) +
            (tmp22 − tmp20);
      vtmp0 = abs(vtmp0);
      sum0 = min(255, htmp0 + vtmp0);
      iram4[h−1] = sum0;
      htmp1 = 2 * (tmp31 − tmp11) +
            (tmp30 − tmp10) +
            (tmp32 − tmp12);
      htmp1 = abs(htmp1);
      vtmp1 = 2 * (tmp22 − tmp20) +
            (tmp12 − tmp10) +
            (tmp32 − tmp30);
        ;
      vtmp1 = abs(vtmp1);
      sum1 = min(255, htmp1 + vtmp1);
      iram5[h−1] = sum1;
    }
  }
}
```

The estimated utilization and worst-case performance (full tile) is shown below.

| Parameter | Value |
|---|---|
| Vector length | 2 * 128 |
| Reused data set size | 384 |
| I/O IRAMs | 5I + 2 O = 7 |
| ALU | 2 * 8 + 4 * 2 = 24 |
| BREG | 20 |
| FREG | 4 * 2 = 8 |
| Dataflow graph width | 12 |
| Dataflow graph height | 3 (shift registers) + 8 (calculation) |
| Configuration cycles | 11 + 128 = 139 |

5.4.9 Performance Evaluation

We assume a 750×500 pixels picture similar to that shown in FIG. 17. We choose the size to simplify measurements since the dimensions are both multiples of 125. The estimated data transfer performance is shown in the table below.

When computation of a new tile is begun (startup case), the first four rows must be loaded from RAM to the cache. During execution of the inner loop (steady state case, abbreviated steady) only two rows/iteration must be loaded. Since the output IRAMs are preloaded clean, no write allocation takes place.

| | | | | |
|---|---|---|---|---|
| | | | | IRAM |
| | Size | Cache | RAM to Cache | [cache |
| Data | [bytes] | Misses | [cache cycles] | cycles] |

Startup preloads

| | | | | |
|---|---|---|---|---|
| p1[vv] | 512 | 16 | 896 | 32 |
| p1[vv + 1] | 512 | 16 | 896 | 32 |
| p1[vv + 2] | 512 | 16 | 896 | 32 |
| p1[vv + 3] | 512 | 16 | 896 | 32 |
| Sum | | | 3584 | 128 |

Steady State Preloads

| | | | | |
|---|---|---|---|---|
| p1[vv] (reuse p[vv + 2]) | 512 | | 0 | 32 |
| p1[vv + 1] (reuse p[vv + | 512 | | 0 | 32 |
| 3]) | | | | |
| p1[vv + 2] | 512 | 16 | 896 | 32 |
| p1[vv + 3] | 512 | 16 | 896 | 32 |
| Sum | | | 1792 | 128 |

Steady State Writebacks

| | | | |
|---|---|---|---|
| p2[vv + 1] | 504 | 512 | 32 |
| p2[vv + 2] | 504 | 512 | 32 |
| Sum | | 1024 | 64 |

The simulation yields a cache cycle count of 496 per two rows of a tile. To compare the values with the reference system we calculate 24 (tiles)*(startup+63*steady) for, each value. Since the configuration takes place only once, it is mentioned in an own row of the following table, and involved without a factor in the summation.

| | Data Access | | Configuration | | XPP Execute | | | Ref. System | | Speedup | | |
|---|---|---|---|---|---|---|---|---|---|---|---|---|
| configurations | RAM | DCache | RAM | ICache | Core | Cache | RAM | Cache | RAM | Core | Cache | RAM |
| edge3x3 config | | | 2464 | 1408 | | 1408 | 2464 | | | | | |
| edge3x3 startup | 3548 | 128 | | | | 128 | 3548 | | | | | |
| edge3x3 steady | 2816 | 192 | | | 496 | 496 | 2816 | | | | | |
| sum | 4342944 | | | | 749952 | 754432 | 4345408 | 8577324 | 12920268 | 11.4 | 11.4 | 3.0 |

Finally the overall utilization is shown in the following table. As mentioned above, the big differences for FREGs and BREGs stem from the missing estimations for counter and controlling PAEs.

| Parameter | Value |
|---|---|
| Vector length | 2 * 128 |
| Reused data set size | 384 |
| I/O IRAMs [sum-pct] | 7-44% |
| ALU[sum-pct] | 27-43% |
| BREG [def/route/sum-pct] | 41/21/62-78% |
| FREG [def/route/sum-pct] | 25/34/59-74% |

5.5 FIR Filter
5.5.1 Original Code

Source Code:

```
  #define N 256
  #define M 8
  int x[N], y[N];
  const int c[M] = { 2, 4, 4, 2, 0, 7, −5, 2 };
  main( ) {
  int i, j;
/* code for loading x*/
  for (i = 0; i < N−M+1; i++) {
    y[i] = 0; // S
    for (j = 0; j < M; j++)
      y[i] += c[j] * x[i+M−j−1]; // S′
  }
/* code for storing y */
}
```

The constants N and M are replaced by their values by the pre-processor. The data dependence graph is the following:

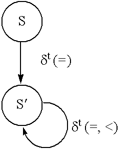

for (i = 0; i < 249; i++) {

S: y[i] = 0;

for (j = 0; j < 8; j++)

S′: y[i] += c[j] * x[i+7−j];
}

We have the following table:

| Parameter | Value |
|---|---|
| Vector length | input: 8, output: 1 |
| Reused data set size | — |
| I/O IRAMs | 3 |
| ALU | 2 |
| BREG | 0 |
| FREG | 0 |
| Dataflow graph width | 1 |
| Dataflow graph height | 2 |
| Configuration cycles | 2 + 8 = 10 |

Increasing the amount of parallelism available in a loop implies to increase the amount of memory needed to achieve the computations of the optimized loop body. In this case, the maximal parallelism is obtained when all multiplications of the inner loop are done in parallel, and the inner loop is completely unrolled. This way, 8 elements of array x are needed at each cycle. This is only possible by using data duplication, which means that all 16 IRAMs (2 IRAMS for each copy of array x) are needed to store array x, and consequently array y has to be output directly on the output port. Running a configuration—that uses only 8 IRAMs for input—twice would be another way to process the 256 values of array x.

The latter is possible in this case as array y is a global variable, but it won't be possible if it would be parameter of a function, as it is usually the case. Moreover, as the same data must be loaded in the different IRAMs from the cache for array x, we have a lot of transfers to achieve before the configuration can begin the computations. The performance of this algorithm is bounded by memory access times and thus there is no need to maximize parallelism. For this reason, the solution chosen by the compiler is to extract less parallelism to release the pressure on the memory hierarchy. It is presented in the next section. Nevertheless the more parallel solution is also presented to have a point of comparison.

5.5.2 Solution Chosen by the Compiler

To find some parallelism in the inner loop, the straightforward solution is to unroll the inner loop. No other optimization is applied before as either they do not have an effect on the loop or they increase the need for IRAMs. After loop unrolling, we obtain the following code:

```
for (i = 0; i < 249; i++) {
  y[i] = 0;
  y[i] += c[0] * x[i+7];
  y[i] += c[1] * x[i+6];
  y[i] += c[2] * x[i+5];
  y[i] += c[3] * x[i+4];
  y[i] += c[4] * x[i+3];
  y[i] += c[5] * x[i+2];
  y[i] += c[6] * x[i+1];
  y[i] += c[7] * x[i];
  }
```

Then the parameter table looks like this:

| Parameter | Value |
|---|---|
| Vector length | input: 256, output: 249 |
| Reused data set size | — |
| I/O IRAMs | 5 |
| ALU | 16 |
| BREG | 0 |
| FREG | 0 |
| Dataflow graph width | 2 |
| Dataflow graph height | 9 |
| Configuration cycles | 9 + 249 = 258 |

Dataflow analysis reveals that y[0]=f(x[0], . . . ,x[7]), y[1]=f(x[1], . . . ,x[8]), . . . ,y[i]=f(x[i], . . . ,x[i+7]). Successive values of y depend on almost the same successive values of x. To prevent unnecessary accesses to the IRAMs, the values of x needed for the computation of the next values of y are kept in registers. In our case this shift register synthesis needs 7 registers. This will be achieved on the PACT XPP, by keeping them into FREGs. Then we obtain the dataflow graph depicted below. An IRAM is used for the input values and an IRAM for the output values. The first 9 cycles are used to fill the pipeline and then the throughput is of one output value/cycle. Furthermore, each array will be stored in two IRAMs, which be linked to each other. The memories will be accessed in FIFO mode. This is depicted as “FIFO pipelining”, and avoid to apply loop tiling to make the amount of memory needed to the IRAMs, when the size of the array is smaller than the total amount of memory available on the PACT XPP. The code becomes the following after shift register synthesis:

```
c0 = c[0];
c1 = c[1];
c2 = c[2];
c3 = c[3];
c4 = c[4];
c5 = c[5];
c6 = c[6];
c7 = c[7];
r0 = x[0];
r1 = x[1];
r2 = x[2];
r3 = x[3];
r4 = x[4];
r5 = x[5];
r6 = x[6];
r7 = x[7];
for (i = 0; i < 249; i++) {
  y[i] = c7*r0 + c6*r1 + c5*r2 + c4*r3 + c3*r4 + c2*r5 + c1*r6 + c0*r7;
  r0 = r1;
  r1 = r2;
  r2 = r3;
  r3 = r4;
  r4 = r5;
  r5 = r6;
  r6 = r7;
  r7 = x[i+7];
}
```

And after FIFO pipelining, the code is transformed like below, where x1 and x2 represents the parts of x, which are loaded in different IRAMs, the same for y1 and y2 with respect to array y.

```
int *piram0_1,*piram1_1;
piram0_1 = &x1[0];
piram1_1 = &y1[0];
for (i = 0;i < 249;i++)
  {
    r0 = r1;
    r1 = r2;
    r2 = r3;
    r3 = r4;
    r4 = r5;
    r5 = r6;
    r6 = r7;
    r7 = x1++;
    if (i < 128)
        piram0_1++ = x2++;
    else
      if (i == 128)
          x1 = &x1[0];
    y1++ = c7*r0 + c6*r1 + c5*r2 + c4*r3 + c3*r4 +
            c2*r5 + c1*r6 + c0*r7;
    if (i < 128)
        y2++ = piram1_1++;
    else
      if (i == 128)
          y1 = &y1[0];
}
```

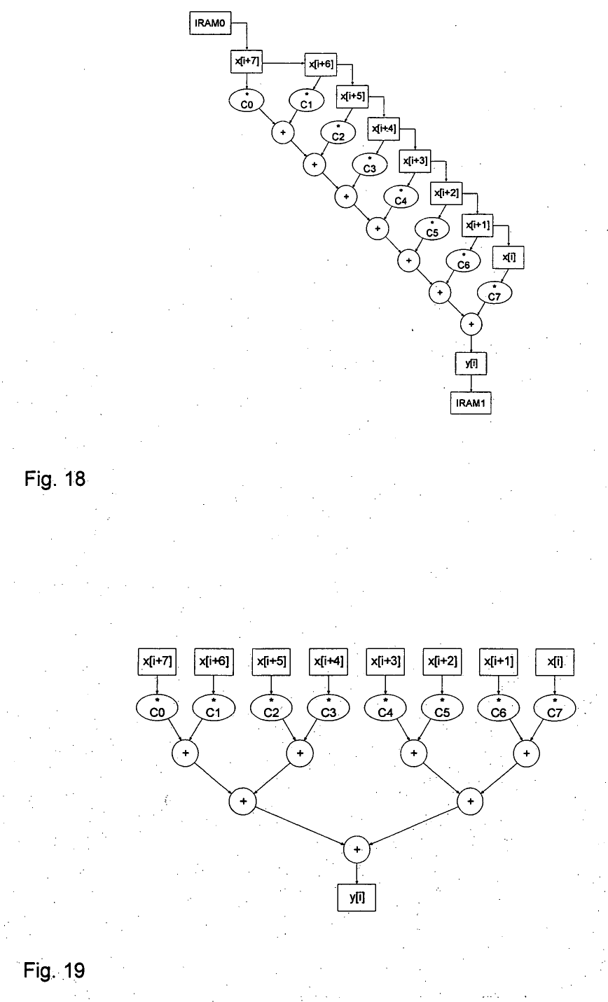

The dataflow graph representing the loop body is shown in FIG. 18.

The final parameter table is shown below:

| Parameter | Value |
|---|---|
| Vector length | input: 256, output: 249 |
| Reused data set size | — |
| I/O IRAMs | 4 |
| ALU | 15 |
| BREG | 0 |
| FREG | 7 |
| Dataflow graph width | 3 |
| Dataflow graph height | 9 |
| Configuration cycles | 9 + 249 = 258 |

Variant with Larger Loop Bounds

Let us take larger loop bounds and set the values of N and M to 2048 and 64.

```
for (i = 0; i < 1985; i++) {
    y[i] = 0;
    for (j = 0; j < 64; j++)
      y[i] += c[j] * x[i+63−j];
  }
```

The loop nest needs 17 IRAMs for the three arrays, which makes it impossible to execute on the PACT XPP. Following the loop optimizations driver given before, we apply loop tiling to reduce the number of IRAMs needed by the arrays, and the number of resources needed by the inner loop. We use a size of 512 for x and y, and 16 for c. Theoretically, we could have taken bigger sizes, and occupy more IRAMs, but subsequent optimizations will need more IRAMs. This can already be stated, as the amount of parallelism in the innermost loop is low, and to increase it more resources will be needed, therefore we must take smaller sizes. We obtain the following loop nest, where only 9 IRAMs are needed for the loop nest at the second level.

```
for (ii = 0;ii < 4;ii++)
    for (i = 0; i < min(512,1985−ii*512); i++) {
      y[i+512*ii] = 0;
      for (jj = 0; jj < 4; jj++)
        for (j = 0;j < 16;j++)
          y[i+512*ii] += c[16*jj+j] * x[i+512*ii+63−16*jj−j];
  }
```

A subsequent application of loop unrolling on the inner loop yields:

```
for (ii = 0;ii < 4;ii++)
  for (i = 0; i < min(512,1985−ii*512); i++) {
    y[i+512*ii] = 0;
    for (jj = 0; jj < 4; jj++) {
      y[i+512*ii] += c[16*jj] * x[i+512*ii+63−16*jj];
      y[i+512*ii] += c[16*jj+1] * x[i+512*ii+62−16*jj];
      y[i+512*ii] += c[16*jj+2] * x[i+512*ii+61−16*jj];
      y[i+512*ii] += c[16*jj+3] * x[i+512*ii+60−16*jj];
      y[i+512*ii] += c[16*jj+4] * x[i+512*ii+59−16*jj];
      y[i+512*ii] += c[16*jj+5] * x[i+512*ii+58−16*jj];
      y[i+512*ii] += c[16*jj+6] * x[i+512*ii+57−16*jj];
      y[i+512*ii] += c[16*jj+7] * x[i+512*ii+56−16*jj];
      y[i+512*ii] += c[16*jj+8] * x[i+512*ii+55−16*jj];
      y[i+512*ii] += c[16*jj+9] * x[i+512*ii+54−16*jj];
      y[i+512*ii] += c[16*jj+10] * x[i+512*ii+53−16*jj];
      y[i+512*ii] += c[16*jj+11] * x[i+512*ii+52−16*jj];
      y[i+512*ii] += c[16*jj+12] * x[i+512*ii+51−16*jj];
      y[i+512*ii] += c[16*jj+13] * x[i+512*ii+50−16*jj];
      y[i+512*ii] += c[16*jj+14] * x[i+512*ii+49−16*jj];
      y[i+512*ii] += c[16*jj+15] * x[i+512*ii+48−16*jj];
      }
    }
```

Finally we obtain the same dataflow graph as above, except that the coefficients must be read from another IRAM rather than being directly handled like, constants by the multiplications. After shift register synthesis the code is the following:

```
for (ii = 0;ii < 4;ii++)
  for (i = 0; i < min(512,1985−ii*512); i++) {
    r0 = x[i+512*ii+48];
    r1 = x[i+512*ii+49];
    r2 = x[i+512*ii+50];
    r3 = x[i+512*ii+51];
    r4 = x[i+512*ii+52];
    r5 = x[i+512*ii+53];
    r6 = x[i+512*ii+54];
    r7 = x[i+512*ii+55];
    r8 = x[i+512*ii+56];
    r9 = x[i+512*ii+57];
    r10 = x[i+512*ii+58];
    r11 = x[i+512*ii+59];
    r12 = x[i+512*ii+60];
    r13 = x[i+512*ii+61];
    r14 = x[i+512*ii+62];
    r15 = x[i+512*ii+63];
    for (jj = 0; jj < 4; jj++) {
      y[i] = c[8*jj]*r15 + c[8*jj+1]*r14 + c[8*jj+2]*r13 +
            c[8*jj+3]*r12 + c[8*jj+4]*r11 + c[8*jj+5]*r10 +
            c[8*jj+6]*r9 + c[8*jj+7]*r8 + c[8*jj+8]*r7 +
            c[8*jj+9]*r6 + c[8*jj+10]*r5 + c[8*jj+11]*r4 +
            c[8*jj+12]*r3 + c[8*jj+13]*r2 + c[8*jj+14]*r1 +
            c[8*jj+15]*r0;
      r0 = r1;
      r1 = r2;
      r2 = r3;
      r3 = r4;
      r4 = r5;
      r5 = r6;
      r6 = r7;
      r7 = r8;
      r8 = r9;
      r9 = r10;
      r10 = r11;
      r11 = r12;
      r12 = r13;
      r13 = r14;
      r14 = r15;
      r15 = x[i+512*ii+63−8*jj];
    }
}
```

The parameter table is then as follows.

| Parameter | Value |
|---|---|
| Vector length | input: 8, output: 1 |
| Reused data set size | — |
| I/O IRAMs | 3 |
| ALU | 31 |
| BREG | 0 |
| FREG | 15 |
| Dataflow graph width | 3 |
| Dataflow graph height | 17 |
| Configuration cycles | 4 + 17 = 21 |

5.5.3 A More Parallel Solution

The solution we presented does not expose maximal parallelism in the loop. This can be done by explicitly parallelizing the loop before we generate the dataflow graph. Of course, as explained before, exposing more parallelism means more pressure on the memory hierarchy.

In the data dependence graph presented at the beginning, the only loop-carried dependence is the dependence on S′ and it is only caused by the reference to y[i]. Hence we apply node splitting to get a more suitable data dependence graph, and a statement that can be parallelized. We obtain then:

```
for (i = 0; i < 249; i++) {
  y[i] = 0;
  for (j = 0; j < 8; j++)
    {
      tmp = c[j] * x[i+7−j];
      y[i] += tmp;
    }
}
```

Then scalar expansion is performed on tmp to remove the anti loop-carried dependence caused by it, and we have the following code:

```
for (i = 0; i < 249; i++) {
  y[i] = 0;
  for (j = 0; j < 8; j++)
    {
      tmp[j] = c[j] * x[i+7−j];
      y[i] += tmp[j];
    }
}
```

The parameter table is the following:

| Parameter | Value |
|---|---|
| Vector length | input: 8, output: 1 |
| Reused data set size | — |
| I/O IRAMs | 3 |
| ALU | 2 |
| BREG | 0 |
| FREG | 1 |
| Dataflow graph width | 2 |
| Dataflow graph height | 2 |
| Configuration cycles | 2 + 8 = 10 |

Then we apply loop distribution to get a vectorizable and a not vectorizable loop.

```
for (i = 0; i < 249; i++) {
  y[i] = 0;
  for (j = 0; j < 8; j++)
    tmp[j] = c[j] * x[i+7−j];
  for (j = 0; j < 8; j++)
      y[i] += tmp[j];
    }
}
```

The parameter table given below corresponds to the two inner loops in order to be compared with the preceding table.

| Parameter | Value |
|---|---|
| Vector length | input: 8, output: 1 |
| Reused data set size | — |
| I/O IRAMs | 5 |
| ALU | 2 |
| BREG | 0 |
| FREG | 1 |
| Dataflow graph width | 1 |
| Dataflow graph height | 3 |
| Configuration cycles | 1 * 8 + 1 * 8 = 16 |

Then we must take into account the architecture. The first loop is fully parallel; this means that we would need 2*8=16 input values at a time. This is all right, as it corresponds to the number of IRAMS of the PACT XPP. Hence we do, not need to strip-mine the first inner loop. The case of the second loop is trivial, it does not need to be strip-mined either. The second loop is a reduction, it computes the sum of a vector. This is easily found by the reduction recognition optimization and we obtain the following code.

```
for (i = 0; i < 249; i++) {
  y[i] = 0;
  for (j = 0; j < 8; j++)
    tmp[j] = c[j] * x[i+7−j];
  /* load the partial sums from memory using a shorter vector length */
  for (j = 0; j < 4; j++)
    aux[j] = tmp[2*j] + tmp[2*j+1];
  /* accumulate the short vector */
  for (j = 0;j < 1; j++)
    aux[2*j] = aux[2*j] + aux[2*j+1];
  /* sequence of scalar instructions to add up the partial sums */
  y[i] = aux[0] + aux[2];
}
```

Like above we give only one table for all innermost loops and the last instruction computing y[i].

| Parameter | Value |
|---|---|
| Vector length | input: 256, output: 249 |
| Reused data set size | — |
| I/O IRAMs | 9 |
| ALU | 4 |
| BREG | 0 |
| FREG | 0 |
| Dataflow graph width | 1 |
| Dataflow graph height | 4 |
| Configuration cycles | 1 * 8 + 1 * 4 + 1 * 1 = 13 |

Finally loop unrolling is applied on the inner loops, the number of operations is always less than the number of processing elements of the PACT XPP.

```
for (i = 0; i < 249; i++)
  {
  tmp[0] = c[0] * x[i+7];
  tmp[1] = c[1] * x[i+6];
  tmp[2] = c[2] * x[i+5];
  tmp[3] = c[3] * x[i+4];
  tmp[4] = c[4] * x[i+3];
  tmp[5] = c[5] * x[i+2];
  tmp[6] = c[6] * x[i+1];
  tmp[7] = c[7] * x[i];
  aux[0] = tmp[0] + tmp[1];
  aux[1] = tmp[2] + tmp[3];
  aux[2] = tmp[4] + tmp[5];
  aux[3] = tmp[6] + tmp[7];
  aux[0] = aux[0] + aux[1];
  aux[2] = aux[2] + aux[3];
  y[i] = aux[0] + aux[2];
}
```

We obtain then the dataflow graph representing the inner loop as shown in FIG. 19.

It could be mapped on the PACT XPP with each layer executed in parallel, thus needing 4 cycles/iteration and 15 ALU-PAEs, 8 of which needed in parallel. As the graph is already synchronized, the throughput reaches one iteration/cycle, after 4 cycles to fill the pipeline. The coefficients are taken as constant inputs by the ALUs performing the multiplications.

The drawback of this solution is that it uses 16 IRAMs, and that the input data must be stored in a special order. But due to data locality of the program, we can assume that the data already reside in the cache. And as the transfer of data from the cache to the IRAMs can be achieved efficiently, the configuration is executed on the PACT XPP without waiting for the data to be ready in the IRAMs. The parameter table is then the following:

| Parameter | Value |
|---|---|
| Vector length | input: 256, output: 249 |
| Reused data set size | — |
| I/O IRAMs | 16 |
| ALU | 15 |
| BREG | 0 |
| FREG | 0 |
| Dataflow graph width | 8 |
| Dataflow graph height | 4 |
| Configuration cycles | 4 + 249 = 253 |

Variant with Larger Bounds

To make the things a bit more interesting, we set the values of N and M to 2048 and 64.

```
for (i = 0; i < 1985; i++) {
    y[i] = 0;
    for (j = 0; j < 64; j++)
      Y[i] += c[j] * x[i+63−j];
  }
```

The data dependence graph is the same as above. We apply then node splitting to get a more convenient data dependence graph.

```
for (i = 0; i < 1985; i++) {
  y[i] = 0;
  for (j = 0; j < 64; j++)
    {
      tmp = c[j] * x[i+63−j];
      y[i] += tmp;
    }
  }
```

After scalar expansion:

```
for (i = 0; i < 1985; i++) {
    y[i] = 0;
    for (j = 0; j < 64; j++)
        {
          tmp[j] = c[j] * x[i+63−j];
          y[i] += tmp[j];
        }
    }
```

After loop distribution:

```
for (i = 0; i < 1985; i++) {
    y[i] = 0;
    for (j = 0; j < 64; j++)
        tmp[j] = c[j] * x[i+63−j];
    for (j = 0; j < 64; j++)
          y[i] += tmp[j];
        }
  }
```

We go through the compiling process, and we arrive to the set of optimizations that depends upon architectural parameters. We want to split the iteration space, as too many operations would have to be performed in parallel, if we keep it as such. Hence we perform strip-mining on the 2 loops. We can only access 16 data at a time, so, because of the first loop, the factor will be 64*2/16=8 for the 2 loops (as we always have in mind that we want to execute both at the same time on the PACT XPP).

```
for (i = 0; i < 1985; i++) {
    y[i] = 0;
    for (jj = 0; jj < 8; jj++)
        for (j=0;j < 8; j++)
            tmp[8*jj+j] = c[8*jj+j] * x[i+63−8*jj−j];
    for (jj = 0; jj < 8 ; jj++)
        for (j=0;j < 8; j++)
              y[i] += tmp[8*jj+j];
}
```

And then loop fusion on the jj loops is performed.

```
for (i = 0; i < 1985; i++) {
    y[i] = 0;
    for (jj = 0; jj < 8; jj++) {
        for (j=0;j < 8;j++)
            tmp[8*jj+j] = c[8*jj+j] * x[i+63−8*jj−j];
        for (j=0;j < 8;j++)
            y[i] += tmp[8*jj+j];
    }
}
```

Now we apply reduction recognition on the second innermost loop.

```
for (i = 0; i < 1985; i++) {
  tmp = 0;
  for (jj = 0; jj < 8; jj++)
    {
    for (j = 0; j < 8; j++)
      tmp[8*jj+j] = c[8*jj+j] * x[i+63−8*jj−j];
    /* load the partial sums from memory using a shorter vector length */
      for (j = 0; j < 4; j++)
      aux[j] = tmp[8*jj+2*j] + tmp[8*jj+2*j+1];
    /* accumulate the short vector */
      for (j = 0;j < 1; j++)
      aux[2*j] = aux[2*j] + aux[2*j+1];
    /* sequence of scalar instructions to add up the partial sums */
      y[i] = aux[0] + aux[2];
}
```

And then loop unrolling.

```
for (i = 0; i < 1985; i++)
    for (jj = 0; jj < 8; jj++)
      {
```

tmp[8*jj] = c[8*jj] * x[i+63−8*jj];
tmp[8*jj+1] = c[8*jj+1] * x[i+62−8*jj];
tmp[8*jj+2] = c[8*jj+2] * x[i+61−8*jj];
tmp[8*jj+3] = c[8*jj+3] * x[i+59−8*jj];
tmp[8*jj+4] = c[8*jj+4] * x[i+58−8*jj];
tmp[8*jj+5] = c[8*jj+5] * x[i+57−8*jj];
tmp[8*jj+6] = c[8*jj+6] * x[i+56−8*jj];
tmp[8*jj+7] = c[8*jj+7] * x[i+55−8*jj];
aux[0] = tmp[8*jj] + tmp[8*jj+1];
aux[1] = tmp[8*jj+2] + tmp[8*jj+3];
aux[2] = tmp[8*jj+4] + tmp[8*jj+5];
aux[3] = tmp[8*jj+6] + tmp[8*jj+7];
aux[0] = aux[0] + aux[1];
aux[2] = aux[2] + aux[3];
y[i] = aux[0] + aux[2];

}

We implement the innermost loop on the PACT XPP directly with a counter. The IRAMs are used in FIFO mode, and filled according to the addresses of the arrays in the loop. IRAM0, IRAM2, IRAM4, IRAM6 and IRAM8 contain array c. IRAM1, IRAM3, IRAM5 and IRAM7 contain array x. Array c contains 64 elements, that is each IRAM contains 8 elements. Array x contains 1024 elements, that is 128 elements for each IRAM. Array y is directly written to memory, as it is a global array and its address is constant. This, constant is used to initialize the address counter of the configuration. The final parameter table is the following:

| Parameter | Value |
|---|---|
| Vector length | input: 8, output: 1 |
| Reused data set size | — |
| I/O IRAMs | 16 |
| ALU | 15 |
| BREG | 0 |
| FREG | 0 |
| Dataflow graph width | 8 |
| Dataflow graph height | 4 |
| Configuration cycles | 4 + 8 = 12 |

Nevertheless it should be noted that this version should be less efficient than the previous one. As the same data must be loaded in the different IRAMs from the cache, we have a lot of transfers to achieve before the configuration can begin the computations. This overhead must be taken into account by the compiler when choosing the code generation strategy. As already stated, this means that the first solution is the solution that will be chosen by the compiler.

5.5.4 Final Code

| int x[256], y[256]; | |
|---|---|
| const int c[8] = { 2, 4, 4, 2, 0, 7, −5, 2 }; | |
| main( ) | |
| { | |
| XppPreloadConfig(_{——}XppCfg_fir); | |
| XppPreload(0, x,128); | |
| XppPreload(1, x +128,128); | |
| XppExecute( ); | |
| XppSync(y,249); | |
| } | |
| void _{——}XppCfg_fir( ) { | |
| // Input IRAMs | |
| int iram0_1[128], iram0_2[128]; | |
| // Output IRAMs | |
| int iram1_1[128],iram1_2[128]; | |
| int *piram0_1,*piram1_1; | |
| piram0_1 = &iram0_1[0]; | |
| piram1_1 = &iram1_1[0]; | |
| for (i = 0;i < 249;i++) | |
| { | |
| r0 = r1; | |
| r1 = r2; | |
| r2 = r3; | |
| r3 = r4; | |
| r4 = r5; | |
| r5 = r6; | |
| r6 = r7; | |
| r7 = iram0_1++; | |
| if (i < 128) | |
| piram0_1++ = iram0_2++; | |
| else | |
| if (i == 128) | |
| iram0_1 = &iram0_1[0]; | |
| iram1_1++ = | c7*r0 + c6*r1 + c5*r2 + c4*r3 + c3*r4 + |
| | c2*r5 + c1*r6 + c0*r7; |

```
    if (i < 128)
    iram1_2++ = piram1_1++;
    else
    if (i == 128)
      iram1_1 = &iram1_1[0];
    }
}
```

5.5.5 Performance Evaluation

The table below contains data about loading input data from memory, and writing output data to memory for the FIR example. The cache is supposed to be empty before execution. The write-back of array y causes no cache miss, because it is only an output data.

| | | | | |
|---|---|---|---|---|
| | Size | Cache | RAM-Cache | Cache-IRAM |
| Data | [bytes] | Misses | [cache cycles] | [cache cycles] |

Preloads

| | | | | |
|---|---|---|---|---|
| x | 512 | 16 | 896 | 32 |
| x + 128 | 512 | 16 | 896 | 32 |
| Sum | | | 1792 | 64 |

Writebacks

| | | | | |
|---|---|---|---|---|
| y | 996 | 0 | 1024 | 63 |
| Sum | | | 1024 | 63 |

In the performance evaluation, the XPP performance is compared to a reference system. The performance data of the reference system was calculated by using a production compiler for a dual issue 32 bit fixed point. DSP. As the RAM to Cache transfer penalty is the same for the XPP and reference system, it can be neglected for the comparison. It is assumed that the DSP can perform a load and memory store in one cycle.

The base for the comparison is the hand-written NML source code fir_simple.nml which implements the configuration _XppCfg_fir. The final performance evaluation table below lists the performance data for the configuration. The transfer cycles for the configuration contain preloads and write-backs necessary for executing the configuration in the steady state case, but not in the startup case where only the preloads are accounted for.

The XPP execute cycles are calculated by taking the double cycle difference between the end of the configuration execution and the start of the configuration execution. The NML sources were

| | Data | | | | | | | | | | | |
|---|---|---|---|---|---|---|---|---|---|---|---|---|
| | Access | | Configuration | | XPP Execute | | | Ref. System | | Speedup | | |
| configurations | RAM | DCache | RAM | ICache | Core | Cache | RAM | Cache | RAM | Core | Cache | RAM |
| startup case | 1792 | 64 | 2464 | 348 | 648 | 648 | 4968 | 17963 | 19755 | 27.7 | 27.7 | 4.0 |
| steady state | 2816 | 127 | | | 648 | 648 | 2816 | 17963 | 20779 | 27.7 | 27.7 | 7.4 |

implemented so that configuration loading and configuration execution do not overlap.

The final utilization of the resources is shown in the following table. The information is taken from the ‘.info’ files generated from the NML source code by the XMAP tool. The difference concerning the number of ALUs between this table and the final parameter table presented before resides in the fact that additions can be executed either by ALUs or BREGs. In the former parameter table, the additions were meant to be executed by ALUs, whereas in the NML code, these are mainly performed by BREGs.

| Parameter | Value |
|---|---|
| Vector length | read: 256, write: 249 |
| Reused data set size | — |
| I/O IRAMs [sum-pct] | 4-25% |
| ALU[sum-pct] | 10-16% |
| BREG [def/route/sum-pct] | 15/2/17-21% |
| FREG [def/route/sum-pct] | 16/3/19-24% |

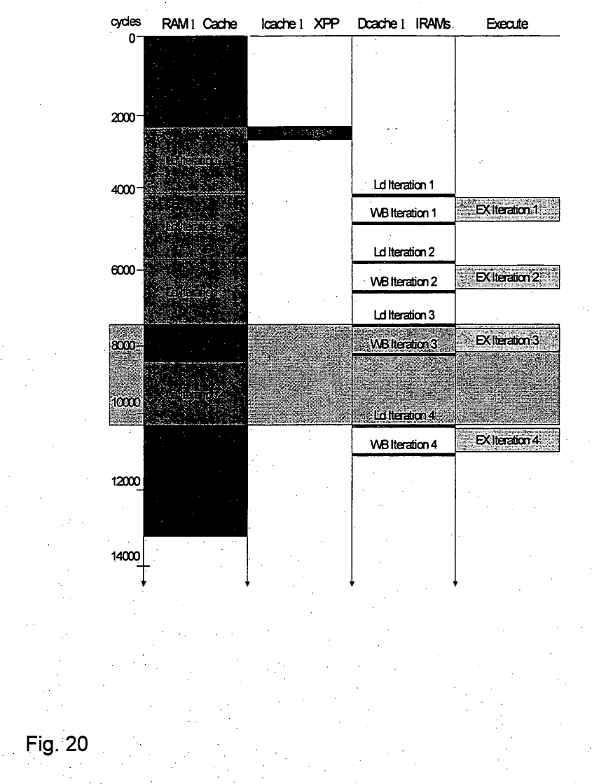

Usually the function computing FIR is called in a loop. In FIG. 20 is sketched how different iterations can overlap. First the configuration itself is loaded, Ld Config, then the data needed for the first iteration, Ld Iteration 1. The configuration is then executed, Ex Iteration 1, and the write-back phase, WB Iteration 1, takes place. The steady state is contained in the orange box. It is the kernel of the loop, and contains phases of four different iterations. After the kernel has been executed (n−3) times, n being the number of iterations of the loop, the remaining phases are executed.

5.5.6 Other Variant

Source Code

```
for (i = 0; i < N−M+1;. i++) {
    tmp = 0;
    for (j = 0; j < M; j++)
      tmp += c[j] * x[i+M−j−1];
    x[i] = tmp;
  }
```

In this case, it is trivial that the data dependence graph is cyclic due to dependences on tmp. Therefore scalar expansion is applied on the loop, and we obtain in fact the same code as the first version of the FIR filter as shown below.

```
for (i = 0; i < N−M+1; i++) {
    tmp[i] = 0;
    for (j = 0; j < M; j++)
      tmp[i] += c[j] * x[i+M−j−1];
    x[i] = tmp[i];
  }
```

5.6 Matrix Multiplication
5.6.1 Original Code

Source Code:

```
#define L 10
#define M 15
#define N 20
int A[L][M];
int B[M][N];
int R[L][N];
main( ) {
  int i, j, k, tmp, aux;
  /* input A (L*M values) */
  for(i=0; i<L; i++)
    for(j=0; j<M; j++)
      scanf(“%d”, &A[i][j]);
  /* input B (M*N values) */
  for(i=0; i<M; i++)
    for(j=0; j<N; j++)
      scanf(“%d”, &B[i][j]);
  /* multiply */
  for(i=0; i<L;i++)
    for(j=0; j<N; j++) {
      aux = 0;
      for(k=0; k<M; k++)
        aux += A[i][k] * B[k][j];
      R[i][j] = aux;
    }
  /* write data stream */
  for(i=0; i<L; i++)
    for(j=0; j<N; j++)
      printf(“%d\n”, R[i][j]);
}
```

5.6.2 Preliminary Transformations

Since no function call is candidate for inlining, no interprocedural code movement is done.

Of the four loop nests the third one is the only candidate for running partly on the XPP. All others have function calls in the loop body and are therefore discarded as candidate very early during the compilation process.

| | |
|---|---|
| S1 | for(i=0; i<L;i++) |
| | for(j=0; j<N; j++) { |
| | aux = 0; |
| S2 | for(k=0; k<M; k++) |
| S3 | aux += A[i][k] * B[k][j]; |
| | R[i][j] = aux; |
| | } |

The data dependence graph shows no dependence that prevents pipeline vectorization. The loop-carried true dependence from S2 to itself can be handled by a feedback of aux as described in [1].

To get a perfect loop nest we move S1 and S3 inside the k-loop. Therefore appropriate guards are generated to protect the assignments. The code after this transformation looks like

```
for(i=0; i<L;i++)
  for(j=0; j<N; j++)
    for(k=0; k<M; k++) {
      if (k == 0) aux = 0;
      aux += A[i][k] * B[k][j];
      if (k == M−1) R[i][j] = aux;
    }
```

Our goal is to interchange the loop nests to improve the array accesses to utilize the cache best. Unfortunately the guarded statements involving aux cause backward loop-carried anti-dependences carried by the j-loop. Scalar expansion will break these dependences, allowing loop interchange.

```
for(i=0; i<L;i++)
  for(j=0; j<N; j++)
    for(k=0; k<M; k++) {
      if (k == 0) aux[j] = 0;
      aux[j] += A[i][k] * B[k][j];
      if (k == M−1) R[i][j] = aux[j];
    }
```

5.6.3 Loop Interchange for Cache Reuse

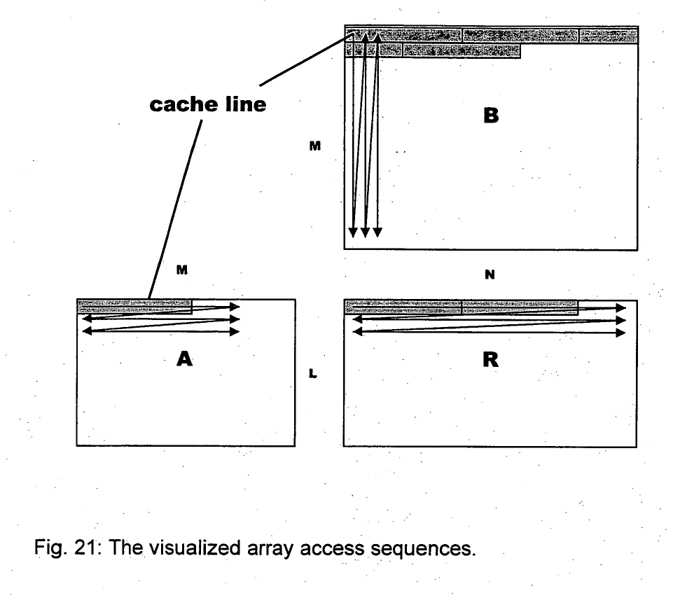

FIG. 21 shows the iteration spaces for the array accesses in the main loop. Since arrays in C are placed in row major order the cache lines are placed in the array rows. At first sight there seems to be no need for optimization because the algorithm requires at least one array access to stride over a column. Nevertheless this assumption, misses the fact that the access rate is of interest, too. Closer examination shows that array R is accessed in every j iteration, while array B is accessed at each iteration of the k-loop, which is very likely to produce a cache miss. This leaves a possibility for loop interchange to improve cache access as proposed by Kennedy and Allen in [7].

Finding the best loop nest is relatively simple. The algorithm simply interchanges each loop of the nest into the innermost position and annotates it with the so-called innermost memory cost term. This cost term is a constant for known loop bounds, or a function of the loop bound for unknown loop bounds. The term is calculated in three steps.
First the cost of each reference¹ in the innermost loop body is calculated. It is equal to:
1, if the reference does not depend on the loop induction variable of the (current) innermost loop
the loop count, if the reference depends on the loop induction variable and strides over a non contiguous area with respect to the cache layout

$$\frac{N \cdot s}{b} ,$$
if the reference depends on the loop induction variable and strides over a contiguous dimension. In this case N is the loop count, s is the step size and b is the cache line size, respectively.
Second each reference cost is weighted with a factor for each other loop, which is
   1, if the reference does not depend on the loop index
   the loop count, if the reference depends on the loop index.
Third the overall loop nest cost is calculated by summing the costs of all reference costs.
   ¹ Reference means access to an array in this case. Since the transformation wants to optimize cache access, it must address references to the same array within small distances as one. This prohibits over-estimation of the actual costs.

After invoking this algorithm for each loop level, the loop levels are ordered with respect to their cost. The one with the lowest cost becomes the innermost loop level, the one with the highest cost becomes the outermost loop level in the loop nest.

| Innermost loop | R[i][j] | A[i][k] | B[k][j] | Memory access cost |
|---|---|---|---|---|
| k | 1 · L · N | $\frac{M}{b} \cdot L$ | M · N | $L \cdot N + \frac{M}{b} \cdot L + M \cdot N$ |
| i | 1 · L · N | 1 · L · M | 1 · M · N | L · N + L · M + |
| | | | | M · N |
| j | $\frac{N}{b} L$ | L · M | $\frac{N}{b} M$ | $\frac{N}{b} ( L + M ) + L \cdot M$ |

The table shows the costs calculated for the loop nest. Since the j term is the smallest (b is 32 bytes or 8 integer words), the j loop is chosen to become the innermost loop level. Then the next outer loop will be the k-loop, and the outermost loop will be the i-loop. Thus the resulting code after loop interchange is:

```
for(i=0; i<L;i++)
  for(k=0; k<M; k++)
    for(j=0; j<N; j++) {
      if (k == 0) aux[j] = 0;
      aux[j] += A[i][k] * B[k][j];
      if (k == M−1)R[i][j] = aux[j];
  }
```

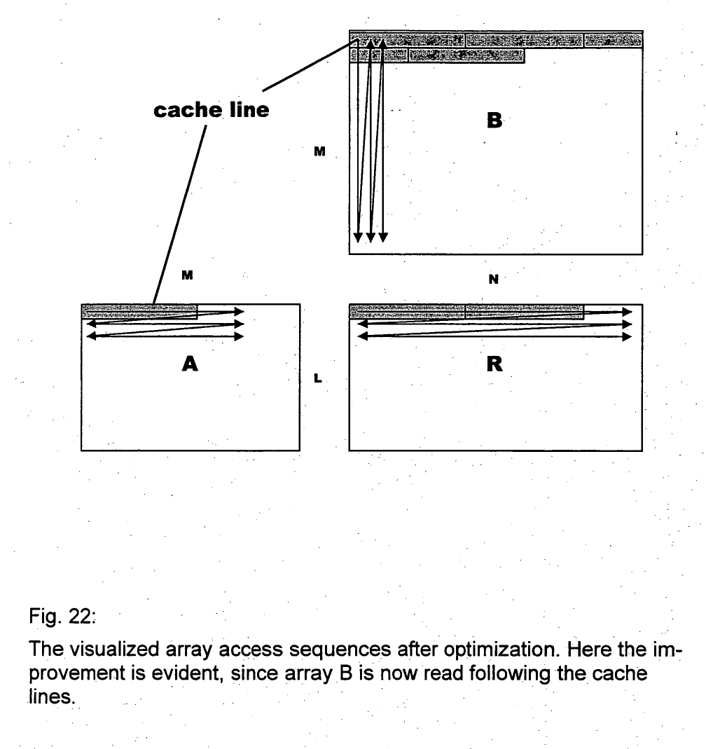

FIG. 22 shows the improved iteration spaces. It is to say that this optimization does not optimize primarily for the XPP, but mainly optimizes the cache-hit rate, thus improving the overall performance.

5.6.4 Enhancing Parallelism

After improving the cache access behavior, the possibility for reduction recognition has been destroyed. This is a typical example for transformations where one excludes the other. Fully unrolling the inner loop is not applicable due to the number of available IRAMs. Therefore we try to unroll-and-jam the two innermost loops.

Unroll-and-Jam

We unroll the outer loop partially with the unrolling degree u. This factor is computed by the minimum of two calculations.
u_{PAM}=IRAMs available/IRAMS needed
u_{PAE}=PAEs available/PAEs needed

In this example the accesses to A and B depend on k (the loop which will be unrolled). Therefore they must be considered in the calculation. The accesses to aux and R do not depend on k. Thus they can be subtracted from the available IRAMs, but do not need to be added to the denominator. Therefore we calculate u_{RAM}=14/2=7.

On the other hand the loop body involves two ALU operations (1 add, 1 mult), which yields
u_{PAE}=64/2=32².

² This is a very inaccurate estimation, since it neither estimates the resources spent by the controlling network, which decreases the unroll factor, nor takes it into account that e.g the BREG-PAEs also have an adder, which increases the unrolling degree. Although it has no influence on this example the unrolling degree calculation of course has to account for this in a production compiler.

The constraint generated by the IRAMs therefore dominates by far as
u=min(7,32)=7.

To keep the complexity of the configuration simple, we choose an unrolling degree

$${u}_{final} = loop count / ⌈ \frac{loop count}{u} ⌉ = 5.$$

The code after this transformation then reads:

```
for(i=0; i<L;i++) {
  for(k=0; k<M; k+= 5) {
    for(j=0; j<N; j++) {
      if (k == 0) aux[j] = 0;
      aux[j] += A[i][k] * B[k][j];
      aux[j] += A[i][k+1] * B[k+1][j];
      aux[j] += A[i][k+2] * B[k+2][j];
      aux[j] += A[i][k+3] * B[k+3][j];
      aux[j] += A[i][k+4] * B[k+4][j];
      if (k == 10) R[i][j] = aux[j];
    }
  }
}
```

5.6.5 Final Code

After allocation of the arrays and scalars to IRAMs the code running on the RISC looks like follows. The array aux storing the intermediate results is normally preloaded, although its value is not used in the first iteration of the k-loop. Nevertheless it must be preloaded by the other iterations, therefore we must issue an XppPreload, not an XppPreloadClean.

```
XppPreloadConfig(_{——}XppCfg_matmult);
for(i=0; i<L;i++) {
  XppPreload(12, &aux, N);
  XppPreload(0, &A[i][0], M);
  XppPreload(1, &A[i][0], M);
  XppPreload(2, &A[i][0], M);
  XppPreload(3, &A[i][0], M);
  XppPreload(4, &A[i][0], M);
  XppPreloadClean(11, &R[i][0], N);
  for(k=0; k<M; k+= 5) {
    XppPreload(5, &k, 1);
    XppPreload(6, &B[k][0], N);
    XppPreload(7, &B[k+1][0], N);
    XppPreload(8, &B[k+2][0], N);
    XppPreload(9, &B[k+3][0], N);
    XppPreload(10, &B[k+4][0], N);
    XppExecute( );
  }
}
```

The configuration is shown below.

```
void _{——}XppCfg_matmult( )
{
  // IRAMs
  // A[i][k]
  int iram0[128], iram1[128], iram2[128], iram3[128], iram4[128];
  // k
  int iram5[128];
  // B[k][j] .. B[k+4][j]
  int iram6[128], iram7[128], iram8[128], iram9[128], iram10[128];
  // R[i][j], aux[j]
  int iram11[128], iram12[128],
  for(j=0; j<N; j++) {
    tmp1 = iram0[iram5[0]] * iram6[j];
    tmp2 = iram1[iram5[0]+1] * iram7[j];
    tmp3 = iram2[iram5[0]+2] * iram8[j];
    tmp4 = iram3[iram5[0]+3] * iram9[j];
    tmp5 = iram4[iram5[0]+4] * iram10[j];
    if (iram5[0] == 0)
      tmp6 = tmp1 + tmp2 +tmp3 +tmp4 +tmp5;
    else
      tmp6 += iram12[j] + tmp1 + tmp2 +tmp3 +tmp4 +tmp5;
    iram12[j] = tmp6;
    if (iram5[0] == 10)
      iram11[j] = tmp6;
  }
}
```

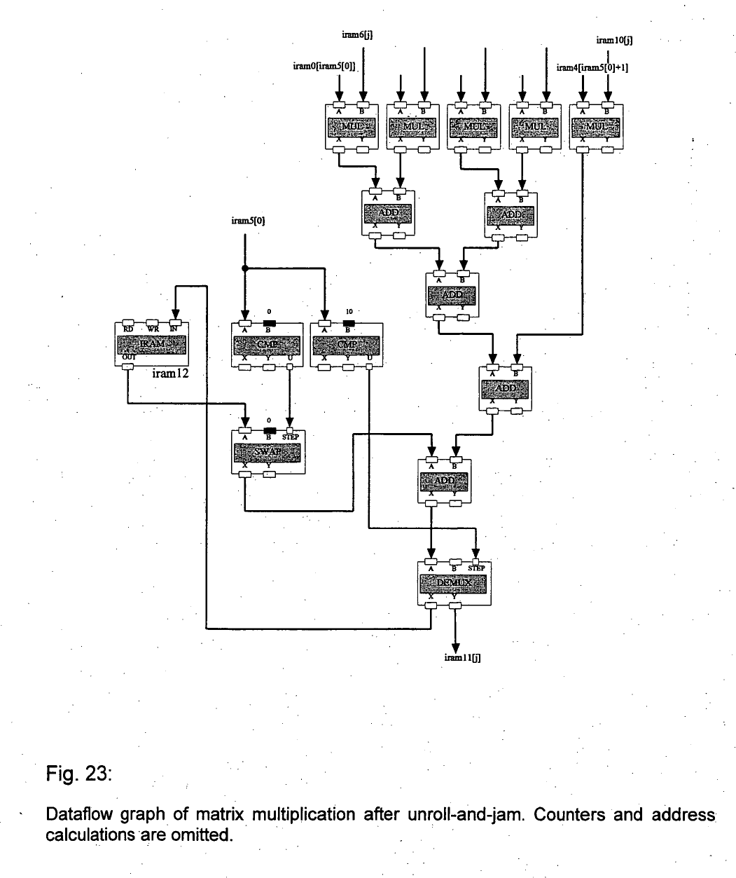

The estimated statistics are shown in the table below. Unfortunately the IRAM usage prevents a better utilization. FIG. 23 shows the dataflow graph of the configuration.

| Parameter | Value |
|---|---|
| Vector length | 20 |
| Reused data set size | — |
| I/O IRAMs | 11 I + 1 O + 1 I/O = 13 |
| ALU | 10 |
| BREG | few |
| FREG | few |
| Dataflow graph width | 14 |
| Dataflow graph height | 6 |
| Configuration cycles | 6 + 20 = 26 |

5.6.6 Performance Evaluation

The next table lists the estimated performance of data transfers.

| | | | | | |
|---|---|---|---|---|---|
| | | | | IRAM | |
| | Size | Cache | RAM to Cache | [cache | |
| Data | [bytes] | Misses | [cache cycles] | cycles] | Factor |

Preloads/i loop

| | | | | | |
|---|---|---|---|---|---|
| A[i][0] | 60 | 2 | 112 | 4 | |
| A[i][0] | 60 | | 0 | 4 | |
| A[i][0] | 60 | | 0 | 4 | |
| A[i][0] | 60 | | 0 | 4 | |
| A[i][0] | 60 | | 0 | 4 | |
| Sum | | | 112 | 20 | 10 |
| aux, stays | 80 | 3 | 168 | 5 | 1 |
| in cache | | | | | |

Preloads/j loop

| | | | | | |
|---|---|---|---|---|---|
| B[k][0] | 80 | 3 | 168 | 5 | |
| B[k + 1][0] | 80 | 3 | 168 | 5 | |
| B[k + 2][0] | 80 | 3 | 168 | 5 | |
| B[k + 2][0] | 80 | 3 | 168 | 5 | |
| B[k + 4][0] | 80 | 3 | 168 | 5 | |
| aux, stays | 80 | | | 5 | |
| in cache | | | | | |
| Sum | | | 840 | 30 | 330 |

Writebacks

| | | | | |
|---|---|---|---|---|
| aux, stays | 80 | | 5 | 30 |
| in cache | | | | |
| R, written | 80 | 96 | 5 | 10 |
| back in i loop | | | | |

For the comparison with the reference system, we assume that first the configuration, the first five A[i][0] values and aux are preloaded, row startup i-loop. In the nine subsequent iterations of the i-loop, only five A[i][0] are preloaded, row steady i-loop. All loads of A[i][0] cause one cache miss and four hits.

Furthermore we assume that all values of B are loaded into the cache during execution of the first iteration of the i-loop. They stay there during the other iterations. Thus cache read misses due to accesses to B are only taken into account three times, row j-loop i==0. All subsequent 27*5 accesses to B cause only cache-IRAM transfers, row j-loop i!=0. We assume that aux stays in its IRAM or is only written back in the cache during the whole execution. While the first assumption assumes that no task switch occurs during calculation of the whole matrix—a fact that we cannot guarantee—the second one is can safely be assumed. Due to the dominance of the execution cycles neither has an impact on the total performance.

The last but one row, row WB R, shows the write-backs of the result matrix R, which occur ten times and are also added to the other terms.

The hand coded configuration cycles are measured to 55 XPP cycles, or 110 cache cycles.

| | Data Access | | Configuration | | XPP Execute | | | Ref. System | | Speedup | | |
|---|---|---|---|---|---|---|---|---|---|---|---|---|
| configurations | RAM | DCache | RAM | ICache | Core | Cache | RAM | Cache | RAM | Core | Cache | RAM |
| startup i-loop | 280 | 25 | 1232 | 687 | | 687 | 1512 | | | | | |
| steady i-loop | 112 | 25 | | | | 25 | 112 | | | | | |
| j-loop i==0 | 840 | 30 | | | 110 | 110 | 840 | | | | | |
| j-loop i!=0 | | 35 | | | 110 | 110 | 110 | | | | | |
| WB R | 96 | 5 | | | | 5 | 96 | | | | | |
| sum | 4768 | | | | 3300 | 4262 | 8970 | 26279 | 31047 | 8.0 | 6.2 | 3.5 |

The final utilization is shown in the next table.

| Parameter | Value |
|---|---|
| Vector length | 20 |
| Reused data set size | — |
| I/O IRAMs [sum-pct] | 13-82% |
| ALU[sum-pct] | 13-20% |
| BREG [def/route/sum-pct] | 10/27/37-46% |
| FREG [def/route/sum-pct] | 17/9/28-35% |

5.7 Viterbi Encoder
5.7.1 Original Code

Source Code:

```
/* C-language butterfly */
#define BFLY(i) {\
unsigned char metric,m0,m1,decision;\
    metric = ((Branchtab29_1[i] \hat{ } sym1) +
            (Branchtab29_2[i] \hat{ } sym2) + 1)/2;\
    m0 = vp->old_metrics[i] + metric;\
    m1 = vp->old_metrics[i+128] + (15 − metric);\
    decision = (m0−m1) >= 0;\
    vp->new_metrics[2*i] = decision ? m1 : m0;\
    vp->dp->w[i/16] |= decision << ((2*i)&31);\
    m0 −= (metric+metric−15);\
    m1 += (metric+metric−15);\
    decision = (m0−m1) >= 0;\
    vp->new_metrics[2*i+1] = decision ? m1 : m0;\
    vp->dp->w[i/16] |= decision << ((2*i+1)&31);\
}
int update_viterbi29(void *p,unsigned char sym1,unsigned char sym2){
  int i;
  struct v29 *vp = p;
  unsigned char *tmp;
  int normalize = 0;
  for(i=0;i<8;i++)
    vp->dp->w[i] = 0;
  for(i=0;i<128;i++)
    BFLY(i);
  /* Renormalize metrics */
  if(vp->new_metrics[0] > 150){
    int i;
    unsigned char minmetric = 255;
    for(i=0;i<64;i++)
      if(vp->new_metrics[i] < minmetric)
      minmetric = vp->new_metrics[i];
    for(i=0;i<64;i++)
      vp->new_metrics[i] −= minmetric;
    normalize = minmetric;
  }
  vp->dp++;
  tmp = vp->old_metrics;
  vp->old_metrics = vp->new_metrics;
  vp->new_metrics = tmp;
  return normalize;
}
```

5.7.2 Interprocedural Optimizations and Scalar Transformations

Since no function call is candidate for inlining, no interprocedural code movement is done.

After expression simplification, strength reduction, SSA renaming, copy coalescing and idiom recognition, the code looks like below, where statements were reordered for convenience. Note that idiom recognition will find the combination of min( ) and use of the comparison result for decision and _decision. However the resulting computation cannot be expressed in C, so we describe it as a comment:

```
int update_viterbi29(void *p,unsigned char syml, unsigned char sym2){
  int i;
  struct v29 *vp = p;
  unsigned char *tmp;
  int normalize = 0;
  char *_vpdpw_= vp->dp->w;
  for(i=0;i<8;i++)
    *_vpdpw_++ = 0;
  char *_bt29_1= Branchtab29_1;
  char *_bt29_2= Branchtab29_2;
  char *_vpom0= vp->old_metrics;
  char *_vpom128= vp->old_metrics+128;
  char *_vpnm= vp->new_metrics;
  char *_vpdpw= vp->dp->w;
  for(i=0;i<128;i++) {
    unsigned char metric,_tmp, m0,m1,_m0,_m1, decision,_decision;
    metric = ((*_bt29_1++ \hat{ } sym1) +
          (*_bt29_2++ \hat{ } sym2) + 1)/2;
    _tmp= (metric+metric−15);
    m0 = *_vpom++ + metric;
    m1 = *_vpom128++ + (15 − metric);
    _m0 = m0 − _tmp;
    _m1 = m1 + _tmp;
    // decision = m0 >= m1;
    // _decision = _m0 >= _m1;
```

| | |
|---|---|
| *_vpnm++ = min(m0,m1); | // = decision ? m1 : m0 |
| *_vpnm++ = min(_m0,_m1); | // = _decision ? _m1 : _m0 |
| _vpdpw[i >> 4] \|= ( m0 >= m1) | /* decision*/ << ((2*i) & 31) |
| \| (_m0 >= _m1) | /*_decision*/ << ((2*i+1)&31); |

```
  }
  /* Renormalize metrics */
  if(vp->new_metrics[0] > 150){
    int i;
    unsigned char minmetric = 255;
    char *_vpnm= vp->new_metrics;
    for(i=0;i<64;i++)
      minmetric = min(minmetric, *vpnm++);
    char *_vpnm= vp->new_metrics;
    for(i=0;i<64;i++)
      *vpnm++ −= minmetric;
    normalize = minmetric;
  }
  vp->dp++;
  tmp = vp->old_metrics;
  vp->old_metrics = vp->new_metrics;
  vp->new_metrics = tmp;
  return normalize;
}
```

5.7.3 Initialization and Butterfly Loop

The first and second loop, in which the BFLY( ) macro has been expanded, are of interest for being executed on the XPP array, and need further examination. Below is the configuration source code of the first two loops:

/** _XppCfg_viterbi29( )
* Performs viterbi butterfly loop

| | |
|---|---|
| * XPPIN: | iram0,2 contains Branchtab29_1 and Branchtab29_2, |
| | respectively |
| * | iram4,5 contains old_metrics and old_metrics+128, |
| | respectively |
| * | iram1,3 contains scalars sym1 and sym2, respectively |
| * XPPOUT: | iram6 contains the new metrics array |
| * | iram7 contains the decision array |
| */ | |

```
void _XppCfg_viterbi29( )
{
  // IRAMs in FIFO mode
  //
  char *iram0; // Branchtab29_1, read access with 32-to-8-bit converter
  char *iram2; // Branchtab29_2, read access with 32-to-8-bit converter
  char *iram4; // vp->old_metrics, read access with 32-to-8-bit converter
  char *iram5; // vp->old_metrics+128, read access with 32-to-8-bit
converter
  short *iram6; // vp->new_metrics, write access with 16-to-32-bit
converter
  // IRAMs in RAM mode
  //
  int iram1[128]; // sym1, read access
  int iram3[128]; // sym2, read access
  int iram7[128]; // vp->dp->w, write access
  int i;
  unsigned char sym1, sym2;
  sym1 = iram1[0];
  sym2 = iram3[0];
  for(i=0;i<8;i++)
    iram7[i] = 0;
  for(i=0;i<128;i++) {
    unsigned char metric,_tmp, m0,m1,_m0,_m1;
    metric = ((*iram0++ \hat{ } sym1) +
          (*iram2++ \hat{ } sym2) + 1)/2;
    _tmp= (metric << 1) −15;
    m0 = *iram4++ + metric;
    m1 = *iram5++ + (15 − metric);
    _m0 = m0 − _tmp;
    _m1 = m1 + _tmp;
    // assuming big endian; little endian has the shift on the latter min( )
    *iram6++ = (min(m0,m1) << 8) | min(_m0,_m1);
    iram7[i >> 4] |= ( m0 >= m1) << ((2*i) & 31)
          | (_m0 >= _m1) << ((2*i+1)&31);
  }
}
```

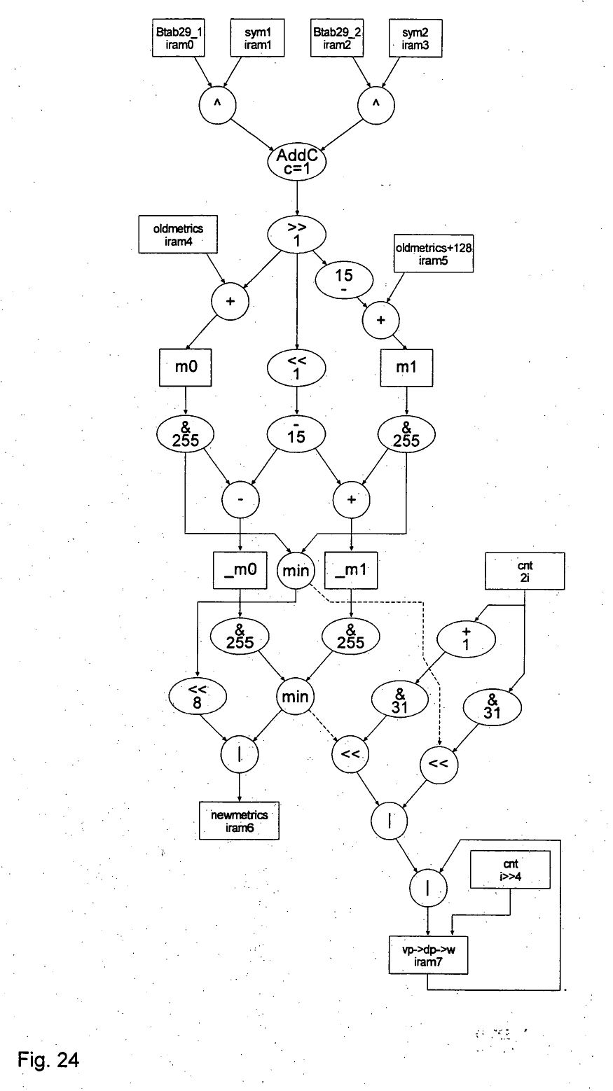

The dataflow graph is shown in FIG. 24 (the 32-to-8-bit converters are not shown). The solid lines represent flow of data, while the dashed lines represent flow of events.

The recurrence on the IRAM7 access needs at least 2 cycles, i.e. 2 cycles are needed for each input value. Therefore a total of 256 cycles are needed for a vector length of 128.

| Parameter | Value |
|---|---|
| Vector length | read: 32(=128 chars), write: 64(=256 |
| | chars) |
| Reused data set size | — |
| I/O IRAMs | 6I + 2O |
| ALU | 26 |
| BREG | few |
| FREG | few |
| Dataflow graph width | 4 |
| Dataflow graph height | 12 + 4 (32-to-8-bit converters) |
| Configuration cycles | 16 + 256 |

A problem is then obvious: IRAM7 is fully busy reading and rewriting the same address 16 times. Loop tiling with a tile size of 16 gives redundant load/store elimination a chance to read the value once, and accumulate the bits in a temporary variable, writing the value to the IRAM at the end of this inner loop. Loop fusion with the initialization loop allows then propagation of the zero values set in the first loop, to the reads of vp->dp->w[i] (IRAM7), eliminating the first loop altogether. Loop tiling with a tile size of 16 also eliminates the & 31 expressions for the shift values: Since the new inner loop only runs from 0 to 16, value range analysis can compute that the & 31 expression is not limiting the value range anymore.

All remaining input IRAMs are character (8-bit) based. Therefore 32-to-8-bit are converters are needed to split the 32-bit stream into an 8-bit stream. Unrolling is limited to unrolling twice due to ALU availability as well as due to the fact, that IRAM6 is already 16-bit based: unrolling once requires a shift by 16 and an or to write 32 bits ever cycle; unrolling further cannot increase pipeline throughput anymore. Hence the body is only unrolled once, eliminating one layer of merges. This yields two separate pipelines, each handling two 8-bit slices of the 32-bit value from the IRAM, serialized by merges.

The resulting configuration source code is listed below, where unrolling has been omitted for the sake of simplicity:

/** _XppCfg_viterbi29( )
* Performs viterbi butterfly loop

| | |
|---|---|
| * XPPIN: | iram0,2 contains Branchtab29_1 and Branchtab29_2, |
| | respectively |
| * | iram4,5 contains old_metrics and old_metrics+128, |
| | respectively |
| * | iram1,3 contains scalars sym1 and sym2, respectively |
| * XPPOUT: | iram6 contains the new metrics array |
| * | iram7 contains the decision array |
| */ | |

```
void _XppCfg_viterbi29( )
{
  // IRAMs in FIFO mode
  //
  char *iram0; // Branchtab29_1, read access with 32-to-8-bit converter
  char *iram2; // Branchtab29_2, read access with 32-to-8-bit converter
  char *iram4; // vp->old_metrics, read access with 32-to-8-bit
converter
  char *iram5; // vp->old_metrics+128, read access with 32-to-8-bit
converter
  short *iram6; // vp->new_metrics, write access with 16-to-32-bit
converter
  unsigned long *iram7; // vp->dp->w, write access
  // IRAMs in RAM mode
  //
  int iram1[128]; // sym1, read access
  int iram3[128]; // sym2, read access
  int i, i2;
  int rlse;
  unsigned char sym1, sym2;
  sym1 = iram1[0];
  sym2 = iram3[0];
  for(i=0;i<8;i++) {
    rlse= 0;
    for(i2=0;i2<32;i2+=2) { // unrolled once
      unsigned char metric,_tmp, m0,m1,_m0,_m1;
      metric = ((*iram0++ \hat{ } sym1) +
          (*iram2++ \hat{ } sym2) + 1)/2;
      _tmp= (metric << 1) −15;
      m0 = *iram4++ + metric;
      m1 = *iram5++ + (15 − metric);
      _m0 = m0 − _tmp;
      _m1 = m1 + _tmp;
      *iram6++ = (min(m0,m1) << 8) | min(_m0,_m1);
      rlse = rlse | ( m0 >= m1) << i2
              | (_m0 >= _m1) << (i2+1);
    }
    *iram7++ = rlse;
  }
}
```

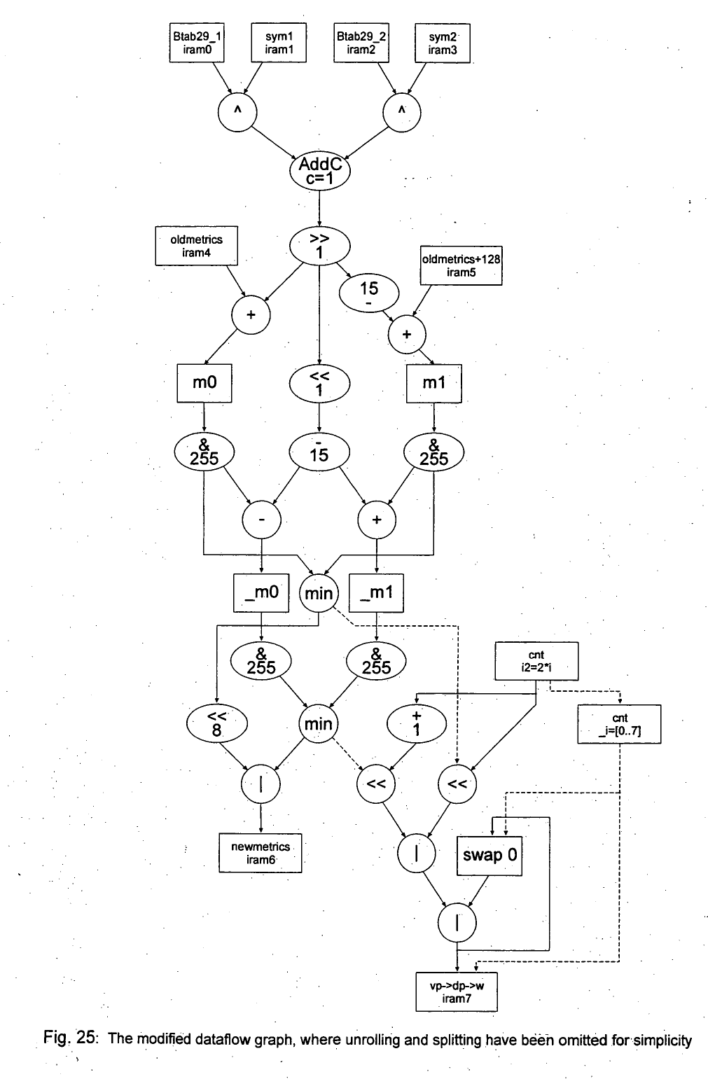

FIG. 25 shows the modified data flow graph (unrolling and splitting have been omitted for simplicity).

Again, the recurrence with the rlse scalar needs two cycles. With an unrolling factor of two, 128 cycles are needed for a vector length of 128.

| Parameter | Value |
|---|---|
| Vector length | 32 (read)/64 (write) |
| Reused data set size | — |
| I/O IRAMs | 6I + 2O |
| ALU | 2 * 26 + 2 (join) = 62 |
| BREG | few |
| FREG | few |
| Dataflow graph width | 4 |
| Dataflow graph height | 12 + 4 (32-to-8-bit converters) = 16 |
| Configuration cycles | 16 + 128 |

5.7.4 Re-Normalization:

Normalization consists of a loop scanning the input for the minimum and a second loop that subtracts the minimum from all elements. There is a data dependence between all iterations of the first loop and all iterations of the second loop. Therefore the two loops cannot be merged or pipelined. They will be handled individually.

Minimum Search

The third loop is a minimum search in an array of bytes. The first version of the configuration source code is listed below:

```
/** _XppCfg_calcmin( )
* Performs a minimum search over a character array
* XPPIN: iram6 contains the character input array
* XPPOUT: iram0 contains the minimum value
*/
void _XppCfg_calcmin( )
{
  // IRAMs in FIFO mode
  //
  unsigned char *iram6; // vp->new_metrics, read access with 32-to-8-bit
converter
  // IRAMs in RAM mode
  //
  int iram0[128]; // minmetric, write access
  int i;
  unsigned char minmetric = 255;
  for(i=0;i<64;i++) {
    minmetric = min(minmetric, *iram6++);
  }
  iram0[0] = minmetric;
}
```

As there is a recurrence with minmetric which needs two cycles, a total of 128 cycles are needed for a vector length of 64.

| Parameter | Value |
|---|---|
| Vector length | 16 (= 64 chars) |
| Reused data set size | — |
| I/O IRAMs | 1 + 1 |
| ALU | 2 |
| BREG | 2 |
| FREG | 3 |
| Dataflow graph width | 1 |
| Dataflow graph height | 1 + 4 (32-to-8-bit converter) |
| Configuration cycles | 5 + 128 |

Reduction recognition eliminates the dependence on minmetric enabling loop unrolling with an unrolling factor of 4 to utilize the IRAM width of 32 bits. A split network has to be added to separate the 8-bit streams using 3 SHIFT and 3 AND operations. Tree balancing redistributes the min( ) operations to minimize the tree height.

```
/** _XppCfg_calcmin( )
* Performs a minimum search over a character array
* XPPIN: iram6 contains the character input array
* XPPOUT: iram0 contains the minimum value
*/
void _XppCfg_calcmin( )
{
  // IRAMs in FIFO mode
  //
  int *iram6; // vp->new_metrics, read access
  // IRAMs in RAM mode
  //
  int iram0[128]; // minmetric, write access
  int i;
  unsigned char minmetric = 255;
  for(i=0;i<16;i++) {
    unsigned long val;
    val = *iram6++;
    minmetric = min(minmetric , min( min(val & 0xff,
          (val >> 8) & 0xff),
          min((val >> 16) & 0xff, val >> 24) ));
  }
  iram0[0] = (long)minmetric;
}
```

| Parameter | Value |
|---|---|
| Vector length | 16 |
| Reused data set size | — |
| I/O IRAMs | 1I + 1O |
| ALU | 8 |
| BREG | 5 |
| FREG | 3 |
| Dataflow graph width | 4 |
| Dataflow graph height | 5 |
| Configuration cycles | 5 + 32 |

The recurrence of two cycles makes it profitable to double the loop body. Reduction recognition again eliminates the loop-carried dependence on minmetric, enabling loop tiling and then unroll-and-jam to increase parallelism. Constant propagation and tree rebalancing reduce the dependence height of the final merging expression. The final configuration source code is listed below:

```
/** _XppCfg_calcmin( )
* Performs a minimum search over a character array
* XPPIN: iram6 contains the character input array
* XPPOUT: iram0 contains the minimum value
*/
void _XppCfg_calcmin( )
{
  // IRAMs in FIFO mode
  //
  int *iram6; // vp->new_metrics, read access
  // IRAMs in RAM mode
  //
  int iram0[128]; // minmetric, write access
  int i;
  unsigned char minmetric0 = 255, minmetric1 = 255;
  for(i=0;i<8;i++) {
    unsigned long val;
    val = *iram6++;
    minmetric0 = min(minmetric0 , min( min(val & 0xff,
                        (val >> 8) & 0xff),
                        min((val >> 16) & 0xff, val >> 24) ));
    val = *iram6++;
    minmetric1 = min(minmetric0 , min( min(val & 0xff,
                        (val >> 8) & 0xff),
                        min((val >> 16) & 0xff, val >> 24) ));
  }
  iram0[0] = (long)min(minmetric0, minmetric1);
}
```

| Parameter | Value |
|---|---|
| Vector length | 16 |
| Reused data set size | — |
| I/O IRAMs | 1I + 1O |
| ALU | 16 |
| BREG | 10 |
| FREG | 0 |
| Dataflow graph width | 2 * 4 = 8 |
| Dataflow graph height | 5 |
| Configuration cycles | 5 + 16 |

Re-Normalization

The fourth loop subtracts the minimum of the third loop from each element in the array. The read-modify-write operation has to be broken up into two IRAMs. Otherwise the IRAM ports will limit throughput.

/** _XppCfg_subtract( )
* Subtracts a scalar from a character array

| | |
|---|---|
| * XPPIN: | iram6 contains the character input array |
| * | iram0 contains the scalar which is subtracted |
| * XPPOUT: | iram1 contains the result array |
| */ | |

```
void _XppCfg_subtract( )
{
  // IRAMs in FIFO mode
  //
  unsigned char *iram6; // vp->new_metrics, read access with 32-to-8-bit
converter
  unsigned char *iram1; // vp->new_metrics, write access with
8-to-32-bit converter
  // IRAMs in RAM mode
  //
  int iram0[128]; // minmetric, read access
  int i;
  unsigned char minmetric = iram0[0];
  for(i=0;i<16;i++) {
    iram1++ = *iram6++ − minmetric;
  }
}
```

| Parameter | Value |
|---|---|
| Vector length | 16 (= 64 chars) |
| Reused data set size | — |
| I/O IRAMs | 2I + 1O |
| ALU | 1 + 2 (converters) |
| BREG | 2 (converters) |
| FREG | 2 (converters) |
| Dataflow graph width | 1 |
| Dataflow graph height | 1 + 8 (converters) |
| Configuration cycles | 9 + 64 |

There is no loop-carried dependence. Since the size of the data is 8 bits, the inner loop can be unrolled four times without exceeding the IRAM bandwidth requirements. Networks splitting, the 32-bit stream into 4 8-bit streams, and re-joining the individual results to a common 32-bit result stream, are inserted. The final configuration source code is listed below:

/** _XppCfg_subtract( )
* Subtracts a scalar from a character array

| | |
|---|---|
| * XPPIN: | iram6 contains the character input array |
| * | iram0 contains the scalar which is subtracted |
| * XPPOUT: | iram1 contains the result array |
| */ | |

```
void _XppCfg_subtract( )
{
  // IRAMs in FIFO mode
  //
  int *iram6; // vp->new_metrics, read access
  int *iram1; // vp->new_metrics, write access
  // IRAMs in RAM mode
  //
  int iram0[128]; // minmetric, read access
  int i;
  unsigned char minmetric = iram0[0];
  for(i=0;i<16;i++) {
    unsigned long val;
    unsigned char r0, r1, r2, r3;
    val = *iram6++;
    r0 = (val & 0xff) − minmetric;
    r1 = ((val >> 8) & 0xff) − minmetric;
    r2 = ((val >> 16) & 0xff) − minmetric;
    r3 = (val >> 24) − minmetric;
    *iram1++ = (r3 << 24) | (r2 << 16) | (r1 << 8) | r0;
  }
}
```

| Parameter | Value |
|---|---|
| Vector length | 16 |
| Reused data set size | — |
| I/O IRAMs | 2I + 1O |
| ALU | 11 |
| BREG | 6 |
| FREG | 0 |
| Dataflow graph width | 4 |
| Dataflow graph height | 5 |
| Configuration cycles | 5 + 16 = 21 |

5.7.5 Final Code

The code executed on the RISC is listed below. It starts the configurations:

```
int update_viterbi29(void *p,unsigned char sym1,unsigned char sym2)
{
  struct v29 *vp = p;
  unsigned char *tmp;
  int normalize = 0;
  long _sym1 = sym1;
  long _sym2 = sym2;
  XppPreloadConfig(_XppCfg_viterbi29);
  XppPreload(0, Branchtab29_1, 32);
  XppPreload(2, Branchtab29_2, 32);
  XppPreload(4, vp->old_metrics, 32);
  XppPreload(5, vp->old_metrics + 128, 32);
  XppPreload(1, &_sym1, 1);
  XppPreload(3, &_sym2, 1);
  XppPreloadClean(6, vp->new_metrics, 64);
  XppPreloadClean(7, vp->dp->w, 8);
  XppExecute( );
  /* Renormalize metrics */
  if(vp->new_metrics[0] > 150){
    long minmetric;
    XppPreloadConfig (_XppCfg_calcmin);
    XppPreloadClean(0, &minmetric, 1);
    XppExecute( );
    XppPreloadConfig(_XppCfg_subtract);
    XppPreloadClean(5, vp->new_metrics, 16);
    XppExecute( );
    XppSync(&minmetric, 1);
    normalize = minmetric;
  }
  XppSync(vp->new_metrics, 64);
  vp->dp++;
  tmp = vp->old_metrics;
  vp->old_metrics = vp->new_metrics;
  vp->new_metrics = tmp;
  return normalize;
}
```

The three configurations are shown in the following:

/** _XppCfg_viterbi29( )
* Performs viterbi butterfly loop

| | |
|---|---|
| * XPPIN: | iram0,2 contains Branchtab29_1 and Branchtab29_2, |
| | respectively |
| * | iram4,5 contains old_metrics and old_metrics+128, |
| | respectively |
| * | iram1,3 contains scalars sym1 and sym2, respectively |
| * XPPOUT: | iram6 contains the new metrics array |
| * | iram7 contains the decision array |
| */ | |

```
void _XppCfg_viterbi29( )
{
  // IRAMs in FIFO mode
  //
  char *iram0; // Branchtab29_1, read access with 32-to-8-bit converter
  char *iram2; // Branchtab29_2, read access with 32-to-8-bit converter
  char *iram4; // vp->old_metrics, read access with 32-to-8-bit converter
  char *iram5; // vp->old_metrics+128, read access with 32-to-8-bit
converter
  short *iram6; // vp->new_metrics, write access with 16-to-32-bit
converter
  unsigned long *iram7; // vp->dp->w, write access
  // IRAMs in RAM mode
  //
  int iram1[128]; // sym1, read access
  int iram3[128]; // sym2, read access
  int i, i2;
  int rlse;
  unsigned char sym1, sym2;
  sym1 = iram1[0];
  sym2 = iram3[0];
  for(i=0;i<8;i++) {
    rlse= 0;
    for(i2=0;i2<32;i2+=2) { // unrolled once
      unsigned char metric,_tmp, m0,m1,_m0,_m1;
      metric = ((*iram0++ \hat{ } sym1) +
      (*iram2++ \hat{ } sym2) + 1)/2;
      _tmp= (metric << 1) −15;
      m0 = *iram4++ + metric;
      m1 = *iram5++ + (15 − metric);
      _m0 = m0 − _tmp;
      _m1 = m1 + _tmp;
      *iram6++ = (min(m0,m1) << 8) | min(_m0,_m1);
      rlse = rlse | ( m0 >= m1) << i2
        | (_m0 >= _m1) << (i2+1);
    }
    *iram7++ = rlse;
  }
}
/** _XppCfg_calcmin( )
* Performs a minimum search over a character array
* XPPIN:  iram6 contains the character input array
* XPPOUT: iram0 contains the minimum value
*/
void _XppCfg_calcmin( )
{
  // IRAMs in FIFO mode
  //
  int *iram6; // vp->new_metrics, read access
  // IRAMs in RAM mode
  //
  int iram0[128]; // minmetric, write access
  int i;
  unsigned char minmetric0 = 255, minmetric1 = 255;
  for(i=0;i<16;i++) {
    unsigned long val;
    val = *iram6++;
    minmetric0 = min(minmetric0 , min( min(val & 0xff,
                      (val >> 8) & 0xff),
                      min((val >> 16) & 0xff, val >> 24) ));
    val = *iram6++;
    minmetric1 = min(minmetric0 , min( min(val & 0xff,
                      (val >> 8) & 0xff),
                      min((val >> 16) & 0xff, val >> 24) ));
  }
  iram0[0] = (long)min(minmetric0, minmetric1);
}
/** _XppCfg_subtract( )
* Subtracts a scalar from a character array
```

| | |
|---|---|
| * XPPIN: | iram6 contains the character input array |
| * | iram0 contains the scalar which is subtracted |
| * XPPOUT: | iram1 contains the result array |
| */ | |

```
void _XppCfg_subtract( )
{
  // IRAMs in FIFO mode
  //
  int *iram6; // vp->new_metrics, read access
  int *iram1; // vp->new_metrics, write access
  // IRAMs in RAM mode
  //
  int iram0[128]; // minmetric, read access
  int i;
  unsigned char minmetric = iram0[0];
  for(i=0;i<16;i++) {
    unsigned long val;
    unsigned char r0, r1, r2, r3;
    val = *iram6++;
    r0 = (val & 0xff) − minmetric;
    r1 = ((val >> 8) & 0xff) − minmetric;
    r2 = ((val >> 16) & 0xff) − minmetric;
    r3 = (val >> 24) − minmetric;
    *iram1++ = (r3 << 24) | (r2 << 16) | (r1 << 8) | r0;
  }
}
```

5.7.6 Performance Evaluation

The data transfer performance is listed for each data object in the following table. It is assumed that there is no data in the cache before executing the update_viterbi29 function. In addition it is assumed that the if condition in the source code is true, i.e. new_metrics[0]>150.

| | | | | | | |
|---|---|---|---|---|---|---|
| | | Type size | Size | Cache | RAM - Cache | Cache - IRAM |
| Data | Data Size | [bytes] | [bytes] | Misses | [cache cycles] | [cache cycles] |

Preloads

| | | | | | | |
|---|---|---|---|---|---|---|
| Branchtab29_1 | 128 | 1 | 128 | 4 | 224 | 8 |
| Branchtab29_2 | 128 | 1 | 128 | 4 | 224 | 8 |
| vp->old_metrics | 128 | 1 | 128 | 4 | 224 | 8 |
| vp->old_metrics + 128 | 128 | 1 | 128 | 4 | 224 | 8 |
| vp->new_metrics | 256 | 1 | 256 | 8 | 448 | 16 |
| sym1 | 1 | 4 | 4 | 1 | 56 | 1 |
| sym2 | 1 | 4 | 4 | 1 | 56 | 1 |
| minmetric | 1 | 4 | 4 | 1 | 56 | 1 |

Writebacks

| | | | | | | |
|---|---|---|---|---|---|---|
| vp->dp->w | 8 | 4 | 32 | 1 | 88 | 2 |
| vp->new_metrics | 256 | 1 | 256 | | 256 | 16 |
| minmetric | 1 | 4 | 4 | 1 | 88 | 1 |

The write-back of the elements of new_metrics causes no cache miss, because the cache line was already loaded by the preload operation of old_metrics. Therefore the write-back does not include cycles for write allocation.

The base for the comparison are the hand-written NML source codes vit.nml, min.nml and sub.nml which implement the configurations _XppCfg_viterbi29, _XppCfg_calcmin and _XppCfg_subtract, respectively. For the _XppCfg_viterbi29 configuration two versions are evaluated: with unrolling (vit.nml) and without unrolling (vit_nounroll.nml).

The performance evaluation was done for each configuration separately, and for all configurations of the update_viterbi29 function. It is assumed that the separate configurations are the only configuration s in the test case³. Therefore the separate configurations need different preloads and write-backs. The following table lists the required data transfers based on the table above. Column Data RAM gives the number of cycles needed for the data transfer between RAM and cache. Column DCache gives the number of cycles needed for the data transfer between cache and IRAM.
³ For testing the separate configurations no RISC source code is given. It must contain the XppPreload and XppPreloadClean functions for the required preloads and write-backs.

| con- | | | Data | |
|---|---|---|---|---|
| figurations | preloads | write-backs | RAM | DCache |
| viterbi29 | Branchtab29_1 | vp->new_metrics | 1352 | 52 |
| | Branchtab29_2 | vp->dp->w | | |
| | vp->old_metrics | | | |
| | vp->old_metrics+128 | | | |
| | sym1 | | | |
| | sym2 | | | |
| calcmin | vp->new_metrics | minmetric | 536 | 17 |
| subtract | vp->new_metrics | vp->new_metrics | 760 | 33 |
| | minmetric | | | |
| all | Branchtab29_1 | vp->dp->w | 1440 | 53 |
| con- | Branchtab29_2 | minmetric | | |
| figurations | vp->old_metrics | vp->new_metrics | | |
| | vp->old_metrics+128 | | | |
| | sym1 | | | |
| | sym2 | | | |

TABLE 1
Performance on IDCT (8 × 8)

| | | LEON with XPP | LEON with XPP | LEON with XPP |
|---|---|---|---|---|
| | LEON alone | in IRQ Mode | in Poll Mode | in Hold Mode |
| Configuration | — | 71.308 ns | 84.364 ns | 77.976 ns |
| of XPP | | 17.827 cycles | 21.091 cycles | 19.494 cycles |
| 2D IDCT (8 × 8) | 14.672 ns | 3.272 ns | 3.872 ns | 3.568 ns |
| | 3.668 cycles | 818 cycles | 968 cycles | 892 cycles |

0

In the following tables the performance is compared to the reference system.

The first table is the worst case, representing the current example. Since no outer loop is given, the configurations cannot be assumed to be in cache. Moreover, an XppSync instruction has to be inserted at the end of the function to force write-backs to the cache, ensuring data consistence for the caller. This setup prevents pipelining of the Ld/Ex/WB phases of the computation, therefore the number of cycles of the RAM and Cache accesses for the XPP has to be added to the computation cycles instead of taking the maximum (columns XPP Execute-Cache and XPP Execute-RAM).

| | Data | | | | XPP | | | Ref. | | | | |
|---|---|---|---|---|---|---|---|---|---|---|---|---|
| | Access | | Configuration | | Execute | | | System | | Speedup | | |
| configurations | RAM | DCache | RAM | ICache | Core | Cache | RAM | Cache | RAM | Core | Cache | RAM |
| viterbi29 (unrolling) | 1352 | 52 | 9688 | 1377 | 366 | 1795 | 12783 | 3624 | 4976 | 9.9 | 2.0 | 0.4 |
| viterbi29 (no unrolling) | 1352 | 52 | 5432 | 770 | 588 | 1410 | 8142 | 3624 | 4976 | 6.2 | 2.6 | 0.6 |
| calcmin | 536 | 17 | 3024 | 429 | 56 | 502 | 4045 | 256 | 792 | 4.6 | 0.5 | 0.2 |
| subtract | 760 | 33 | 1736 | 245 | 76 | 354 | 2817 | 192 | 952 | 2.5 | 0.5 | 0.3 |
| all cfgs (unrolling) | 1440 | 53 | 14392 | 2051 | 498 | 2602 | 18381 | 4072 | 5512 | 8.2 | 1.6 | 0.3 |
| all cfgs (no unrolling) | 1440 | 53 | 10136 | 1444 | 720 | 2217 | 13740 | 4072 | 5512 | 5.7 | 1.8 | 0.4 |

Usually the update_viterbi29 function is called in a loop. Therefore—in the following table—it is assumed that all three configurations are cached in the XPP array for all but the first iteration. Additionally the XppSync instruction can be placed after the outer loop, enabling pipelining of the memory transfers and the execution.

| | Data | | | | XPP | | | Ref. | | | | |
|---|---|---|---|---|---|---|---|---|---|---|---|---|
| | Access | | Configuration | | Execute | | | System | | Speedup | | |
| configurations | RAM | DCache | RAM | ICache | Core | Cache | RAM | Cache | RAM | Core | Cache | RAM |

| | | | | | | | | | | |
|---|---|---|---|---|---|---|---|---|---|---|
| viterbi29 (unrolling) | 1352 | 52 | 366 | 366 | 1352 | 3624 | 4976 | 9.9 | 9.9 | 3.7 |
| viterbi29 (no unrolling) | 1352 | 52 | 588 | 588 | 1352 | 3624 | 4976 | 6.2 | 6.2 | 3.7 |
| calcmin | 536 | 17 | 56 | 56 | 536 | 256 | 792 | 4.6 | 4.6 | 1.5 |
| subtract | 760 | 33 | 76 | 76 | 760 | 192 | 952 | 2.5 | 2.5 | 1.3 |
| all cfgs (unrolling) | 1440 | 53 | 498 | 498 | 1440 | 4072 | 5512 | 8.2 | 8.2 | 3.8 |
| all cfgs (no unrolling) | 1440 | 53 | 720 | 720 | 1440 | 4072 | 5512 | 5.7 | 5.7 | 3.8 |

For viterbi a significant performance improvement up to a factor of 8.2 can be achieved using the XPP compared to the reference system.

The final utilization is shown in the following tables. The information is taken from the ‘.info’ files generated from the NML source code by the XMAP tool.

| | |
|---|---|
| Parameter | Value |

Utilization of the viterbi29 configuration with unrolling (vit.nml):

| | |
|---|---|
| Vector length | read: 32, write: 64 |
| Reused data set size | — |
| I/O IRAMs [sum-pct] | 8-50% |
| ALU[sum-pct] | 47-73% |
| BREG [def/route/sum-pct] | 27/37/64-80% |
| FREG [def/route/sum-pct] | 24/27/51-64% |

Utilization of the viterbi29 configuration without
unrolling (vit_nounroll.nml):

| | |
|---|---|
| Vector length | read: 32, write: 64 |
| Reused data set size | — |
| I/O IRAMs [sum-pct] | 8-50% |
| ALU[sum-pct] | 25-39% |
| BREG [def/route/sum-pct] | 18/23/41-51% |
| FREG [def/route/sum-pct] | 18/11/29-36% |

Utilization of the calcmin configuration (min.nml):

| | |
|---|---|
| Vector length | 16 |
| Reused data set size | — |
| I/O IRAMs [sum-pct] | 2-13% |
| ALU[sum-pct] | 19-30% |
| BREG [def/route/sum-pct] | 14/16/30-38% |
| FREG [def/route/sum-pct] | 7/6/13-16% |

Utilization of the subtract configuration (sub.nml):

| | |
|---|---|
| Vector length | 16 |
| Reused data set size | — |
| I/O IRAMs [sum-pct] | 3-19% |
| ALU[sum-pct] | 11-17% |
| BREG [def/route/sum-pct] | 6/10/16-20% |
| FREG [def/route/sum-pct] | 2/9/11-14% |

5.8 MPEG2 Codec—Quantization

The quantization file contains routines for quantization and inverse quantization of 8×8 macro blocks. These functions differ for intra and non-intra blocks, and furthermore the encoder distinguishes between MPEG1 and MPEG2 inverse quantization.

Since all functions have the same layout, i.e. some checks, one main loop running over the macro block quantizing with a quantization matrix, we concentrate on iquant_intra, the inverse quantization of intra-blocks, since it contains all elements found in the other procedures. The non_intra quantization loop bodies are more complicated, but add no compiler complexity. In the source code the MPEG1 part is already inlined, which is straightforward since the function is statically defined and contains no function calls itself. Therefore the compiler inlines it, and dead function elimination removes the whole definition.

5.8.1 Original Code

```
void iquant_intra(src,dst,dc_prec,quant_mat,mquant)
short *src, *dst;
int dc_prec;
unsigned char *quant_mat;
int mquant;
{
  int i, val, sum;
  if (mpeg1) {
    dst[0] = src[0] << (3−dc_prec);
    for (i=1; i<64; i++)
    {
      val = (int)(src[i]*quant_mat[i]*mquant)/16;
      /* mismatch control */
      if ((val&1)==0 && val!=0)
        val+= (val>0) ? −1 : 1;
      /* saturation */
      dst[i] = (val>2047) ? 2047 : ((val<−2048) ? −2048 : val);
  }
  else
  {
    sum = dst[0] = src[0] << (3−dc_prec);
    for (i=1; i<64; i++)
    {
      val = (int)(src[i]*quant_mat[i]*mquant)/16;
      sum+= dst[i] = (val>2047) ? 2047 : ((val<−2048) ? −2048 : val);
    }
    /* mismatch control */
    if ((sum&1)==0)
      dst[63]\hat{ }= 1;
  }
}
```

In the following subsections we concentrate on the MPEG2 part.

5.8.2 Preliminary Transformations

Interprocedural Optimizations

Analyzing the loop bodies shows that they easily fit on the XPP array and do not use the maximum of resources by far. The function is called three times from module putseq.c. With inter-module function inlining the code for the function call disappears and is replaced with the function. Therefore it reads:

```
for (k=0; k<mb_height*mb_width; k++) {
  if (mbinfo[k].mb_type & MB_INTRA)
    for (j=0; j<block_count; j++)
      if (mpeg1) {
        /* omitted */
      } else {
        sum = dst[0] = src[0] << (3−dc_prec);
        for (i=1; i<64; i++)
        {
          val = (int) (src[i]*quant_mat[i]*mquant)/16;
          sum+= dst[i] = (val>2047) ? 2047 : ((val<−2048) ? −2048 :
          val);
        }
        /* mismatch control */
        if ((sum&1)==0)
          dst[63]\hat{ }= 1;
      }
  else
  /* non intra block part omitted */
}
```

Basic Transformations

The following transformations are done:
A peephole optimization reduces the division by 16 to a right shift by 4. This is essential since we do not consider loop bodies containing division for the XPP.
Idiom recognition reduces the statement after the comment /* saturation */ to dst[i]=min(max(val, −2048), 2047).
Since the global variable mpeg1 does not change within the loop, loop unswitching moves the control statement outside the j-loop and produces two loop nests.
Partial redundancy elimination inserts temporaries which store intermediate results.
Reads from arrays are stored in temporaries and moved as early as possible.
Writes to arrays are moved as late as possible.

Below is the code after these three transformations. The MPEG1 part again is omitted, but looks similar.

```
for (k=0; k<mb_height*mb_width; k++) {
  if (mbinfo[k].mb_type & MB_INTRA)
    if (mpeg1)
    /* omitted */
    else
      for (j=0; j<block_count; j++) {
        block_data = blocks[k*block_count+j][0];
        tmp1 = block_data << (3−dc_prec);
        sum = tmp1
        blocks[k*block_count+j][0] = tmp1;
        for (i=1; i<64; i++) {
          block_data = blocks[k*block_count+j][i];
          mat_data = intra_q [i];
          val = (int)( block_data * mat_data *mquant)>>4;
          tmp2 = min(2047, max(−2048,val));
          sum += tmp2;
          blocks[k*block_count+j][i] = tmp2;
        }
        /* mismatch control */
        block_data = blocks[k*block_count+j][63];
        if ((sum&1)==0) {
          block_data \hat{ }= 1;
      }
      blocks[k*block_count+j][63] = block_data;
    }
```

The i-loop is candidate to run on the XPP array, therefore we try to increase the size of the loop body as much as possible. Before we increase parallelism the next subsection shows an optimization which transforms the loop nest into a perfect loop nest.

Inverse Loop-Invariant Code Motion

The loop-invariant statements surrounding the loop body are candidates for inverse loop invariant code motion. By moving them into the loop body and guarding them properly the loop nest gets perfect, and the utilization of the innermost loop increases. Since this optimization is reversible it can be undone whenever needed.

This time we only show the two innermost loop nests.

```
for (j=0; j<block_count; j++) {
  for (i=0; i<64; i++) {
    block_data = blocks[k*block_count+j][i];
    mat_data = intra_q [i];
    sol_0 = block_data << (3-dc_prec);
    sol_1_63 = (int)( block_data * mat_data *mquant)>>4;
    sat_1_63 = min(2047, max(−2048,sol_1_63));
    guard1 = (i==0);
    guard2 = (i==63);
    if (guard1)
      sol = sol_0;
    else
      sol = sat_1_63;
    if (guard1)
      sum = sol;
    else
      sum += sol;
    guard3 = ((sum & 1) == 0);
    if (guard2 && guard3)
      sol \hat{ }= 1
    blocks[k*block_count+j][i] = sol;
  }
}
```

The following table shows the estimated utilization and performance by a configuration synthesized from the inner loop. The values show that there are many resources left for further optimizations.

| Parameter | Value |
|---|---|
| Vector length | 32 (64 16-bit values) |
| Reused data set size | — |
| I/O IRAMs | 4 |
| ALU | 9 |
| BREG | 9 |
| FREG | few |
| Dataflow graph width | 4 |
| Dataflow graph height | 7 + 2 (converters) |
| Configuration cycles | 9 + 64 |

5.8.3 Enhancing Parallelism

To increase parallelism we have two possibilities, which can be combined:
Since the smallest data type used in the inner loop limits the throughput of the synthesized pipeline, we must try to improve this throughput. This is shown in the next subsection.
The j-loop nest is candidate for unroll-and-jam when interprocedural value range analysis finds out that block_count can only have the values 6, 8 or 12.
   Loop Distribution, Partial Unrolling, Reduction Recognition, Loop Fusion

The conversion of the 8-bit values due to the unsigned character array containing the quantization matrix limits the throughput of the pipeline. In the best case only every fourth cycle a value can be read or written from the IRAM. Therefore we must try to increase the throughput by splitting the 32-bit value into 8-bit values, and process them concurrently in different pipelines. Unfortunately the loop-carried true dependence due to the accesses to sum prevents a simple partial unrolling which would achieve this. Loop distribution overcomes this problem.

Loop Distribution

Since there is no dependence from a read of sum to a write of block_data in the code, it is possible to distribute the innermost loop into two loops. The first loop also absorbs the guarded loop-invariant code which represents the first iteration.

```
for (j=0; j<block_count; j++) {
  for (i=0; i<64; i++) {
    block_data = blocks[k*block_count+j][i];
    mat_data  = intra_q [i];
    sol_0 = block_data << (3−dc_prec);
    sol_1_63 = (int)( block_data * mat_data *mquant)>>4;
    sat_1_63 = min(2047, max(−2048,sol_1_63));
    guard1 = (i==0);
    if (guard1)
      sol = sol_0;
    else
      sol = sat_1_63;
    blocks[k*block_count+j][i] = sol;
  }
  for (i=0; i<64; i++) {
    block_data = blocks[k*block_count+j][i];
    guard1 = (i==0);
    if (guard1)
      sum = block_data;
    else
      sum += block_data;
  }
  /* mismatch control */
  block_data = blocks[k*block_count+j][63];
  if ((sum&1)==0) {
    block_data \hat{ }= 1;
  }
  blocks[k*block_count+j][63] = block_data;
}
```

Now the first generated loop can be partially unrolled, while the second one is a classical example for sum reduction.

Loop 1—Partial Unrolling

The first loop utilizes about 10 ALUs (including 32-to-8 bit-conversion). Therefore the unrolling factor would be limited to 6. The next smaller divisor of the loop count is 4. Assuming this factor would be taken, another restriction gets valid. The factor causes that four block_data values are read and written in one iteration. Although this could be synthesized by means of shift register synthesis or data duplication for the reads, the writes would cause either an undefined result at write-back, if written to two distinct IRAMs, or the merge of the values would half the throughput. Therefore the unrolling factor chosen is 2, reaching the maximum throughput with minimum utilization.

Dead code elimination removes the guarded statement for the parts representing the odd iteration values.

```
for (i=0; i<64; i+=2) { // unrolled once
  // iteration i==0,2,4....
  block_data_0 = blocks[k*block_count+j][i];
  mat_data_0  = intra_q [i];
  sol_0_0 = block_data_0 << (3−dc_prec);
  sol_1_63_0 = (int)( block_data_0 * mat_data_0 *mquant)>>4;
  sat_1_63_0 = min(2047, max(−2048,sol_1_63_0));
  guard1_0 = (i==0);
  if (guard1_0)
    sol_0 = sol_0_0;
  else
    sol_0 = sat_1_63_0;
  blocks[k*block_count+j][i] = sol_0;
  // iteration i==1,3,5
  block_data_1 = blocks[k*block_count+j][i+1];
  mat_data_1  = intra_q [i+1];
  sol_0 = block_data_1 << (3−dc_prec);
  sol_1_63_1 = (int)( block_data_1 * mat_data_1 *mquant)>>4;
  sat_1_63_1 = min(2047, max(−2048,sol_1_63_1));
  blocks[k*block_count+j][i+1] = sat_1_63_1;
}
```

Loop2—Sum Reduction

As upon the block data write limits the reduction possibilities, therefore the code transforms to

```
for (i=0; i<64; i+=2) {
  block_data_0 = blocks[k*block_count+j][i];
  block_data_1 = blocks[k*block_count+j][i+1];
  guard1 = (i==0);
  if (guard1)
    sum = block_data_0 + block_data_1;
  else
    sum += block_data_0 + block_data_1;
}
```

Loop Fusion

The new loops can then be merged again, because still no dependence exists between them. Furthermore the loop-invariant code following the loops is moved inside the loop body, producing a perfect loop nest.

```
for (j=0; j<block_count; j++) {
  for (i=0; 1<64; i+=2) { // unrolled once
    block_data_0 = blocks[k*block_count+j][i];
    block_data_1 = blocks[k*block_count+j][i+1];
    mat_data_0  = intra_q [i];
    mat_data_1  = intra_q [i+1];
    // i== 0,2,4.....
    sol_0_0 = block_data_0 << (3−dc_prec);
    sol_1_63_0 = (int)( block_data_0 * mat_data_0 *mquant)>>4;
    sat_1_63_0 = min(2047, max(−2048,sol_1_63_0));
    guard0 = (i==0);
    if (guard0)
      sol_0 = sol_0_0;
    else
      sol_0 = sat_1_63_0;
    sol_0 = block_data_1 << (3−dc_prec);
    // i== 1,3,5
      sol_1_63_1 = (int)( block_data_1 * mat_data_1 *mquant)>>4;
    sol_1 = min(2047, max(−2048,sol_1_63_1));
    guard2 = (i == 62);
    guard3 = ((sum & 1) == 0);
    if (guard2 && guard3)
      sat_1_63_3 \hat{ }= 1
    blocks[k*block_count+j][i] = sol_0;
    blocks[k*block_count+j][i+1] = sat_1_63_1;
  }
```

As can be seen in the next table, these transformations have almost doubled the utilization and performance.

| Parameter | Value |
|---|---|
| Vector length | 32 (64 16-bit values) |
| Reused data set size | — |
| I/O IRAMs | 4 |
| ALU | 18 |
| BREG | 11 |
| FREG | 4 |
| Dataflow graph width | 8 |
| Dataflow graph height | 9 + 4 (converters) |
| Configuration cycles | 13 + 32 |

Unroll-and-Jam

As said above, the j-loop nest is candidate for unroll-and-jam when interprocedural value range analysis finds out that block_count can only have the values 6, 8 or 12. Therefore it has a value range [6,12] with the additional property to be dividable by 2. Thus unroll-and-jam with an unrolling factor equal to 2 is applicable. If should be noted that the resource constraints would give a bigger value. Since no loop-carried dependence at the level of the j-loop exists, this transformation is safe. Please note that redundant load/store elimination removes the loop-invariant duplicated loads from the array intra_q and the scalars dc_prec and mquant.

```
for (j=0; j<block_count; j+=2) { // unrolled and jammed once
  for (i=0; i<64; i+=2) { // unrolled once
    // common code
    mat_data_0 = intra_q [i];
    mat_data_1 = intra_q [i+1];
    guard1 = (i==0);
    guard2 = (i == 62);
    // j == 0,2,...
    block0_data_0 = blocks[k*block_count+j][i];
    block0_data_1 = blocks[k*block_count+j][i+1];
    // i== 0,2,4.....
    sol_0_0 = block0_data_0 << (3−dc_prec);
    sol0_1_63_0 = (int)( block0_data_0 * mat_data_0 *mquant)>>4;
    sat0_1_63_0 = min(2047, max(−2048,sol0_1_63_0));
    if (guard1)
      sol0_0 = sol0_0_0;
    else
      sol0_0 = sat0_1_63_0;
    // i== 1,3,5
    sol0_1_63_1 = (int)( block0_data_1 * mat_data_1 *mquant)>>4;
    sol0_1 = min(2047, max(−2048,sol0_1_63_1));
    if (guard1)
      sum0 = sol0_0 + sol0_1;
    else
      sum0 += sol0_0 + sol0_1;
    guard3 = ((sum0 & 1) == 0);
    if (guard2 && guard3)
      sol0_1 \hat{ }= 1;
    blocks[k*block_count+j][i] = sol0_0;
    blocks[k*block_count+j][i+1] = sol0_1;
    // j == 1,3,...
    block1_data_0 = blocks[k*block_count+j+1][i];
    block1_data_1 = blocks[k*block_count+j+1][i+1];
    // i== 0,2,4.....
    sol1_0_0 = block1_data_0 << (3−dc_prec);
    sol1_1_63_0 = (int)( block_data_0 * mat_data_0 *mquant)>>4;
    sat1_1_63_0 = min(2047, max(−2048,sol1_1_63_0));
    if (guard1)
      sol1_0 = sol1_0_0;
    else
      sol1_0 = sat1_1_63_0;
    // i== 1,3,5
    sol1_1_63_1 = (int)( block1_data_1 * mat_data_1 *mquant)>>4;
    sol1_1 = min(2047, max(−2048,sol1_1_63_1));
    if (guard1)
      sum1 = sol1_0 + sol1_1;
    else
      sum1 += sol1_0 + sol1_1;
    guard4 = ((sum1 & 1) == 0);
    if (guard2 && guard4)
      sol1_1 \hat{ }= 1
    blocks[k*block_count+j][i] = sol_0;
    blocks[k*block_count+j][i+1] = sol1_1;
  }
```

The results of the version where unroll-and-jam is applied are shown in the following table.

| Parameter | Value |
|---|---|
| Vector length | 2 * 32 (2 * 64 16-bit values) |
| Reused data set size | — |
| I/O IRAMs | 5 |
| ALU | 36 |
| BREG | 22 |
| FREG | 8 |
| Dataflow graph width | 2 * 8 |
| Dataflow graph height | 9 + 4 (converters) |
| Configuration cycles | 13 + 32 |

5.8.4 Final Code

The RISC code contains only the outer loops control code and the preload and execute calls. Since the data besides the block data does not vary within the j-loop, and the XPP FIFO initially sets the IRAM values to the previous preload, redundant load/store elimination moves the preloads in front of the j-loop. The same is done with the configuration preload. The RISC code looks then like:

```
for (k=0; k<mb_height*mb_width; k++) {
  if (mbinfo[k].mb_type & MB_INTRA)
    if (mpeg1)
    /* omitted */
  else {
    XppPreloadConfig(_XppCfg_iquant_intra_mpeg2);
    XppPreload(2, &intra_q, 16);
    XppPreload(3, &mbinfo[k].mquant, 1);
    XppPreload(4, &dc_prec, 1);
    for (j=0; j<block_count; j+=2) {
      XppPreload(0, &blocks[k*block_count + j], 32);
      XppPreload(1, &blocks[k*block_count + j+1], 32);
      XppExecute( );
    }
    xppSync(&blocks[k*block_count], 64 * block_count);
  }
```

The configuration code reads:

```
void _xppCfg_iquant_intra_mpeg2( )
{
  // IRAMs
  // blocks[k*block_count+j] and blocks[k*block_count+j+1],
  respectively
  // Read access with splitter to two 16 bit packets.
  // iram0,1[i] and iram0,1[i+1] are available concurrently.
  short iramo[256], iram1[256];
  // intra_q
  // Read access with splitter to 4 8-bit streams remerge to 2 streams.
  // iram2[i] and iram2[i+1] are available concurrently.
  unsigned char iram2[512];
  int iram3[128], iram4[128]; // scalars mquant and dc_prec
  // temporaries
  int i;
  int sol0_0_0, sol0_0_1, sol0_0, sol0_1;
  int sol1_0_0, sol1_0_1, sol1_0, sol1_1;
  int sol0_1_63_0, sol0_1_63_1, sat0_1_63_0;
  int sol1_1_63_0, sol1_1_63_1, sat1_1_63_0;
  int sum0, sum1;
  event guard1, guard2, guard3, guard4;
  for (i=0; i<64; i+=2) { // unrolled once
    // common code
    guard1 = (i==0);
    guard2 = (i == 62);
    // j == 0,2,...
    // i== 0,2,4.....
    sol0_0_0 = iram0[i] << (3−iram3[0]);
    sol0_1_63_0 = (int)( iram0[i] * iram2[i] * iram4[0])>>4;
    sat0_1_63_0 = min(2047, max(−2048,sol0_1_63_0));
    if (guard1)
      sol0_0 = sol0_0_0;
    else
      sol0_0 = sat0_1_63_0;
    // i== 1,3,5
    sol0_1_63_1 = (int)( iram0[i+1] * iram2[i+1] * iram4[0])>>4;
    sol0_1 = min(2047, max(−2048,sol0_1_63_1));
    if (guard1)
      sum0 = sol0_0 + sol0_1;
    else
      sum0 += sol0_0 + sol0_1;
    guard3 = ((sum0 & 1) == 0);
    if (guard2 && guard3)
      sol0_1 \hat{ }= 1;
    iram1[i] = sol1_0;
    iram1[i+1] = sol1_1;
    // part for odd j values omitted
  }
}
```

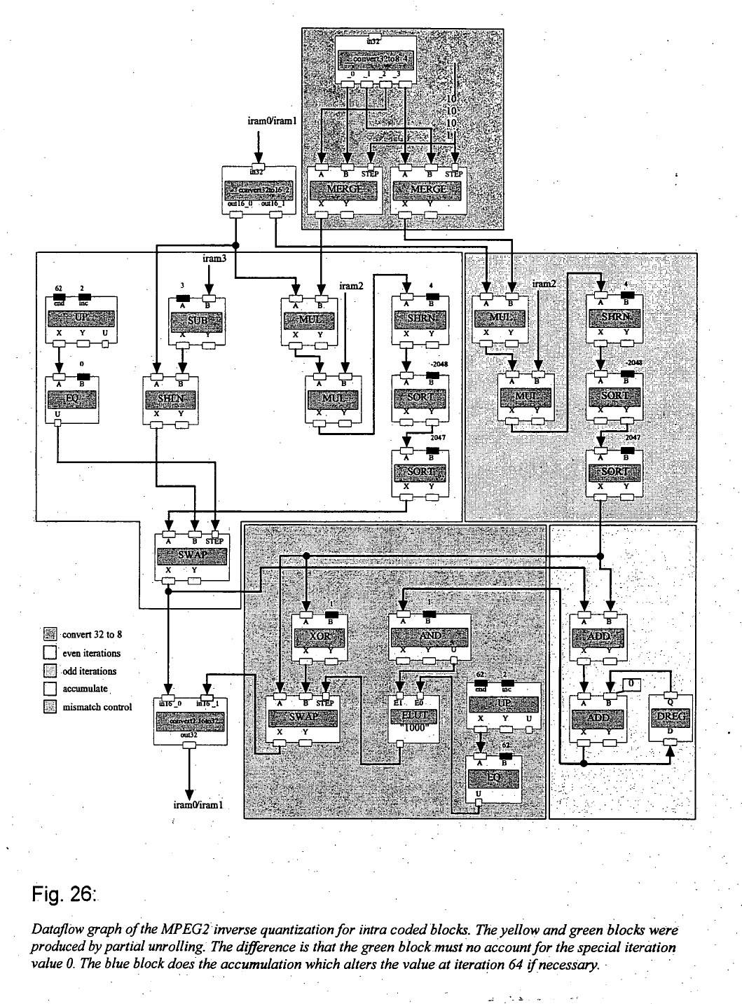

FIG. 26 shows the dataflow graph of one branch of the configuration. The different sections are colored for convenience.

5.8.5 Performance Evaluation

The next table lists the estimated performance of data transfers. The values assume that each read causes a cache miss, i.e. that the cache does not contain any data before the first preload occurs. The startup preloads section contains the preloads before the j-loop and the preloads of the block data in the first iteration. On the other hand the steady state preloads and write-backs describe the preloads and write-backs in the body of the j-loop.

| | | | | |
|---|---|---|---|---|
| | | | RAM to | |
| | | | Cache | IRAM |
| | Size | Cache | [cache | [cache |
| Data | [bytes] | Misses | cycles] | cycles] |

Startup preloads

| | | | | |
|---|---|---|---|---|
| intra_q | 64 | 2 | 112 | 4 |
| mbinfo[k].mquant | 4 | 1 | 56 | 1 |
| dc_prec | 4 | 1 | 56 | 1 |
| Sum | | | 224 | 6 |

Steady State Preloads

| | | | | |
|---|---|---|---|---|
| blocks[k*block_count + j] | 128 | 4 | 224 | 8 |
| blocks[k*block_count + j+1] | 128 | 4 | 224 | 8 |
| Sum | | | 448 | 16 |

Steady State Writebacks

| | | | |
|---|---|---|---|
| blocks[k*block_count + j] | 128 | 128 | 8 |
| blocks[k*block_count + j+1] | 128 | 128 | 8 |
| Sum | | 256 | 16 |

The write-back of the block data causes no cache miss, because the cache line was already loaded by the preload operation. Therefore the write-back does not include cycles for write allocation.

To compare the performance with the reference system we define some assumptions. The cycle count of one iteration of the k-loop is measured. As said upon the value of block_count has a maximum value of 12. This means that XppExecute is called 6 times in one iteration, since the configuration works on two blocks concurrently. Thus the total cycles calculate to the sum of the loads and 6 times the maximum of the steady state preloads and the execution cycles.

The execution cycles were measured by mapping and simulating the hand written _XppCfg_iquant_intra_mpeg2 configuration, where a special start object ensures that configuration buildup and execution do not overlap. Experiments showed that it is valuable to place distinct counters everywhere where, the iteration count is needed. The short connections that can be routed have a great impact on the execution speed. This optimization can be done easily by a compiler. Another relatively simple optimization was done by manually placing the most important parts of the dataflow graph.

Although this is not as simple as the optimization before, the performance impact of almost 100, cycles seems to make it to a required feature for a compiler.

The simulation yields 110 cycles for the configuration execution, which must be doubled to scale it to the data transfer cache cycles. A multiplication by 6 yields the final execution cycles for one iteration of the k-loop.

The results are summarized in the following table.

| | Data | | Confi- | | XPP | | | Ref. | | | | |
|---|---|---|---|---|---|---|---|---|---|---|---|---|
| | Access | | guration | | Execute | | | System | | Speedup | | |
| configurations | RAM | DCache | RAM | ICache | Core | Cache | RAM | Cache | RAM | Core | Cache | RAM |
| startup | 224 | 6 | 1960 | 1117 | | 1117 | 2184 | | | | | |
| steady state | 672 | 32 | | | 220 | 220 | 672 | | | | | |
| sum | 4256 | | | | 1320 | 2437 | 6216 | 17611 | 21867 | 13.2 | 7.2 | 3.5 |

This table describes the worst case. All data must be loaded from RAM. When we assume that the configuration is loaded from cache, which is an accurate assumption because it mainly alters with the configuration for non intra coded blocks, the statistics look much better. Since the quantization matrix and the scaling constants also stay in the cache, their preloads do not burden the cache-RAM bus as well.

| | Data | | Confi- | | XPP | | | Ref. | | | | |
|---|---|---|---|---|---|---|---|---|---|---|---|---|
| | Access | | guration | | Execute | | | System | | Speedup | | |
| configurations | RAM | DCache | RAM | ICache | Core | Cache | RAM | Cache | RAM | Core | Cache | RAM |
| startup | | 6 | | 1117 | | 1117 | 1117 | | | | | |
| steady state | 672 | 32 | | | 220 | 220 | 672 | | | | | |
| sum | 4032 | | | | 1320 | 2437 | 5149 | 17611 | 21643 | 13.3 | 7.2 | 4.2 |

The final utilization is shown in the following table. The big differences with the estimated values for the BREGs and FREGs result from the distributed counters.

| Parameter | Value |
|---|---|
| Vector length | 2 * 32 (2 * 64 16-bit values) |
| Reused data set size | — |
| I/O IRAMs [sum-pct] | 5-31% |
| ALU[sum-pct] | 39-61% |
| BREG [def/route/sum-pct] | 39/14/53-66% |
| FREG [def/route/sum-pct] | 20/16/36-45% |

5.9 MPEG2 Codec—IDCT

The idct-algorithm (inverse discrete cosine transformation) is used for the MPEG2 video decompression algorithm. It operates on 8×8 blocks of video images in their frequency representation and transforms them back into their original signal form. The MPEG2 decoder contains a transform-function that calls idct for all blocks of a frequency-transformed picture to restore the original image.

The idct function consists of two for-loops. The first loop calls idctrow—the second idctcol. Function inlining is able to eliminate the function calls within the entire loop nest so that the numeric code is not interrupted by function calls anymore. Another way to get rid of function calls in the loop nest is loop embedding that pushes loops from the caller into the callee.

5.9.1 Original Code (idct.c)

```
/* two dimensional inverse discrete cosine transform */
void idct(block)
short *block;
{
  int i;
  for (i=0; i<8; i++)
    idctrow(block+8*i);
  for (i=0; i<8; i++)
    idctcol(block+i);
}
```

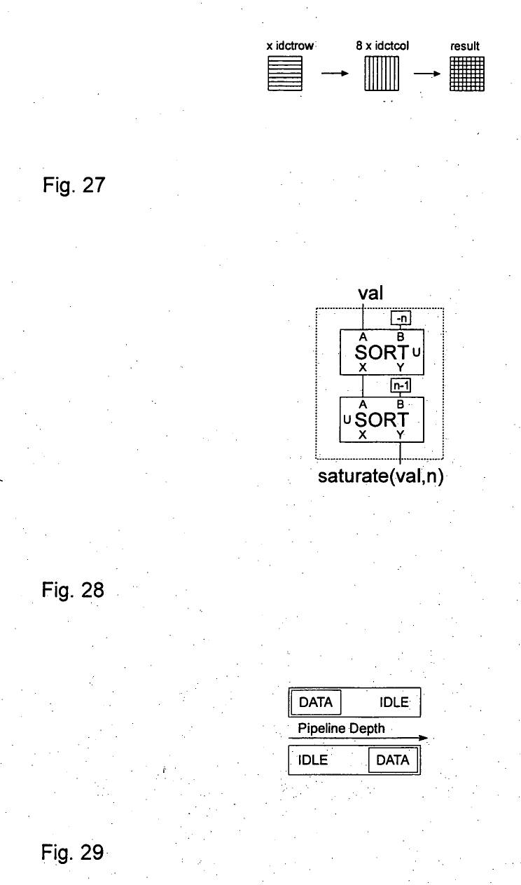

The first loop changes the values of the block row by row. Afterwards the changed block is further transformed column by column. All rows have to be finished before any column processing can be started (see FIG. 27).

Data dependence analysis detects true data dependences between row processing and column processing. Therefore processing of the columns has to be delayed until all rows are done. The innermost loop bodies of idctrow and idctcol are nearly identical. They process numeric calculations on eight input values, column values in the case of idctcol and row values in the case of idctcol. Eight output values are calculated and written back (as column/row) idctcol additionally applies clipping before the values are written back. This is why we concentrate on idctcol:

```
/* column (vertical) IDCT
  *
$\begin{matrix}* \\ * \\ *\end{matrix} dst [ 8 * k ] = {sum}_{l = 0}^{7} c [ 1 ] * src [ 8 * 1 ] * cos ( \frac{pi}{8} * ( k + \frac{1}{2} ) * 1 )$
  *
  * where: c[0]  = 1/1024
  * c[1..7] = (1/1024)*sqrt(2)
  static void idctcol (blk)
  short *blk;
  {
  int x0, x1, x2, x3, x4, x5, x6, x7, x8;
  /* shortcut */
  if (!((x1 = (blk[8*4]<<8)) | (x2 = blk[8*6]) |
      (x3 = blk[8*2]) | (x4 = blk[8*1]) | (x5 = blk[8*7]) |
      (x6 = blk[8*5]) | (x7 = blk[8*3])))
  {
    blk[8*0] =blk[8*1] =blk[8*2] =blk[8*3] =blk[8*4] =blk[8*5] =
    blk[8*6] =blk[8*7] =iclp[(blk[8*0] =) >>6];
    return;
  }
  x0 = (blk[8*0] <<8) + 8192;
  /* first stage */
  x8 = W7*(x4+x5) + 4;
  x4 = (x8+(W1−W7) *x4) >>3;
  x5 = (x8−(W1+W7) *x5) >>3;
  x8 = W3* (x6+x7) + 4;
  x6 = (x8− (W3−W5) *x6) >>3;
  x7 = (x8− (W3+W5) *x7) >>3;
  /* second stage */
  x8 = x0 + x1;
  x0 −= x1;
  x1 = W6* (x3+x2) + 4;
  x2 = (x1− (W2+W6) *x2) >>3;
  x3 = (x1+ (W2−W6) *x3) >>3;
  x1 = x4 + x6;
  x4 −= x6;
  x6 = x5 + x7;
  x5 −= x7;
  /* third stage */
  x7 = x8 + x3;
  x8 −= x3;
  x3 = x0 + x2;
  x0 −= x2;
  x2 = (181*(x4+x5) +128) >>8;
  x4 = (181*(x4−x5) +128) >>8;
  /* fourth stage */
  blk[8*0] = iclp[(x7+x1) >>14];
  blk[8*1] = iclp[(x3+x2) >>14];
  blk[8*2] = iclp[(x0+x4) >>14];
  blk[8*3] = iclp[(x8+x6) >>14];
  blk[8*4] = iclp[(x8−x6) >>14];
  blk[8*5] = iclp[(x0−x4) >>14];
  blk[8*6] = iclp[(x3−x2) >>14];
  blk[8*7] = iclp[(x7−x1) >>14];
}
```

W1-W7 are macros for numeric constants that are substituted by the preprocessor. Array iclp is used for clipping the results to 8-bit values. It is fully defined by the init_idct function before idct is called the first time:

```
void init_idct( )
{
  int i;
  iclp = iclip+512;
  for (i= −512; i<512; i++)
    iclp[i] = (i<−256) ? −256 : ((i>255) ? 255 : i);
}
```

A special kind of idiom recognition, function recognition, is able to replace the calculation of each array element by a compiler known function that can be realized efficiently on the XPP. If the compiler features whole program memory aliasing analysis, it is able to replace all uses of the iclp array with the call of the compiler known function. Alternatively a developer can replace the iclp array accesses manually by the compiler known saturation function calls. The illustration shows a possible implementation for saturate(val,n) as NML schematic using two ALUs. In this case it is necessary to replace array accesses like iclp[i] by saturate(i,256), see FIG. 28.

The /* shortcut */ code in idctcol speeds column processing up if x1 to x7 are equal to zero. This breaks the well-formed structure of the loop nest. The if-condition is not loop-invariant and loop unswitching cannot be applied. But nonetheless, the code after shortcut handling is well suited for the XPP. It is possible to synthesize if-conditions for the XPP, speculative processing of both blocks plus selection based on condition, but this would just waste PAEs without any performance benefit. Therefore the /* shortcut */ code in idctrow and idctcol has to be removed manually. The code snippet below shows the inlined version of the idctrow-loop with additional cache instructions for XPP control:

```
void idct(block)
short *block;
{
  int i;
  XppPreloadConfig(_XppCfg_idctrow); // Loop Invariant
  for (i=0; i<8; i++) {
    short *blk;
    int x0, x1, x2, x3, x4, x5, x6, x7, x8;
    blk = block+8*i;
    XppPreload(0, blk, 8/2); // 8 shorts = 4 ints
    XppPreloadClean(1, blk, 8/2); // IRAM1 is erased and assigned to blk
    XppExecute( );
  }
  for (i=0; i<8; i++) {
    ...
  }
}
```

As the configuration of the XPP does not change during the loop execution invariant code motion has moved out XppPreloadConfig(_XppCfg_idctrow) from the loop.

5.9.2 Enhancing XPP Utilization

As mentioned at the beginning idct is called for all data blocks of a video image (loop in transform.c). This circumstance allows us to further improve the XPP utilization.

When we look at the dataflow graph of idctcol in detail we see that it forms a very deep pipeline. _XppCfg_idctrow runs only eight times on the XPP which means that only 64 (8 times 8 elements of a column) elements are processed through this pipeline. Furthermore all data must have left the pipeline before the XPP configuration can change to the _XppCfg_idctcol configuration to go on with column processing. This means that something is still suboptimal in the example.

Pipeline Depth

The pipeline is just too deep for processing only eight times eight rows. Filling and flushing a deep pipeline is expensive if only little data is processed with it. First the units at the end of the pipeline are idle and then the units at the begin are unused (see FIG. 29).

Loop Interchange and Loop Tilling

It is profitable to use loop interchange for moving the dependences between row and column processing to an outer level of the loop nest. The loop that calls the idct-function in transform.c on several blocks of the image has no dependence preventing loop interchange. Therefore this, loop can be moved inside the loops of column and row processing.

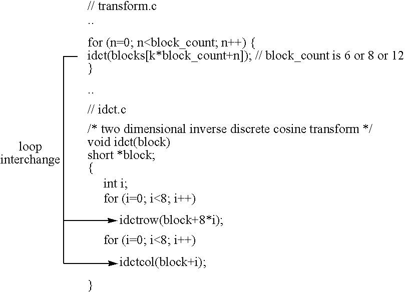

Now processing of rows and columns can be applied on more data by applying loop tiling, and the fixed costs for filling and flushing the pipeline contribute less to the total costs.

Constraints (Cache Sensitive Loop Tiling)

The cache hierarchy has to be taken into account when we define the number of blocks that will be processed by _XppCfg_idctrow. Remember, that the same blocks in the subsequent _XppCfg_idctcol configuration are needed! We have to take care that all blocks that are processed during _XppCfg_idctrow fit into the cache. Loop tiling has to be applied with respect to the cache size so that the processed data fit into the cache for all three configurations.

5.9.3 NML Code Generation

Dataflow Graph

As idctcol is more complex due to clipping at the end of the calculations, we decided to take idctcol as representative loop body for a presentation of the dataflow graph.

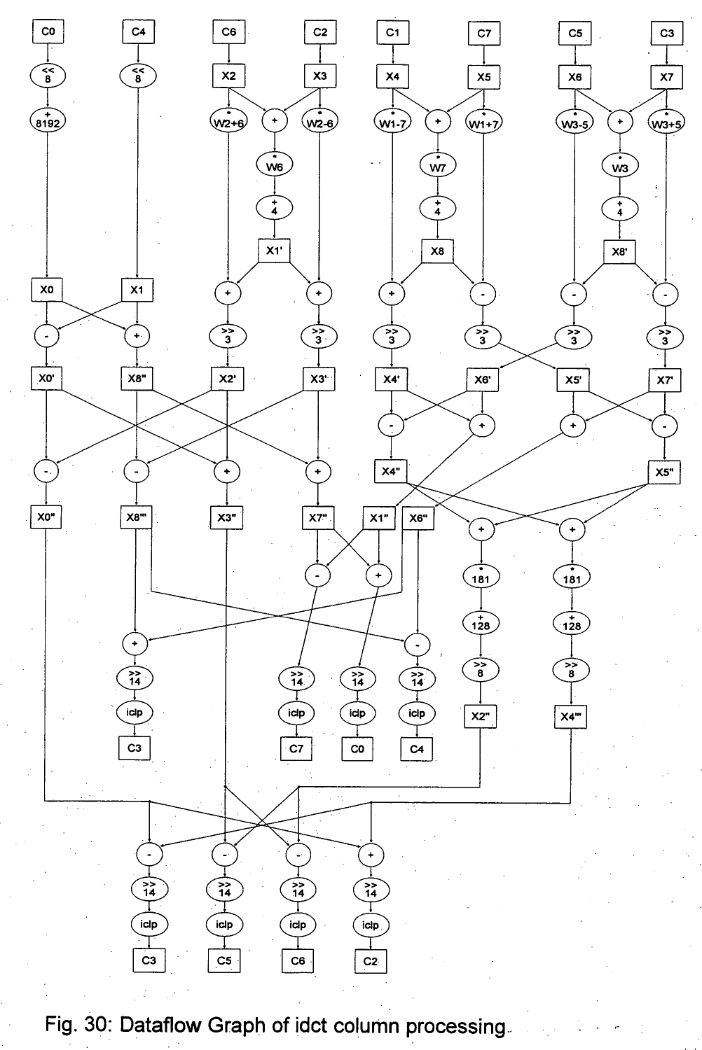

FIG. 30 shows the dataflow graph for _XppCfg_idctcol. A heuristic has to be applied to the graph to estimate the resource needs on the XPP. In our example the heuristic produces the following results:

| | ADD, SUB | MUL | <<X, >>X | Saturate(x, n) |
|---|---|---|---|---|
| Ops needed | 35 | 11 | 18 | 8 |

| | ALUs | FREGs | BREGs |
|---|---|---|---|
| Res. avail. | 64 | 80 | 80 |
| Res. left | 19 | 80 | 45 |
| Res. used | 45 | 0 | 35 |

Address Generation, Data Duplication and Data Layout Transformation:

To fully synthesize the loop body we have to face the problem of address generation for accessing the data of four 8×8 blocks.

For idctrow and idctcol we have to access one row/column per cycle to get a fully utilized pipeline. As the rows/columns are packed, i.e. one row/column is packed into four words, we use 4-times data duplication, as described in the hardware section), to enable 4-times parallel access which is needed to fetch a full row/column (eight short values) per cycle.

We use one counter per. RAM to realize address generation. The four counters are started with different offsets as they correspond to different elements of the fetched row/column (elements of the row/column are packed columns/rows). Therefore we implemented a counter macro that has a configurable start, stop and increment value, and fits into the same PAE as the IRAM. Detailed descriptions of the used macros are given in the appendix.

The fetched row/column has to be unpacked with split macros. A split macro splits packets of two shorts in an input stream into two separate streams. Now eight input values are processed to the dataflow graph and eight result values (shorts) are created.

Address generation for writing back the results is not needed, as we connect the eight result streams to FIFO mode IRAMs which are mapped to one continuous address range. Before the results are written into the FIFO, packing is applied to provide packed input data for the next configuration.

Unfortunately this combination of reading data duplicated IRAMS in RAM-mode, and writing the results into FIFOs cause changes in the data layout of the input array. We have to ensure that after all data processing the original data layout is recovered. For this reason we need an extra configuration which restores the original data layout of the input array. This is done in _XppCfg_idctreorder that also performs the saturation of idctcol to make the configuration for idctcol a bit smaller.

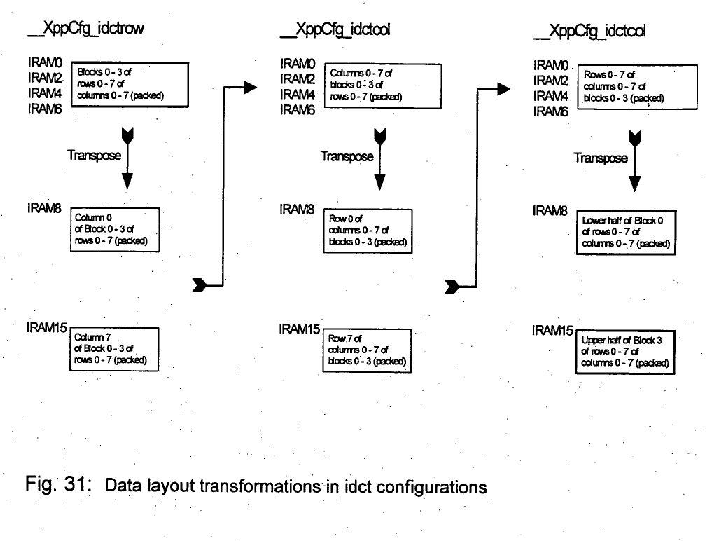

FIG. 31 illustrates the data layout changes during the whole process. After applying the last configuration the data layout is the same as before.

5.9.4 Architectural Parameters

The following section shows the architectural parameters used by the compiler driver. This values are based on heuristics and may not exactly meet the final results. These are just start values for the optimizations process.

| | |
|---|---|
| Parameter | Value |

_XppCfg_idctrow

| | |
|---|---|
| Vector length | 4 words |
| Reused data set size | 4 × 8 × 4 words |
| I/O IRAMs | 4 (data duplication) + 8(output) |
| ALU | 31(dfg) + 8(pack) |
| BREG | 32(dfg) + 8(pack) + 8(unpack) + 4(addr.sel.) |
| FREG | 0(dfg) + 8(pack) + 4(unpack) + 4(addr.sel.) |
| Dataflow graph width | 8 |
| Dataflow graph height | 10 |
| Configuration cycles | 128/4 + 10 × 2 |

_XppCfg_idctcol

| | |
|---|---|
| Vector length | 4 words |
| Reused data set size | 4 × 8 × 4 words |
| I/O IRAMs | 4 (data duplication) + 8(output) |
| ALU | 37(dfg) + 8(pack) |
| BREG | 35(dfg) + 8(pack) + 8(unpack) + 4(addr.sel.) |
| FREG | 0(dfg) + 8(pack) + 4(unpack) + 4(addr.sel.) |
| Dataflow graph width | 8 |
| Dataflow graph height | 10 |
| Configuration cycles | 128/4 + 10 × 2 |

_XppCfg_idctreorder

| | |
|---|---|
| Vector length | 4 words |
| Reused data set size | 4 × 8 × 4 words |
| I/O IRAMs | 4 (data duplication) + 8(output) |
| ALU | 16(dfg) + 8(pack) |
| BREG | 8(dfg) + 8(pack) + 8(unpack) + 4(addr.sel.) |
| FREG | 0(dfg) + 8(pack) + 4(unpack) + 4(addr.sel.) |
| Dataflow graph width | 8 |
| Dataflow graph height | 2 |
| Configuration cycles | 128/4 + 2 × 2 |

Total estimated optimal configuration cycles (considering no routing delays and pipeline stalls) for processing 4 blocks:
2×(128/4+10×2)+128/4+2×2=140 cycles
5.9.5 Example Source Code after Transformations

The following sources result from applying the optimizations discussed above. As the IRAM size is finally fixed to 128 words we can only process 4 blocks at once. The original source code has to be adapted to make this block size possible.

Transform

Finally the idct-function gets completely inlined in the itransform function of transform.c. If block_count is equal to 4, and we assume that 32*4 words do not exceed the cache size, then we can transform the example into:

```
/* inverse transform prediction error and add prediction */
void itransform(pred,cur,mbi,blocks)
unsigned char *pred[ ],*cur[ ];
struct mbinfo *mbi;
short blocks[ ][64];
{
  int i, j, i1, j1, k, n, cc, offs, lx;
  short *block, *nextblock;
  k = 0;
  for (j=0; j<height2; j+=16)
    for (i=0; i<width; i+=16)
    {
      if(block_count == 4) { // xpp execution only if blockcount is 4
        XppPreloadconfig(_XppCfg_idctrow);
        // hide cache miss with preloading
        next 4 blocks (if not last iteration)
        nextblock = blocks[(k+1) * 4];
        if(i+16 >= width) XppPreload(1, nextblock, 128);
        // do processing of actual 4 blocks
        block = blocks[k * 4];
        // Input Data
        // IRAMs 0,2,4,6 = 0x55 = 0b1010101
```

| | |
|---|---|
| XppPreloadMultiple(0x55, block, 128); | // this one causes |
| | a read miss |

```
        // Output Data
        XppPreloadClean( 8, &block[0*16], 16);
        XppPreloadClean( 9, &block[1*16], 16);
        XppPreloadClean(10, &block[2*16], 16);
        XppPreloadClean(11, &block[3*16], 16);
        XppPreloadClean(12, &block[4*16], 16);
        XppPreloadClean(13, &block[5*16], 16);
        XppPreloadClean(14, &block[6*16], 16);
        XppPreloadClean(15, &block[7*16], 16);
        XppExecute( );
        XppPreloadConfig(_XppCfg_idctcol);
        // Input Data
        // IRAMs 0,2,4,6 = 0x55 = 0b1010101
        XppPreloadMultiple(0x55, block, 128);
        // Output Data
        XppPreloadClean( 8, &block[0*16], 16);
        XppPreloadClean( 9, &block[1*16], 16);
        XppPreloadClean(10, &block[2*16], 16);
        XppPreloadClean(11, &block[3*16], 16);
        XppPreloadClean(12, &block[4*16], 16);
        XppPreloadClean(13, &block[5*16], 16);
        XppPreloadClean(14, &block[6*16], 16);
        XppPreloadClean(15, &block[7*16], 16);
        XppExecute( );
        XppPreloadConfig(_XppCfg_idctreorder);
        // Input Data
        // IRAMs 0,2,4,6 = 0x55 = 0b1010101
        XppPreloadMultiple(0x55, block, 128);
        // Output Data
        XppPreloadClean( 8, &block[0*16], 16);
        XppPreloadClean( 9, &block[1*16], 16);
        XppPreloadClean(10, &block[2*16], 16);
        XppPreloadClean(11, &block[3*16], 16);
        XppPreloadClean(12, &block[4*16], 16);
        XppPreloadClean(13, &block[5*16], 16);
        XppPreloadClean(14, &block[6*16], 16);
        XppPreloadClean(15, &block[7*16], 16);
        XppExecute( );
    }
    for (n=0; n<block_count; n++) {
      cc = (n<4) ? 0 : (n&1)+1; /* color component index */
      if (cc==0) {
        /* luminance */
        if ((pict_struct==FRAME_PICTURE) && mbi[k].dct_type) {
          /* field DCT */
          offs = i + ((n&1)<<3) + width*(j+((n&2)>>1));
          lx = width<<1;
        }
        else {
          /* frame DCT */
          offs = i + ((n&1)<<3) + width2*(j+((n&2)<<2));
          lx = width2;
        }
        if (pict_struct==BOTTOM_FIELD) offs += width;
      }
      else {
        /* chrominance */
        /* scale coordinates */
        i1 = (chroma_format==CHROMA444) ? i : i>>1;
        j1 = (chroma_format!=CHROMA420) ? j : j>>1;
        if ((pict_struct==FRAME_PICTURE) && mbi[k].dct_type
            && (chroma_format!=CHROMA420)) {
          /* field DCT */
          offs = i1 + (n&8) + chrom_width*(j1+((n&2)>>1));
          lx = chrom_width<<1;
        }
        else {
          /* frame DCT */
          offs = i1 + (n&8) + Chrom_width2*(j1+((n&2)<<2));
          lx = chrom_width2;
        }
        if (pict_struct==BOTTOM_FIELD) offs += chrom_width;
      }
      // fallback to RISC execution if block_count != 4
      if(block_count != 4) idct(blocks[k*block_count+n]);
```

| | |
|---|---|
| else XppSync(blocks[k*block_count+n], 64/2); | // ensure WB |
| | done for block |
| add_pred(pred[cc]+offs,cur[cc]+offs, | |
| lx,blocks[k*block_count+n]); | |
| } | |
| k++; | |
| } | |
| } | |

_XppCfg_idctrow

```
#define W1 2841 /* 2048*sqrt(2)*cos(1*pi/16) */
#define W2 2676 /* 2048*sqrt(2)*cos(2*pi/16) */
#define W3 2408 /* 2048*sqrt(2)*cos(3*pi/16) */
#define W5 1609 /* 2048*sqrt(2)*cos(5*pi/16) */
#define W6 1108 /* 2048*sqrt(2)*cos(6*pi/16) */
#define W7 565 /* 2048*sqrt(2)*cos(7*pi/16) */
/** _XppCfg_idctrow( )
* Does idct row calculation for 4 blocks
* XPPIN: iram0,2,4,6 contains 4 blocks (data duplication)
* XPPOUT: iram8-15 contains transposed calc. results
*/
void _XppCfg_idctrow( ) {
  // Input IRAMs in RAM Mode
  int iram0[128], iram2[128], iram4[128], iram6[128];
  // Output IRAMs in FIFO Mode
  int *iram8, *iram9, *iram10, *iram11, *iram12, *iram13,
  *iram14, *iram15;
  int r0, r1, r2, r3, r4, r5, r6, r7, r8;
  int r01, r23, r45, r67;
  // Counter offsets for parallel access
  int i0=0, i1=1, i2=2, i3=3;
  int k;
  for(k=0; k<32; k++) {
    // Data layout of input array is:
    // row0blk0, ..., row7blk0, row0blk1, ..., ..., row7blk3
    // (with 4 packed columns([0,1],[2,3],[4,5],[6,7]))
    // 0 3, ..., 28 31, 32 35, ..., ..., 124 127
    r01 = iram0[i0+=4]; // row element 0 and 1
    r23 = iram2[i1+=4]; // row element 2 and 3
    r45 = iram4[i2+=4]; // row element 4 and 5
    r67 = iram6[i3+=4]; // row element 6 and 7
    // Packed row elements have to be separated with _split16
    _split16(r01, r4, r0);
    _split16(r23, r7, r3);
    _split16(r45, r6, r1);
    _split16(r67, r5, r2);
    r1 = r1<<11;
    r0 = (r0<<11) + 128; /* for proper rounding in the fourth stage */
    /* first stage */
    r8 = W7*(r4+r5);
    r4 = r8 + (W1−W7)*r4;
    r5 = r8 − (W1+W7)*r5;
    r8 = W3*(r6+r7);
    r6 = r8 − (W3−W5)*r6;
    r7 = r8 − (W3+W5)*r7;
    /* second stage */
    r8 = r0 + r1;
    r0 −= r1;
    r1 = W6*(r3+r2);
    r2 = r1 − (W2+W6)*r2;
    r3 = r1 + (W2−W6)*r3;
    r1 = r4 + r6;
    r4 −= r6;
    r6 = r5 + r7;
    r5 −= r7;
    /* third stage */
    r7 = r8 + r3;
    r8 −= r3;
    r3 = r0 + r2;
    r0 −= r2;
    r2 = (181*(r4+r5)+128)>>8;
    r4 = (181*(r4−r5)+128)>>8;
    /* fourth stage */
    // _write16 does vertical packing on row element streams (columns)
    // to have horizontal packing on columns for the next configuration
    _write16(iram8, k, (r7+r1)>>8);
    _write16(iram9, k, (r3+r2)>>8);
    _write16(iram10, k, (r0+r4)>>8);
    _write16(iram11, k, (r8+r6)>>8);
    _write16(iram12, k, (r8−r6)>>8);
    _write16(iram13, k, (r0−r4)>>8);
    _write16(iram14, k, (r3−r2)>>8);
    _write16(iram15, k, (r7−r1)>>8);
  }
}
```

_XppCfg_idctcol

```
#define W1 2841 /* 2048*sqrt(2)*cos(1*pi/16) */
#define W2 2676 /* 2048*sqrt(2)*cos(2*pi/16) */
#define W3 2408 /* 2048*sqrt(2)*cos(3*pi/16) */
#define W5 1609 /* 2048*sqrt(2)*cos(5*pi/16) */
#define W6 1108 /* 2048*sqrt(2)*cos(6*pi/16) */
#define W7 565 /* 2048*sqrt(2)*cos(7*pi/16) */
/** _XppCfg_idctcol( )
* Does idct column calculation for 4 blocks
* XPPIN: iram0,2,4,6 contains 4 blocks (data duplication)
* XPPOUT: iram8-15 contains transposed calc. results
*/
void _XppCfg_idctcol( ) {
  // Input IRAMs in RAM Mode
  int iram0[128], iram2[128], iram4[128], iram6[128];
  // Output IRAMs in FIFO Mode
  int *iram8, *iram9, *iram10, *iram11, *iram12, *iram13, *iram14,
  *iram15;
  int c0, c1, c2, c3, c4, c5, c6, c7, c8;
  int c01, c23, c45, c67;
  // Counter offsets for parallel access
  int i0=0, i1=1, i2=2, i3=3;
  int k;
  for(k=0; k<32; k++) {
    // Data layout of input array is:
    // col0blk0, ..., col0blk3, col1blk0, ..., ..., col7blk3
    // (with 4 packed rows([0,1],[2,3],[4,5],[6,7]))
    // 0  3, ..., 12 15, 16  19, ..., ..., 124 127
    c01 = iram0[i0+=4]; // column element 0 and 1
    c23 = iram2[i1+=4]; // column element 2 and 3
    c45 = iram4[i2+=4]; // column element 4 and 5
    c67 = iram6[i3+=4]; // column element 6 and 7
    // Packed column elements have to be separated with _split16
    _split16(c01, c4, c0);
    _split16(c23, c7, c3);
    _split16(c45, c6, c1);
    _split16(c67, c5, c2);
    c1 = c1<<8;
    c0 = (c0<<8) + 8192;
    /* first stage */
    c8 = W7*(c4+c5) + 4;
    c4 = (c8+(W1−W7)*c4)>>3;
    c5 = (c8−(W1+W7)*c5)>>3;
    c8 = W3*(c6+c7) + 4;
    c6 = (c8−(W3−W5)*c6)>>3;
    c7 = (c8−(W3+W5)*c7)>>3;
    /* second stage */
    c8 = c0 + c1;
    c0 −= c1;
    c1 = W6*(c3+c2) + 4;
    c2 = (c1−(W2+W6)*c2)>>3;
    c3 = (c1+(W2−W6)*c3)>>3;
    c1 = c4 + c6;
    c4 −= c6;
    c6 = c5 + c7;
    c5 −= c7;
    /* third stage */
    c7 = c8 + c3;
    c8 −= c3;
    c3 = c0 + c2;
    c0 −= c2;
    c2 = (181*(c4+c5)+128)>>8;
    c4 = (181*(c4−c5)+128)>>8;
    /* fourth stage */
    // _write16 does vertical packing on column element streams
    // (blocks) to have horizontal packing on blocks for the next
    configuration
    _write16(iram8, k, (c7+c1)>>14);
    _write16(iram9, k, (c3+c2)>>14);
    _write16(iram10, k, (c0+c4)>>14);
    _write16(iram11, k, (c8+c6)>>14);
    _write16(iram12, k, (c8−c6)>>14);
    _write16(iram13, k, (c0−c4)>>14);
    _write16(iram14, k, (c3−c2)>>14);
    _write16(iram15, k, (c7−c1)>>14);
  }
}
```

_XppCfg_idctreorder

```
#define min(A,B)  (((A)>=(B))?(A):(B))
#define max(A,B)  (((A)>=(B))?(B):(A))
/** _XppCfg_idctreorder( )
* Saturates and restores original data layout
* XPPIN:  iram0,2,4,6 contains 4 blocks (data duplication)
* XPPOUT: iram8-15 contains transposed calc. results
*/
void _XppCfg_idctreorder( ) {
  // Input IRAMs in RAM Mode
  int iram0[128], iram2[128], iram4[128], iram6[128];
  // Output IRAMs in FIFO Mode
  int *iram8, *iram9, *iram10, *iram11, *iram12, *iram13, *iram14,
  *iram15;
  int b0l, b0h, b1l, b1h, b2l, b2h, b3l, b3h;
  int b01l, b01h, b23l, b23h;
  // Counter offsets for parallel access
  int i0=0, i1=0+64, i2=1, i3=1+64;
  int k;
  for(k=0; k<32; k++) {
    // Data layout of input array is:
    // row0col0, ..., row0col7, row1col0, ..., ..., row7col7
    // (with 2 packed blocks(0,1,2,3))
    // 0  1, ..., 14 15, 16  17, ..., ..., 124 127
    b01l = iram0[i0+=2]; // fetch lower half of block 0 and 1
    b01h = iram2[i1+=2]; // fetch upper half of block 0 and 1
    b23l = iram4[i2+=2]; // fetch lower half of block 2 and 3
    b23h = iram6[i3+=2]; // fetch upper half of block 2 and 3
    // Packed blocks have to be separated with _split16
    _split16(b01l, b1l, b0l);
    _split16(b01h, b1h, b0h);
    _split16(b23l, b3l, b2l);
    _split16(b23h, b3h, b2h);
    // _write16 does vertical packing on block streams to
    // have horizontal packing on rows as in the original data layout
    _write16(iram8, k, min(max(b0l,−256),255));
    _write16(iram9, k, min(max(b0h,−256),255));
    _write16(iram10, k, min(max(b1l,−256),255));
    _write16(iram11, k, min(max(b1h,−256),255));
    _write16(iram12, k, min(max(b2l,−256),255));
    _write16(iram13, k, min(max(b2h,−256),255));
    _write16(iram14, k, min(max(b3l,−256),255));
    _write16(iram15, k, min(max(b3h,−256),255));
  }
}
```

5.9.6 Performance Evaluation

To guarantee fair conditions for this example, we have to compare the total amounts of cycles the idct-algorithm executes on a fixed amount of data, once on the reference system, and once on the XPP-RISC combination. As determining cycle times of single configurations for execution on the RISC processor causes unrealistic bad results for execution on the reference system, we decided to compare on a total to total basis.

Data Transfer Times

The cycle times for data transfer are listed in the table below. It is assumed that there is no data in the cache before executing the idct algorithm.

| | | | | | | |
|---|---|---|---|---|---|---|
| | | Type size | Size | Cache | RAM-Cache | Cache-IRAM |
| Data | Data Size | [bytes] | [bytes] | Misses | [cache cycles] | [cache cycles] |

Preloads

| | | | | | | |
|---|---|---|---|---|---|---|
| Input data of idctrow | 128 | 4 | 512 | 16 | 896 | 32 |
| Input data of idctcol | 128 | 4 | 512 | 0 | 0 | 32 |
| Input data of idctreorder | 128 | 4 | 512 | 0 | 0 | 32 |
| Sum | | | | | 896 | 96 |

Writebacks

| | | | | | | |
|---|---|---|---|---|---|---|
| Output data of idctrow | 128 | 4 | 512 | 0 | 0 | 32 |
| Output data of idctcol | 128 | 4 | 512 | 0 | 0 | 32 |
| Output data of idctreorder | 128 | 4 | 512 | 1 | 568 | 32 |
| Sum | | | | | 568 | 96 |

Only the first preload causes a cache misses as all other configurations operate on the same data, and there is no need to load data from RAM. The same applies for the write-backs. As output data created by idctrow and idctcol are only temporary, and immediately consumed by the subsequent configurations, they are never written back to RAM. Only the final output created by idctreorder has to be written back to RAM.

Final Performance Results for the First Iteration

| | Data Access | | Configuration | | XPP Execute | | | Ref. System | | Speedup | | |
|---|---|---|---|---|---|---|---|---|---|---|---|---|
| configurations | RAM | DCache | RAM | ICache | Core | Cache | RAM | Cache | RAM | Core | Cache | RAM |
| idctrow | 896 | 32 | 10248 | 1461 | 660 | 1461 | 11144 | | | 0.0 | 0.0 | 0.0 |
| idctcol | 0 | 32 | 10640 | 1513 | 728 | 1513 | 10640 | | | 0.0 | 0.0 | 0.0 |
| idctreorder | 0 | 32 | 5040 | 714 | 156 | 714 | 5040 | | | 0.0 | 0.0 | 0.0 |
| all configurations | 896 | 96 | 25816 | 3688 | 1544 | 3688 | 26712 | 7860 | 8756 | 5.1 | 2.1 | 0.3 |

Final Performance Results for the Subsequent Iterations

| | Data Access | | Configuration | | XPP Execute | | | Ref. System | | Speedup | | |
|---|---|---|---|---|---|---|---|---|---|---|---|---|
| configurations | RAM | DCache | RAM | ICache | Core | Cache | RAM | Cache | RAM | Core | Cache | RAM |
| idctrow | 896 | 32 | | | 660 | 660 | 896 | | | 0.0 | 0.0 | 0.0 |
| idctcol | 0 | 32 | | | 728 | 728 | 728 | | | 0.0 | 0.0 | 0.0 |
| idctreorder | 0 | 32 | | | 156 | 156 | 156 | | | 0.0 | 0.0 | 0.0 |
| all configurations | 896 | 96 | 0 | 0 | 1544 | 1544 | 1544 | 7860 | 8756 | 5.1 | 5.1 | 5.7 |

5.10 Wavelet

5.10.1 Original Code

```
#define BLOCK_SIZE 16
#define COL 64
#define ROW 1
void forward_wavelet( )
{
  int i,nt, *dmid;
  int *sp, *dp, d_tmp0, d_tmp1, d_tmpi, s_tmp0, s_tmp1;
  int mid, ii;
  int *x;
  int s[256],d[256];
  for (nt=COL; nt >= BLOCK_SIZE; nt>>=1) {
    for (i=0; i < nt*COL; i+=COL) { /* column loop nest */
      x = &int_data[i];
      mid = (nt >> 1) − 1;
      s[0] = x[0];
      d[0] = x[ROW];
      s[1] = x[2];
      s[mid] = x[2*mid];
      d[mid] = x[2*mid+ROW];
      d[0] = (d[0] <<1 ) − s[0] − s[1];
      s[0] = s[0] + (d[0] >> 2);
      d_tmp0 = d[0];
      s_tmp0 = s[1];
      for(ii=1; ii < mid; ii++) {
        s_tmp1 = x[2*ii+2];
        d_tmp1 =((x[2*ii+ROW]) << 1) − s_tmp0 − s_tmp1;
        d[ii] = d_tmp1;
        s[ii] = s_tmp0 + ((d_tmp0 + d_tmp1)>>3);
        d_tmp0 = d_tmp1;
        s_tmp0 = s_tmp1;
      }
      d[mid] = (d[mid] − s[mid]) << 1;
      s[mid] = s[mid] + ((d[mid−1] + d[mid]) >> 3);
      for(ii=0; ii <= mid; ii++) {
        x[ii] = s[ii];
        x[ii+mid+1] = d[ii];
      }
    }
    for (i=0; i < nt; i++) { /* row loop nest */
      x = &int_data[i];
      mid = (nt >> 1) − 1;
      s[0] = x[0];
      d[0] = x[COL];
      s[1] = x[COL<<1];
      s[mid] = x[(COL<<1)*mid];
      d[mid] = x[(COL<<1)*mid+COL];
      d[0] = (d[0] << 1) − s[0] − s[1];
      s[0] = s[0] + (d[0] >> 2);
      d_tmp0 = d[0];
      s_tmp0 = s[1];
      for(ii=1; ii < mid; ii++) {
        s_tmp1 = x[2*COL*(ii+1)];
        d_tmp1 = (x[2*COL*ii+COL] << 1) − s_tmp0 − s_tmp1;
        d[ii] = d_tmp1;
        s[ii] = s_tmp0 + ((d_tmp0 + d_tmp1) >> 3);
        d_tmp0 = d_tmp1;
        s_tmp0 = s_tmp1;
      }
      d[mid] = (d[mid] << 1) − (s[mid] << 1);
      s[mid] = s[mid] + ((d[mid−1] + d[mid]) >> 3);
      for(ii=0; ii <= mid; ii++) {
        x[ii*COL] = s[ii];
        x[(ii+mid+1)*COL] = d[ii];
      }
    }
  }
}
```

The source code exhibits a loop nest depth of three. Level 1 is an outermost loop with induction variable nt. Level 2 consists of two inner loops with induction variable i, and level 3 is built by the four innermost loops with induction variable ii. The compiler notices by means of value range analysis, that nt will take on three values only (64, 32, and 16). As all inner loop nest iteration counts depend on the knowledge of the value of nt, the compiler will completely unroll the outermost loop, leaving us with six level 2 loop nests. As the unrolled source code is relatively voluminous we restrict the further presentation of code optimization to the case where nt takes the value 64. The two loops of level 2 of the original source code are highly symmetric, so we start the presentation with the first, or column loop nest, and handle differences to the second, or row loop nest, later.

5.10.2 Optimizing the Column Loop Nest

After pre-processing, application of copy propagation followed by dead code elimination over s_tmp1, d_tmp1, and constant propagation for nt (64) and mid (31) we obtain the following loop nest. For readability reasons we rename the unwieldy variable names s_tmp0 by s0, d_tmp0 by d0, and ii by the more common index j.

```
for (i=0; i < 64*64; i+=64) {
  x = &int_data[i];
  s[0] = x[0];
  d[0] = x[1];
  s[1] = x[2];
  s[31] = x[62];
  d[31] = x[63];
  d[0] = (d[0] << 1) − s[0] − s[1];
  s[0] = s[0] + (d[0] >> 2);
  d0 = d[0];
  s0 = s[1];
  for (j=1; j < 31; j++) {
    d[j] =((x[2*j+1]) << 1) − s0 − x[2*j+2];
    s[j] = s0 + ((d0 + d[j]) >> 3);
    d0 = d[j];
    s0 = s[j];
  }
  d[31] = (d[31] − s[31]) << 1;
  s[31] = s[31] + ((d[30] + d[31]) >> 3);
  for (j=0; j <= 31; j++) {
    x[j] = s[j];
    x[j+32] = d[j];
  }
}
```

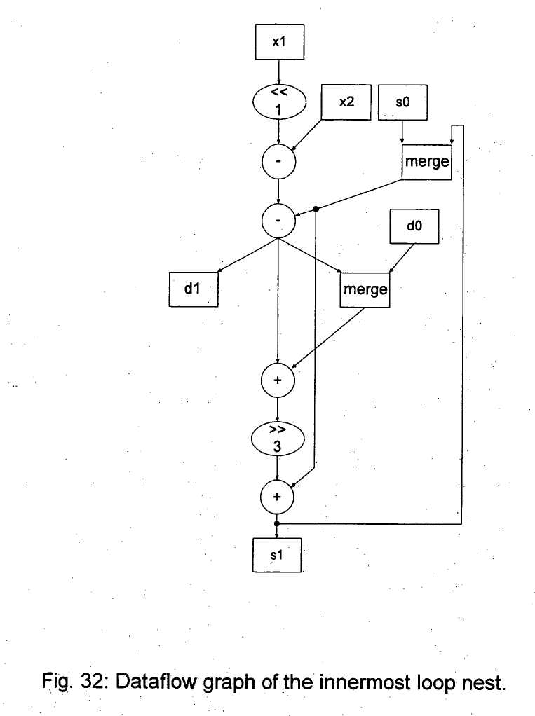

FIG. 32 shows the dataflow graph of the innermost loop nest.

From the dataflow, graph of the first innermost loop nest (induction variable j) the compiler computes an optimization table. In this stage of optimization it just counts computations and neglects the secondary effort necessary for IRAM address generation and signal merging. If there are different possibilities to perform an operation on the XPP in this initial stage, the compiler schedules ALU with highest priority. Inputs from or outputs to arrays with address differences of less than 128 words (IRAM size) are always counted as coming from the same IRAM. Hence the first innermost loop needs three input IRAMs (s0, d0, x[2*j+1] and x[2*j+2]) and two output IRAMs (s, d). The second innermost loop needs two input IRAMs (s, d) and one output IRAM (x[j] and x[j+32]).

| Parameter | Value |
|---|---|
| Vector length | 30 |
| Reused data set size | — |
| I/O IRAMs | 3I + 2O |
| ALU | 5 |
| BREG | 1 (shift right by three) |
| FREG | 0 |
| Dataflow graph width | 2 |
| Dataflow graph height | 6 |
| Configuration cycles | 5 * 30 + 2 |

The compiler recognizes from this table that the XPP core is by far not used to capacity by the first innermost loop. Data dependence analysis shows that the output values of the first innermost loop are the same as the input values for the second innermost loop. Finally the second innermost loop has nearly the same iteration count as the first one. So the compiler tries to merge the second innermost loop with the first one. However, data dependence analysis shows that the fusion of the two loops is not legal without further measures, as this introduces loop carried anti-dependences within the x array. During iteration j=1 of the second innermost loop for instance, x[33] of the original x array is overwritten, while during iteration j=16 of the first innermost loop the original value of x[33] must be available. The cache memory layout of the XPP, however, allows a neat and cheap solution to this problem. One cache memory area can be mapped to two different IRAMs, one for reading, and one for writing. As the IRAM filling from the cache is triggered by XppPreload commands, the read-only IRAM is filled once before the configuration is executed. It does not interfere with the values written to the write-only IRAM. Hence the dependence vanishes without any explicit array copying. For correctness of the transformed source code we introduce a temporary output array t and a (cost free) array copy loop after the merged innermost loops. As mentioned above the iteration counts of the two innermost loops are not equal. Hence peeling of the first as well as of the last iteration of the second loop is necessary. Data dependence analysis shows that the peeled code as well as the d[31] and s[31] assignments before the second loop can be moved after the second loop. Now the two loops are merged leaving us with the following code:

```
for (i=0; i < 64*64; i+=64) {
  int t[64];  // Temporary array built by output IRAM
  x = &int_data[i];
  s[0] = x[0];
  d[0] = x[1];
  s[1] = x[2];
  s[31] = x[62];
  d[31] = x[63];
  d[0] = (d[0] << 1) − s[0] − s[1];
  s[0] = s[0] + (d[0] >> 2);
  d0 = d[0];
  s0 = s[1];
  for (j=1; j < 31; j++) {
    d[j] =(x[2*j+1] << 1) − s0 − x[2*j+2];
    s[j] = s0 + ((d0 + d[j]) >> 3);
    d0 = d[j];
    s0 = s[j];
    t[j]  = s[j];
    t[j+32] = d[j];
  }
  // The following array copy code is implicitely
  // done by the cache controller.
  for (j=1; j < 31; j++) {
    x[j]  = t[j];
    x[j+32] = t[j+32];
  }
  d[31] = (d[31] − s[31]) << 1;
  s[31] = s[31] + ((d[30] + d[31]) >> 3);
  x[0] = s[0];
  x[32] = d[0];
  x[31] = s[31];
  x[63] = d[31];
}
```

Next the compiler tries to reduce IRAM usage. Data dependence analysis shows that the values of array s which are manipulated within the innermost loop are not used outside of the loop. d[30] is the only value which depends on values of array d calculated within the innermost loop. Thus the compiler replaces d[30] by t[62] outside of the loop. Now it is legal that array contraction replaces arrays s and d within the loop by scalars s1 and d1. A further IRAM reduction is done by using a common IRAM for the input scalars s0 and d0 (array sd). The tradeoff for this IRAM saving is a minor extra effort for the distribution of the two values to their dedicated PAE locations on the XPP. We arrive at:

```
for (i=0; i < 64*64; i+=64) {
  int t[64];  // Temporary array built by output IRAM
  x = &int_data[i];
  s[0] = x[0];
  d[0] = x[1];
  s[1] = x[2];
  s[31] = x[62];
  d[31] = x[63];
  d[0] = (d[0] << 1) − s[0] − s[1];
  s[0] = s[0] + (d[0] >> 2);
  d0 = d[0];
  s0 = s[1];
  // The following loop is executed on the XPP.
  for (j=1; j < 31; j++) {
    d1 =((x[2*j+1]) << 1) − s0 − x[2*j+2];
    s1 = s0 + ((d0 + d1) >> 3);
    d0 = d1;
    s0 = s1;
    x[j] = s1;
    x[j+32] = d1;
  }
  // The following array copy code is implicitely
  // done by the cache controller.
  for (j=1; j < 31; j++) {
    x[j] = t[j];
    x[j+32] = t[j+32];
  }
  d[31] = (d[31] − s[31]) << 1;
  s[31] = s[31] + ((t[62] + d[31]) >> 3);
  x[0] = s[0];
  x[32] = d[0];
  x[31] = s[31];
  x[63] = d[31];
}
```

with an optimization table

| Parameter | Value |
|---|---|
| Vector length | 30 |
| Reused data set size | — |
| I/O IRAMs | 2I + 1O |
| ALU | 5 |
| BREG | 1 |
| FREG | 0 |
| Dataflow graph width | 2 |
| Dataflow graph height | 6 |
| Configuration cycles | 5 * 30 + 2 |

The innermost loop does not exploit the XPP to capacity. So the compiler tries to unroll the innermost loop. For the computation of the unrolling degree it is necessary to have a more detailed estimate of the necessary computational units, i.e. the compiler estimates the address computation network for the IRAMs. Array x must provide two successive array elements within each loop iteration. This is done by an address counter starting with address 3 and closing with address 62 (1 FREG, 1 BREG). The IRAM data is then distributed to two different data paths by a demultiplexer (1 FREG) which toggles with every incoming data packet between the two output lines (1 FREG, 1 BREG). The same demultiplexer plus toggle network is necessary for the array sd. A merger (1 FREG, 1 BREG) is used to fetch the first data packet from s0 and all others from s1. A second one merges d0 and d1. Finally two counters (2 FREG, 2 BREG) compute the storage addresses, the first starting with address 1, and the second with address 33. The resulting data as well as the addresses are crossed by mergers which toggle between the two incoming packet streams (4 FREG, 2 BREG). This results in the following optimization table.

| Parameter | Value |
|---|---|
| Vector length | 30 |
| Reused data set size | — |
| I/O IRAMs | 2I + 1O |
| ALU | 5 |
| BREG | 10 |
| FREG | 13 |
| Dataflow graph width | 2 |
| Dataflow graph height | 6 |
| Configuration cycles | 5 * 30 + 2 |

The compiler computes from the maximum number of FREGs (80) and from the minimal number of FREGs per innermost loop (13) an unrolling degree equal to 6 (=80/13). On the other hand, the IRAM use per innermost loop is 3 compared to 16 available IRAMs. From this, the compiler computes an unrolling degree equal to 5 (=16/3). The second innermost loop (induction variable i) is executed 64 times. In order to avoid additional RISC code, the iteration count should be a multiple of the unrolling degree. This finally results in an unrolling degree of 4 and in the configuration source code listed below:

/** _XppCfg_wavelet64( )
* Performs four innermost loops of the wavelet transformation
* in parallel.

| | | |
|---|---|---|
| * XPPIN: | iram0 | s0_0, d0_0 |
| * | iram1 | 64 integers of the x array of iteration i |
| * | iram2 | s0_64, d0_64 |
| * | iram3 | 64 integers of the x array of iteration i+64 |
| * | iram4 | s0_128, d0_128 |
| * | iram5 | 64 integers of the x array of iteration i+128 |
| * | iram6 | s0_192, d0_192 |
| * | iram7 | 64 integers of the x array of iteration i+192 |
| * XPPOUT: | iram9 | 64 integers of the x array of iteration i |
| * | iram11 | 64 integers of the x array of iteration i+64 |
| * | iram13 | 64 integers of the x array of iteration i+128 |
| * | iram15 | 64 integers of the x array of iteration i+192 |
| */ | | |

```
void _XppCfg_wavelet64( )
{
  int iram0[128], iram2[128], iram4[128], iram6[128];
  int iram1[128], iram3[128], iram5[128], iram7[128];
  int iram9[128], iram11[128], iram13[128], iram15[128];
  int tmp_d0_0 = iram0[0];
  int tmp_s0_0 = iram0[1];
  int tmp_d0_64 = iram2[0];
  int tmp_s0_64 = iram2[1];
  int tmp_d0_128 = iram4[0];
  int tmp_s0_128 = iram4[1];
  int tmp_d0_192 = iram6[0];
  int tmp_s0_192 = iram6[1];
  for(j=1; j<31; j++) {
    int tmp_d1_0, tmp_d1_64, tmp_d1_128, tmp_d1_192;
    int tmp_s1_0, tmp_s1_64, tmp_s1_128, tmp_s1_192;
    tmp_d1_0= ((iram1[2*j+1]) << 1) − tmp_s0_0 − iram1[2*j+2];
    tmp_s1_0 = ((tmp_d0_0 + tmp_d1_0) >> 3) + tmp_s0_0;
    iram9[j] = tmp_s0_0 = tmp_s1_0;
    iram9[j+32] = tmp_d0_0 = tmp_d1_0;
    tmp_d1_64 = ((iram3[2*j+1]) << 1) − tmp_s0_64 − iram3[2*j+2];
    tmp_s1_64 = ((tmp_d0_64 + tmp_d1_64) >> 3) + tmp_s0_64;
    iram11[j] = tmp_s0_64 = tmp_s1_64;
    iram11[j+32] = tmp_d0_64 = tmp_d1_64;
    tmp_d1_128 = ((iram5[2*j+1]) << 1) − tmp_s0_128 −
    iram5[2*j+2];
    tmp_s1_128 = ((tmp_d0_128 + tmp_d1_128) >> 3) +
    tmp_s0_128;
    iram13[j] = tmp_s0_128 = tmp_s1_128;
    iram13[j+32] = tmp_d0_128 = tmp_d1_128;
    tmp_d1_192 = ((iram7[2*j+1]) << 1) − tmp_s0_192 −
    iram7[2*j+2];
    tmp_s1_192 = ((tmp_d0_192 + tmp_d1_192) >> 3) +
    tmp_s0_192;
    iram15[j] = tmp_s0_192 = tmp_s1_192;
    iram15[j+32] = tmp_d0_192 = tmp_d1_192;
  }
}
```

Two similar configurations handle the cases where nt=32 and nt=16. They are not shown here as they differ only in the number of loop iterations (15, and 7, respectively).

At this point some remarks about the further translation of the configuration code to NML code are useful. The necessary operational elements and connections are defined by the dataflow graph of FIG. 32. But this definition is incomplete. It does neither include which element to place in which cell of the XPP array (placing), nor does it allow an ad hoc decision which operation to execute in which computational unit. It is, for instance, possible to perform a subtraction in an ALU or in a BREG. These decisions are very delicate, as they highly influence the performance of the generated XPP code. In the current example the following strategy is applied. The first thing to notice is the cycle in the dataflow graph. It defines a critical path as it decides how many XPP cycles are at least necessary to provide a new output value. Counting along the dataflow cycle we find five operational elements from one s1 value to the next: merge, subtract, add1, shift right by 3, and add2. The worst case assumption is that every operational element takes one XPP cycle. This explains the 5*30+2 configuration cycles in the optimization tables. The XPP provides BREG elements which can be used to operate without a delay. The starting point is the shift right by 3. This operation can be done in a BREG only. We define the NOREG property here (0 XPP cycles). Both neighboring additions are chosen as ALU operations (2 XPP cycles). The subtraction is done in a BREG with NOREG property (0 XPP cycles), and the merge is only possible as FREG (1 XPP cycle). Hence we obtain a minimum of three XPP cycles per s1 value. But this result holds only if all operational elements of the cycle can be placed within one line of the XPP array, and within a bus section free of switch objects of the horizontal XPP buses. Hence the compiler must definitely choose the placement of this critical code section. Otherwise a severe deterioration of the performance is inevitable.

5.10.3 Optimizing the Row Loop Nest

The optimization of the row loop nest starts along the same lines as the column loop nest. After pre-processing, application of copy propagation followed by dead code elimination over s_tmp1, d_tmp1, and constant propagation for nt (64) and mid (31) the compiler peels off the first and last iteration of the second innermost loop, and moves the assignments between the two innermost loops after the second one.

```
for (i=0; i < 64; i++) {
  x = &int_data[i];
  s[0] = x[0];
  d[0] = x[64];
  s[1] = x[64*2];
  s[31] = x[64*62];
  d[31] = x[64*63];
  d[0] = (d[0] << 1) − s[0] − s[1];
  s[0] = s[0] + (d[0] >> 2);
  d0 = d[0];
  s0 = s[1];
  for (j=1; j < 31; j++) {
    d[j] =((x[64*(2*j+1)]) << 1) − s0 − x[64*(2*j+2)];
    s[j] = s0 + ((d0 + d1) >> 3);
    d0 = d[j];
    s0 = s[j];
  }
  for (j=1; j < 31; j++) {
    x[64*j] = s[j];
    x[64*(j+32)] = d[j];
  }
  d[31] = (d[31] << 1) − (s[31] << 1);
  s[31] = s[31] + ((x[64*62] + d[31]) >> 3);
  x[0] = s[0];
  x[32] = d[0];
  x[64*31] = s[31];
  x[64*63] = d[31];
}
```

Data dependence analysis computes an iteration distance of 64 for array x within the first innermost loop. As an IRAM can store at most 128 integers we run out of memory after the first iteration of the innermost loop. Hence the compiler reorders the data to a new array y before the first innermost loop. A similar problem arises with the second innermost loop, where the compiler also introduces array y. The new array y suffers from the same array anti-dependences like array x in the previous section. The loop fusion preventing anti-dependence is overcome by the introduction of a temporary array t which guarantees correctness of the transformed source code.

| for (i=0; i < 64; i++) { | |
|---|---|
| int y[64], t[64]; | |
| x = &int_data[i]; | |
| s[0] = x[0]; | |
| d[0] = x[64]; | |
| s[1] = x[64*2]; | |
| s[31] = x[64*62]; | |
| d[31] = x[64*63]; | |
| d[0] = (d[0] << 1) − s[0] − s[1]; | |
| s[0] = s[0] + (d[0] >> 2); | |
| d0 = d[0]; | |
| s0 = s[1]; | |
| // Column to row transfer. | |
| for (j=1; j < 31; j++) { | |
| y[2*j+1] = x[64*(2*j+1)]; | |
| y[2*j+2] = x[64*(2*j+2)]; | |
| } | |
| // The following loop is executed on the XPP. | |
| for (j=1; j < 31; j++) { | |
| d[j] =((y[2*j+1]) << 1) − s0 − y[2*j+2]; | |
| s[j] = s0 + ((d0 + d1) >> 3); | |
| d0 = d[j]; | |
| s0 = s[j]; | |
| t[j] | = s[j]; |
| t[j+32] | = d[j]; |
| } | |
| // The following array copy code is implicitely | |
| // done by the cache controller. | |
| for (j=1; j < 31; j++) { | |
| y[j] | = t[j]; |
| y[j+32] | = t[j+32]; |

| } | |
|---|---|
| // Row to column transfer. | |
| for (j=1; j < 31; j++) { | |
| x[64*j] | = y[j]; |
| x[64*(j+32)] | = y[j+32]; |

```
  }
  d[31] = (d[31] << 1) − (s[31] << 1);
  s[31] = s[31] + ((x[64*62] + d[31]) >> 3);
  x[0] = s[0];
  x[32] = d[0];
  x[64*31] = s[31];
  x[64*31] = d[31];
}
```

After loop fusion the second innermost loop looks exactly like the loop handled in the previous section and can thus use the same XPP configuration. The two surrounding reordering loops actually perform a transposition of a column vector to a row vector and are most efficiently executed on the RISC.

5.10.4 Final Code

The outermost loop is completely unrolled which produces six inner loop nests (induction variable i). Each of these inner loops is unrolled four times with the wavelet XPP configuration in the center. The unrolling of the inner loops requires a bundle of new local variables whose names are suffixed by the original iteration numbers. Array variables with constant array indices are replaced by scalar variables for readability reasons. s[0], for instance, becomes s0_{—}0, s0_{—}64, s0_{—}128, s0_{—}192.

One further loop transformation is necessary to facilitate the work of the cache controller. When the wavelet configuration finishes, a computation result in array x of each iteration i is used in the succeeding RISC code. Hence an XppSync operation is necessary after each XppExecute which, forces a write-back of the IRAM contents to the first level cache. The RISC must wait until the write-back finishes. However, if the compiler splits the loop after XppExecute, it is possible to prepare the RISC data for the next configuration during the write-back operation of the cache controller (pipelining effect). The cost for the loop distribution is the expansion of some scalar variables, i.e. all scalars which are computed before and used after XppExecute must be expanded to array variables. Hence variable s0_{—}0, for instance, becomes s0_{—}0[16].

Loop distribution is applicable for both, the column as well as the row loop nest. However, in the case of the row loop nest this requires an array for each vector element of y, i.e. y actually becomes a matrix. In order to reduce the memory demand the compiler does no complete loop distribution, it rather executes the two loops shifted by a memory requirement factor. This loop optimization is called shifted loop merging (or shifted loop fusion) [7]. The memory requirement factor is chosen to a value of four as the architecture provides three IRAM shadows.

As the final Code is voluminous because of successive loop unrolling we present the optimized RISC code for nt=64 only.

void forward_wavelet( )
{
int i, j, k;

| | | |
|---|---|---|
| int s0_0[4], | s31_0[4], | s1_0; |
| int s0_64[4], | s31_64[4], | s1_64; |
| int s0_128[4], | s31_128[4], | s1_128; |
| int s0_192[4], | s31_192[4], | s1_192; |
| int d0_0[4], | d31_0[4]; | |
| int d0_64[4], | d31_64[4]; | |
| int d0_128[4], | d31_128[4]; | |
| int d0_192[4], | d31_192[4]; | |

```
  int sd_0[2], sd_64[2], sd_128[2], sd_192[2];
  int y_0[64][4], y_64[64][4], y_128[64][4], y_192[64][4];
  for (i=0; i < 16*256; i+=256) { /* nt=64, column loop */
    if (i < 16*256) { /* XppPreload and XppExecute */
      XppPreloadConfig(_{——}XppCfg_wavelet64);
      k = (i / 256) % 4;
      x = &int_data[i];
```

| | |
|---|---|
| s0_0[k] | = x[0]; |
| d0_0[k] | = x[1]; |
| s1_0 | = x[2]; |
| s31_0[k] | = x[62]; |
| d31_0[k] | = x[63]; |

```
      sd_0[0] = d0_0[k] = (d0_0[k] << 1) − s0_0[k] − s1_0;
      sd_0[1] = s0_0[k] = (d0_0[k] >> 2) + s0_0[k];
```

| | | | |
|---|---|---|---|
| XppPreload | (0, | sd_0, | 2); |
| XppPreload | (1, | x, | 64); |
| XppPreloadClean | (9, | x, | 64); |

x = &int_data[i+64];

| | |
|---|---|
| s0_64[k] | = x[0]; |
| d0_64[k] | = x[1]; |
| s1_64 | = x[2]; |
| s31_64[k] | = x[62]; |
| d31_64[k] | = x[63]; |

```
      sd_64[0] = d0_64[k] = (d0_64[k] << 1) − s0_64[k] − s1_64;
      sd_64[1] = s0_64[k] = (d0_64[k] >> 2) + s0_64[k];
```

| | | | |
|---|---|---|---|
| XppPreload | (2, | sd_64, | 2); |
| XppPreload | (3, | x, | 64); |
| XppPreloadClean | (11, | x, | 64); |

x = &int_data[i+128];

| | |
|---|---|
| s0_128[k] | = x[0]; |
| d0_128[k] | = x[1]; |
| s1_128 | = x[2]; |
| s31_128[k] | = x[62]; |
| d31_128[k] | = x[63]; |

```
      sd_128[0] = d0_128[k] = (d0_128[k] << 1) − s0_128[k] − s1_128;
      sd_128[1] = s0_128[k] = (d0_128[k] >> 2) + s0_128[k];
```

| | | | |
|---|---|---|---|
| XppPreload | (4, | sd_128, | 2); |
| XppPreload | (5, | x, | 64); |
| XppPreloadClean | (13, | x, | 64); |

x = &int_data[i+192];

| | |
|---|---|
| s0_192[k] | = x[0]; |
| d0_192[k] | = x[1]; |
| s1_192 | = x[2]; |
| s31_192[k] | = x[62]; |
| d31_192[k] | = x[63]; |

```
      sd_192[0] = d0_192[k] = (d0_192[k] << 1) − s0_192[k] − s1_192;
      sd_192[1] = s0_192[k] = (d0_192[k] >> 2) + s0_192[k];
```

| | | | |
|---|---|---|---|
| XppPreload | (6, | sd_192, | 2); |
| XppPreload | (7, | x, | 64); |
| XppPreloadClean | (15, | x, | 64); |

```
      XppExecute( );
    } /* i < 16*256 */
    if (i >= 4*256) { /* delayed XppSync */
      k = (i − 4*256) % 4;
      x = &int_data[i−4*256];
      Xppsync(x, 64);
```

| | |
|---|---|
| d31_0[k] | = (d31_0[k] − s31_0[k]) << 1; |
| s31_0[k] | = s31_0[k] + ((x[62] + d31_0[k]) >> 3); |
| x[0] | = s0_0[k]; |
| x[32] | = d0_0[k]; |
| x[31] | = s31_0[k]; |
| x[63] | = d31_0[k]; |

```
      x = &int_data[i−4*256+64];
      XppSync(x, 64);
```

| | |
|---|---|
| d31_64[k] | = (d31_64[k] − s31_64[k]) << 1; |
| s31_64[k] | = s31_64[k] + ((x[62] + d31_64[k]) >> 3); |
| x[0] | = s0_64[k]; |
| x[32] | = d0_64[k]; |
| x[31] | = s31_64[k]; |
| x[63] | = d31_64[k]; |

```
      x = &int_data[i−4*256+128];
      XppSync(x, 64);
```

| | |
|---|---|
| d31_128[k] | = (d31_128[k] − s31_182[k]) << 1; |
| s31_128[k] | = s31_128[k] + ((x[62] + d31_128[k]) >> 3); |
| x[0] | = s0_128[k]; |
| x[32] | = d0_128[k]; |
| x[31] | = s31_128[k]; |
| x[63] | = d31_128[k]; |

```
      x = &int_data[i−4*256+192];
      XppSync(x, 64);
```

| | |
|---|---|
| d31_192[k] | = (d31_192[k] − s31_192[k]) << 1; |
| s31_192[k] | = s31_192[k] + ((x[62] + d31_192[k]) >> 3); |
| x[0] | = s0_192[k]; |
| x[32] | = d0_192[k]; |
| x[31] | = s31_192[k]; |
| x[63] | = d31_192[k]; |

```
    } /* i >= 4*256 */
  }
  for (i=0; i < 64+16; i+=4) { /* nt=64, row loop */
    if (i < 64) { /* XppPreload and XppExecute */
      XppPreloadConfig(_{——}XppCfg_{——}wavelet64);
      k = (i / 4) % 4;
      x = &int_data[i];
```

| | |
|---|---|
| s0_0[k] | = x[0]; |
| d0_0[k] | = x[64]; |
| s1_0 | = x[128]; |
| s31_0[k] | = x[3968]; |
| d31_0[k] | = x[4032]; |

| | |
|---|---|
| sd_0[0] | = d0_0[k%4] = (d0_0[k] << 1) − s0_0[k] − s1_0; |
| sd_0[1] | = s0_0[k] = (d0_0[k] >> 2) + s0_0[k]; |

```
      for (j=1; j < 31; j++) {
        y_0[2*j+1][k] = x[64+128*j];
        y_0[2*j+2][k] = x[128+128*j];
      }
```

| | | | |
|---|---|---|---|
| XppPreload | (0, | sd_0, | 2); |

| | | | |
|---|---|---|---|
| XppPreload | (1, | y_0[k], | 64); |
| XppPreloadClean | (9, | y_0[k], | 64); |

x = &int_data[i+1];

| | |
|---|---|
| s0_64[k] | = x[0]; |
| d0_64[k] | = x[64]; |
| s1_64 | = x[128]; |
| s31_64[k] | = x[3968]; |
| d31_64[k] | = x[4032]; |

| | |
|---|---|
| sd_64[0] | = d0_64[k] = (d0_64[k] << 1) − s0_64[k] − s1_64; |
| sd_64[1] | = s0_64[k] = (d0_64[k] >> 2) + s0_64[k]; |

```
      for (j=1; j < 31; j++) {
        y_64[2*j+1][k] = x[64+128*j];
        y_64[2*j+2][k] = x[128+128*j];
      }
```

| | | | |
|---|---|---|---|
| XppPreload | (2, | sd_64, | 2); |

| | | | |
|---|---|---|---|
| XppPreload | (3, | y_64[k], | 64); |
| XppPreloadClean | (11, | y_64[k], | 64); |

x = &int_data[i+2];

| | |
|---|---|
| s0_128[k] | = x[0]; |
| d0_128[k] | = x[64]; |
| s1_128 | = x[128]; |
| s31_128[k] | = x[3968]; |
| d31_128[k] | = x[4032]; |

| | |
|---|---|
| sd_128[0] | = d0_128[k] = (d0_128[k] << 1) − s0_128[k] − s1_128; |
| sd_128[1] | = s0_128[k] = (d0_128[k] >> 2) + s0_128[k]; |

```
      for (j=1; j < 31; j++) {
        y_128[2*j+1][k] = x[64+128*j];
        y_128[2*j+2][k] = x[128+128*j];
      }
```

| | | | |
|---|---|---|---|
| XppPreload | (4, | sd_128, | 2); |

| | | | |
|---|---|---|---|
| XppPreload | (5, | y_128[k], | 64); |
| XppPreloadClean | (13, | y_128[k], | 64); |

x = &int_data[i+3];

| | |
|---|---|
| s0_192[k] | = x[0]; |
| d0_192[k] | = x[64]; |
| s1_192 | = x[128]; |
| s31_192[k] | = x[3968]; |
| d31_192[k] | = x[4032]; |

| | |
|---|---|
| sd_192[0] | = d0_192[k] = (d0_192[k] << 1) − s0_192[k] − s1_192; |
| sd_192[1] | = s0_192[k] = (d0_192[k] >> 2) + s0_192[k]; |

```
      for (j=1; j < 31; j++) {
        y_192[2*j+1][k] = x[64+128*j];
        y_192[2*j+2][k] = x[128+128*j];
      }
```

| | | | |
|---|---|---|---|
| XppPreload | (6, | sd_192, | 2); |
| XppPreload | (7, | y_192, | 64); |
| XppPreloadClean | (15, | y_192, | 64); |

```
      XppExecute( );
    } /* i < 64 */
    if (i >= 16) { /* delayed XppSync */
      k = (i − 16) % 4;
      x = &int_data[i−16];
      XppSync(y_0[k], 64);
      for (j=1; j < 31; j++) {
```

| | |
|---|---|
| x[64*j] | = y_0[j][k]; |
| x[2048+64*j] | = y_0[j+32][k]; |

}

| | |
|---|---|
| d31_0[k] | = (d31_0[k] << 1) − (s31_0[k] << 1); |
| s31_0[k] | = s31_0[k] + ((x[3968] + d31_0[k]) >> 3); |
| x[0] | = s0_0[k]; |
| x[2048] | = d0_0[k]; |
| x[1984] | = s31_0[k]; |
| x[4032] | = d31_0[k]; |

```
      x = &int_data[i−16+1];
      XppSync(y_64[k], 64);
      for (j=1; j < 31; j++) {
```

| | |
|---|---|
| x[64*j] | = y_64[j][k]; |
| x[2048+64*j] | = y_64[j+32][k]; |
| } | |

| | |
|---|---|
| d31_64[k] | = (d31_64[k] << 1) − (s31_64[k] << 1); |
| s31_64[k] | = s31_64[k] + ((x[3968] + d31_64[k]) >> 3); |
| x[0] | = s0_64[k]; |
| x[2048] | = d0_64[k]; |
| x[1984] | = s31_64[k]; |
| x[4032] | = d31_64[k]; |

```
      x = &int_data[i−16+2];
      XppSync(y_128[k], 64);
      for (j=1; j < 31; j++) {
```

| | |
|---|---|
| x[64*j] | = y_128[j][k]; |
| x[2048+64*j] | = y_128[j+32][k]; |

}

| | |
|---|---|
| d31_128[k] | = (d31_128[k] << 1) − (s31_128[k] << 1); |
| s31_128[k] | = s31_128[k] + ((x[3968] + d31_128[k]) >> 3); |
| x[0] | = s0_128[k]; |
| x[2048] | = d0_128[k]; |
| x[1984] | = s31_128[k]; |
| x[4032] | = d31_128[k]; |

```
      x = &int_data[i−16+3];
      XppSync(y_192[k], 64);
      for (j=1; j < 31; j++) {
```

| | |
|---|---|
| x[64*j] | = y_192[j][k]; |
| x[2048+64*j] | = y_192[j+32][k]; |

}

| | |
|---|---|
| d31_192[k] | = (d31_192[k] << 1) − (s31_192[k] << 1); |
| s31_192[k] | = s31_192[k] + ((x[3968] + d31_192[k]) >> 3); |
| x[0] | = s0_192[k]; |
| x[2048] | = d0_192[k]; |
| x[1984] | = s31_192[k]; |
| x[4032] | = d31_192[k]; |

```
    } /* i >= 16 */
  }
  /* nt=32, column loop */
  ...
  /* nt=32, row loop */
  ...
  /* nt=16, column loop */
  ...
  /* nt=16, row loop */
  ...
}
```

5.10.5 Performance Evaluation

The performance evaluation of this example is based on the assumption that the code optimizations done for the XPP are also useful for the reference processor. Hence we compare the code executed within each configuration only. But this argumentation is not entirely correct for the current example, as the compiler applied a column to row transposition (and vice versa) for the row loop nest because of the restricted IRAM size. This optimization is not meaningful for the reference processor. This is why we correct the reference system performance values by subtracting the cycles necessary for the transposition.

The data transfer performance for the configuration _XppCfg_wavelet64 as part of the column loop nest is listed in the following table. It is assumed that there is no data in the cache (startup case).

| | | | | |
|---|---|---|---|---|
| | Size | Cache | RAM - Cache | Cache - IRAM |
| Data | [bytes] | Misses | [cache cycles] | [cache cycles] |

Preloads

| | | | | |
|---|---|---|---|---|
| sd_0 | 8 | 1 | 56 | 1 |
| int_data | 256 | 8 | 448 | 16 |
| sd_64 | 8 | 1 | 56 | 1 |
| int_data + 64 | 256 | 8 | 448 | 16 |
| sd_128 | 8 | 1 | 56 | 1 |
| int_data + 128 | 256 | 8 | 448 | 16 |
| sd_0 | 8 | 1 | 56 | 1 |
| int_data + 192 | 256 | 8 | 448 | 16 |
| Sum | | | 2016 | 68 |

Writebacks

| | | | | |
|---|---|---|---|---|
| int_data | 256 | 0 | 256 | 16 |
| int_data + 64 | 256 | 0 | 256 | 16 |
| int_data + 128 | 256 | 0 | 256 | 16 |
| int_data + 192 | 256 | 0 | 256 | 16 |
| Sum | | | 1024 | 64 |

The write-back of array in_data causes no cache miss, because the relevant array sector is already in the cache (loaded by the corresponding preload operations). Therefore the write-back does not include cycles for write allocation. In row Sum the total number of cycles for the first execution of the whole _XppCfg_wavelet64 configurations is given.

This configuration is invoked 16 times on different sectors of array int_data. Hence the cache miss situation for array int_data is identical in each iteration. No cache miss, however, is produced by accesses to the arrays sd as these are already in the cache. After the 16 iterations the whole array int_data is loaded into the first level cache. The following table summarizes the data transfer cycles for the remaining 15 iterations (steady state case).

| | | |
|---|---|---|
| | RAM-Cache | Cache-IRAM |
| Data | [cache cycles] | [cache cycles] |

Preloads

| | | |
|---|---|---|
| Sum | 1792 | 68 |

Writebacks

| | | |
|---|---|---|
| Sum | 1024 | 64 |

The configurations _XppCfg_wavelet32 and _XppCfg_wavelet16 as part of the column loop access the same arrays but with smaller data sizes. Hence there is no cache miss at all. The following tables summarize the data transfer cycles for the _XppCfg_wavelet32 and _XppCfg_wavelet16 configurations as part of the column loop nest (startup case=steady state case).

| | | |
|---|---|---|
| | RAM-Cache | Cache-IRAM |
| Data | [cache cycles] | [cache cycles] |

Preloads

| | | |
|---|---|---|
| Sum | 0 | 36 |

Writebacks

| | | |
|---|---|---|
| Sum | 512 | 32 |

Preloads

| | | |
|---|---|---|
| Sum | 0 | 20 |

Writebacks

| | | |
|---|---|---|
| Sum | 256 | 16 |

The data transfer, performance for, configuration _XppCfg_wavelet64 as part of the row loop nest is listed in the following table (startup case).

| | | | | |
|---|---|---|---|---|
| | Size | Cache | RAM-Cache | Cache-IRAM |
| Data | [bytes] | Misses | [cache cycles] | [cache cycles] |

Preloads

| | | | | |
|---|---|---|---|---|
| sd_0 | 8 | 0 | 0 | 1 |
| y_0[k] | 256 | 8 | 448 | 16 |
| sd_64 | 8 | 0 | 0 | 1 |
| y_64[k] | 256 | 8 | 448 | 16 |
| sd_128 | 8 | 0 | 0 | 1 |
| y_128[k] | 256 | 8 | 448 | 16 |
| sd_0 | 8 | 0 | 0 | 1 |
| y_192[k] | 256 | 8 | 448 | 16 |
| Sum | | | 1792 | 68 |

Writebacks

| | | | | |
|---|---|---|---|---|
| y_0[k] | 256 | 0 | 256 | 16 |
| y_64[k] | 256 | 0 | 256 | 16 |
| y_128[k] | 256 | 0 | 256 | 16 |
| y_192[k] | 256 | 0 | 256 | 16 |
| Sum | | | 1024 | 64 |

Here the situation is a bit more complicated. The table is valid for the first four iterations as k loops from zero to three which produce cache misses for the y arrays. After 4 iterations all y arrays are in the cache and no further cache miss occurs. Hence the nest table shows the cycles for iterations 5 to 16 (steady state case).

| | | |
|---|---|---|
| | RAM-Cache | Cache-IRAM |
| Data | [cache cycles] | [cache cycles] |

Preloads

| | | |
|---|---|---|
| Sum | 0 | 68 |

Writebacks

| | | |
|---|---|---|
| Sum | 1024 | 64 |

The configurations _XppCfg_wavelet32 and _XppCfg_wavelet16 as part of the row loop nest have the same data transfer performance as if they were used as part of the column loop nest. Again, this is due to the fact, that no cache miss occurs.

The base for the comparison are the hand-written NML source codes wavelet64.nml, wavelet32.nml and wavelet16.nml which implement the configurations _XppCfg_wavelet64, _XppCfg_wavelet32 and _XppCfg_wavelet16, respectively. Note, that these configurations are completely placed by hand in order to obtain a clearly arranged cell structure for debugging reasons. It is, however, possible to automatically place most modules without a significant decrease in performance. The only exception is the LOOP module the contents of which must be definitely placed by the compiler (see section 5.10.2).

The following two performance tables present the overall results. The first table shows the startup case where neither data nor configurations are preloaded in the cache. As configuration loading is extremely expensive it dominates all figures and guarantees a poor performance. The second table presents the steady state case after a (theoretically) infinite number of iterations. Now a data preload followed by a write-back are done during the execution of a configuration. However, we constantly work at new sections of array int_data. This is why we have a steady load from RAM to the cache and a write from the cache to RAM. This memory bottleneck degrades the overall performance to a factor of 1,6. On the assumption that array int_data is handled several times by the forward_wavelet function, the whole data remains in the cache and the performance increases to the considerable factor of 3,9. The example demonstrates that only loop bodies with a considerable amount of computations promise a considerable performance gain. Pure data shuffling applications suffer with the XPP from the same memory limitations as the RISC host processor.

| | Data Access | | Configuration | | XPP Execute | | | Ref. System | | Speedup | | |
|---|---|---|---|---|---|---|---|---|---|---|---|---|
| configurations | RAM | DCache | RAM | ICache | Core | Cache | RAM | Cache | RAM | Core | Cache | RAM |
| wavelet64 (column nest) | 2016 | 68 | 7728 | 1100 | 212 | 1100 | 9744 | 1020 | 3036 | 4.8 | 0.9 | 0.3 |
| wavelet64 (row nest) | 1792 | 68 | 0 | 0 | 212 | 212 | 1792 | 804 | 2596 | 3.8 | 3.8 | 1.4 |
| wavelet32 (column nest) | 0 | 36 | 7728 | 1100 | 116 | 1100 | 7728 | 492 | 492 | 4.2 | 0.4 | 0.1 |
| wavelet32 (row nest) | 0 | 36 | 0 | 0 | 116 | 116 | 116 | 388 | 388 | 3.3 | 3.3 | 3.3 |
| wavelet16 (column nest) | 0 | 20 | 7728 | 1100 | 68 | 1100 | 7728 | 228 | 228 | 3.4 | 0.2 | 0.0 |
| wavelet16 (row nest) | 0 | 20 | 0 | 0 | 68 | 68 | 68 | 180 | 180 | 2.6 | 2.6 | 2.6 |
| all configurations | 3808 | 248 | 23128 | 3300 | 792 | 3300 | 26936 | 3112 | 6920 | 3.9 | 0.9 | 0.3 |
| wavelet64 (column nest) | 2816 | 68 | | | 212 | 212 | 2816 | 1020 | 3836 | 4.8 | 4.8 | 1.4 |
| wavelet64 (row nest) | 1024 | 68 | | | 212 | 212 | 1024 | 804 | 1828 | 3.8 | 3.8 | 1.8 |
| wavelet32 (column nest) | 512 | 36 | | | 116 | 116 | 512 | 492 | 1004 | 4.2 | 4.2 | 2.0 |
| wavelet32 (row nest) | 512 | 36 | | | 116 | 116 | 512 | 388 | 900 | 3.3 | 3.3 | 1.8 |
| wavelet16 (column nest) | 256 | 20 | | | 68 | 68 | 256 | 228 | 484 | 3.4 | 3.4 | 1.9 |
| wavelet16 (row nest) | 256 | 20 | | | 68 | 68 | 256 | 180 | 436 | 2.6 | 2.6 | 1.7 |
| all configurations | 5376 | 248 | | | 792 | 792 | 5376 | 3112 | 8488 | 3.9 | 3.9 | 1.6 |

The utilization of the _XppCfg_wavelet configurations shows that the XPP capacity is mostly used for memory (wavelet64.nml, wavelet32.nml, wavelet16.nml). The information is taken from the ‘.info’ files generated from the NML source code by the GAP tool.

| Parameter | Value |
|---|---|
| Vector length | 30 (14, 6) 32-bit values |
| Reused data set size | — |
| I/O IRAMs [sum-pct] | 12-75% |
| ALU[sum-pct] | 12-19% |
| BREG [def/route/sum-pct] | 37/5/42-66% |
| FREG [def/route/sum-pct] | 40/2/42-66% |

5.11 Conclusion

The theoretical results did not scale well to real world results. The biggest single performance loss was experienced during placement and routing. This on one hand demonstrates the potential of the architecture, but on the other hand also shows current limitations of the architecture as well as of the tools.

The following proposals may help to narrow the gap between theoretical and practical performance:

5.11.1 RAM Bus Width

A bus width of more than 32 bits is more apted for such a highly parallel architecture.

5.11.2 Use of the Cache Instead of Separate IRAMs

As the utilization of the shadow IRAMs is less than the utilization of the cache, the second design without dedicated IRAM memory is more silicon efficient, also eliminating the cache-IRAM transfer cycles.

5.11.3 Configuration Size

The configuration bus is narrow compared to the average configuration size. The same is true for the instruction cache. The replicated structure of the array allows for a highly parallel reconfiguration bus from the instruction cache. A 128 bit bus can be split into eight 16 bit configuration busses to each line of the array.

5.11.4 ALU/FREG/BREG Orthogonality

The NOREG feature is limited to BREGs. Only one. BREG in a sequence can be in unregistered mode. This way it is possible to save cycles in a backend post optimization, if the BREGs can be set to unregistered mode. The number of saved cycles depends on the type and order of operations. This feature is unorthogonal and makes it hard for the compiler to estimate the actual number of cycles needed.

The current specialization of the forward and backward units together with the delays on the busses interacts in a bad way with placement and routing: The type and sequence of the operations determines the direction of the computational flow:

If FREGs and BREGs can be used alternatingly, the computation propagates values along the line of the PAE array. All BREGs can be set to unregistered mode, saving half of the cycles.

If FREGs and ALUs are used in line the computational flow either follows the column downward or the line in the array. For the latter mode, NOREG BREGs, must be used.

If only BREGs are needed sequentially, the computational flow follows the column in upward direction. As at least every second BREG in line must be in registered mode, half of the cycles can be saved.

If a PAE consists of a forward ALU, a forward REG, a backward ALU and a backward REG, this orthogonality would have positive effects on the freedom of placement and routing.

5.11.5 Placement and Routing Improvements

If placement and routing of the critical path is done first, followed by the placement and routing of the less critical components, less registers will be inserted into the critical path by the router. In general, several different heuristics should be used in placement and routing.

Feedback from the placement and routing tool to the compiler can help avoid the added registers in the critical path.

NML currently does not cover specification of the bus switch elements. There is no way to control the register property of the switches. Control of this feature enables efficient control of bus delays with feedback directed compilation.

### 6 REFERENCES

[1] Markus Weinhardt and Wayne Luk. Memory Access Optimization for Reconfigurable Systems. IEEE Proceedings Computers and Digital Techniques, 48(3), May 2001.
[2] Michael Wolfe. High Performance Compilers for Parallel Computing. Addison-Wesley, 1996.
[3] Hans Zima and Barbara Chapman. Supercompilers for parallel and vector computers. Addison-Wesley, 1991.
[4] David F. Bacon, Susan L. Graham and Oliver J. Sharp. Compiler Transformations for High-Performance Computing. ACM Computing Surveys, 26(4):325-420, 1994.
[5] Steven Muchnick. Advanced Compiler Design and Implementation. Morgan Kaufmann, 1997.
[6] João M. P. Cardoso and Markus Weinhardt. XPP-VC: A C Compiler with Temporal Partitioning for the PACT-XPP Architecture. In Proceedings of the 12th International Conference on Field-Programmable Logic and Applications, FPL'2002, volume 2438 of LNCS, pages 864-874, Montpellier, France, 2002.
[7] Markus Weinhardt and Wayne Luk. Pipeline Vectorization. IEEE Transactions on Computer-Aided Design of integrated Circuits and Systems, 20(2):234-248, February 2001.
[8] V. Baumgarte, F. May, A. Nückel, M. Vorbach and M. Weinhardt. PACT XPP—A Self-Reconfigurable Data Processing Architecture. In Proceedings of the 1st International Conference on Engineering of Reconfigurable Systems and Algorithms (ERSA'2001), Las Vegas, Nev., 2001.
[9] Katherine Compton and Scott Hauck. Reconfigurable Computing: A Survey of Systems and Software. ACM Computing Surveys, 34(2): 171-210, 2002.
[10] Sam Larsen, Emmett Witchel and Saman Amarasinghe. Increasing and Detecting Memory Address Congruence. In Proceedings of the 2002 IEEE International Conference on Parallel Architectures and Compilation Techniques (PACT'02), pages 18-29, Charlottesville, Va., September, 2002.
[11] Daniela Genius and Sylvain Lelait. A Case for Array Merging in Memory Hierarchies. In Proceedings of the 9th International Workshop on Compilers for Parallel Computers, CPC'01, Edinburgh, Scotland, Jun. 27-29, 2001.
[12] Christopher W. Fraser, David R. Hanson and Todd A. Proebsting: Engineering a Simple, Efficient Code-Generator. ACM Letters on Programming Languages and Systems, 1(3):213-226, 1992.
[13] Erik Eckstein, Oliver König and Bernhard Scholz. Code Instruction Selection based on SSA-Graphs. In Proceedings of the 7th International Workshop on Software and Compilers for Embedded Systems, SCOPES'03 Vienna, Austria, September, 2003, to appear.

The invention will now be described further and/or in other details by the following part of the description entitled “A Method for Compiling High Level Language Programs to a Reconfigurable Data-Flow Processor”.

1 Introduction

This document describes a method for compiling a subset of a high-level programming language (HLL) like C or FORTRAN, extended by port access functions, to a reconfigurable data-flow processor (RDFP) as described in Section 3. The program is transformed to a configuration of the RDFP.

This method can be used as part of an extended compiler for a hybrid architecture consisting of standard host processor and a reconfigurable data-flow coprocessor. The extended compiler handles a full HLL like standard ANSI C. It maps suitable program parts like inner loops to the coprocessor and the rest of the program to the host processor. It is also possible to map separate program parts to separate configurations. However, these extensions are not subject of this document.

2 Compilation Flow

This section briefly describes the phases of the compilation method.

2.1 Frontend

The compiler uses a standard frontend which translates the input program (e.g. a C program) into an internal format consisting of an abstract syntax tree (AST) and symbol tables. The frontend also performs well-known compiler optimizations as constant propagation, dead code elimination, common subexpression elimination etc. For details, refer to any compiler construction textbook like [1]. The SUIF compiler [2] is an example of a compiler providing such a frontend.

2.2 Control/Dataflow Graph Generation

Next, the program is mapped to a control/dataflow graph (CDFG) consisting of connected RDFP functions. This phase is the main subject of this document and presented in Section 4.

2.3 Configuration Code Generation

Finally, the last phase directly translates the CDFG to configuration code used to program the RDFP. For PACT XPP™ Cores, the configuration code is generated as an NML Native Mapping Language) file.

3 Configurable Objects and Functionality of a RDFP

This section describes the configurable objects and functionality of a RDFP. A possible implementation of the RDFP architecture is a PACT XPP™ Core. Here we only describe the minimum requirements for a RDFP for this compilation method to work. The only data types considered are multi-bit words called data and single-bit control signals called events. Data and events are always processed as packets, cf. Section 3.2. Event packets are called 1-events or 0-events, depending on their bit-value.

3.1 Configurable Objects and Functions

An RDFP consists of an array of configurable objects and a communication network. Each object can be configured to perform certain functions (listed below). It performs the same function repeatedly until the configuration is changed. The array needs not be completely uniform, i.e. not all objects need to be able to perform all functions. E. g., a RAM function can be implemented by a specialized RAM object which cannot perform any other functions. It is also possible to combine several objects to a “macro” to realize certain functions. Several RAM objects can, e.g., be combined to realize a RAM function with larger storage.

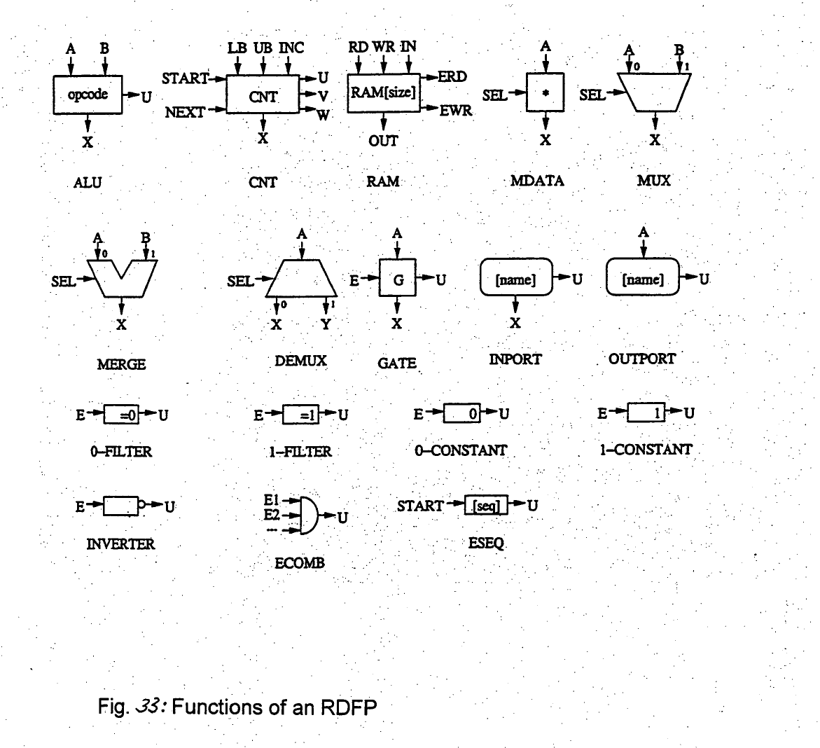

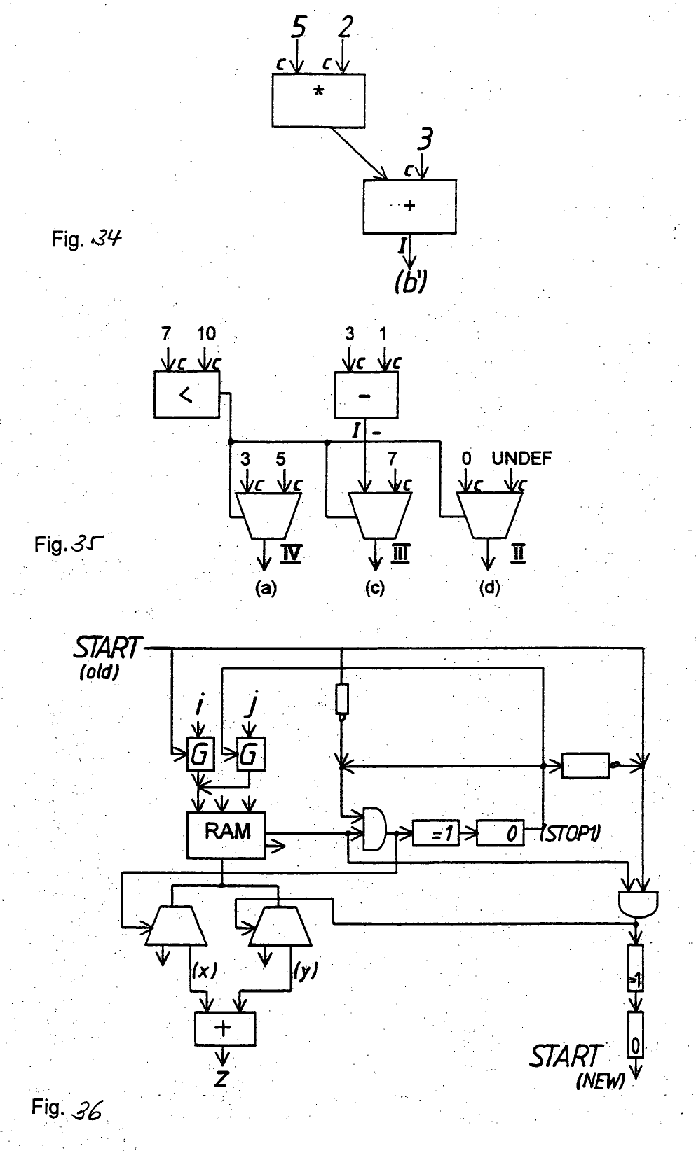

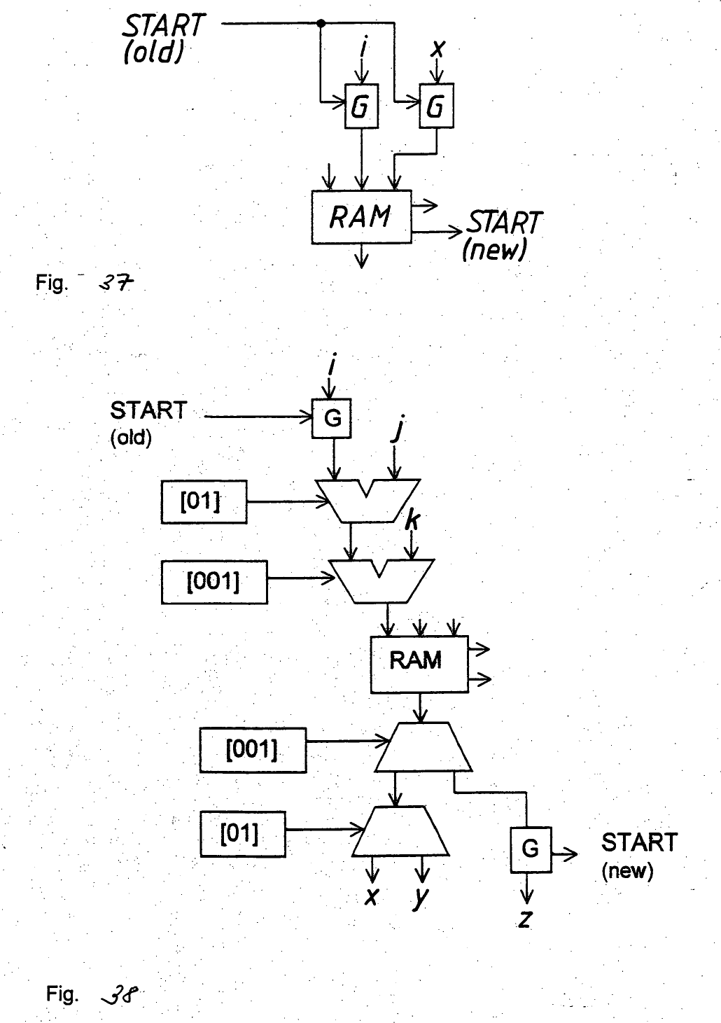

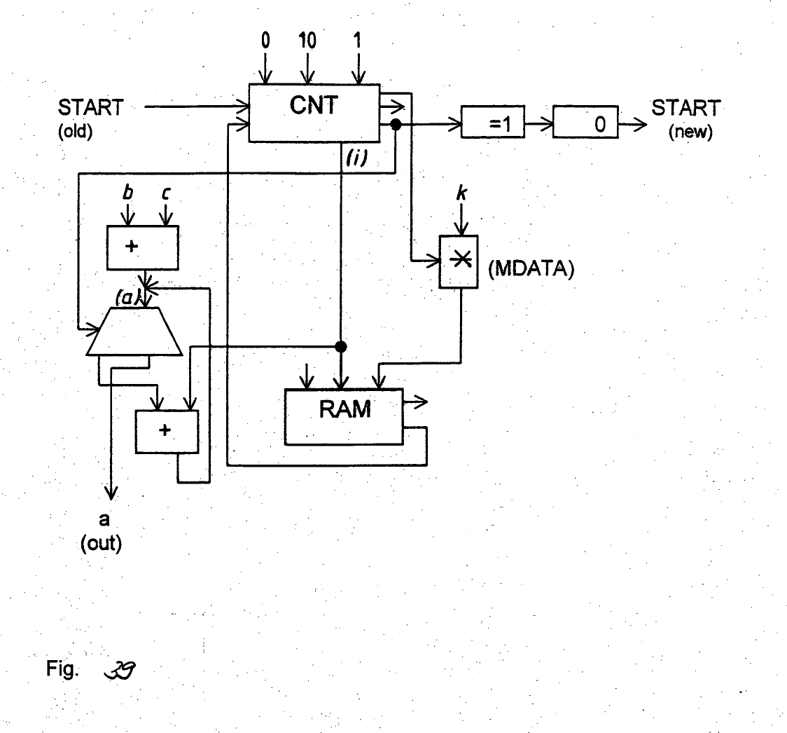

The following functions for processing data and event packets can be configured into an RDFP. See FIG. 33 for a graphical representation.
ALU[opcode]: ALUs perform common arithmetical and logical operations on data ALU functions (“opcodes”) must be available for all operations used in the HLL¹: ALU functions have two data inputs A and B, and one data output X. Comparators have an event output U instead of the data output. They produce a 1-event if the comparison is true, and a 0-event otherwise.
   ¹ Otherwise programs containing operations which do not have ALU opcodes in the RDFP must be excluded from the supported HLL subset or substituted by “macros” of existing functions.
CNT: A counter function which has data inputs LB, UB and INC (lower bound, upper bound and increment) and data output X (counter value). A packet at event input START starts the counter, and event input NEXT causes the generation of the next output value (and output events) or causes the counter to terminate if UB is reached. If NEXT is not connected, the counter counts continuously. The output events U, V, and W have the following functionality: For a counter counting N times, N−1 0-events and one 1-event are generated at output U. At output V, N 0-events are generated, and at output W, N 0-events and one 1-event are created. The 1-event at W is only created after the counter has terminated, i.e. a NEXT event packet was received after the last data packet was output.
RAM[size]: The RAM function stores a fixed number of data words (“size”). It has a data input RD and a data output OUT for reading at address RD. Event output ERD signals completion of the read access. For a write access, data inputs WR and IN (address and value) and data output OUT is used. Event output EWR signals completion of the write access. ERD and EWR always generate 0-events. Note that external RAM can be handled as RAM functions exactly like internal RAM.
GATE: A GATE synchronizes a data packet at input A back and an event packet at input E. When both inputs have arrived, they are both consumed. The data packet is copied to output X, and the event packet to output U.
MUX: A MUX function has 2 data inputs A and B, an event input SEL, and a data output X. If SEL receives a 0-event, input A is copied to output X and input B discarded. For a 1-event, B is copied and A discarded.
MERGE: A MERGE function has 2 data inputs A and B, an, event input SEL, and a data output X. If SEL receives a 0-event, input A is copied to output. X, but input B is not discarded. The packet is left at the input B instead. For a 1-event, B is copied and A left at the input.
DEMUX: A DEMUX function has one data input A, an event input SEL, and two data outputs X and Y. If SEL receives a 0-event, input A is copied to output X, and no packet is created at output Y. For a 1-event, A is copied to Y, and no packet is created at output
MDATA: A MDATA function multiplicates data packets. It has a data input A, an event input SEL, and a data output X. If SEL receives a 1-event, a data packet at. A is consumed and copied to output X. For all subsequent 0-event at SEL, a copy of the input data packet is produced at the output without consuming new packets at A. Only if another 1-event, arrives at SEL, the next data packet at A is consumed and copied².
   ² Note that this can be implemented by a MERGE with special properties on XPP™.
INPORT[name]: Receives data packets from outside the RD FP through input port “name” and copies them to data output X. If a packet was received, a 0-event is produced at event output U, too. (Note that this function can only be configured at special objects connected to external busses.)
OUTPORT[name]: Sends data packets received at data input A to the outside of the RDFP through output port “name”. If a packet was sent, a 0-event is produced at event output U, too. (Note that this function can only be configured at special objects connected to external busses.)

Additionally, the following functions manipulate only event packets:
0-FILTER, 1-FILTER: A FILTER has an input E and an output U. A 0-FILTER copies a 0-event from E to U, but 1-EVENTs at B are discarded. A 1-FILTER copies 1-events and discards 0-events.
INVERTER: Copies all events from input B to output U but inverts its value.
0-CONSTANT, 1-CONSTANT: 0-CONSTANT copies all events from input E to output U, but changes them all to value 0. 1-CONSTANT changes all to value 1.
ECOMB: Combines two or more inputs E1, E2, E3 . . . , producing a packet at output U. The output is a 1-event if and only if one or more of the input packets are 1-events (logical or). A packet must be available at all inputs before an output packet is produced.³
   ³ Note that this function is implemented by the EAND operator on the XPP™.
ESEQ[seq]: An ESEQ generates a sequence “seq” of events, e.g. “0001”, at its output U. If it has an input START, one entire sequence is generated for each event packet arriving at U. The sequence is only repeated if the next event arrives at U. However, if START is not connected, ESEQ constantly repeats the sequence.

Note that ALU, MUX, DEMUX, GATE and ECOMB functions behave like their equivalents in classical dataflow machines [3, 4].

3.2 Packet-Based Communication Network

The communication network of an RDFP can connect an outputs of one object (i.e. its respective function) to the input(s) of one or several other objects. This is usually achieved by busses and, switches. By placing the functions properly on the objects, many functions can be connected arbitrarily up to a limit imposed by the device size. As mentioned above, all values are communicated as packets. A separate communication network exists for data and event packets. The packets synchronize the functions as in a dataflow machine with acknowledge [3]. I. e., the function only executes when all input packets are available (apart from the non-strict exceptions as described above). The function also stalls if the last output packet has not been consumed. Therefore a data-flow graph mapped to an RDFP self-synchronizes its execution without the need for external control. Only if two or more function outputs (data or event) are connected to the same function input (“N to 1 connection”), the self-synchronization is disabled.⁴ The user has to ensure that only one packet arrives at a time in a correct CDFG. Otherwise a packet might get lost, and the value resulting from combining two or more packets is undefined. However, a function output can be connected to many function inputs (“1 to N connection”) without problems.
⁴ Note that on XPP™ Cores, a “N to 1 connection” for events is realized by the EOR function, and for data by just assigning several outputs to an input.

There are some special cases:
A function input can be preloaded with a distinct value during configuration. This packet is consumed like a normal packet coming from another object.
A function input can be defined as constant. In this case, the packet at the input is reproduced repeatedly for each function execution.

An RDFP requires register delays in the dataflow. Otherwise very long combinational delays and asynchronous feedback is possible. We assume that delays are inserted at the inputs of some functions (like for most ALUs) and in some routing segments of the communication network. Note that registers change the timing, but not the functionality of a correct CDFG.

4 Configuration Generation

4.1 Language Definition

The following HLL features are not supported by the method described here:
pointer operations
library calls, operating system calls (including standard I/O functions)
recursive function calls (Note that non-recursive function calls can be eliminated by function inlining and therefore are not considered here.)
All scalar data types are converted to type integer. Integer values are equivalent to data packets in the RDFP. Arrays (possibly multi-dimensional) are the only composite data types considered.

The following additional features are supported:

INPORTS and OUTPORTS can be accessed by the HLL functions getstream(name, value) and putstream(name, value) respectively.

4.2 Mapping of High-Level Language Constructs

This method converts a HLL program to a CDFG consisting of the RDFP functions defined in Section 3.1. Before the processing starts, all HLL program arrays are mapped to RDFP RAM functions. An array x is mapped to RAM RAM(x). If several arrays are mapped to the same RAM, an offset is assigned, too. The RAMs are added to an initially empty CDFG. There must be enough RAMs of sufficient size for all program arrays.

The CDFG is generated by a traversal of the AST of the HLL program. It processes the program statement by statement and descends into the loops and conditional statements as appropriate. The following two pieces of information are updated at every program point⁵ during the traversal:
⁵ In a program, program points are between two statements or before the beginning or after the end of a program component like a loop or a conditional statement.

START points to an event output of a RDFP function. This output delivers a 0-event whenever the program execution reaches this program point. At the beginning, a 0-CONSTANT preloaded with an event input is added to the CDFG. (It delivers a 0-event immediately after configuration.) START initially points to its output. This event is used to start the overall program execution. The START_{new} signal generated after a program part has finished executing is used as new START signal for the following program parts, or it signals termination of the entire program. The START events guarantee that the execution order of the original program is maintained wherever the data dependencies alone are not sufficient. This scheduling scheme is similar to a one-hot controller for digital hardware.
VARLIST is a list of {variable,function-output} pairs. The pairs map integer variables or array elements to a CDFG function's output. The first pair for a variable in VARLIST contains the output of the function which produces the value of this variable valid at the current program point. New pairs are always added to the front of VARLIST. The expression VARDEF(var) refers to the function-output of the first pair with variable var in VARLIST.⁶
   ⁶ This method of using a VARLIST is adapted from the Transmogrifier C compiler [5].

The following subsections systematically list all HLL program components and describe how they are processed, thereby altering the CDFG, START and VARLIST.

4.2.1 Integer Expressions and Assignments

Straight-line code without array accesses can be directly mapped to a data-flow graph. One ALU is allocated for each operator in the program. Because of the self-synchronization of the ALUs, no explicit control or scheduling is needed. Therefore processing these assignments does not access or alter START. The data dependences (as they would be exposed in the DAG representation of the program [1]) are analyzed through the processing of VARLIST. These assignments synchronize themselves through the data-flow. The data-driven execution automatically exploits the available instruction level parallelism.

All assignments evaluate the right-hand side (RHS) or source expression. This evaluation results in a pointer to a CDFG object's output (or pseudo-object as defined below). For integer assignments, the left-hand side (LHS) variable or destination is combined with the RHS result object to form a new pair {LHS, result(RHS)} which is added to the front of VARLIST.

The simplest statement is a constant assigned to an integer.⁷
⁷ Note that we use C syntax for the following examples.

a=5;

It doesn't change the CDFG, but adds {a, 5} to the front of VARLIST. The constant 5 is a “pseudoobject” which only holds the value, but does not refer to a CDFG object. Now VARDEF(a) equals 5 at subsequent program points before a is redefined.

Integer assignments can also combine variables already defined and constants:

b=a*2+3;

In the AST, the RHS is already converted to an expression tree. This tree is transformed to a combination of old and new CDFG objects (which are added to the CDFG) as follows: Each operator (internal node) of the tree is, substituted by an ALU with the opcode corresponding to the operator in the tree. If a leaf node is a constant, the ALU's input is directly connected to that constant. If a leaf note is an integer variable var it is looked up in VARLIST, i.e. VARDEF(var) is retrieved. Then VARDEF(var) (an output of an already existing object in CDFG or a constant) is connected to the ALU's input. The output of the ALU corresponding to the root operator in the expression tree is defined as the result of the RHS. Finally, a new pair {LHS, result(RHS)} is added to VARLIST. If the two assignments above are processed, the CDFG with two ALUs in FIG. 34 is created.⁸ Outputs occurring in VARLIST are labeled by Roman numbers. After these two assignments, VARLIST [{b, I}, {a, 5}]. (The front of the list is on the left side.) Note that all inputs connected to a constant (whether direct from the expression tree or retrieved from VARLIST) must be defined as constant. Inputs defined as constants have a small c next to the input arrow in FIG. 34.
⁸ Note that the input and output names can be deduced from their position, cf. FIG. 33. Also note that the compiler frontend would normally have substituted the second assignment by b=13 (constant propagation). For the simplicity of this explanation, no frontend optimizations are considered in this and the following examples.

4.2.2 Conditional Integer Assignments

For conditional if-then-else statements containing only integer assignments, objects for condition evaluation are created first. The object event output indicating the condition result is kept for choosing the correct branch result later. Next, both branches are processed in parallel, using separate copies VARLIST1 and VARLIST2 of VARLIST. (VARLIST itself is not changed.) Finally, for all variables added to VARLIST1 or VARLIST2, a new entry for VARLIST is created (combination phase). The valid definitions from VARLIST1 and VARLIST2 are combined with a MUX function, and the correct input is selected by the condition result. For variables only defined in one of the two branches, the multiplexer uses the result retrieved from the original VARLIST for the other branch. If the original VARLIST does not have an entry for this variable, a special “undefined” constant value is used. However, in a functionally correct program this value will never be used. As an optimization, only variables live [1] after the if-then-else structure need to be added to VARLIST in the combination phase.⁹
⁹ Definition: A variable is live at a program point if its value is read at a statement reachable from here without intermediate redefinition.

Consider the following example:

```
i = 7;
a = 3;
if (i < 10) {
  a = 5;
  c = 7;
}
else {
  c = a − 1;
  d = 0;
}
```

FIG. 35 shows the resulting CDFG. Before the if-then-else construct, VARLIST=[{a, 3},{i, 7}]. After processing the branches, for the then branch, VARLIST1=[{c, 7}, {a, 5}, {a, 3}, {i, 7}], and for the else branch, VARLIST2=[{d, 0}, {c, I}, {a, 3}, {i, 7.}]. After combination, VARLIST=[{d, II}, {c, III}, {a, IV}, {a, 3}, {i, 7}].

Note that case- or switch-statements can be processed, too, since they can—without loss of generality—be converted to nested if-then-else statements.

Processing conditional statements this way does not require explicit control and does not change START. Both branches are executed in parallel and synchronized by the data-flow. It is possible to pipeline the dataflow for optimal throughput.

4.2.3 General Conditional Statements

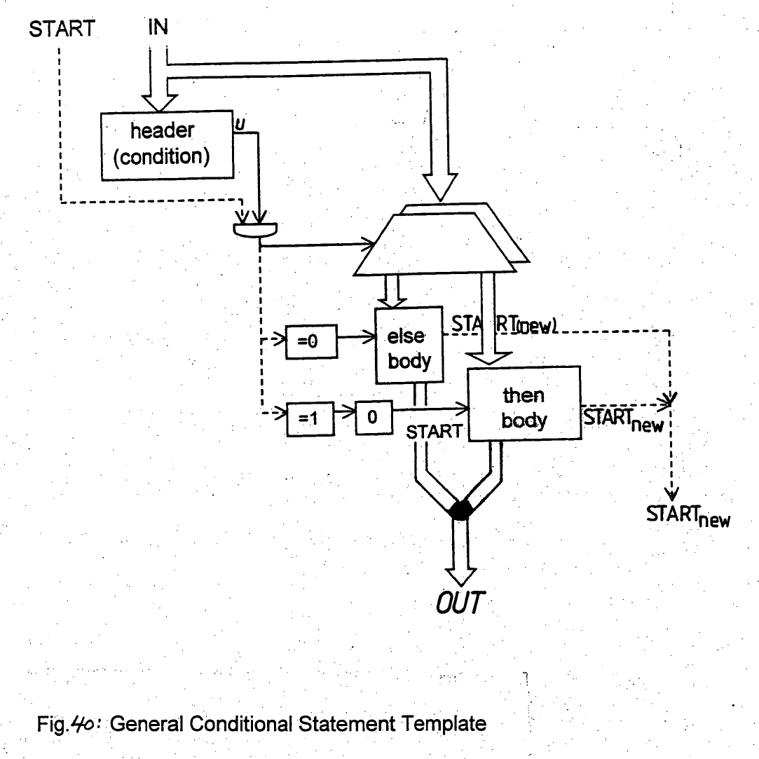

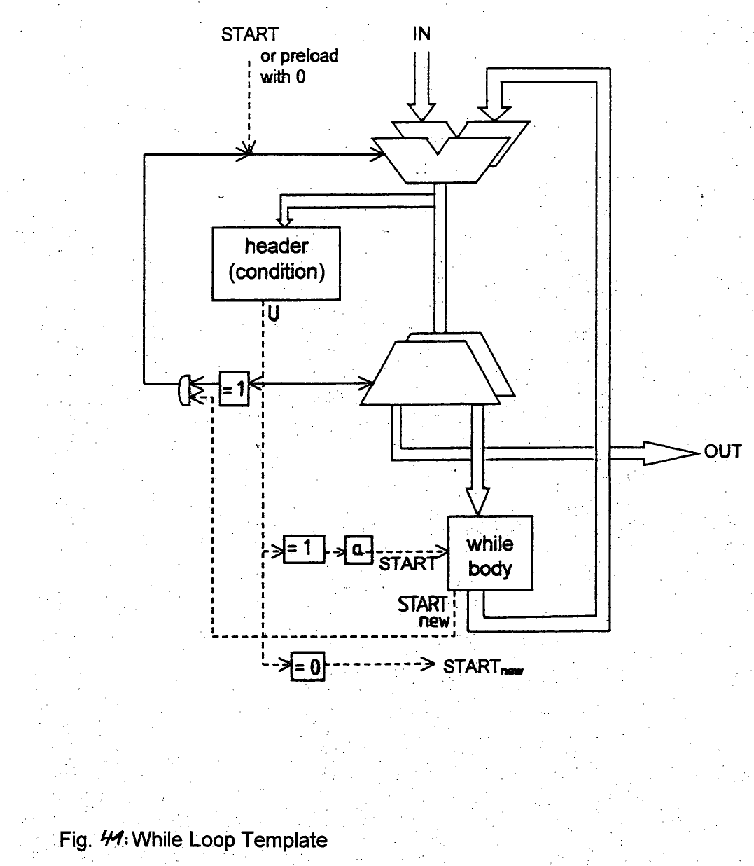

Conditional statements containing either array accesses (cf. Section 4.2.7 below) or inner loops cannot be processed as described in Section 4.2.2. Data packets must only be sent to the active branch. This is achieved by the implementation shown in FIG. 40, similar to the method presented in [4].

A dataflow analysis is performed to compute used sets use and defined sets def [1] of both branches.¹⁰ For the current VARLIST entries of all variables in IN=use(thenbody)∪def(then-body)∪use (elsebody)∪def(elsebody)∪use (header), DEMUX functions controlled by the IF condition are inserted. Note that arrows with double lines in FIG. 40 denote connections for all variables in IN, and the shaded DEMUX function stands for several DEMUX functions, one for each variable in IN. The DEMUX functions forward data packets only to the selected branch. New lists VARLIST1 and VARLIST2 are compiled with the respective outputs of these DEMUX functions. The then-branch is processed with VARLIST1, and the else branch with VARLIST2. Finally, the output values are combined. OUT contains the new values for the same variables as in IN. Since only one branch is ever activated there will not be a conflict due to two packets arriving simultaneously. The combinations will be added to VARLIST after the conditional, statement. If the IF execution shall be pipelined, MERGE opcodes for the output must be inserted, too. They are controlled by the condition like the DEMUX functions.
¹⁰ A variable is used in a statement (and hence in a program region containing this statement) if its value is read. A variable is defined in a statement (or region) if a new value is assigned to it.

The following extension with respect to [4] is added (dotted lines in FIG. 40) in order to control the execution as mentioned above with START events: The START input is ECOMB-combined with the condition output and connected to the SEL input of the DEMUX functions. The START inputs of thenbody and elsebody are generated from the ECOMB output sent through a 1-FILTER and a 0-CONSTANT¹¹ or through a 0-FILTER, respectively. The overall START_{new} output is generated by a simple “2 to 1 connection” of thenbody's and elsebody's START_{new} outputs. With this extension, arbitrarily nested conditional statements or loops can be handled within thenbody and elsebody.
¹¹ The 0-CONSTANT is required since START events must always be 0-events.

4.2.4 WHILE Loops

WHILE loops are processed similarly to the scheme presented in [4], cf. FIG. 41. As in Section 4.2.3, double line connections and shaded MERGE and DEMUX functions represent duplication for all variables in IN. Here IN=use(whilebody)∪def(whilebody)∪use(header). The WHILE loop executes as follows: In the first loop iteration, the MERGE functions select all input values from VARLIST at loop entry (SEL=0). The MERGE outputs are connected to the header and the DEMUX functions. If the while condition is true (SEL=1), the input values are forwarded to the whilebody, otherwise to OUT. The output values of the while body are fed back to whilebody's input via the MERGE and DEMUX operators as long as the condition is true. Finally, after the last iteration, they are forwarded to OUT. The outputs are added to the new VARLIST.¹²
¹² Note that the MERGE function for variables not live at the loop's beginning and the whilebody's beginning can be removed since its output is not used. For these variables, only the DEMUX function to output the final value is required. Also note that the MERGE functions can be replaced by simple “2 to 1 connections” if the configuration process guarantees that packets from IN1 always arrive at the DEMUX's input before feedback values arrive.

Two extensions with respect to [4] are added (dotted lines in FIG. 41):
In [4], the SEL input of the MERGE functions is preloaded with 0. Hence the loop execution begins immediately and can be executed only once. Instead, we connect the START input to the MERGE's SEL input (“2 to 1 connection” with the header output). This allows to control the time of the start of the loop execution and to restart it.
The whilebody's START input is connected to the header output, sent through a 1-FILTER/0-CONSTANT combination as above (generates a 0-event for each loop iteration). By ECOMB-combining whilebody's START_{new} output with the header output for the MERGE functions' SEL inputs, the next loop iteration is only started after the previous one has finished. The while loop's START_{new} output is generated by filtering the header output for a 0-event.

With these extensions, arbitrarily nested conditional statements or loops can be handled within whilebody.

4.2.5 FOR Loops

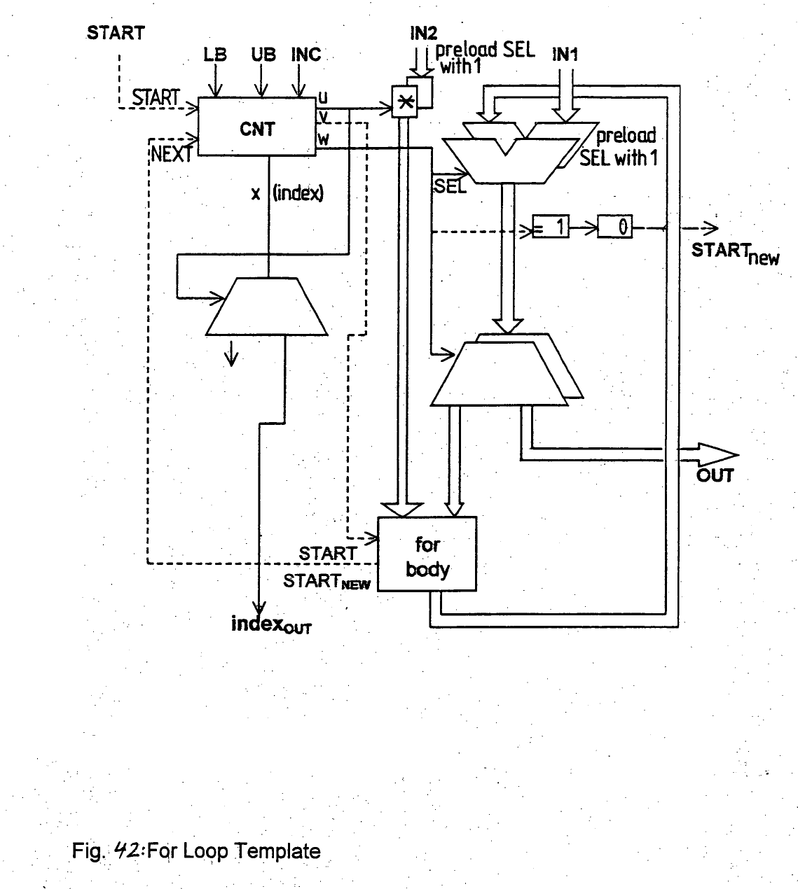

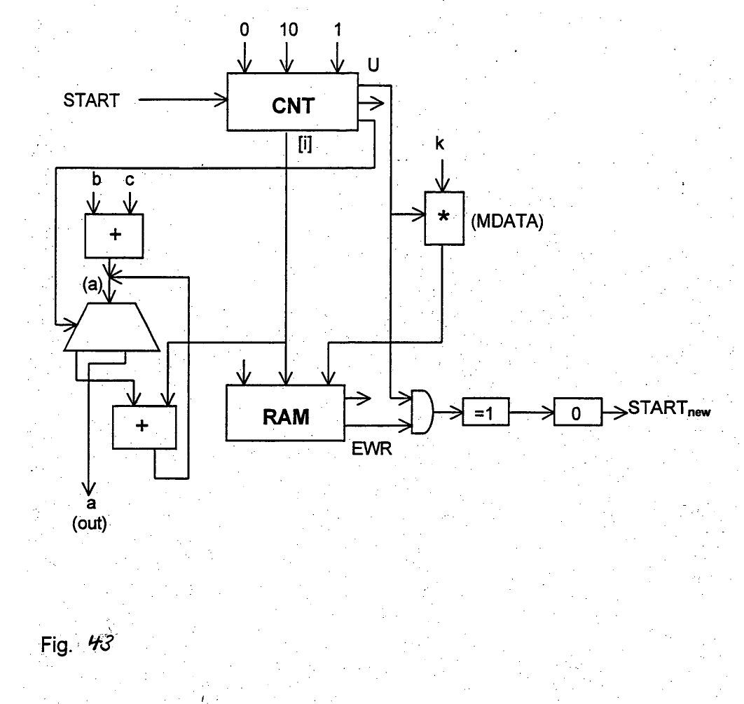

FOR loops are particularly regular WHILE loops. Therefore we could handle them as explained above. However, our RDFP features the special counter function CNT and the data packet multiplication function MDATA which can be used for a more efficient implementation of FOR loops. This new FOR loop scheme is shown in FIG. 42.

A FOR loop is controlled by a counter CNT. The lower bound (LB), upper bound (UB), and increment (INC) expressions are evaluated like any other expressions (see Sections 4.2.1 and 4.2.7) and connected to the respective inputs.

As opposed to WHILE loops, a MERGE/DEMUX combination is only required for variables in IN1=def(forbody), i.e. those defined in forbody.¹³ IN1 does not contain variables which are only used in forbody, LB, UB, or INC, and does also not contain the loop index variable. Variables in IN1 are processed as in WHILE loops, but the MERGE and DEMUX functions' SEL input is connected to CNT's W output. (The W output does the inverse of a WHILE loop's header output; it outputs a 1-event after the counter has terminated. Therefore the inputs of the MERGE functions and the outputs of the DEMUX functions are swapped here, and the MERGE functions' SEL inputs are preloaded with 1-events.)
¹³ Note that the MERGE functions can be replaced by simple “2 to 1 connections” as for WHILE loops if the configuration process guarantees that packets from IN1 always arrive at the DEMUX's input before feedback values arrive.

CNT's X output provides the current value of the loop index variable. If the final index value is required (live) after the FOR loop, it is selected with a DEMUX function controlled by CNT's U event output (which produces one event for every loop iteration).

Variables in IN2=use(forbody)\def(forbody), i.e. those defined outside the loop and only used (but not redefined) inside the loop are handled differently. Unless it is a constant value, the variable's input value (from VARLIST) must be reproduced in each loop iteration since it is consumed in each iteration. Otherwise the loop would stall from the second iteration onwards. The packets are reproduced by MDATA functions, with the SEL inputs connected to CNT's U output. The SEL inputs must be preloaded with a 1-event to select the first input. The 1-event provided by the last iteration selects a new value for the next execution of the entire loop.

The following control events (dotted lines in FIG. 42) are similar to the WHILE loop extensions, but simpler. CNT's START input is connected to the loop's overall START signal. START_{new} is generated from CNT's W output, sent through a 1-FILTER and 0-CONSTANT. CNT's V output produces one 0-event for each loop iteration and is therefore used as forbody's START. Finally, CNT's NEXT input is connected to forbody's START_{new} output.

For pipelined loops (as defined below in Section 4.2.6), loop iterations are allowed to overlap. Therefore CNT's NEXT input needs not be connected. Now the counter produces index variable values and control events as fast as they can be consumed. However, in this case CNT's W output in not sufficient as overall START_{new} output since the counter terminates before the last iteration's forbody finishes. Instead, START_{new} is generated from CNT's U output ECOMB-combined with forbody's START_{new} output, sent through a 1-FILTER/0-CONSTANT combination. The ECOMB produces an event after termination of each loop iteration, but only the last event is a 1-event because only the last output of CNT's U output is a 1-event. Hence this event indicates that the last iteration has finished. Cf. Section 4.3 for a FOR loop example compilation with and without pipelining.

As for WHILE loops, these methods allow to process arbitrarily nested loops and conditional statements. The following advantages over WHILE loop implementations are achieved:
One index variable value is generated by the CNT function each clock cycle. This is faster and smaller than the WHILE loop implementation which allocates a MERGE/DEMUX/ADD loop and a comparator for the counter functionality.
Variables in IN2 (only used in forbody) are reproduced in the special MDATA functions and need not go through a MERGE/DEMUX loop. This is again faster and smaller than the WHILE loop implementation.
   4.2.6 Vectorization and Pipelining

The method described so far generates CDFGs performing the HLL program's functionality on an RDFP. However, the program execution is unduly sequentialized by the START signals. In some cases, innermost loops can be vectorized. This means that loop iterations can overlap, leading to a pipelined dataflow through the operators of the loop body. The Pipeline Vectorization technique [6] can be easily applied to the compilation method presented here. As mentioned above, for FOR loops, the CNT's NEXT input is removed so that CNT counts continuously, thereby overlapping the loop iterations.

All loops without array accesses can be pipelined since the dataflow automatically synchronizes loopcarried dependences, i.e. dependences between a statement in one iteration and another statement in a subsequent iteration. Loops with array accesses can be pipelined if the array (i.e. RAM) accesses do not cause loop-carried dependences or can be transformed to such a form. In this case no RAM address is written in one and read in a subsequent iteration. Therefore the read and write accesses to the same RAM may overlap. This degree of freedom is exploited in the RAM access technique described below. Especially for dual-ported RAM it leads to considerable performance improvements.

4.2.7 Array Accesses

In contrast to scalar variables, array accesses have to be controlled explicitly in order to maintain the program's correct execution order. As opposed to normal dataflow machine models [3], a RDFP does not have a single address space. Instead, the arrays are allocated to several RAMs. This leads to a different approach to handling RAM accesses and opens up new opportunities for optimization.

To reduce the complexity of the compilation process, array accesses are processed in two phases. Phase 1 uses “pseudo-functions” for RAM read and write accesses. A RAM read function has a RD data input (read address) and an OUT data output (read value), and a RAM write function has WR and IN data inputs (write address and write value). Both functions are labeled with the array the access refers to, and both have a START event input and a U event output. The events control the access order. In Phase 2 all accesses to the same RAM are combined and substituted by a single RAM function as shown in FIG. 33. This involves manipulating the data and event inputs and outputs such that the correct execution order is maintained and the outputs are forwarded to the correct part of the CDFG.

Phase 1 Since arrays are allocated to several RAMs, only accesses to the same RAM have to be synchronized. Accesses to different RAMs can occur concurrently or even out of order. In case of data dependencies, the accesses self-synchronize automatically. Within pipelined loops, not even read and write accesses to the same RAM have to be synchronized. This is achieved by maintaining separate START signals for every RAM or even separate START signals for RAM read and RAM write accesses in pipelined loops. At the end of a basic block [1]¹⁴, all START_{new} outputs must be combined by a ECOMB to provide a START signal for the next basic block which guarantees that all array accesses in the previous basic block are completed. For pipelined loops, this condition can even be relaxed. Only after the loop exit all accesses have to be completed. The individual loop iterations need not be synchronized.
¹⁴ A basic block is a program part with a single entry and a single exit point, i.e. a piece of straight-line code.

First the RAM addresses are computed. The compiler frontend's standard transformation for array accesses can be used, and a CDFG function's output is generated which provides the address. If applicable, the offset with respect to the RDFP RAM (as determined in the initial mapping phase) must be added. This output is connected to the pseudo RAM read's RD input (for a read access) or to the pseudo RAM write's WR input (for a write access). Additionally, the OUT output (read) or IN input (write) is connected. The START input is connected to the variable's START signal, and the U output is used as START_{new} for the next access.

To avoid redundant read accesses, RAM reads are also registered in VARLIST. Instead of an integer variable, an array element is used as first element of the pair. However, a change in a variable occurring in an array index invalidates the information in VARLIST. It must then be removed from it.

The following example with two read accesses compiles to the intermediate CDFG shown in FIG. 44. The START signals refer only to variable a. STOP1 is the event connection which synchronizes the accesses. Inputs START (old), i and j should be substituted by the actual outputs resulting from the program before the array reads.

x=a [i]

y=a[j]

z=x+y;

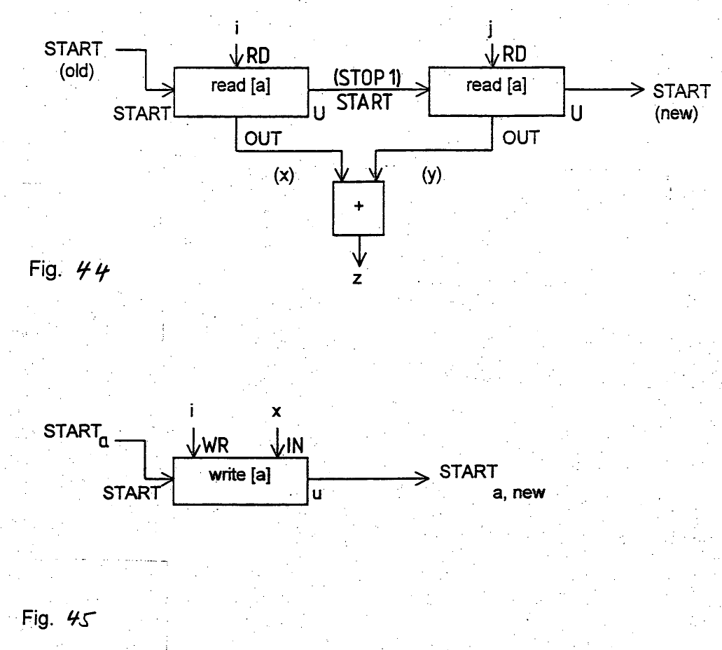

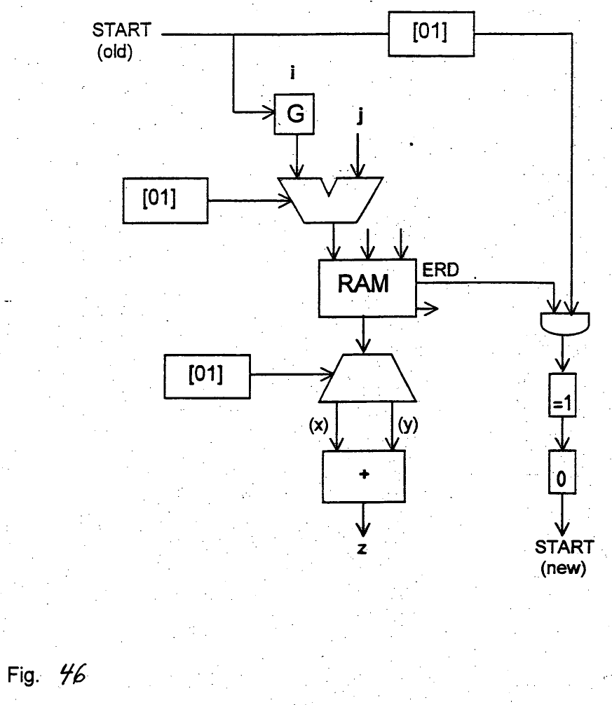

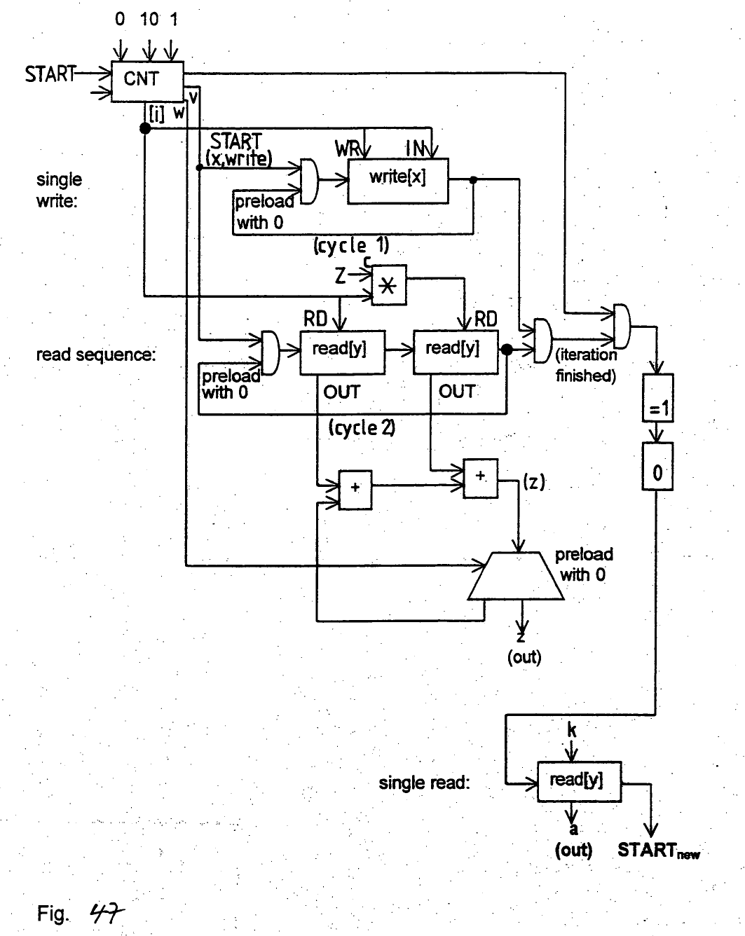

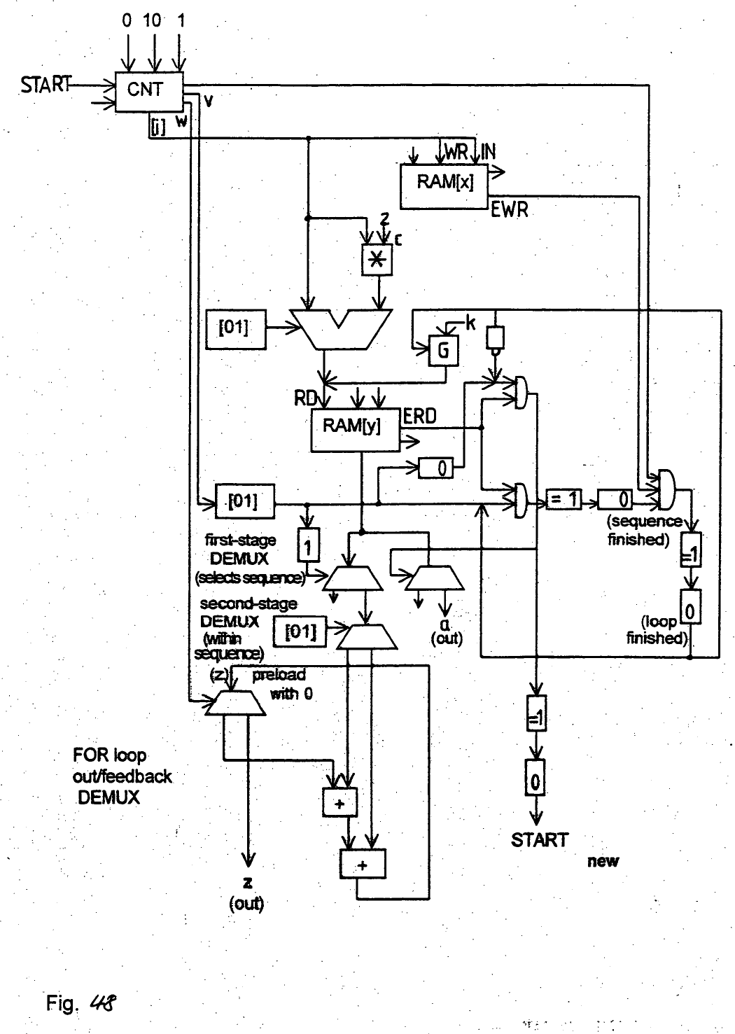

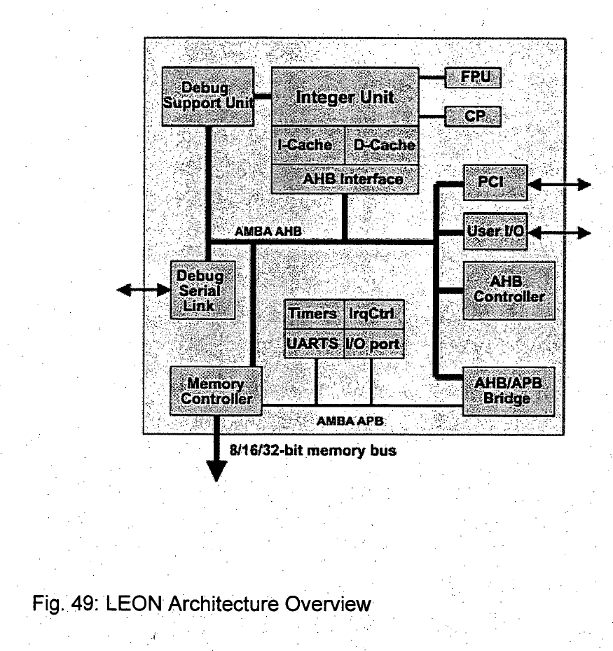

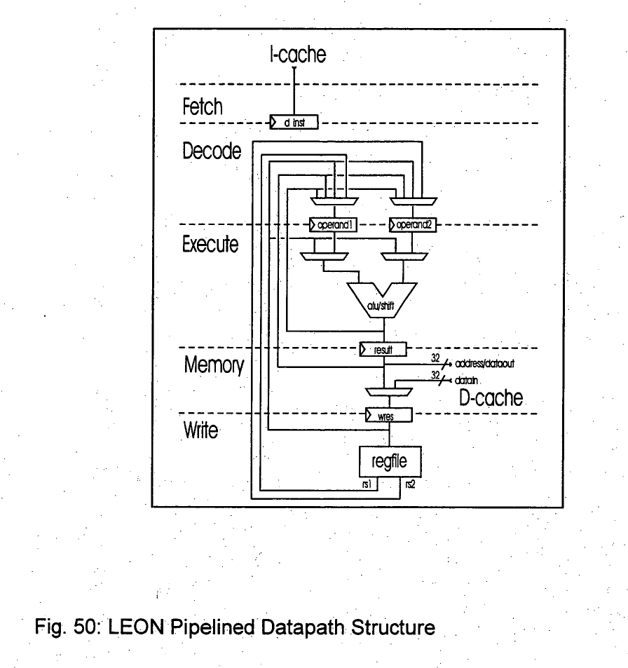

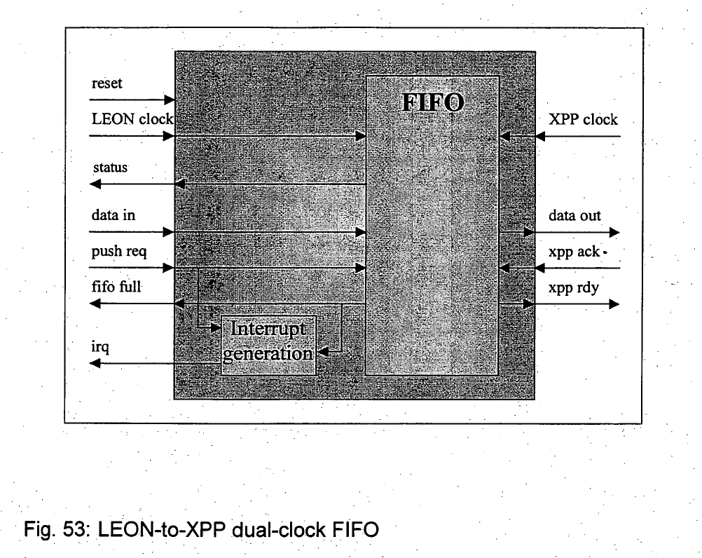

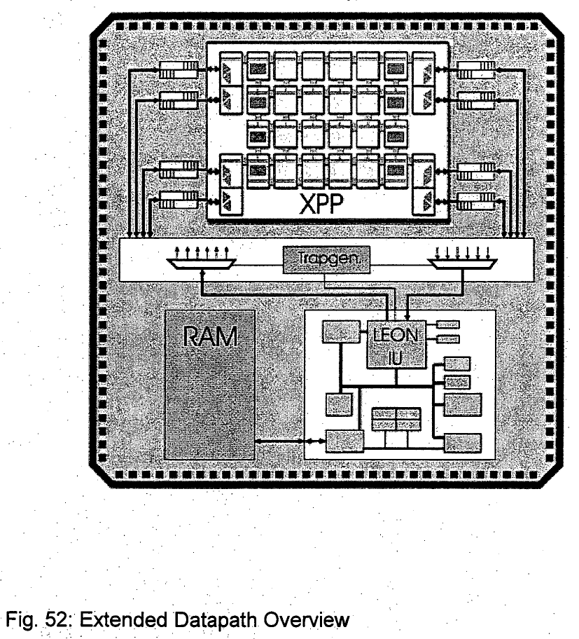

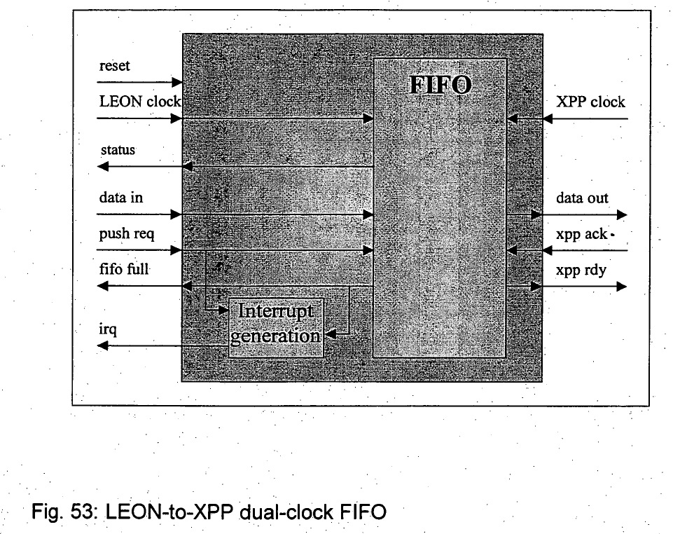

FIG. 45 shows the translation of the following write access:

a[i] x;

Phase 2 We now merge, the pseudo-functions of all accesses to the same RAM and substitute them by a single RAM function. For all data inputs (RD for read access and WR and IN for write access), GATEs are inserted between the input and the RAM function. Their E inputs are connected to the respective START inputs of the original pseudo-functions. If a RAM is read and written at only one program point, the U output of the read and write access is moved to the ERD or EWR output, respectively. For example, the single access a [i=x; from FIG. 45 is transformed to the final CDFG shown in FIG. 37.

However, if several read or several write accesses (i.e. pseudo-functions from different program points) to the same RAM occur, the ERD or EWR events are not specific anymore. But a START_{new} event of the original pseudo function should only be generated for the respective program point, i.e. for the current access. This is achieved by connecting the START signals of all other accesses (pseudo-functions) of the same type (read or write) with the inverted START signal of the current access. The resulting signal produces an event for every, access, but only for the current access a 1-event. This event is ECOMB-combined with the RAM's ERD or EWR output. The ECOMB's output will only occur after the access is completed. Because ECOMB OR-combines its event packets, only the current access produces a 1-event. Next, this event is filtered with a 1-FILTER and changed by a 0-CONSTANT, resulting in a START_{new} signal which produces a 0-event only after the current access is completed as required.

For several accesses, several sources are connected to the RD, WR and IN inputs of a RAM. This disables the self-synchronization. However, since only one access occurs at a time, the GATEs only allow one data packet to arrive at the inputs.

For read accesses, the packets at the OUT output face the same problem as the ERD event packets: They occur for every read access, but must only be used (and forwarded to subsequent operators) for the current access. This can be achieved by connecting the OUT output via a DEMUX function. The Y output of the DEMUX is used, and the X output is left unconnected. Then it acts as a selective gate which only forwards packets if its SEL input receives a 1-event, and discards its data input if SEL receives a 0-event. The signal created by the ECOMB described above for the START_{new} signal creates a 1-event for the current access, and a 0-event otherwise. Using it as the SEL input achieves exactly the desired functionality.

FIG. 36 shows the resulting CDFG for the first example above (two read accesses), after applying the transformations of Phase 2 to FIG. 44. STOP1 is now generated as follows: START(old) is inverted, “2 to 1 connected” to STOP1 (because it is the START input of the second read pseudo-function), ECOMB-combined with RAM's ERD output and sent through the 1-FILTER/0-CONSTANT combination. START(new) is generated similarly, but here START(old) is directly used and STOP1 inverted. The GATEs for input IN (i and j) are connected to START(old) and STOP1, respectively, and the DEMUX functions for outputs x and y are connected to the ECOMB outputs related to STOP1 and START(new).

Multiple write accesses use the same control events, but instead of one GATE per access for the RD inputs, one GATE for WR and one gate for IN (with the same E input) are used. The EWR output is processed like the ERD output for read accesses.

This transformation ensures that all RAM accesses are executed correctly, but it is not very fast since read or write accesses to the same RAM are not pipelined. The next access only starts after the previous one is completed, even if the RAM being used has several pipeline stages. This inefficiency can be removed as follows:

First continuous sequences of either read accesses or write accesses (not mixed) within a basic block are detected by checking for pseudo-functions whose U output is directly connected to the START input of another pseudo-function of the same RAM and the same type (read or write). For these sequences it is possible to stream data into the RAM rather than waiting for the previous access to complete. For this purpose, a combination of MERGE functions selects the RD or WR and IN inputs in the order given by the sequence. The MERGEs must be controlled by iterative ESEQs guaranteeing that the inputs are only forwarded in the desired order. Then only the first access in the sequence needs to be controlled by a GATE or GATEs. Similarly, the OUT outputs of a read access can be distributed more efficiently for a sequence. A combination of DEMUX functions with the same ESEQ control can be used. It is most efficient to arrange the MERGE and DEMUX functions as balanced binary trees.

The START_{new} signal is generated as follows: For a sequence of length n, the START signal of the entire sequence is replicated n times by an ESEQ[00..1] function with the START input connected to the sequence's START. Its output is directly “N to 1 connected” with the other accesses' START signal (for single accesses) or ESEQ outputs sent through 0-CONSTANT (for access sequences), ECOMB-connected to EWR or ERD, respectively, and sent through a 1-FILTER/O-CONSTANT combination, similar to the basic method described above. Since only the last ESEQ output is a 1-event, only the last RAM access generates a START_{new} as required. Alternatively, for read accesses, the generation of the last output can be sent through a GATE (without the E input connected), thereby producing a START_{new} event.

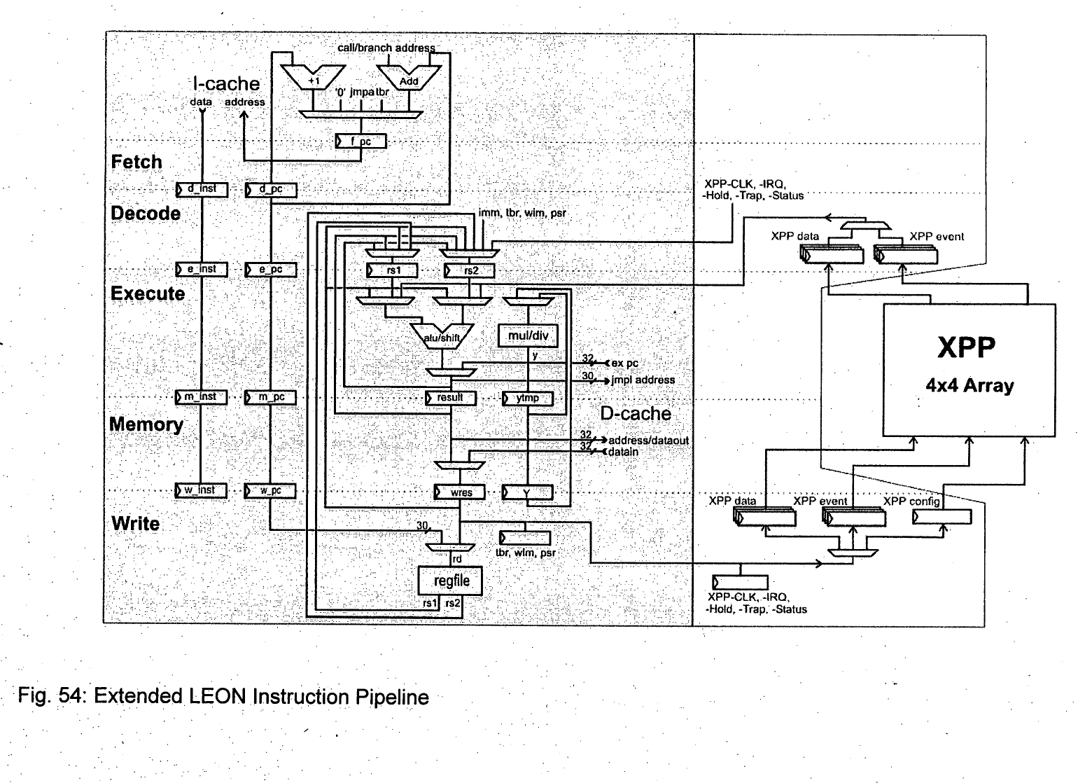

FIG. 46 shows the optimized version of the first example (FIGS. 44 and 36) using the ESEQ-method for generating START_{new} and FIG. 38 shows the final CDFG of the following, larger example with three array reads. Here the latter method for producing the START_{new} event is used.

x=a[i];

y=a[j];

z=a[k];

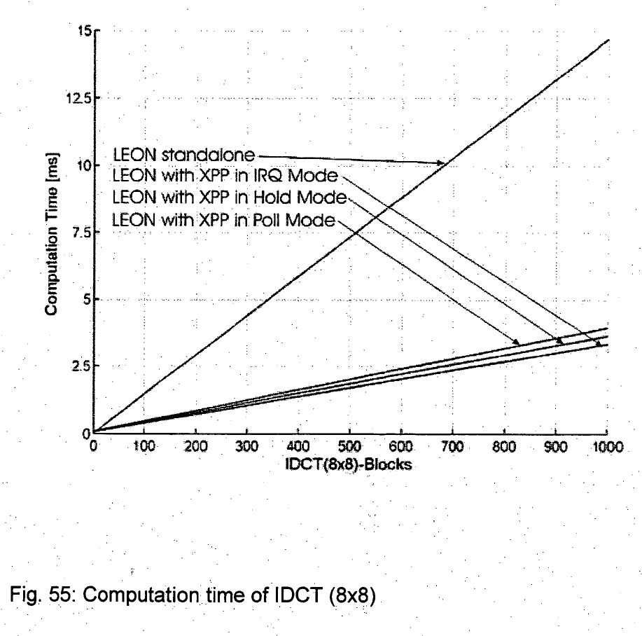

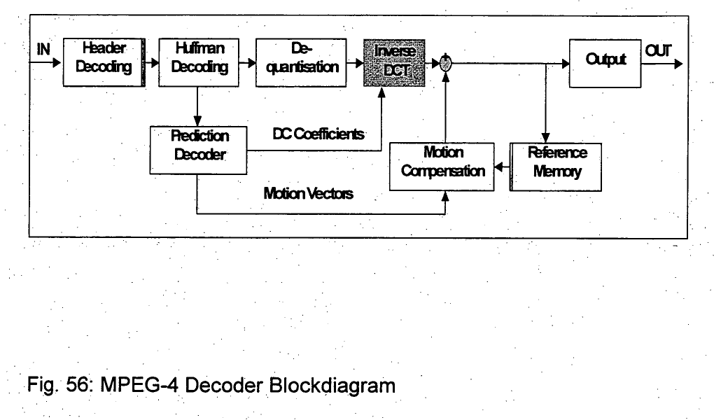

If several read sequences or read sequences and single read accesses occur for the same RAM, 1-events for detecting the current accesses must be generated for sequences of read accesses. They are needed to separate the OUT-values relating to separate sequences. The ESEQ output just defined, sent through a 1-CONSTANT, achieves this. It is again “N to 1 connected” to the other accesses' START signals (for single accesses) or ESEQ outputs sent through 0-CONSTANT (for access sequences). The resulting event is used to control a first-stage DEMUX which is inserted to select the relevant OUT output data packets of the sequence as described above for the basic method. Refer to the second example (FIGS. 47 and 48) in Section 4.3 for a complete example.

4.2.8 Input and Output Ports

Input and output ports are processed similar to vector accesses. A read from an input port is like an array read without an address. The input data packet is sent to DEMUX functions which send it to the correct subsequent operators. The STOP signal is generated in the same way as described above for RAM accesses by combining the INPORT's U output with the current and other START signals.

Output ports control the data packets by GATEs like array write accesses. The STOP signal is also created as for RAM accesses.

4.3 More Examples

FIG. 39 shows the generated CDFG for the following for loop.

```
a = b + c;
for (i=0; i<=10; i++) {
  a = a + i;
  x[i] = k;
}
```

In this example, IN1={a} and IN2={k} (cf. FIG. 42). The MERGE function for variable a is replaced by a 2:1 data connection as mentioned in the footnote of Section 4.2.5. Note that only one data packet arrives for variables b, c and k, and one final packet is produced for a (out) forbody does not use a START event since both operations (the adder and the RAM write) are dataflow-controlled by the counter anyway. But the RAM's EWR output is the forbody's START_{new} and connected to CNT's NEXT input. Note that the pipelining optimization, cf. Section 4.2.6, was not applied here. If it is applied (which is possible for this loop), CNT's NEXT input is not connected, cf. FIG. 43. Here, the loop iterations overlap. START_{new} is generated from CNT's U output and forbody's START_{new} (i.e. RAM's EWR output), as defined at the end of Section 4.2.5.

The following program contains a vectorizable (pipelined) loop with one write access to array (RAM) x and a sequence of two read accesses to array (RAM) y. After the loop, another single read access to y occurs.

```
z = 0;
for (i=0; i<=10; i++) {
  x[i] = i;
  z = z + y[i] + y[2*i];
}
a = y[k];
```

FIG. 47 shows the intermediate CDFG generated before the array access Phase 2 transformation is applied. The pipelined loop is controlled as follows: Within the loop, separate START signals for write accesses to x and read accesses to y are used. The reentry to the forbody is also controlled by two independent signals (“cycle1” and “cycle2”). For the read accesses, “cycle2” guarantees that the read y accesses occur in the correct order. But the beginning of an iteration for read y and write x accesses is not synchronized. Only at loop exit all accesses must be finished, which is guaranteed by signal. “loop finished”. The single read access is completely independent of the loop.

FIG. 48 shows the final CDFG after Phase 2. Note that “cycle1” is removed since a single write, access needs no additional control, and “cycle2” is removed since the inserted MERGE and DEMUX functions automatically guarantee the correct execution order. The read y accesses are not independent anymore since they all refer to the same RAM, and the functions have been merged. ESEQs have been allocated to control the MERGE and DEMUX functions of the read sequence, and for the first-stage DEMUX functions which separate the read OUT values for the read sequence and for the final single read access. The ECOMBs, 1-FILTERs, 0-CONSTANTs and 1-CONSTANTs are allocated as described in Section 4.2.7, Phase 2, to generate correct control events for the GATEs and DEMUX functions.

### REFERENCES

[1] A. V. Aho, R. Sethi, and J. D. Ullman. Compilers—Principles, Techniques, and Tools. Addison-Wesley, 1986.
[2] The Stanford SUIF Compiler Group. Homepage http://suif.stanford.edu.
[3] A. H. Veen. Dataflow architecture. ACM Computing Surveys, 18(4), December 1986.
[4] S. J. Allan and A. E. Oldehoeft. A flow analysis procedure for the translation of high-level languages to a data flow language. IEEE Transactions on Computers, C-29(9):826-831, September 1980.
[5] D. Galloway. The transmogrifier C hardware description language and compiler for FPGAs. In Proc. FPG As for Custom Computing Machines, pages 136-144. IEEE Computer Society Press, 1995.
[6] M. Weinhardt and W. Luk. Pipeline vectorization. IEEE Transactions on Computer-Aided Design of Integrated Circuits and Systems, 20(2), February 2001.

[image]

[image]

[image]

[image]

[image]

[image]

In connection with the coupling of an array and a processor, the following is noted as well:

In coupling the XPP or any other data processing array having a number of preferably coarse grain cells to a conventional (that is sequential and/or von Neumann-) processor/microcontroller design, a number of op code instructions may be added to the instructions set of the conventional processor. A non-limiting example is given below and it will be obvious to the average skilled person that it is not intended to limit the invention but disclose certain aspects thereof in more detail, the aspects being of more or less importance. For example, it may be the case that other bit lengths than indicated for instructions are used. It is also to be understood that the mnemonics might be changed and that in certain cases additional instructions and/or operations might be useful whereas in other cases or for other cases, a subset of the instructions indicated below might be useful as well. For example, it is easily possible to combine one or more XPP or any other reconfigurable device or set or group of identical or different devices, in particular runtime reconfigurable and/or coarse grain devices, FPGA and or data streaming processors with any design other than the LEON processor and/or a processor using SPARC instructions. Also, the use of the instruction set is not limited to certain compiling algorithms although the compiling techniques disclosed in other parts of the present invention are very useful. It is to be noted that one preferred way of using the XPP or other reconfigurable device or set or group of identical or different devices, in particular runtime reconfigurable add/or coarse grain devices, FPGA and or data streaming processors coupled to a design such as the LEON processor and/or other conventional processor is the use of macro libraries so that predefined configurations can be instantiated and/or called as subroutines. These libraries may be automatically compiled and/or the configurations corresponding thereto may be set up by hand. This being noted, with respect to additional op-code instructions the following is noted:

All additional instructions refer to format 3 of the SPARC instruction set, the op index being 3. The SPARC specification uses this format for the declaration of memory accesses. As in the original instruction set a plurality of op-codes had not been implemented, there was an opportunity to use the free fields for dedicated purposes.

Also, it was possible to ensure completeness of instructions; for example, no memory access instruction is located inbetween arithmetic instructions.

Overview over the SPARC instruction format 3

| op | rd | op3 | rs1 | i = 0 | Asi | rs2 | |
|---|---|---|---|---|---|---|---|
| op | rd | op3 | rs1 | i = 1 | simm13 | | |
| op | rd | op3 | rs1 | Opf | | rs2 | |
| 31 | 29 | 24 | 18 | 13 | 12 | 4 | 0 |

Here, the abbreviations have the following meaning:
rd: This field is five bit long. It contains the address of the source or target register, arithmetic and for Load-/Store-operations.
op3: This field is six bit long. Together with the op field it builds the instructions.
rs1: This field is five bit long. It contains the first operand of an ALU-operation.
opf: This field is nine bit long and contains the instructions of a floating point operation.
i: This is a one-bit-field selecting the second operand for arithmetic or Load-/Store-operations respectively. In case i=1, the operand is the content of simm13, otherwise the operand is the content of rs2.
asi: This field is eight bit long and indicates the address space which is accessed by Load-/Store-operations.
sim13: This field is thirteen bit long and contains the second operand of an arithmetic and/or Load-/Store-operation, the operand having a sign (+, −).
rs2: This field is five bit long and corresponds to the operand of an arithmetic and/or Load-/Store-operation respectively. It does not have a sign (+, −).

Overview Over Additional Instructions

| Opcode | Meaning | privileged |
|---|---|---|
| stxppd | Write word from memory to an XPP data register | no |
| ldxppd | Load word from memory to an XPP data register | no |
| stxppe | Write word from XPP event register into memory | no |
| ldxppe | Load word from memory into XPP event register | no |
| ldcm | Load word from memory into CM register | yes |
| stcm | Write word from cm register into memory | yes |
| cptoxppd | Copy a word from a LEON register into an XPP data register | no |
| cptoleond | Copy a word from an XPP register into a LEON data register | no |
| cptoxppe | Copy a word from a LEON register into an XPP event register | no |
| cptoleone | Copy a word from an XPP register into a LEON event register | no |
| cptocm | Copy a word from a LEON register into a CM register | yes |
| cptoleoncm | Copy a word from a CM register into an LEON register | yes |
| cptoleonsdi | Copy a word from the status register of an XPP data input | no |
| | register into a LEON register | |
| cptoleonsdo | Copy a word from the status register of an XPP data output | no |
| | register into a LEON register | |
| cptoleonsei | Copy a word from the status register of an XPP event input | no |
| | register into a LEON register | |
| cptoleonseo | Copy a word from the status regiser of an XPP event output | no |
| | register into a LEON register | |
| wrclkr | Write into a clock register to determine clock ratio LEON-XPP | yes |
| wroffsetr | Write into memory offset register for memory mapped mode | yes |
| rdclkr | Read clock register for clock ration LEON-XPP | yes |
| rdoffsetr | Read memory offset register for memory mapped mode | yes |
| rdtrapr | Read register with information about XPP trap | yes |

Data Transfer Between LEON and XPP

| Opcode | op3 | Operation |
|---|---|---|
| cptoxppd | 101110 | Copy a word from a LEON register into an XPP |
| | | data register |
| cptoleond | 101111 | Copy a word from an XPP register into a LEON |
| | | data register |
| cptoxppe | 110010 | Copy a word from a LEON register into an XPP |
| | | event register |
| cptoleone | 110011 | Copy a word from an XPP register into a LEON |
| | | event register |

Format (3):

| | | | | | | | |
|---|---|---|---|---|---|---|---|
| 11 | rd | op3 | Rs1 | rxpp(opf) | | rs2 | |
| 31 | 29 | 24 | 18 | 13 | 12 | 4 | 0 |

Assembler Syntax:

| | |
|---|---|
| cptoxppd | reg_{rd}, regᵣₓₚₚ |
| cptoleond | regᵣₓₚₚ, reg_{rd} |
| cptoxppe | reg_{rd}, regᵣₓₚₚ |
| cptoleone | regᵣₓₚₚ, reg_{rd} |

Description

CPTOXPPD loads a word from r[rd] to the data register r[rxpp] of XPP architecture.

CPTOLEOND loads a word from a data register r[rxpp] of XPP architecture to r[rd].

CPTOXPPE loads a word from r[rd] to event register r[rxpp] of XPP architecture.

CPTOLEONE loads a word from event register r[rxpp] of XPP architecture to r[rd].

Traps:

xpp_readaccess_error

xpp_writeaccess_error

xpp_regnotexist_error

Data Transfer Between LEON and CM

| Opcode | op3 | Operation |
|---|---|---|
| cptocm | 110110 | Load word from memory into CM register |
| cptoleoncm | 110111 | Load word from CM register into LEON register |

Format (3):

| | | | | | | | |
|---|---|---|---|---|---|---|---|
| 11 | rd | op3 | Rs1 | rcm(opf) | | rs2 | |
| 31 | 29 | 24 | 18 | 13 | 12 | 4 | 0 |

Assembler Syntax:

| | |
|---|---|
| cptocm | reg_{rd}, reg_{rcm} |
| cptoleoncm | reg_{rcm}, reg_{rd} |

Description:

CPTOCM loads a word of r[rd] into a register r[rcm] of CM.

CPTOLEONCM loads a word from register r[rcm] of CM to r[rd].

Traps:

privileged_instruction

cm_writeaccess error

cm_regnotexist error

Data Transfer Between XPP and Memory

| Opcode | op3 | Operation |
|---|---|---|
| stxppd | 100010 | Store word from an XPP data register into memory |
| ldxppd | 100011 | Load word from memory into an XPP data register |
| stxppe | 100110 | Store word from an XPP event register into memory |
| ldxppe | 100111 | Load word from memory into an XPP event register |

Format (3):

| op | rxpp(rd) | op3 | Rs1 | i = 0 | asi | rs2 | |
|---|---|---|---|---|---|---|---|
| op | rxpp(rd) | op3 | Rs1 | i = 1 | simm13 | | |
| 31 | 29 | 24 | 18 | 13 | 12 | 4 | 0 |

Assembler Syntax:

| | |
|---|---|
| stxppd | regᵣₓₚₚ, [adresse] |
| ldxppd | [adresse], regᵣₓₚₚ |
| stxppe | regᵣₓₚₚ, [adresse] |
| ldxppe | [adresse], regᵣₓₚₚ |

Description:

STXPPD/STXPPE writes a word from register rxpp into memory.

LDXPPD/LDXPPE loads a word from memory into register rxpp.

The effective address is calculated as “r[rs1]+r[s2]” in case that i=0, otherwise “r[rs1]+simm13”.

Traps:

xpp_readaccess_error

xpp_writeaccess_error

xpp_regnotexist_error

mem_address_not_aligned

Data Transfer Between CM and Memory

| Opcode | op3 | Operation |
|---|---|---|
| ldcm | 101010 | Load word from memory into a CM register |
| stcm | 101011 | Write word from CM register into memory |

Format (3):

| op | rcm(rd) | Op3 | rs1 | i = 0 | asi | rs2 | |
|---|---|---|---|---|---|---|---|
| op | rcm(rd) | Op3 | rs1 | i = 1 | simm13 | | |
| 31 | 29 | 24 | 18 | 13 | 12 | 4 | 0 |

Assembler Syntax:

| | |
|---|---|
| ldcm | reg_{rcm}, [adresse] |
| stcm | [adresse], reg_{rcm} |

Description:

STCM writes a word from register rcm into memory.

LDCM loads a word from memory into register rcm.

The effective address is calculated as “r[rs1]+rqrs2]” in case that i=0, otherwise as “r[rs1]+simm13”.

Traps:

privileged_instruction

cm_readaccess_error

cm_writeaccess_error

cm_regnotexist_error

mem_address_not_aligned

Data Transfer from Status Registers to LEON

| Opcode | Op3 | Operation |
|---|---|---|
| cptoleonsdi | 101100 | Copy a word from the status |
| | | register of an XPP data input |
| | | register into a LEON register |
| cptoleonsdo | 101101 | Copy a word from the status |
| | | register of an XPP data output |
| | | register into a LEON register |
| cptoleonsei | 110000 | Copy a word from the status |
| | | register of an XPP event input |
| | | register into a LEON register |
| cptoleonseo | 110001 | Copy a word from the status |
| | | register of an XPP event output |
| | | register into a LEON register |

Format (3):

| 11 | rd | op3 | rs1 | rst(opf) | | rs2 | |
|---|---|---|---|---|---|---|---|
| 31 | 29 | 24 | 18 | 13 | 12 | 4 | 0 |

Assembler Syntax:

| | |
|---|---|
| cptoleonsdi | regᵣₛₜ, reg_{rd} |
| cptoleonsdo | regᵣₛₜ, reg_{rd} |
| cptoleonsei | regᵣₛₜ, reg_{rd} |
| cptoleonseo | regᵣₛₜ, reg_{rd} |

Description:

CPTOLEONSDI loads a word from the status register r[rst] of a data input register into the register r[rd] of the LEON processor.

CPTOLEONSDO loads a word from the status register r[rst] of a data output register into the register r[rd] of the LEON processor.

CPTOLEONSEI loads a word from the status register r[rst] of an event input register into the register r[rd] of the LEON processor.

CPTOLEONSEO load a word from the status register r[rst] of an event output register into the register r[rd] of the LEON processor.

Traps:

st_readaccess_error

st_regnotexist_error

Data Transfer Between XPP Configuration Register and LEON

| Opcode | op3 | Operation |
|---|---|---|
| wrclkr | 111000 | Write clock ratio LEON-XPP into |
| | | clock register |
| wroffsetr | 111001 | Write into memory offset register |
| | | for memory mapped mode |
| rdclkr | 111010 | Read clock register for clock ratio |
| | | LEON-XPP |
| rdoffsetr | 111011 | Read memory offset register for |
| | | memory mapped mode |
| rdtrapr | 111110 | Read registers with informationen |
| | | about XPP trap |

Format (3):

| 11 | rd | op3 | unused | Unused | | unused | |
|---|---|---|---|---|---|---|---|
| 31 | 29 | 24 | 18 | 13 | 12 | 4 | 0 |

Assembler Syntax:

| | |
|---|---|
| wrclkr | r_{rd}, % clkr |
| wroffsetr | r_{rd}, % memoffsetr |
| rdclkr | % clkr, r_{rd} |
| rdoffsetr | % memoffsetr, r_{rd} |
| rdtrapr | % trapr, r_{rd} |

Description:

WRCLKR loads a word from the register r[rd] into the clock register. In case the register contains the value 0, the XPP unit is deactivated, whereas any other value indicates the clock ratio of the XPP unit to the LEON processor clock.

WROFFSETR loads a word from the register r[rd] into the memory offset register.

RDCLKR loads the content from the clock register into the register r[rd].

RDOFFSETR loads the content from the memory offset register into the register r[rd].

RDTRAPR loads the content of the trap information register into the register r[rd].

While at least a first embodiment of a coupling is disclosed in the text above, variations are possible.

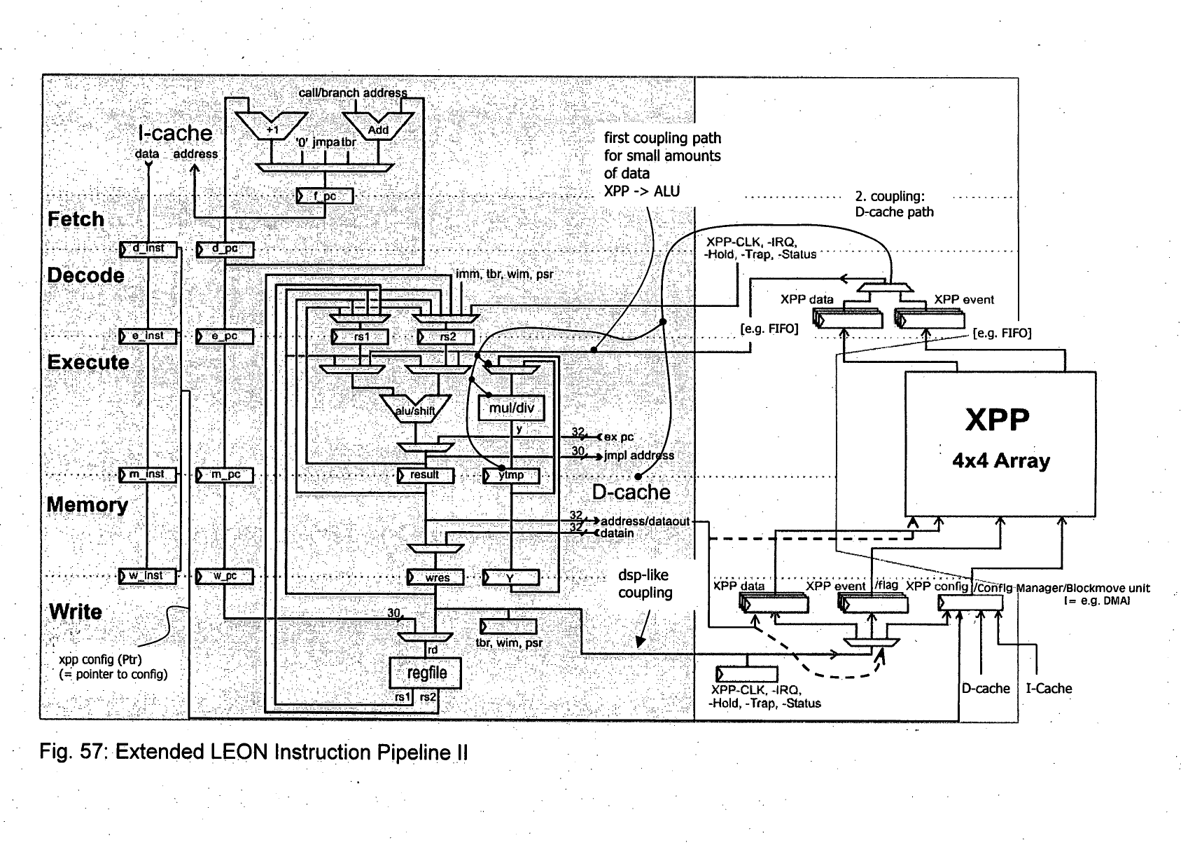

FIG. 57 shows another example of a preferred coupling between a conventional (von-Neumann-like and/or sequential) processor and an array of processing elements reconfigurable at runtime and/or on the fly, the figure referring to an XPP by way of example only, although, as in all parts of the present invention, aspects of the disclosure might in some cases be better understood by referring to publications that show and explain the functioning of an XPP in more detail.

Here, a plurality of details is described in other parts of the present application as will be obvious between the similarity of figures, yet some particular aspects showing preferred implementations and/or embodiments and/or aspects can be found in more detail in FIG. 57.

Now, as for FIG. 57, the attention is drawn to the following facts:

A coupling may use either one of two different paths, both paths can be implemented as an alternative, although in the preferred embodiment, these paths are implemented simultaneously.

The first path transfers data between the ALU (or other part, particularly in the data path) of the conventional processor and the XPP is dps-like and is thus intended for low-volume data transfer. As shown, it is possible to transfer data from the xpp array, preferably via FIFOs and, preferably a MUX allowing selection of either an XPP event data or an XPP result data in response to a setting of the MUX preferably by either the processor or the XPP to one or a number of operand inputs of the ALU or other units in the data path for ALU operand input such as MUXes or the like. It is to be noted that a number of different data can be transferred in that way, such as status information, flags and the like as well as arithmetic data. This transfer can be either from the ALU or a unit downstream therefrom in the datapath of the conventional processor. Also, data other than operand data, such as event and/or information regarding internal statas can be transferred from the XPP to the conventional processor it is coupled.

The second data path is to and/or from the cache and it is to e be noted that a coupling may be effected to both the D- and/or the I-cache. The coupling to the I-cache is advantageous so as to allow for a very fast reconfiguration of the processing array due to the possibility to handle only a minute amount of data within the sequential processor while allowing for large configuration data by. Here, not the entire configuration must be transferred through the ALU or other conventional unit. Reconfiguration can rely on either the conventional processor sending configurations or, more preferably, configuration load instructions (e.g. the address of a configuration or macro needed) to the array and/or a configuration unit such as a configuration manager coupled thereto, e.g. a FILMO and/or can rely on the array itself requesting reconfiguration for example after the instantiation of a first configuration as part of a larger macro that has been called as a subroutine or the like by the conventional processor. With respect to the data coupling to the D-cache or other (large) memory units such as memory banks, it is possible to allow for data streaming, e.g. using load/store configurations within the array as have been described elsewhere. It is possible to implement various methods of data streaming units such as DMA, cache controllers dedicated to operate together with the array and the like. It is to be noted that within the data path for this coupling, no register needs be present so that block move commands are easily implementable.

One of the advantages of the preferred coupling according to the invention as described in one aspect thereof is that it is effected via the instruction pipeline of the conventional processor design. The conventional processor and the array can be decoupled does not rely on registers, need to handle every single operand separately and also allows for a decoupling of processor and array by the use of FIFOs, the later aspect being advantageous in that both devices may be operated asynchronously, that is, it is not absolutely necessary in all and every case for one unit to wait until the other has finished a certain task. In contrast, it is sufficient to synchronize the two units by methods such as interrupt routines, and/or polling.

Also, the coupling shown is preferable over those known in the art since it allows for coupling into both the data and the control flow.

With respect to other parts of the present application, it is noted that whereas this part refers to FIFOs used in the data path to effect the data coupling, other parts, esp. those dealing in more detail with certain compiler techniques refer to the use of I-RAMs (internal RAMs) to effect the decoupling. It will be obvious that a FIFO used in the XPP-data input path, XPP data event input path and/or XPP config path might be replaced by an I-RAM or that both I-RAMs and FIFOs might be used simultaneously.

Where reference is being made to event data, it is to be noted that in simple cases these will be single bit data, but that it is possible to use event vectors as well, that is, event data having more than one bit.

1. A method of coupling
at least one (conventional) unit processing data in a sequential manner, e.g. a CPU, von-Neumann-Processor and/or microcontroller,
the (conventional) unit for data processing comprising an instruction pipeline,
and
an array for processing data comprising a plurality of data processing cells, e.g. a preferrably coarse grain and/or preferrably runtime reconfigurable data processor, FPGA, DFP, DSP, XPP or chaemeleon-technology-like data processing fabric,
wherein the array is coupled to the instruction pipeline.

2. A method in particular according to claim 1, wherein the input and/or output between the at least one (conventional) unit processing data in a sequential manner, e.g. a CPU, von-Neumann-Processor, microcontroller, and
an array for processing data comprising a plurality of data processing cells, e.g. a runtime and/or reconfigurable data processor, DFP, DSP, XPP or chaemeleon-technology-like data processing fabric,
wherein data is transferred via at least one data path being provided therebetween comprising at least one FIFO so as to allow for a less tight coupling and/or data processing within the at least two units that is not strictly synchronous.

3. A method according to any of the previous claims wherein data is transferred via at least one data path that allows for transfer of data between units not being transferred through a register.

4. A method according to any of the previous claims wherein a path for the transferal of status information and/or event information such as flags, overflow, carry and the like is provided between the (conventional) unit for data processing and the at least one array for processing data.

5. A device for processing data comprising at least one (conventional) unit processing data in a sequential manner, e.g. a CPU, von-Neumann-Processor and/or microcontroller,
the (conventional) unit for data processing comprising an instruction pipeline,
and,
an array for processing data comprising a plurality of data processing cells, e.g. a runtime and/or reconfigurable data processor, DFP, DSP, XPP or chaemeleon-technology-like data processing fabric,
wherein the array is coupled to the instruction pipeline.

6. The device according to the previous claim wherein
at least one data path is provided between the array and the conventional processor comprising at least one FIFO so as to allow for a less tight coupling and/or data processing within the at least two units that is not strictly synchronous
and/or wherein
at least one data path is provided that allows for transfer of data not being transferred through a register.

7. A method of at least one (conventional) unit processing data in a sequential manner, e.g. a CPU, von-Neumann-processor, microcontroller, being preferrably adapted for data processing to any of the previous methods and or according to a previously claimed devices
the (conventional) unit for data processing preferably comprising an instruction pipeline and
an array for processing data comprising a plurality of data processing cells, e.g. a runtime and/or reconfigurable data processor, DFP, DSP, XPP or chaemeleon-technology-like data processing fabric, wherein a path allowing for block data transfer is provided from the data cache and/or other data source and the array.

8. A method of data processing using an array of data processing elements wherein input data to be processed are duplicated prior to processing.

9. A method according to the previous claim wherein the input data to be processed are duplicated
by connecting a plurality of operand or other inputs to an input source such as the output of a data processing unit upstream in the data stream or
by using a unit storing and/or latching and/or holding said input data, the unit being within the data path and/or fanning out the data to a number of different inputs.

10. A method of data processing using an array of data processing elements reconfigurable at runtime, said data processing being effected by a plurality of configurations, wherein the amount of time allowed for running one configuration is limited.

11. A method of preparing an array for processing data reconfigurable at run time wherein a number of instructions is combined to form a number of configurations to be run one after the other and/or in parallel on said array and wherein an execution time of a single configuration is restricted, in particular when repeated operations are to be performed such as loops and/or iterations.
